(19) United States
(12) Patent Application Publication
(10) Pub. No.: US 2006/0198659 A1
(43) Pub. Date: Sep. 7, 2006

(54) Image forming apparatus and image forming method

(76) Inventor: Tatsuya Niimi, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/364,325

(22) Filed: Mar. 1, 2006

(30) Foreign Application Priority Data
Mar. 4, 2005 (JP) 2005-059829

(51) Int. Cl. G03G 15/00; G03G 21/00; G03G 5/06

(52) U.S. Cl. 399/128; 399/159; 430/59.2; 430/59.3; 430/59.4; 430/124

(57) ABSTRACT

An image forming apparatus including an electrostatic latent image bearing member including a photosensitive layer including a charge generation layer containing an organic charge generation material, and a charge transport layer; an electrostatic latent image forming device configured to form an electrostatic latent image on a surface of the electrostatic latent image bearing member; a developing device configured to develop the electrostatic latent image bearing member with a developer including a toner to form a toner image on the surface of the image bearing member; a transfer device configured to transfer the toner image onto a receiving material; a discharging device configured to dissipate charges remaining on the image bearing member by irradiating the image bearing member with discharging light with a wavelength of less than 500 nm after the toner image is transferred; and a fixing device configured to fix the toner image to the receiving material.

### BACKGROUND OF THE INVENTION

1. Field of the Invention

The present invention relates to an image forming apparatus and an image forming method. Particularly, the present invention relates to an electrophotographic image forming apparatus and an electrophotographic image forming method using a photoreceptor, which has a layered photosensitive layer including a charge generation layer, and a charge transport layer; and a discharging device using light.

2. Discussion of the Background

Recently, development of information processing systems utilizing electrophotography is remarkable. In particular, optical printers in which information converted to digital signals is recorded using light have been dramatically improved in print qualities and reliability. This digital recording technique is applied not only to printers but also to copiers, and so-called digital copiers have been developed and used. Copiers utilizing both the conventional analogue recording technique and this digital recording technique have various information processing functions, and therefore it is expected that demand for such copiers will be escalating. In addition, with popularization and improvement of personal computers, the performance of digital color printers which can produce documents including color images has been rapidly improved.

Electrophotographic image forming methods typically include the following image forming processes:
(1) charging an image bearing member such as photoreceptors (charging process);
(2) irradiating the charged photoreceptor with imagewise light to form an electrostatic latent image on the photoreceptor (imagewise light irradiating process);
(3) developing the electrostatic latent image with a developer including a toner to form a toner image on the photoreceptor (developing process);
(4) transferring the toner image onto a receiving material (transfer process);
(5) fixing the toner image on the receiving material (fixing process);
(6) cleaning the surface of the photoreceptor (cleaning process); and
(7) discharging a charge remaining on the photoreceptor (discharging process).

Conventionally analogue image forming methods have been used for electrophotographic image formation. Analogue image forming methods typically use a posi-posi developing method. However, currently digital image forming methods are typically used and almost all of these image forming apparatuses use a nega-posi developing method. This is because almost all images to be produced by these image forming apparatuses are character images, which typically have a relatively low image area proportion of from 5 to 10%.

Conventional analogue image forming methods typically use a posi-posi developing method in which a charged photoreceptor is exposed to a light image which is prepared by irradiating an original image, and a non-lighted portion, which is an image portion and has a relatively high potential, is developed with a toner, resulting in formation of a toner image. In contrast, digital image forming methods typically use a nega-posi developing method in which a charged photoreceptor is exposed to a light image, and a lighted portion, which is an image portion and has a relatively low potential, is reversely developed with a toner, resulting in formation of a toner image. The image forming methods using a nega-posi developing method have an advantage in that the output time of a light source (such as laser diodes) of a light irradiating device can be dramatically reduced (to about one-tenth).

In the nega-posi developing method, a non-image portion (i.e., a non-lighted portion) of a photoreceptor has a high potential even after a developing process. Therefore, the photoreceptor is subjected to a discharge process after the transfer process. Specific examples of the discharging methods include optical discharging methods in which light irradiates the photoreceptor to cancel the residual charge by the photo-carriers generated by light irradiation; mechanical discharging methods in which an electroconductive member such as brushes is contacted with the photoreceptor to leak the residual charge; electrical discharging methods in which a reverse bias is applied to the photoreceptor to cancel the residual charge; etc.

Recently, electrophotographic image forming apparatuses can produce high definition images and color images. Therefore, information (i.e., original images) input to such image forming apparatuses to be produced is slightly changed from character images to photograph images, color pictures and graphs, etc. When such images are produced, a problem in that the resultant images have a ghost image of a previously formed image occurs unless the charge remaining on the photoreceptor is discharged. A ghost image is typically formed as follows. When a residual charge is insufficiently discharged, the photoreceptor has an uneven potential after being charged. When light irradiates such a photoreceptor to form an image (particularly a half tone image), the resultant electrostatic latent image has an uneven potential. When such a latent image is developed, a ghost image of the image formed in the last image forming operation is formed in the resultant toner image.

There are two causes for formation of a ghost image. One of the causes is that since image formation is performed at a high speed, there is a case where the capacity of the charger used is insufficient for evenly charging a photoreceptor having a residual charge. In this case, a ghost image is caused. The other of the causes is that a charging roller is used as a charger of an image forming apparatus to miniaturize the image forming apparatus (particularly tandem type image forming apparatus). Charging rollers, which cause discharging between the surface thereof and the surface of a photoreceptor, cause a ghost image relatively easily compared to conventional charging device such as corotrons and scorotrons.

In any event it is important to uniform the residual potential of a photoreceptor (i.e., the potential of a photoreceptor just before charging). Therefore, in order to produce high quality images, the discharging process is very important now.

Among the various discharging methods mentioned above, the methods except for the optical discharging methods have the following drawbacks. Specifically, since the discharging methods using a brush or the like contacts the member with a photoreceptor, the photoreceptor and the member are easily abraded, and thereby the lives of the photoreceptor and the member are shortened. In addition, the methods cause a problem in that when the surface of the photoreceptor or the member is contaminated with a toner or the like, the discharging effect is deteriorated. Further, the methods cannot perform discharging at a high speed, and therefore the methods are not suitable for high speed image forming apparatuses.

The electrical discharging methods applying a reverse bias to a photoreceptor have a drawback in that when the bias is too low, even discharging cannot be performed, and when the bias is too high, the photoreceptor is reversely charged (i.e., the photoreceptor has positive charges). Since general photoreceptors can transport only positive charges, positive charges formed on the photoreceptors cannot be cancelled. When the thus positively charged photoreceptor is negatively charged in the following charging process for forming an image, the photoreceptor is charged so as to have a predetermined negative potential after the positive charges thereon are cancelled by the negative charging. Therefore, the negatively charging tends to be insufficiently performed, resulting in formation of an uneven residual potential on the photoreceptor. In addition, when positive charges are formed, traps are formed in the photosensitive layer, and thereby a residual potential is easily formed on the photoreceptor. In this case, the life of the photoreceptor is shortened.

Thus, the optical discharging methods are preferable for electrophotographic image forming methods and apparatuses at the present time. As mentioned above, images to be produced by an image forming apparatus typically have an image area proportion of 10% at the highest. Therefore, 90% or more of the surface of a photoreceptor is discharged (i.e., photo-carriers are generated in 90% or more of the photosensitive layer to discharge the residual charges) when the nega-posi developing method is used whereas 10% or less of the surface of a photoreceptor is discharged when conventional image forming methods using a posi-posi developing method are used. Therefore, the discharging process has been hardly studied until now.

Published unexamined Japanese patent applications Nos. (hereinafter referred to as JP-As) 60-88981 and 60-88982 disclose an image forming apparatus which uses a photoreceptor including an inorganic photosensitive material (such as selenium alloys and amorphous silicon) and which uses a discharging device emitting light having a relatively short wavelength to reduce fatigue of the photoreceptor caused by the light irradiation and charging. However, the photoreceptor disclosed therein is an inorganic photoreceptor and therefore the technique cannot be applied to organic photoreceptors as it is. This is because the photo-carrier generation mechanism of inorganic photoreceptors is different from that of organic photoreceptors. In addition, the image forming apparatus uses a posi-posi developing method, and therefore the technique cannot be used for nega-posi developing methods as it is because the influence of the discharging on residual charges in nega-posi developing methods is different from that in posi-posi developing methods. Further, as a result of the present inventor's experiment, it is found that the discharging device, which emits light including a component with a wavelength of not less than 500 nm, cannot produce good discharging effects.

JP-A 61-36784 discloses a discharging technique in that light used for discharging a photoreceptor including a photosensitive material whose photosensitivity is improved by a dye has a wavelength which is substantially identical to the specific wavelength at which the non-sensitized photosensitive material has a photosensitivity (i.e., which is not the wavelength at which the dye has absorption). For example, when a photoreceptor using polyvinyl carbazole which has absorption in the ultraviolet region and whose sensitivity to visible light is improved by adding a dye (which has absorption in the visible region) thereto is used, a discharging device emitting light having a wavelength in the ultraviolet region is used. In this case, when discharging is performed using ultraviolet light, the photo-carrier generation efficiency is low and thereby discharging cannot be efficiently performed. In addition, the photosensitive material (i.e., polyvinyl carbazole) is easily deteriorated by the ultraviolet light. Therefore, the technique is not effective. Further, this technique is used for posi-posi developing methods, and therefore the technique cannot be effectively used for nega-posi developing methods.

JP-A 62-38491 discloses a discharging technique in that light having a relatively short wavelength range irradiates a photoreceptor having a photosensitivity in a relatively long wavelength region and having lower or little photosensitivity in the relative short wavelength range to prevent fatigue of the photoreceptor caused by the light irradiation. However, when the technique is used for high speed image forming apparatuses, the discharging effect is poor, resulting in formation of a ghost image. Namely, the technique cannot be applied to current image forming apparatuses. In addition, JP-A 62-38491 does not specify the wavelength range of the discharging light.

JP-As 01-217490 and 01-274186 have disclosed discharging techniques in that light with a wavelength of not greater than 620 nm irradiates a positive-chargeable photoreceptor having a layered photosensitive layer in which a charge generation layer is formed on a charge transport layer. The light used for discharging includes light with a wavelength of not less than 500 nm. As a result of the present inventor's experiment using these techniques, the residual charge decreasing effect is insufficient.

JP-A 04-174489 discloses a discharging technique in that two kinds of light emitting diodes irradiate a photoreceptor to prevent increase of residual potential of the photoreceptor under high temperature and high humidity conditions. The light used for discharging includes light with a wavelength of not less than 500 nm. As a result of the present inventor's experiment using this technique, the residual charge decreasing effect is insufficient.

Japanese patent No. 3,460,285 (i.e., JP-A 7-199759) discloses a discharging technique of using discharging light having light intensity, which exceeds the half value of the maximum absorption peak of the photosensitive layer of the photoreceptor used, at a wavelength within the wavelength range between the lower and upper half values of the maximum absorption peak, wherein the photosensitive layer is a single-layered photosensitive layer including an organic pigment. In general, organic pigments used as photosensitive materials have absorption in the visible region, and thereby light with a wavelength of not less than 500 nm has to be used for the discharging light. As a result of the present inventor's experiment using the technique, the residual charge decreasing effect is insufficient.

JP-A 2002-287382 discloses a discharging technique in that discharging is performed using light to which the photoreceptor used has a higher sensitivity than that to the image writing light. It is described therein that by using this technique, the residual potential can be reduced and thereby formation of a ghost image can be prevented. In JP-A 2002-287382, the wavelength of the discharging light changes depending on the photosensitive material used for the photoreceptor and therefore the wavelength is not specified therein. In general, organic pigments have absorption in the visible region. Therefore there is a case where light with a wavelength not less than 500 nm is used for discharging. In this case, the residual charge decreasing effect is insufficient.

JP-A 2005-31110 discloses a discharging technique in that light, against which the photoreceptor used has relatively low absorption, irradiates the photoreceptor to discharge residual charge thereon, wherein the photoreceptor has a single-layered photosensitive layer in which a charge generation material is dispersed. This light irradiation is performed to remove charges generated within the photosensitive layer. Specifically, in a case of single-layered photosensitive layer, a charge generation material is uniformly dispersed in the entire photosensitive layer. Imagewise light, against which the photosensitive layer has relatively high absorption, is absorbed by the surface portion of the photosensitive layer, and therefore photo-carriers are formed in the surface portion. However, the charges formed in the inner portions of the photosensitive layer far from the surface portion remain therein while being trapped. The thus trapped charges cannot be cancelled by the discharging. In attempting to solve the problem, light which has such a relatively long wavelength as to be able to enter into the bottom portions of the layer is used as discharging light to generate photo-carriers therein, and cancel the trapped charges with the photo-carriers. However, in general the photosensitive layer of a photoreceptor having a layered photosensitive layer is relatively thin compared to single-layered photosensitive layers. In addition, the image writing light is absorbed by the layered photosensitive layers at a rate of not greater than 90% (i.e., 10% or more of the image writing light passes through the photosensitive layers. Therefore, charge generation is performed in the entire photosensitive layers unlike the single-layered photosensitive layers even when the wavelength of the image writing light is changed. Therefore, the effect described in JP-A 2005-31110 is not produced for photoreceptors having a layered photosensitive layer.

JP-A 2004-45996 discloses a discharging technique of using discharging light having a wavelength corresponding to the soret band of a phthalocyanine compound used for the photosensitive layer. It is described therein to use a fluorescent lamp as a discharging light source. It is also described in JP-A 2004-45997 to use a fluorescent lamp as a discharging light source for a photoreceptor including a phthalocyanine compound as a photosensitive material. FIG. 1 illustrates the emission spectrum of a fluorescent lamp. The spectrum includes several emission lines, and a high emission line is observed at a wavelength of from 500 to 650 nm. Since the quantities of components of the fluorescent light are proportional to the areas of the peaks, the components of the light having a wavelength of from 500 to 650 nm mainly irradiate the photoreceptor. In JP-As 2004-45996 and 2004-45997, discharging using a LED emitting red light with a wavelength of 680 nm is compared with discharging using a fluorescent lamp. Since a fluorescent lamp mainly irradiates light having a wavelength of from 500 to 650 nm, discharging using light having a wavelength of from 500 to 650 nm is compared with discharging using light with a wavelength of 680 nm. Although each light includes a component corresponding to the soret band of a phthalocyanine compound, the light quantity of the component is small. Therefore, the discharging method hardly produces a good effect.

In addition, image forming apparatuses are required to produce high quality color images and to have high durability. In order to produce high quality images in digital image forming apparatuses, one of the key points is to form a clear and small one-dot electrostatic latent image and the other of the key points is to prevent formation of abnormal images. In addition, it is important to prolong the life of the photoreceptors used for the image forming apparatuses. In order to develop the key technologies, it is important to reduce fatigue of a photoreceptor, specifically it is important to prevent increase of residual potential of lighted portions of a photoreceptor.

In order to prevent increase of residual potential of lighted portions of a photoreceptor, the materials used for the photoreceptor and the formulation of the layers of the photoreceptors have been studied. However, the fatigue of photoreceptor largely depends not only on the formulation of the layers of photoreceptors but also on the image forming conditions of image forming apparatuses. Therefore, it is the conventional way of researchers and developers that materials and formulations are studied to develop a photoreceptor suitable for the target image forming apparatus. In other words, it has not been performed to study fatigue of photoreceptors from the viewpoint of image forming conditions.

Because of these reasons, a need exists for an image forming apparatus and method which can produce high quality images while preventing increase of residual potential of the photoreceptor used for the apparatus even after long repeated use.

### SUMMARY OF THE INVENTION

As one aspect of the present invention, an image forming apparatus is provided which includes:

an electrostatic latent image bearing member configured to bear an electrostatic latent image, which includes a photosensitive layer including a charge generation layer containing an organic charge generation material, and a charge transport layer;

an electrostatic latent image forming device configured to form the electrostatic latent image on a surface of the electrostatic latent image bearing member;

a developing device configured to develop the electrostatic latent image with a developer including a toner to form a toner image on the image bearing member;

a transferring device configured to transfer the toner image onto a receiving material;

a fixing device configured to fix the toner image to the receiving material; and

a discharging device configured to dissipate charges remaining on the image bearing member by irradiating the image bearing member with light having a wavelength of less than 500 nm after the toner image is transferred.

As another aspect of the present invention, an image forming method is provided which includes:

forming an electrostatic latent image on an electrostatic latent image bearing member including a photosensitive layer including a charge generation layer containing an organic charge generation material, and a charge transport layer;

developing the electrostatic latent image with a developer including a toner to form a toner image on the image bearing member;

transferring the toner image onto a receiving material;

fixing the toner image to the receiving material; and

dissipatng charges remaining on the image bearing member by irradiating the image bearing member with light having a wavelength of less than 500 nm after transferring the toner image transfer process.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 illustrates the emission spectrum of a fluorescent lamp;

FIG. 2 is a schematic view for explaining how an organic material generates a photo-carrier;

FIG. 3 is a schematic view for explaining how an inorganic material generates a photo-carrier;

FIGS. 4-7 are schematic views illustrating the cross-section of examples of the photoreceptor for use in the image forming apparatus of the present invention;

FIGS. 8 and 9 are photographs showing the dispersion states of a charge generation material in different dispersions A and B which are prepared by the same method except that the dispersion time is changed;

FIG. 10 is a graph showing the particle diameter distributions of the dispersions A and B;

FIG. 11 is a schematic view illustrating an embodiment of the image forming apparatus of the present invention;

FIG. 12 is a schematic view illustrating another embodiment (a tandem-type full color image forming apparatus) of the image forming apparatus of the present invention;

FIG. 13 is a schematic view illustrating a process cartridge for use in the image forming apparatus of the present invention;

FIGS. 14 and 15 are test charts for use in the running test in Examples 6 and 13;

FIG. 16 is a micrograph showing a titanyl phthalocyanine raw material having an amorphous state, which is taken using a transmission electron microscope;

FIG. 17 is a micrograph showing primary particles of a titanyl phthalocyanine crystal prepared by subjecting the titanyl phthalocyanine raw material to a crystal changing treatment, which is taken using a transmission electron microscope;

FIG. 18 is a micrograph showing primary particles of a titanyl phthalocyanine crystal prepared by rapidly performing the crystal changing treatment, which is taken using a transmission electron microscope;

FIG. 19 is the X-ray diffraction spectrum of the titanyl phthalocyanine crystal prepared in Synthesis Example 5;

FIG. 20 is the X-ray diffraction spectrum of the titanyl phthalocyanine pigment obtained by drying the wet paste prepared in Synthesis Example 5;

FIG. 21 is the X-ray diffraction spectrum of the titanyl phthalocyanine crystal prepared in Comparative Synthesis Example 10;

FIG. 22 is the X-ray diffraction spectrum of the pigment prepared in Measurement Example 1; and

FIG. 23 is the X-ray diffraction spectrum of the pigment prepared in Measurement Example 2.

### DETAILED DESCRIPTION OF THE INVENTION

The present inventor has studied how the electrostatic fatigue (particularly increase of residual potential) of a photoreceptor is influenced by image forming conditions of the image forming apparatus for which the photoreceptor is used. The procedure for the study is as follows.

A running test which was performed is that a photoreceptor is repeatedly subjected to a charging process, an imagewise light irradiating process and a discharging process in an image forming apparatus from which the developing device, transferring device and cleaning device are removed to avoid influence of the devices on the electrostatic fatigue of the photoreceptor. In this running test, (1) the image area proportion of the images to be produced was changed while the quantity of charges passing through the photoreceptor and the residual potential of the photoreceptor were measured, and (2) the charges of the charged photoreceptor were removed only by discharging light (without performing image writing) while the quantity of charges passing through the photoreceptor and the residual potential of the photoreceptor were measured.

As a result of the running test, the following knowledge can be obtained.

(1) The increase of residual potential of the photoreceptor depends on the quantity of charges passing through the photoreceptor. This is true even when the image area proportion of the images to be produced is changed.

(2) The quantity of charges passing through the photoreceptor depends on the quantity of light irradiating the photoreceptor (i.e., the total quantities of image writing light and discharging light, namely the quantity of light absorbed by the photoreceptor) in one image forming cycle.

(3) In a nega-posi developing method, the quantity of discharging light constitutes the majority of the total light quantity.

In addition, the procedure for the running test was repeated except that the transfer device was attached to the image forming apparatus so that a reverse bias could be applied to the photoreceptor. In this case, the conditions of the bias were adjusted so that the residual potential of the photoreceptor just before the discharging process (i.e., just after the transfer process) was substantially the same as that of the photoreceptor just after the discharge process in the above running test. As a result of this running test, it was found that the increase of residual potential of the photoreceptor can be dramatically reduced; and the increase of residual potential depends on the image area proportion of the produced images. Namely, it was found that the discharging process does not influence on the increase of residual potential in this case.

As a result of the running test, the following knowledge can be obtained.

(4) When the residual potential of a photoreceptor before a discharging process is decreased, the residual potential increasing problem can be avoided. In other words, when the potential of a photoreceptor just before a discharging process is low, the residual potential increasing problem is not caused by discharging light irradiation.

(5) Even when residual potential of a photoreceptor is decreased by applying a reverse bias, the degree of increase in residual potential of the photoreceptor is proportional to the charges passing through the photoreceptor, which is the same as the result mentioned above in paragraph (1).

It is clear from the knowledge (1) to (5) that the increase of residual potential of a photoreceptor depends on the charges passing through the photoreceptor and almost all the charges passing through the photoreceptor are generated in the discharging process. Therefore, in order to control the increase of residual potential of a photoreceptor, it is important to control the discharging process for the photoreceptor.

The quantity of charges passing through a photoreceptor are defined as the quantity of charges passing through a portion of the photoreceptor having a unit area in one image forming cycle, and changes depending on the quantity of photo-carriers generated. Therefore, the charge quantity changes depending on the following factors:

(A) the potential of the charged photoreceptor (i.e., the intensity of the electric field formed on the photoreceptor);

(B) the quantity of light irradiating the photoreceptor;

(C) the area of the lighted portion of the photoreceptor;

(D) the capacitance (thickness) of the photoreceptor (photosensitive layer);

(E) the photo-carrier generating efficiency of the photoreceptor; etc.

However, these conditions cannot be widely changed in image forming apparatuses. For example, when the potential of a charged photoreceptor is largely increased, the photoreceptor is easily damaged. In contrast, when the potential is largely decreased, the potential of a background area of an image (i.e., difference between the potential of a non-lighted portion of the photoreceptor and the developing bias) is decreased or the developing potential (i.e., difference between the developing bias and the potential of a lighted portion of the photoreceptor) is decreased. Therefore, high quality images cannot be stably produced because there is little margin for image forming conditions.

When the quantity of light irradiating the photoreceptor is largely decreased, images with low image density and low contrast are produced. In contrast, when the light quantity is largely increased, clear dot images cannot be produced because each dot of the dot images is widened.

The capacitance and carrier generation efficiency of a photoreceptor cannot be largely changed unless the materials constituting the photoreceptor are changed. In this regard, the main materials used for photoreceptors (such as charge generation materials and charge transport materials) for use in high speed, and highly durable and stable image forming apparatuses are limited. Therefore, it is difficult to largely change the capacitance and carrier generation efficiency of a photoreceptor.

Accordingly, the quantity of charges passing through a photoreceptor is changed mainly depending on the quantity of light irradiating the photoreceptor.

As mentioned above, one image forming cycle typically includes charging, imagewise light irradiating, developing, transferring, fixing, cleaning and discharging processes. Among these processes, only imagewise light irradiating and discharging processes are related to the light irradiation.

In general, current digital image forming apparatuses use a nega-posi developing method. This is because since the image area proportion of images to be produced is about 10% at the highest, the stress on the imagewise light irradiating device can be decreased by using the method. However, the charges remaining on a photoreceptor affect the following charging process to be performed on the photoreceptor. Therefore, residual charges have to be decreased as much as possible before the following charging process.

Since the image area proportion of images is about 10%, 90% or more of the surface of a photoreceptor has a relatively high potential just before the discharging process. By irradiating the surface of the photoreceptor with discharging light, photo-carriers are generated in the photoreceptor and thereby the residual charges can be cancelled. Namely, in one image forming cycle 90% of the charges passing through the photoreceptor are generated in the discharging process.

As mentioned above, analysis of electrostatic fatigue of a photoreceptor from the viewpoint of image forming conditions has been hardly performed. As a result of the present inventor's study, it is found that the discharging process largely influences thereon. Further, the present inventor has studied the conditions of discharging light (particularly the wavelength of discharging light).

In general, light which can be absorbed by the photoreceptor (i.e., the charge generation layer) can be used as the discharging light. In order to uniformly irradiate a photoreceptor in the longitudinal direction thereof, light sources such as LED arrays and fluorescent lamps are typically used for discharging. In the past, fluorescent lamps were mainly used. However, fluorescent lamps have the following drawbacks.

(1) Since a part of the light emitted thereby is absorbed by a charge transport layer, a sufficient quantity of light cannot reach a charge generation layer, and thereby the quantity of the light has to be increased; and

(2) Since a part of the light emitted thereby is absorbed by a charge transport layer, the charge transport material therein is deteriorated, resulting in deterioration of the charging properties of the photoreceptor.

In order to avoid such problems, LEDs emitting red light (with a wavelength on the order of 600 nm) have been used because such light is not absorbed by typical charge transport materials and is well absorbed by typical charge generation materials. Therefore, the above-mentioned problems specific to fluorescent lamps can be solved, and discharging can be well performed. In addition, such red LEDs have low costs.

The present inventor has a question as to whether such long wavelength light is suitable for discharging, and has studied the dependence of discharging (i.e., residual potential) on the wavelength of the light used for the discharging. Specifically, residual potentials of photoreceptors after a running test were measured by changing the wavelength of discharging light. As a result of the experiment, it was found that the residual potential after discharging using red light is relatively high compared to that in the cases where light having a relatively short wavelength is used for discharging. In addition, it was found that when light having a wavelength of less than 500 nm is used, the residual potential is hardly increased. This experiment was performed while controlling the quantity of charges passing through the photoreceptors per a unit time in the discharging process to be constant. Therefore, the quantity of discharging light irradiating a photoreceptor is changed depending on the wavelength of the discharging light, but the quantity of light absorbed by the photoreceptor is not changed. Accordingly, it was found from the experiment that the increase of residual potential of a photoreceptor is influenced by the wavelength of discharging light.

Thus, the present inventor has made this invention. Specifically, it is found that by using light having a wavelength of less than 500 nm for discharging charges remaining on a photoreceptor which includes a layered photosensitive layer including a charge generation layer and a charge transport layer, the residual charge increasing problem can be avoided and high quality images without abnormal images can be produced.

More specifically, the present invention is as follows.

An image forming apparatus is provided which includes:

an electrostatic latent image bearing member configured to bear an electrostatic latent image, which includes a photosensitive layer including a charge generation layer containing an organic charge generation material, and a charge transport layer;

an electrostatic latent image forming device configured to form the electrostatic latent image on a surface of the electrostatic latent image bearing member;

a developing device configured to develop the electrostatic latent image with a developer including a toner to form a toner image on the image bearing member;

a transferring device configured to transfer the toner image onto a receiving material;

a fixing device configured to fix the toner image to the receiving material; and

a discharging device configured to dissipate charges remaining on the image bearing member by irradiating the image bearing member with light with a wavelength of less than 500 nm after the toner image is transferred.

The organic charge generation material is preferably an azo pigment having the following formula (XI):
Ar—(—N═N-Cp)ₙ (XI)
wherein Ar represents a substituted or unsubstituted aromatic hydrocarbon group or a substituted or unsubstituted heterocyclic ring group, which can be connected with the azo group with or without a group therebetween; Cp represents a residual group of a coupler; n is an integer of from 2 to 6, wherein the coupler has the following formula (XII): 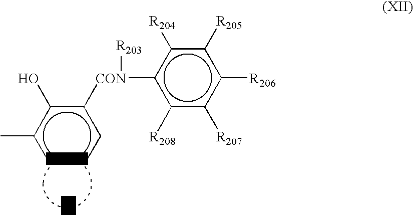
wherein R₂₀₃ represents a hydrogen atom, an alkyl group, or an aryl group; R₂₀₄, R₂₀₅, R₂₀₆, R₂₀₇ and R₂₀₈ independently represent a hydrogen atom, a nitro group, a cyano group, a halogen atom (such as a fluorine atom, a chlorine atom, a bromine atom and an iodine atom), a halogenated alkyl group, an alkyl group (such as a methyl group and an ethyl group), an alkoxyl group (such as a methoxy group and an ethoxy group), a dialkylamino group or a hydroxyl group; and Z represents an atomic group needed for constituting a substituted or unsubstituted aromatic carbon ring or a substituted or unsubstituted aromatic heterocyclic ring.

Alternatively, the azo pigment may be a compound having the following formula (XIII): 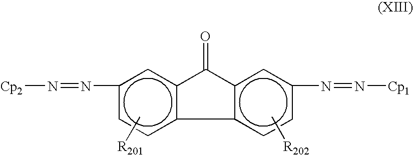
wherein R₂₀₁ and R₂₀₂ independently represent a hydrogen atom, a halogen atom, an alkyl group, an alkoxyl group, or a cyano group; and Cp₁ and Cp₂ independently represent a residual group of a coupler, which has the above-mentioned formula (XII).

Alternatively, the azo pigment may be a compound having the following formula (XIV): 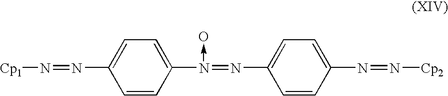
wherein Cp₁ and Cp₂ are defined above in formula (XI).

Alternatively, the azo pigment may be a compound having the following formula (XV): 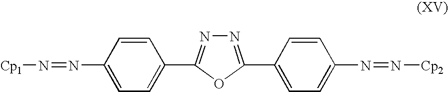
wherein Cp₁ and Cp₂ are defined above in formula (XI).

The groups Cp₁ and Cp₂ are preferably different from each other.

The organic charge generation material may be a phthalocyanine compound. Suitable phthalocyanine compounds are as follows.
(1) gallium phthalocyanine compounds;
(2) chlorogallium phthalocyanine compounds, which preferably have an X-ray diffraction spectrum such that a strong peak is observed at each of Bragg (2 θ) angles (±0.2°) of 7.4°, 16.6°, 25.5° and 28.3° when a Cu—K_{α} X-ray having a wavelength of 1.542 Å is used;
(3) hydroxygallium phthalocyanine compounds, which preferably have an X-ray diffraction spectrum such that a strong peak is observed at each of Bragg (2 θ) angles (±0.2°) of 7.5°, 25.1° and 28.3°; and
   (4) titanyl phthalocyaine compounds, which preferably have an X-ray diffraction spectrum such that a maximum peak is observed at a Bragg (2 θ) angle (±0.2°) of 27.2°; an X-ray diffraction spectrum such that a strong peak is observed at each of Bragg (2 θ) angles (±0.2°) of 9.0°, 14.2°, 23.9° and 27.1°; or an X-ray diffraction spectrum such that a maximum peak is observed at a Bragg (2 θ) angle of 27.2±0.2°, a lowest angle peak at an angle of 7.3±0.2°, and a main peak at each of Bragg (2 θ) angles (±0.2°) of 9.4°, 9.6°, and 24.0°, wherein no peak is observed between the peaks of 7.3° and 9.4° and at an angle of 26.3±0.2°.

The titanyl phthalocyanine compounds preferably have an average primary particle diameter of not greater than 0.25 μm.

The charge generation layer is preferably prepared using a coating liquid prepared by a method including:

dispersing the titanyl phthalocyanine crystal in a solvent such that the titanyl phthalocyanine crystal therein has a particle diameter distribution such that an average particle diameter is not greater than 0.3 μm and a standard deviation is not greater than 0.2 μm to prepare a dispersion; and

filtering the dispersion using a filter having an effective pore diameter of not greater than 3 μm.

The titanyl phthalocyanine compound is preferably prepared by a method including:

providing a titanyl phthalocyanine pigment having an amorphous state or a low crystallinity, which has an average particle diameter of not greater than 0.1 μm and has a second X-ray diffraction spectrum such that a maximum peak having a half width not less than 10 is observed at a Bragg (2 θ) angle of from 7.0° to 7.5° with a tolerance of ±0.2°;

changing the crystal form of the titanyl phthalocyanine having an amorphous state or a low crystallinity in an organic solvent in the presence of water so that the resultant titanyl phthalocyanine crystal has an X-ray diffraction spectrum such that a maximum peak is observed at a Bragg (2 θ) angle of 27.2°±0.2°; a peak is observed at each of Bragg (2 θ) angles (±0.2°) of 9.4°, 9.6° and 24.0°; a lowest angle peak is observed at an angle of 7.3°±0.2°; no peak is observed between the lowest angle peak and the 9.4° peak; and no peak is observed at a Bragg (2 θ) angle of 26.3°±0.2°, when a Cu—K_{α} X-ray having a wavelength of 1.542 Å is used; and

filtering the dispersion including the titanyl phthalocyanine crystal before the average primary particle diameter thereof exceeds 0.25 μm, to prepare the titanyl phthalocyanine compound.

The charge transport layer preferably has a transmittance of not less than 30% against the discharging light.

The charge transport material included in the charge transport layer preferably has a triarylamine structure, which is preferably the following formula (XVI): 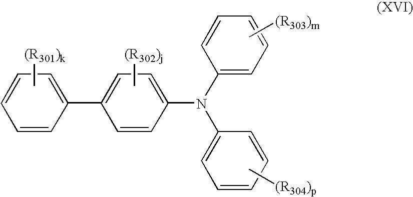
wherein R₃₀₁, R₃₀₃, and R₃₀₄ independently represent a hydrogen atom, an amino group, an alkoxyl group, a thioalkoxyl group, an aryloxy group, a methylenedioxy group, a substituted or unsubstituted alkyl group, a halogen atom, or a substituted or unsubstituted aryl group; R₃₀₂ represents a hydrogen atom, an alkoxyl group, a substituted or unsubstituted alkyl group or a halogen atom; and each of k, j, m and p is an integer of from 1 to 4, wherein when k, j, m or p is an integer of from 2 to 4, the plural groups in the corresponding group R₃₀₁, R₃₀₂, R₃₀₃ or R₃₀₄ may be the same or different from each other.

The charge transport layer preferably includes a polycarbonate having a triarylamine structure in a main chain or a side chain thereof.

The photoreceptor preferably has a protective layer overlying the charge transport layer. In this regard, “overlying” can include direct contact and allow for intermediate layers. The protective layer preferably has a transmittance of not less than 30% against the discharging light. The protective layer preferably includes a material selected from the group consisting of inorganic pigments and metal oxides, which have a resistivity of not less than 10¹⁰ Ω·cm. The protective layer is preferably prepared by subjecting a tri- or more-functional radical polymerizable monomer having no charge transport structure and a monofunctional radical polymerizable monomer having a charge transport structure to a crosslinking reaction. The monofunctional radical polymerizable monomer having a charge transport structure preferably has the following formula (XVII) or (XVII):

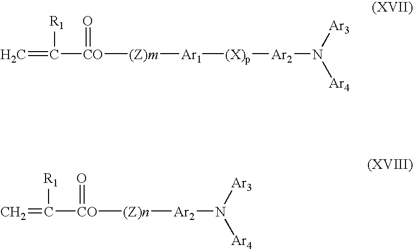

In formulae (XVII) and (XVIII), R¹ represents a hydrogen atom, a halogen atom, a substituted or unsubstituted alkyl group, a substituted or unsubstituted aralkyl group, a substituted or unsubstituted aryl group, a cyano group, a nitro group, an alkoxy group, a —COOR⁷ group (wherein R⁷ represents a hydrogen atom, a substituted or unsubstituted alkyl group, a substituted or unsubstituted aralkyl group and a substituted or unsubstituted aryl group), a halogenated carbonyl group or a —CONR⁸R⁹ (wherein each of R⁸ and R⁹ represents a hydrogen atom, a substituted or unsubstituted alkyl group, a substituted or unsubstituted aralkyl group and a substituted or unsubstituted aryl group); each of Ar¹ and Ar² represents a substituted or unsubstituted arylene group; each of Ar³ and Ar⁴ represents a substituted or unsubstituted arylene group; X represents a substituted or unsubstituted alkylene group, a substituted or unsubstituted cycloalkylene group, a substituted or unsubstituted alkylene ether group, an oxygen atom, a sulfur atom or a vinylene group; Z represents a substituted or unsubstituted alkylene group, a substituted or unsubstituted divalent alkylene ether group, or a substituted or unsubstituted divalent alkyleneoxy carbonyl group; each of m and n is 0 or an integer of from 1 to 3; and p is 0 or 1.

The monofunctional radical polymerizable monomer having a charge transport structure preferably has the following formula (XIX):

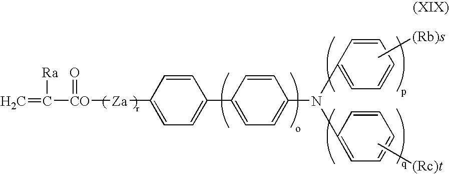

In formula (XIX), each of o, p and q is 0 or 1; Ra represents a hydrogen atom, or a methyl group; each of Rb and Rc represents an alkyl group having from 1 to 6 carbon atoms, wherein each of Rb and Rc can include plural groups which are the same as or different from each other; each of s and t is 0, 1, 2 or 3; r is 0 or 1; Za represents a methylene group, an ethylene group or a group having one of the following formulae.

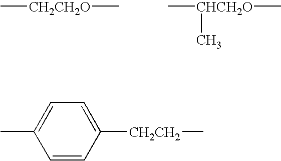

In formula (XIX), each of Rb and Rc is preferably a methyl group or an ethyl group.

The protective layer is preferably crosslinked upon application of heat or light thereto.

The photoreceptor preferably has an intermediate layer between the substrate and the charge generation layer, wherein the intermediate layer includes a charge blocking layer and a moiré preventing layer. The charge blocking layer preferably includes an insulating material and has a thickness of less than 2.0 μm and not less than 0.3 μm. The moiré preventing layer preferably includes an inorganic pigment and a binder resin, wherein the volume ratio of the inorganic pigment to the binder resin is preferably from 1/1 to 3/1.

The image writing light preferably has a wavelength of less than 450 nm.

The image forming apparatus may include a plurality of image forming units each of which includes an image bearing member, an electrostatic latent image forming device, a developing device, a transferring device, and a discharging device.

The image forming apparatus can include a process cartridge which includes an image bearing member, and one or more of an electrostatic latent image forming device, a developing device, a discharging device, and a cleaning device and which can be detachably attached to the image forming apparatus as a unit.

As another aspect of the present invention, an image forming method is provided which includes:

forming an electrostatic latent image on an electrostatic latent image bearing member including a photosensitive layer including a charge generation layer containing an organic charge generation material, and a charge transport layer;

developing the electrostatic latent image with a developer including a toner to form a toner image on the image bearing member;

transferring the toner image onto a receiving material;

fixing the toner image to the receiving material; and

dissipating charges remaining on the image bearing member by irradiating the image bearing member with light with a wavelength of less than 500 nm after transferring the toner image.

The image writing light preferably has a wavelength of less than 450 nm.

At least the electrostatic latent image forming, the electrostatic latent image developing, the toner image transferring and discharging processes can be performed plural times to form an image.

The present invention will be then explained in detail.

As a result of the present inventor's study, it is found that the degree of increase in residual potential can be decreased when the discharging light has a short wavelength of less than 500 nm. It is found that when the discharging light include not only light having a wavelength of less than 500 nm and light having a wavelength of not less than 500 nm, the effect of the light having a a wavelength of less than 500 nm can be reduced. Therefore, the residual potential increasing problem cannot be well solved by the discharging method described in JP-A60-88981.

In the present application, light having a wavelength of less than 500 nm for use in the discharging process does not include light having a wavelength of not less than 500 nm.

The reason why increase in residual potential can be suppressed by performing discharging using light having a wavelength less than 500 nm is not yet determined but is considered as follows.

FIG. 2 is a schematic view for explaining how photo-carriers are generated from an organic material. As illustrated in FIG. 2, an organic material (i.e., a charge generation material) typically generates photo-carriers with two steps (i.e., photo-excitation→formation of intermediate→formation of free carriers). Specifically, when a charge generation material absorbs light, the material is photo-excited from a ground state (S₀) to an excited state. When the energy level of the excited state is higher than that of a lowest singlet excited state (S₁), photo-carriers are generated. In other words, when light having a relatively long wavelength is used for discharging, photo-carriers are hardly generated because light having a relatively long wavelength has relatively low energy compared to light having a short wavelength.

The charge generation material excited to a singlet excited state (S*) rapidly achieves the lowest singlet excited state (S₁), resulting in formation of an intermediate (geminate-pair). In this regard, the energy corresponding to the difference in energy between the singlet excited state (S*) and the lowest singlet excited state (S₁) (i.e., excess energy in FIG. 2) is thermally relaxed.

Residual potential increases as follows. Specifically, the positive and negative photo-carriers thus produced are transported to the sites having opposite polarities (namely, if a negative charge type photoreceptor is used, the negative charges are formed on the surface of the photoreceptor and therefore positive holes are transported to the surface of the photoreceptor and negative electrons are transported to the substrate). In this case, the photo-carriers are often trapped in the transportation process, resulting in formation of residual charges. The trapped carriers cannot escape therefrom because the energy is greater than the activation energy at room temperature, and the charges are accumulated. However, when light having a wavelength of less than 500 nm is used, large excess energy is generated and the excess energy releases the trapped carriers from the traps. Therefore, increase of residual potential can be prevented.

FIG. 3 is a schematic view for explaining how photo-carriers are generated from an inorganic material. In general, a band model including a valence band and a conduction band applies to an inorganic material.

An electron obtaining energy which is caused by photo-excitation and which corresponds to the band gap can freely move in the valence band. In addition, in the conduction band the electron is directly ionized, and thereby free carriers are formed. Namely when an electron obtains energy greater than the band gap, the carrier generation efficiency (i.e., ion dissociation efficiency) is increased but excess energy is not generated unlike the above-mentioned organic material case. This model is supported by the fact in that the carrier generation efficiency of an inorganic photoreceptor depends on the wavelength of the exciting light

When considering the difference in carrier generation mechanism between inorganic materials and organic materials, the effect of discharging light having a specific wavelength can be well understood.

Specifically, in the case of organic photoreceptors, the number of carriers generated is not changed when the wavelength of the discharging light is changed (i.e., there is no dependence of the quantum efficiency on the wavelength of the discharging light), but the quantity of the excess energy generated depends on the wavelength of the discharging light. Namely, as the discharging light irradiating a photoreceptor has a shorter wavelength, the quantity of the excess energy generated in the photoreceptor becomes larger.

In contrast, in the case of inorganic photoreceptors, the quantum efficiency depends on the wavelength of the discharging light. Therefore, when the discharging light has a short wavelength, the number of generated carriers increases but excess energy is not generated. Namely, the energy corresponding to the excess energy is used for increasing the carrier generation efficiency.

In the present invention, light having a wavelength of less than 500 nm is used as the discharging light. By irradiating an organic photoreceptor with discharging light having a wavelength of less than 500 nm, the excess energy can be relatively increased compared to the case where visible light is used as the discharging light. The thus generated excess energy can be used as the activation energy for releasing charges trapped in the photosensitive layer.

In contrast, since excess energy is not generated in inorganic photoreceptors, the charges trapped in the photosensitive layer cannot be released. Therefore, even when discharging is performed on an inorganic photoreceptor using light having such a wavelength as mentioned above, the effect of the present invention cannot be produced.

Then the image forming apparatus and method of the present invention will be explained in detail.

The image forming apparatus of the present invention includes at least an electrostatic image bearing member (hereinafter referred to as a photoreceptor) which includes a layered photosensitive layer including a charge generation layer (hereinafter referred to as a CGL), which includes an organic charge generation material (a charge generation material is hereinafter referred to as a CGM), and a charge transport layer (hereinafter referred to as a CTL), which is located overlying the CGL; an electrostatic latent image forming device; a developing device; a transferring device; a fixing device; and a discharging device configured to irradiate the photoreceptor with light having a wavelength of less than 500 nm. The image forming apparatus optionally includes other devices such as a cleaning device, a toner recycling device, and a controller.

The image forming method of the present invention includes at least an electrostatic latent image forming step for forming an electrostatic latent image on such a photoreceptor as mentioned above, a developing step, a transferring step, a discharging step for irradiating the photoreceptor with light having a wavelength of less than 500 nm, and a fixing step. The image forming method optionally includes other steps such as a cleaning step, a toner recycling step and a controlling step.

The image forming method of the present invention can be well performed using the image forming apparatus of the present invention. Specifically, the electrostatic latent image forming step, developing step, transferring step, discharging step and fixing step are performed with the electrostatic latent image forming device, developing device, transferring device, discharging device and fixing device, respectively. The other optional steps can be performed with the corresponding devices mentioned above.

Electrostatic Latent Image Bearing Member (i.e., Photoreceptor)

The photoreceptor for use in the image forming apparatus of the present invention includes at least an organic CGM. The materials, shape, structure, dimension, etc. of the photoreceptor are not particularly limited. The photoreceptor preferably includes an electroconductive substrate.

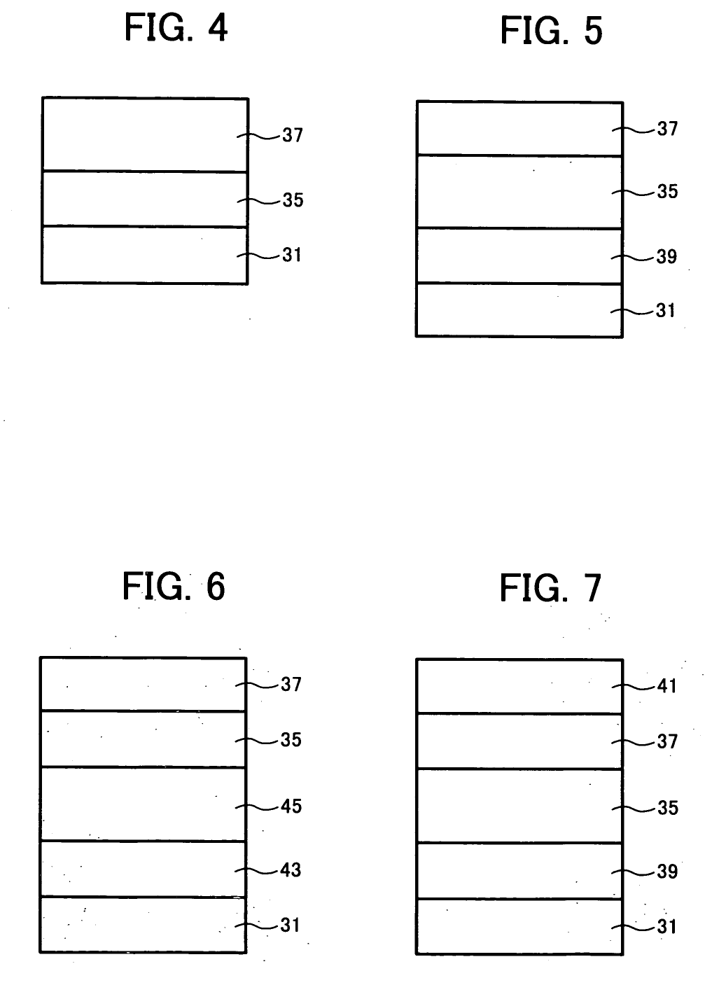

FIGS. 4-7 illustrate examples of the photoreceptor for use in the image forming apparatus of the present invention.

The photoreceptor illustrated in FIG. 4 has an electroconductive substrate 31, a CGL 35 including an organic CGM as a main component and located on the substrate, and a CTL 37 including a CTM as a main component and located on the CGL.

The photoreceptor illustrated in FIG. 5 has a structure similar to the photoreceptor illustrated in FIG. 4 except that an intermediate layer 39 is located between the substrate 31 and the CGL 35.

The photoreceptor illustrated in FIG. 6 has a structure similar to the photoreceptor illustrated in FIG. 5 except that the intermediate layer 39 includes a charge blocking layer 43 and a moiré preventing layer 45.

The photoreceptor illustrated in FIG. 7 has a structure similar to the photoreceptor illustrated in FIG. 5 except that a protective layer 41 is located on the CTL.

Suitable materials for use as the electroconductive substrate 31 include materials having a volume resistivity not greater than 10¹⁰ Ω·cm. Specific examples of such materials include plastic cylinders, plastic films or paper sheets, on the surface of which a metal such as aluminum, nickel, chromium, nichrome, copper, gold, silver, platinum and the like, or a metal oxide such as tin oxides, indium oxides and the like, is formed by deposition or sputtering. In addition, a plate of a metal such as aluminum, aluminum alloys, nickel and stainless steel can be used. A metal cylinder can also be used as the substrate 1, which is prepared by tubing a metal such as aluminum, aluminum alloys, nickel and stainless steel by a method such as impact ironing or direct ironing, and then treating the surface of the tube by cutting, super finishing, polishing and the like treatments. Further, endless belts of a metal such as nickel, stainless steel and the like can also be used as the substrate 31.

Furthermore, substrates, in which a coating liquid including a binder resin and an electroconductive powder is coated on the supports mentioned above, can be used as the substrate 31. Specific examples of such an electroconductive powder include carbon black, acetylene black, powders of metals such as aluminum, nickel, iron, nichrome, copper, zinc, silver and the like, and metal oxides such as electroconductive tin oxides, ITO and the like. Specific examples of the binder resin include known thermoplastic resins, thermosetting resins and photo-crosslinking resins, such as polystyrene, styrene-acrylonitrile copolymers, styrene-butadiene copolymers, styrene-maleic anhydride copolymers, polyesters, polyvinyl chloride, vinyl chloride-vinyl acetate copolymers, polyvinyl acetate, polyvinylidene chloride, polyarylates, phenoxy resins, polycarbonates, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins and the like resins.

Such an electroconductive layer can be formed by coating a coating liquid in which an electroconductive powder and a binder resin are dispersed or dissolved in a proper solvent such as tetrahydrofuran, dichloromethane, methyl ethyl ketone, toluene and the like solvent, and then drying the coated liquid.

In addition, substrates, in which an electroconductive resin film is formed on a surface of a cylindrical substrate using a heat-shrinkable resin tube which is made of a combination of a resin such as polyvinyl chloride, polypropylene, polyesters, polyvinylidene chloride, polyethylene, chlorinated rubber and fluorine-containing resins (such as TEFLON), with an electroconductive material, can also be used as the substrate 31.

Among these materials, cylinders made of aluminum or an aluminum alloy are preferable because aluminum can be easily anodized. Suitable aluminum materials for use as the substrate include aluminum and aluminum alloys such as JIS 1000 series, 3000 series and 6000 series.

Anodic oxide films can be formed by anodizing metals or metal alloys in an electrolyte solution. Among the anodic oxide films, alumite films which can be prepared by anodizing aluminum or an aluminum alloy are preferably used for the photoreceptor of the present invention. This is because the resultant photoreceptor hardly causes undesired images such as black spots and background fouling when used for reverse development (i.e., nega-posi development).

The anodizing treatment is performed in an acidic solution including an acid such as chromic acid, sulfuric acid, oxalic acid, phosphoric acid, boric acid, and sulfamic acid. Among these acids, sulfuric acid is preferably used for the anodizing treatment in the present invention. It is preferable to perform an anodizing treatment on a substrate under the following conditions:

(1) concentration of sulfuric acid: 10 to 20%

(2) temperature of treatment liquid: 5 to 25° C.

(3) current density: 1 to 4 A/dm²

(4) electrolyzation voltage: 5 to 30 V

(5) treatment time: 5 to 60 minutes.

However, the treatment conditions are not limited thereto.

In this case, it is not preferable that the roughened surface of the substrate is smoothed by the anodizing treatment. Namely, the surface of the anodized substrate preferably has a roughness within the preferable range mentioned above (i.e., 0.1 to 2 μm, and preferably 0.3 to 1.5 μm).

The thus prepared anodic oxide film is porous and highly insulative. Therefore, the surface of the substrate is very unstable, and the physical properties of the anodic oxide film change with time. In order to avoid such a problem, the anodic oxide film is preferably subjected to a sealing treatment. The sealing treatment can be performed by, for example, the following methods:
(1) the anodic oxide film is dipped in an aqueous solution of nickel fluoride or nickel acetate;
(2) the anodic oxide film is dipped in a boiling water; and
(3) the anodic oxide film is subjected to steam sealing.

After the sealing treatment, the anodic oxide film is subjected to a washing treatment to remove foreign materials such as metal salts adhered to the surface of the anodic oxide film during the sealing treatment. Such foreign materials present on the surface of the substrate not only affect the coating quality of a layer formed thereon but also produce images having background fouling because of typically having a low electric resistance. The washing treatment is performed by washing the substrate having an anodic oxide film thereon with pure water one or more times. It is preferable that the washing treatment is performed until the washing water is as clean (i.e., deinonized) as possible. In addition, it is also preferable to rub the substrate with a washing member such as brushes in the washing treatment.

The thickness of the thus prepared anodic oxide film is preferably from 5 to 15 μm. When the anodic oxide film is too thin, the barrier effect thereof is not satisfactory. In contrast, when the anodic oxide film is too thick, the time constant of the electrode (i.e., the substrate) becomes excessively large, resulting in increase of residual potential of the resultant photoreceptor and deterioration of response thereof.

The photoreceptor of the present invention can include an intermediate layer 39 between the electroconductive substrate 31 and the CGL 35. The intermediate layer 39 includes a resin as a main component. Since a CGL is formed on the intermediate layer typically by coating a liquid including an organic solvent, the resin in the intermediate layer preferably has good resistance to general organic solvents.

Specific examples of such resins include water-soluble resins such as polyvinyl alcohol resins, casein and polyacrylic acid sodium salts; alcohol soluble resins such as nylon copolymers and methoxymethylated nylon resins; and thermosetting resins capable of forming a three-dimensional network such as polyurethane resins, melamine resins, alkyd-melamine resins, epoxy resins and the like.

The intermediate layer may include a fine powder of metal oxides such as titanium oxide, silica, alumina, zirconium oxide, tin oxide and indium oxide to prevent occurrence of moiré in the resultant images and to decrease residual potential of the resultant photoreceptor. Among these metal oxides, titanium oxide is preferably included in the intermediate layer to enhance the effect of the present invention. In this regard, it is more preferable that the titanium oxide included in the intermediate layer is contacted with the CGL 35.

The intermediate layer can be formed by coating a coating liquid using a proper solvent and a proper coating method. The intermediate layer may be formed using a silane coupling agent, titanium coupling agent or a chromium coupling agent. In addition, a layer of aluminum oxide which is formed by an anodic oxidation method and a layer of an organic compound such as polyparaxylylene or an inorganic compound such as SiO, SnO₂, TiO₂, ITO or CeO₂ which is formed by a vacuum evaporation method is also preferably used as the intermediate layer. In addition, the intermediate layer can also be formed by any known methods. The thickness of the intermediate layer is preferably 0 to 5 μm.

The intermediate layer 39 has both a function of preventing the charges, which are induced at the electroconductive substrate side of the layer in the charging process, from being injected into the photosensitive layer, and a function of preventing occurrence of moiré fringe caused by using coherent light such as laser light as image writing light. In the present invention it is preferable to use a functionally separated intermediate layer (i.e., a combination of the charge blocking layer 43 and the moiré preventing layer 45).

Next, the functionally separated intermediate layer will be explained.

The function of the charge blocking layer 43 is to prevent the charges, which are induced in the electrode (i.e., the electroconductive substrate 31) and have a polarity opposite to that of the voltage applied to the photoreceptor by a charger, from being injected to the photosensitive layer. Specifically, when negative charging is performed, the charge blocking layer 43 prevents injection of positive holes to the photosensitive layer. In contrast, when positive charging is performed, the charge blocking layer 43 prevents injection of electrons to the photosensitive layer. Specific examples of the charge blocking layer include the following:

(1) a layer prepared by anodic oxidation such as aluminum oxide layer;

(2) an insulating layer of an inorganic material such as SiO;

(3) a layer made of a network of a glassy metal oxide;

(4) a layer made of polyphosphazene;

(5) a layer made of a reaction product of aminosilane;

(6) a layer made of an insulating resin; and

(7) a crosslinked resin layer.

Among these layers, an insulating resin layer and a crosslinked resin layer, which can be formed by a wet coating method, are preferably used. Since the moiré preventing layer and the photosensitive layer are typically formed on the charge blocking layer by a wet coating method, the charge blocking layer preferably has good resistance to the solvents included in the coating liquids of the moiré preventing layer and the photosensitive layer.

Suitable resins for use in the charge blocking layer include thermoplastic resins such as polyamide resins, polyester resins, and vinyl chloride/vinyl acetate copolymers; and thermosetting resins which can be prepared by thermally polymerizing a compound having a plurality of active hydrogen atoms (such as hydrogen atoms of —OH, —NH₂, and —NH) with a compound having a plurality of isocyanate groups and/or a compound having a plurality of epoxy groups.

Specific examples of the compounds having a plurality of active hydrogen atoms include polyvinyl butyral, phenoxy resins, phenolic resins, polyamide resins, phenolic resins, polyamide resins, polyester resins, polyethylene glycol resins, polypropylene glycol resins, polybutylene glycol resins, and acrylic resins (such as hydroxyethyl methacrylate resins). Specific examples of the compounds having a plurality of isocyanate groups include tolylene diisocyanate, hexamethylene diisocyanate, diphenylmethane diisocyanate, and prepolymers of these compounds. Specific examples of the compounds having a plurality of epoxy groups include bisphenol A based epoxy resins, etc.

Among these resins, polyamide resins are preferably used in view of film formability, environmental stability and resistance to solvents.

In addition, oil-free alkyd resins; amino resins such as thermosetting amino resins prepared by thermally polymerizing a butylated melamine resin; and photo-crosslinking resins prepared by reacting an unsaturated resin, such as unsaturated polyurethane resins unsaturated polyester resins, with a photo-polymerization initiator such as thioxanthone compounds and methylbenzyl formate, can also be used.

In addition, electroconductive polymers having a rectification property, and layers including a resin or a compound having an electron accepting or donating property which is determined depending on the polarity of the charges formed on the surface of the photoreceptor can also be used.

The charge blocking layer 43 preferably has a thickness not less than 0.1 μm and less than 2.0 μm, and more preferably from 0.3 μm to 1.0 μm. When the charge blocking layer is too thick, the residual potential of the photoreceptor increases after imagewise light irradiation is repeatedly performed particularly under low temperature and low humidity conditions. In contrast, the charge blocking layer is too thin, the charge blocking effect is hardly produced. The charge blocking layer 43 can include one or more materials such as crosslinking agents, solvents, additives and crosslinking promoters. The charge blocking layer 43 can be prepared by coating a coating liquid by a coating method such as blade coating, dip coating, spray coating, bead coating and nozzle coating, followed by drying and crosslinking using heat or light.

Next, the moiré preventing layer 45 will be explained.

The function of the moiré preventing layer 45 is to prevent occurrence of moiré fringe in the resultant images due to interference of light, which is caused when coherent light (such as laser light) is used for optical writing. Namely, the moiré preventing layer scatters the light used for optical writing. In order to carry out this function, the layer preferably includes a material having a high refractive index. The moiré preventing layer typically includes a binder resin and an inorganic pigment. Suitable inorganic pigments include white inorganic pigments. Specific examples of the white inorganic pigments include titanium oxide, calcium fluoride, calcium oxide, silica, magnesium oxide and aluminum oxide. Among these pigments, titanium oxide is preferably used because of having high hiding power.

Since the injection of charges from the substrate 31 is blocked by the charge blocking layer 43, the moiré preventing layer 45 preferably has an ability to transport charges having the same polarity as that of the charges formed on the surface of the photoreceptor, to prevent increase of residual potential. For example, in a negative charge type photoreceptor, the moiré preventing layer 45 preferably has an electron conducting ability. Therefore it is preferable to use an electroconductive inorganic pigment or a conductive inorganic pigment for the moiré preventing layer 45. Alternatively, an electroconductive material (such as acceptors) may be added to the moiré preventing layer 45.

Specific examples of the binder resin for use in the moiré preventing layer 45 include the resins mentioned above for use in the charge blocking layer 43. Since the photosensitive layer (CGL 35 and CTL 37) is formed on the moiré preventing layer 45 by coating a coating liquid, the binder resin preferably has a good resistance to the solvent included in the photosensitive layer coating liquid. Among the resins, thermosetting resins, and more preferably mixtures of alkyd and melamine resins, are preferably used as the binder resin of the moiré preventing layer 45. The mixing ratio of an alkyd resin to a melamine resin is an important factor influencing the structure and properties of the moiré preventing layer 45, and the weight ratio thereof is preferably from 5/5 to 8/2. When the content of the melamine resin is too high, the coated film is shrunk in the thermosetting process, and thereby coating defects are formed in the resultant film. In addition, the residual potential increasing problem occurs. In contrast, when the content of the alkyd resin is too high, the electric resistance of the layer seriously decreases, and thereby the resultant images have background fouling, although residual potential of the photoreceptor is reduced.

The mixing ratio of the inorganic pigment to the binder resin in the moiré preventing layer 45 is also an important factor, and the volume ratio thereof is preferably from 1/1 to 3/1. When the ratio is too low (i.e., the content of the inorganic pigment is too low), not only the moiré preventing effect deteriorates but also the residual potential increases after repeated use. In contrast, when the ratio is too high, the film formability of the layer deteriorates, resulting in deterioration of surface conditions of the resultant layer. In addition, a problem in that the upper layer (e.g., the photosensitive layer) cannot form a good film thereon because the coating liquid penetrates into the moiré preventing layer occurs. This problem is fatal to the photoreceptor having a layered photosensitive layer including a thin charge generation layer as a lower layer because such a thin CGL cannot be formed on such a moiré preventing layer. In addition, when the ratio is too large, a problem in that the surface of the inorganic pigment cannot be covered with the binder resin. In this case, the CGM is directly contacted with the inorganic pigment and thereby the possibility of occurrence of a problem in that carriers are thermally produced increases, resulting in occurrence of the background development problem.

By using two kinds of titanium oxides having different average particle diameters for the moiré preventing layer, the substrate 1 is effectively hidden by the moiré preventing layer and thereby occurrence of moiré fringes can be well prevented and formation of pinholes in the layer can also be prevented. In this regard, the average particle diameters (D1 and D2) of the two kinds of titanium oxides preferably satisfy the following relationship:
0.2<D2/D1≦0.5.

When the ratio D2/D1 is too low, the surface of the titanium oxide becomes more active, and thereby stability of the electrostatic properties of the resultant photoreceptor seriously deteriorates. In contrast, when the ratio is too high, the electroconductive substrate 31 cannot be well hidden by the moiré preventing layer and thereby the moiré preventing effect deteriorates and abnormal images such as moiré fringes are produced. In this regard, the average particle diameter of the pigment means the average particle diameter of the pigment in a dispersion prepared by dispersing the pigment in water while applying a strong shear force thereto.

Further, the average particle diameter (D2) of the titanium oxide (T2) having a smaller average particle diameter is also an important factor, and is preferably greater than 0.05 μm and less than 0.20 μm. When D2 is too small, hiding power of the layer deteriorates. Therefore, moiré fringes tend to be caused. In contrast, when D2 is too large, the filling factor of the titanium oxide in the layer is small, and thereby background development preventing effect cannot be well produced.

The mixing ratio of the two kinds of titanium oxides in the moiré preventing layer 45 is also an important factor, and is preferably determined such that the following relationship is satisfied:
0.2≦T2/(T1+T2)≦0.8,
wherein T1 represents the weight of the titanium oxide having a larger average particle diameter, and T2 represents the weight of the titanium oxide having a smaller average particle diameter.

When the mixing ratio is too low, the filling factor of the titanium oxide in the layer is small, and thereby background development preventing effect cannot be well produced. In contrast, when the mixing ratio is too high, the hiding power of the layer deteriorates, and thereby the moiré preventing effect cannot be well produced.

The moiré preventing layer preferably has a thickness of from 1 to 10 μm, and more preferably from 2 to 5 μm. When the layer is too thin, the moiré preventing effect cannot be well produced. In contrast, when the layer is too thick, the residual potential increases after repeated use.

The moiré preventing layer is typically prepared as follows. An inorganic pigment is dispersed in a solvent together with a binder resin using a dispersion machine such as ball mills, sand mills, and attritors. In this case, crosslinking agents, other solvents, additives, crosslinking promoters, etc., can be added thereto if desired. The thus prepared coating liquid is coated on the charge blocking layer by a method such as blade coating, dip coating, spray coating, bead coating and nozzle coating, followed by drying and crosslinking using light or heat.

Next, the photosensitive layer will be explained. The photosensitive layer includes the CGL 35 including an organic CGM and the CTM 37 located overlying the CGL 35.

The CGL 35 includes an organic CGM as a main component, and is typically prepared by coating a coating liquid, which is prepared by dispersing an organic CGM in a solvent optionally together with a binder resin using a dispersing machine such as ball mills, attritors, sand mills and supersonic dispersing machines, on an electroconductive substrate, followed by drying.

Specific examples of the organic CGMs include phthalocyanine pigments such as metal phthalocyanine, metal-free phthalocyanine, azulenium salt pigments, squaric acid methine pigments, azo pigments having a carbazole skeleton, azo pigments having a triphenyl amine skeleton, azo pigments having a diphenyl amine skeleton, azo pigments having a dibenzothiophene skeleton, azo pigments having a fluorenone skeleton, azo pigments having an oxadiazole skeleton, azo pigments having a bisstilbene skeleton, azo pigments having a distyryloxadiazole skeleton, azo pigments having a distyrylcarbazole skeleton, perylene pigments, anthraquinone pigments, polycyclic quinone pigments, quinone imine pigments, diphenylmethane pigments, triphenylmethane pigments, benzoquinone pigments, naphthoquinone pigments, cyanine pigments, azomethine pigments, indigoide pigments, bisbenzimidazole pigments, and the like organic pigments. These CGMs can be used alone or in combination.

The method for synthesizing the azo pigments having formula (XI) is described, for example, in JP-Bs 61-30265, and 60-29109 and Japanese patents Nos. 2,800,938 and 3,026,645.

Specific examples of the residual groups of couplers Cp in formula (XI) and Cp₁ and Cp₂ in formula (XIII) to (XV) include residual groups obtained from aromatic hydrocarbon compounds having a hydroxyl group, such as phenolic compounds and naphthol compounds; heterocyclic compounds having a hydroxyl group; aromatic hydrocarbon compounds and heterocyclic compounds having an amino group; aromatic hydrocarbon compounds and heterocyclic compounds having an amino group and a hydroxyl group such as aminonaphthol; compounds having an aliphatic or aromatic keto-enol type ketone group (i.e., compounds having an active methylene group); etc. Suitable groups for use as the residual groups of couplers include compounds having one of the following formulae (A) to (N): 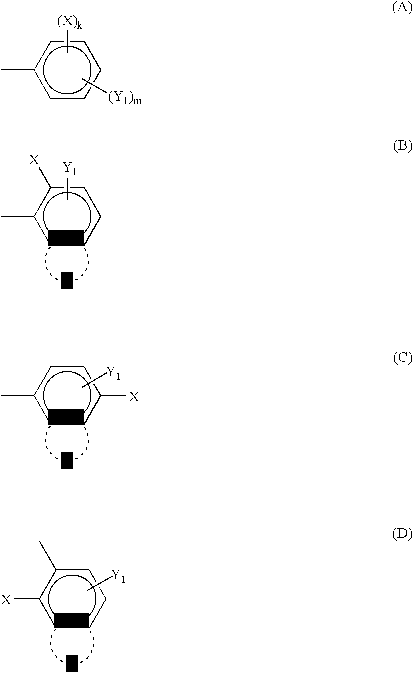
In the compounds having one of formulae (A) to (D), each of k and m is 1 or 2; and X, Y₁, and Z are as follows.
X: —OH, —N(R₁)(R₂), or —NHSO₄—R₃, wherein R₁ and R₂ independently represent a hydrogen atom, or a substituted or unsubstituted alkyl group; and R₃ represents a substituted or unsubstituted alkyl group or a substituted or unsubstituted aryl group.
Y₁: a hydrogen atom, a halogen atom, a substituted or unsubstituted alkyl group, a substituted or unsubstituted alkoxyl group, a carboxyl group, a sulfonic acid group, a substituted or unsubstituted sulfamoyl group, —CON(R₄)(Y₂) or —CONHCON(R₄)(Y₂), wherein R₄ represents a hydrogen atom, a substituted or unsubstituted alkyl group or a substituted or unsubstituted phenyl group; Y₂ represents a substituted or unsubstituted hydrocarbon ring group, a substituted or unsubstituted heterocyclic ring group or —N═C(R₅)(R₆), wherein R₅ represents a substituted or unsubstituted hydrocarbon ring group, a substituted or unsubstituted heterocyclic group or a substituted or unsubstituted styryl group; R₆ represents a hydrogen atom, a substituted or unsubstituted alkyl group or a substituted or unsubstituted phenyl group, and wherein R₅, R₆ and the carbon atom connected therewith optionally share bond connectivity to form a ring.
Z: a group capable of forming a substituted or unsubstituted aromatic hydrocarbon group or a substituted or unsubstituted aromatic heterocyclic group. 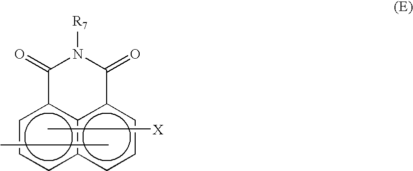
wherein R₇ represents a substituted or unsubstituted hydrocarbon group and X is defined above. 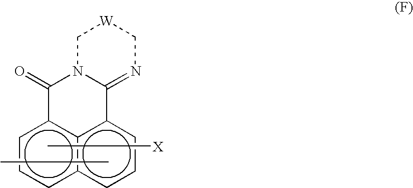
wherein W represents a divalent aromatic hydrocarbon group, or a divalent heterocyclic group having a nitrogen atom in the ring (the rings can be substituted), and X is defined above. 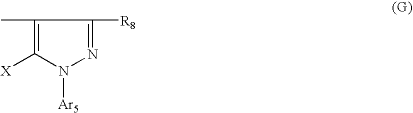
wherein R₈ represents an alkyl group, a carbamoyl group, a carboxyl group, or a carboxylic acid ester group, and X is defined above. 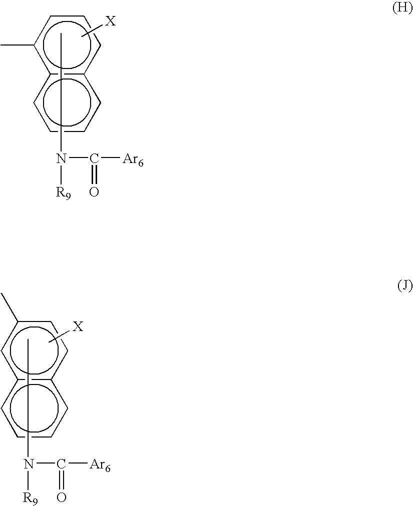
In formulae (H) and (J), R₉ represents a hydrogen atom, or a substituted or unsubstituted hydrocarbon group; and Ar₆ represents a substituted or unsubstituted hydrocarbon ring group.

Specific examples of the hydrocarbon groups for use as Z in formula (A) to (D) include benzene ring groups, naphthalene groups, etc. Specific examples of the heterocyclic groups for use as Z include indole ring groups, carbazole ring groups, benzofuran ring groups, dibenzofuran ring groups, etc.

Specific examples of the hydrocarbon ring groups for use as Y₂ or R₅ include a phenyl group, a naphthyl group, an anthoryl group, a pyrenyl group, etc. Specific examples of the heterocyclic groups for use as Y₂ or R₅ include a pyridyl group, a thienyl group, a furyl group, an indolyl group, a benzofuranyl group, a carbazolyl group, a dibenzofuranyl group, etc. Specific examples of the rings formed by R₅ and R₆ include fluorine rings. These groups can be substituted with a group such as alkyl groups (e.g., a methyl group, an ethyl group, a propyl group, and a butyl group); alkoxyl groups (e.g., a methoxy group, an ethoxy group, a propoxy group, and a butoxy group); halogen atoms (e.g., a chlorine atom and a bromine atom); dialkylamino groups (e.g., a dimethylamino group and a diethylamino group); halomethyl groups (e.g., a trifluoromethyl group); a nitro group, a cyano group, a carboxyl group, carboxylic acid ester groups, a hydroxyl group, sulfonic acid salt groups such as —SO₃Na.

Specific examples of the substituents for the phenyl group for use as R₄ include halogen atoms such as a chlorine atom and a bromine atom. Specific examples of the hydrocarbon groups for use as R₇ and R₉ include alkyl groups such as a methyl group, an ethyl group, a propyl group and a butyl group; and substituted or unsubstituted aryl groups such as phenyl groups. Specific examples of the substituents for the hydrocarbon groups for use as R₇ and R₉ include alkyl groups such as a methyl group, an ethyl group, a propyl group and a butyl group; alkoxyl groups (e.g., a methoxy group, an ethoxy group, a propoxy group, and a butoxy group); halogen atoms (e.g., a chlorine atom and a bromine atom); a hydroxyl group, a nitro group, etc.

Specific examples of the hydrocarbon ring groups for use as Ar₅ and Ar₆ include a phenyl group, and a naphthyl group. Specific examples of the substituents for the groups include alkyl groups such as a methyl group, an ethyl group, a propyl group and a butyl group; alkoxyl groups (e.g., a methoxy group, an ethoxy group, a propoxy group, and a butoxy group); halogen atoms (e.g., a chlorine atom and a bromine atom); a cyano group; dialkylamino groups such as a dimethylamino group and a diethylamino group; etc. Suitable groups for use as X include a hydroxyl group.

Among the residual groups of couplers, groups having formula (B), (E), (F), (G), (H) or (J) are preferable, and the residual groups having the following formula (K) or (L) are more preferable. 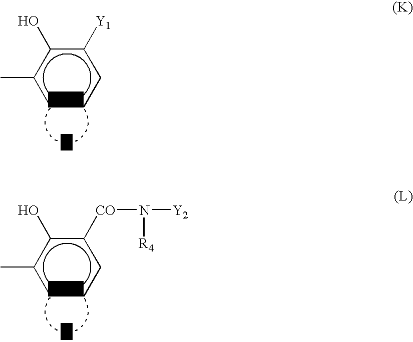
wherein Y₁, Z, Y₂, and R₄ are defined above.

Further, the residual groups having the following formula (M) or (N) are even more preferable. 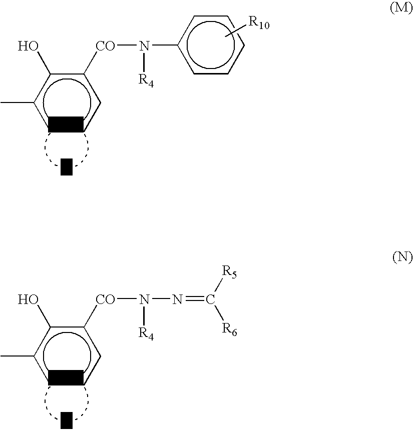
wherein Z, and R₄-R₆ are defined above, and R₁₀ represent the substituents listed above for use in Y₂.

Specific examples of the residual groups for use as Cp (in formula (XI)), Cp₁ and Cp₂ (in formula (XIII)), or Cp₃ and Cp₄ (in formula (XIV)) include the following.

TABLE 1

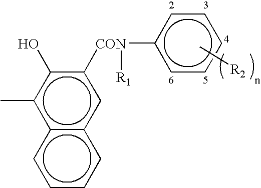

| Coupler No. | R₁ | (R₂)ₙ |
|---|---|---|
| 1 | H | H |
| 2 | H | 2-NO₂ |
| 3 | H | 3-NO₂ |
| 4 | H | 4-NO₂ |
| 5 | H | 2-CF₃ |
| 6 | H | 3-CF₃ |
| 7 | H | 4-CF₃ |
| 8 | H | 2-CN |
| 9 | H | 3-CN |
| 10 | H | 4-CN |
| 11 | H | 2-I |
| 12 | H | 3-I |
| 13 | H | 4-I |
| 14 | H | 2-Br |
| 15 | H | 3-Br |
| 16 | H | 4-Br |
| 17 | H | 2-Cl |
| 18 | H | 3-Cl |
| 19 | H | 4-Cl |
| 20 | H | 2-F |
| 21 | H | 3-F |
| 22 | H | 4-F |
| 23 | H | 2-CH₃ |
| 24 | H | 3-CH₃ |
| 25 | H | 4-CH₃ |
| 26 | H | 2-C₂H₅ |
| 27 | H | 4-C₂H₅ |
| 28 | H | 2-OCH₃ |
| 29 | H | 3-OCH₃ |
| 30 | H | 4-OCH₃ |
| 31 | H | 2-OC₂H₅ |
| 32 | H | 3-OC₂H₅ |
| 33 | H | 4-OC₂H₅ |
| 34 | H | 4-N(CH₃)₂ |
| 35 | —CH₃ | H |
| 36 | 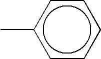 | H |
| 37 | H | 2-OCH₃, 5-OCH₃ |
| 38 | H | 2-OC₂H₅, 5-OC₂H₅ |
| 39 | H | 2-CH₃, 5-CH₃ |
| 40 | H | 2-Cl, 5-Cl |
| 41 | H | 2-CH₃, 5-Cl |
| 42 | H | 2-OCH₃, 4-OCH₃ |
| 43 | H | 2-CH₃, 4-CH₃ |
| 44 | H | 2-CH₃, 4-Cl |
| 45 | H | 2-NO₂, 4-OCH₃ |
| 46 | H | 3-OCH₃, 5-OCH₃ |
| 47 | H | 2-OCH₃, 5-Cl |
| 48 | H | 2-OCH₃, 5-OCH₃, 4-Cl |
| 49 | H | 2-OCH₃, 4-OCH₃, 5-Cl |
| 50 | H | 3-Cl, 4-Cl |
| 51 | H | 2-Cl, 4-Cl, 5-Cl |
| 52 | H | 2-CH₃, 3-Cl |
| 53 | H | 3-Cl, 4-CH₃ |
| 54 | H | 2-F, 4-F |
| 55 | H | 2-F, 5-F |
| 56 | H | 2-Cl, 4-NO₂ |
| 57 | H | 2-NO₂, 4-Cl |
| 58 | H | 2-Cl, 3-Cl, 4-Cl, 5-Cl |
| 59 | H | 4-OH |

TABLE 2

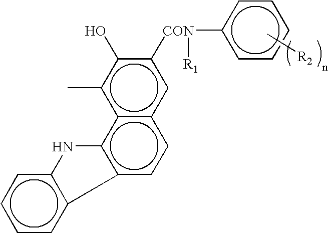

| Coupler No. | R₁ | (R₂)ₙ |
|---|---|---|
| 60 | H | H |
| 61 | H | 2-NO₂ |
| 62 | H | 3-NO₂ |
| 63 | H | 4-NO₂ |
| 64 | H | 2-Cl |
| 65 | H | 3-Cl |
| 66 | H | 4-Cl |
| 67 | H | 2-CH₃ |
| 68 | H | 3-CH₃ |
| 69 | H | 4-CH₃ |
| 70 | H | 2-C₂H₅ |
| 71 | H | 4-C₂H₅ |
| 72 | H | 2-OCH₃ |
| 73 | H | 3-OCH₃ |
| 74 | H | 4-OCH₃ |
| 75 | H | 2-OC₂H₅ |
| 76 | H | 4-OC₂H₅ |
| 77 | H | 2-CH₃, 4-OCH₃ |
| 78 | H | 2-CH₃, 4-CH₃ |
| 79 | H | 2-CH₃, 5-CH₃ |
| 80 | H | 2-CH₃, 6-CH₃ |
| 81 | H | 2-OCH₃, 4-OCH₃ |
| 82 | H | 2-OCH₃, 5-OCH₃ |
| 83 | H | 3-OCH₃, 5-OCH₃ |
| 84 | H | 2-CH₃, 3-Cl |
| 85 | H | 2-CH₃, 4-Cl |
| 86 | H | 2-CH₃, 5-Cl |
| 87 | H | 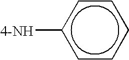 |
| 88 | H | 2-CH(CH₃)₂ |

TABLE 3

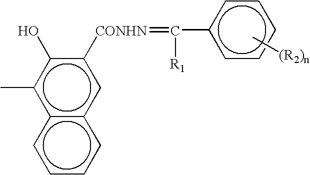

| Coupler No. | R₁ | (R₂)ₙ |
|---|---|---|
| 89 | H | H |
| 90 | H | 4-N(CH₃)₂ |
| 91 | H | 2-OCH₃ |
| 92 | H | 3-OCH₃ |
| 93 | H | 4-OCH₃ |
| 94 | H | 4-C₂H₅ |
| 95 | H | 2-CH₃ |
| 96 | H | 3-CH₃ |
| 97 | H | 4-CH₃ |
| 98 | H | 2-F |
| 99 | H | 3-F |
| 100 | H | 4-F |
| 101 | H | 2-Cl |
| 102 | H | 3-Cl |
| 103 | H | 4-Cl |
| 104 | H | 2-Br |
| 105 | H | 3-Br |
| 106 | H | 4-Br |
| 107 | H | 2-Cl, 4-Cl |
| 108 | H | 3-Cl, 3-Cl |
| 109 | H | 2-CN |
| 110 | H | 4-CN |
| 111 | H | 2-NO₂ |
| 112 | H | 3-NO₂ |
| 113 | H | 4-NO₂ |
| 114 | H | 2-CH₃, 4-CH₃ |
| 115 | H | 2-OCH₃, 5-OCH₃ |
| 116 | H | 2-OCH₃, 3-OCH₃, 4-OCH₃ |
| 117 | CH₃ | H |
| 118 | 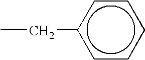 | H |
| 119 | 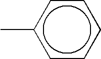 | H |
| 120 | H | 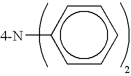 |

TABLE 4

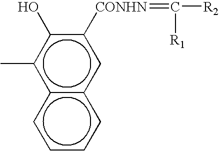

| Coupler No. | R₁ | R₂ |
|---|---|---|
| 121 | —CH₃ | —CH₃ |
| 122 | H | 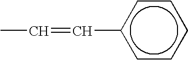 |
| 123 | H | 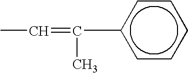 |
| 124 | H | 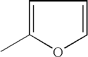 |
| 125 | H | 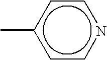 |
| 126 | H | 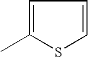 |
| 127 | CH₃ | 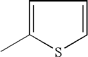 |
| 128 | H | 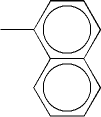 |
| 129 | H | 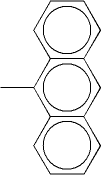 |
| 130 | H | 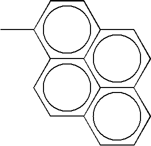 |
| 131 | H | 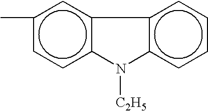 |
| 132 | H | 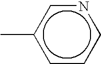 |

TABLE 5

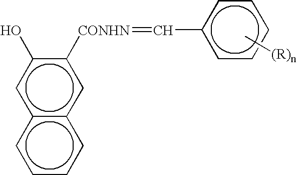

| Coupler No. | (R)ₙ |
|---|---|
| 133 | H |
| 134 | 2-OCH₃ |
| 135 | 3-OCH₃ |
| 136 | 4-OCH₃ |
| 137 | 2-CH₃ |
| 138 | 3-CH₃ |
| 139 | 4-CH₃ |
| 140 | 4-Cl |
| 141 | 2-NO₂ |
| 142 | 4-NO₂ |
| 143 | 2-OH |
| 144 | 2-OH, 3-NO₂ |
| 145 | 2-OH, 5-NO₂ |
| 146 | 2-OH, 3-OCH₃ |

TABLE 6

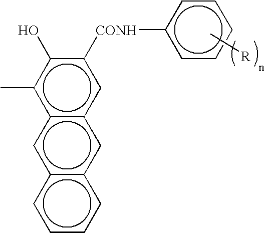

| Coupler No. | (R)ₙ |
|---|---|
| 147 | 4-Cl |
| 148 | 2-NO₂ |
| 149 | 3-NO₂ |
| 150 | 4-NO₂ |
| 151 | 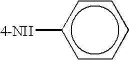 |
| 152 | H |
| 153 | 2-OCH₃ |
| 154 | 3-OCH₃ |
| 155 | 4-OCH₃ |
| 156 | 2-CH₃ |
| 157 | 3-CH₃ |
| 158 | 4-CH₃ |
| 159 | 2-Cl |
| 160 | 3-Cl |

TABLE 7

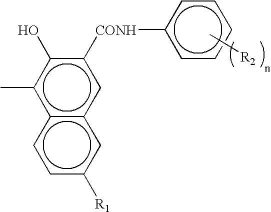

| Coupler No. | R₁ | (R₂)ₙ |
|---|---|---|
| 161 | H | 2-OCH₃, 4-Cl, 5-CH₃ |
| 162 | —OCH₃ | H |
| 163 | —OCH₃ | 2-CH₃ |
| 164 | —OCH₃ | 2-OCH₃, 5-OCH₃, 4-Cl |

TABLE 8

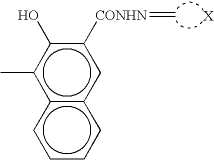

| Coupler No. | X |
|---|---|
| 165 | 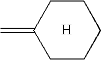 |
| 166 | 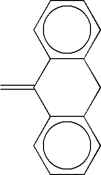 |
| 167 | 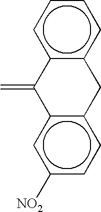 |

TABLE 9

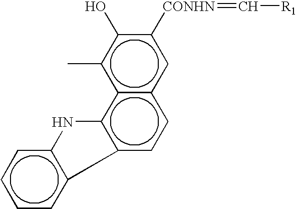

| Coupler No. | R₁ |
|---|---|
| 168 | 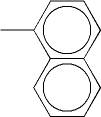 |
| 169 | 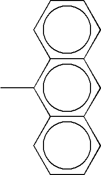 |
| 170 | 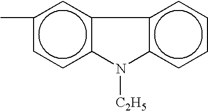 |
| 171 | 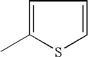 |

TABLE 10

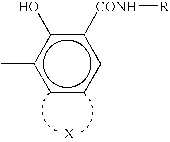

| Coupler No. | X | R |
|---|---|---|
| 172 | 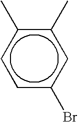 | 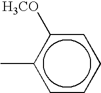 |
| 173 | 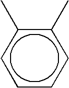 | 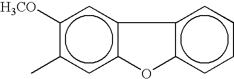 |
| 174 | 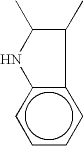 | 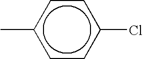 |
| 175 | 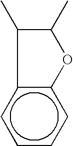 | 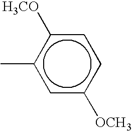 |
| 176 | 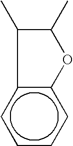 | 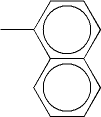 |
| 177 | 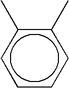 | 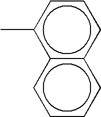 |

TABLE 11

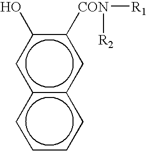

| Coupler No. | R₁ | R₂ |
|---|---|---|
| 178 | H | H |
| 179 | —CH₃ | H |
| 180 | —CH₃ | —CH₃ |
| 181 | H | 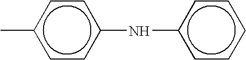 |

| Coupler No. | Structure |
|---|---|
| 182 | 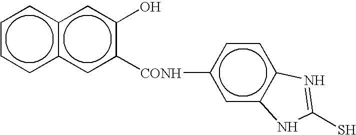 |
| 183 | 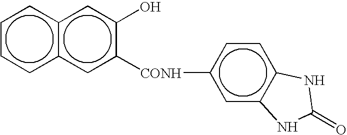 |
| 184 | 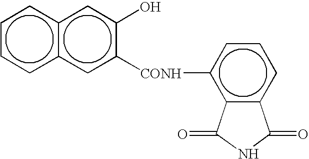 |
| 185 | 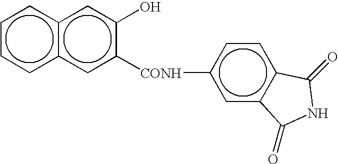 |
| 186 | 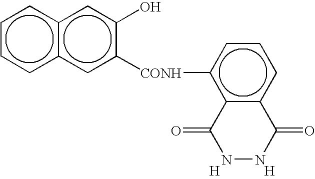 |
| 187 | 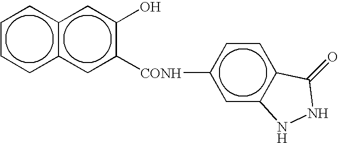 |
| 188 | 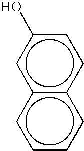 |
| 189 | 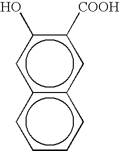 |
| 190 | 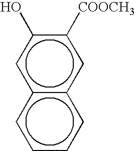 |
| 191 | 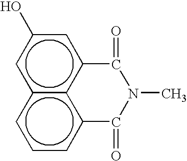 |
| 192 | 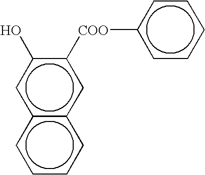 |
| 193 | 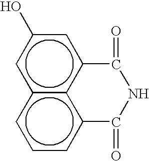 |
| 194 | 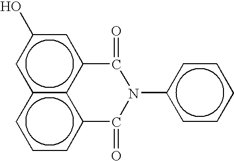 |
| 195 | 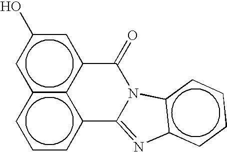 |
| 196 | 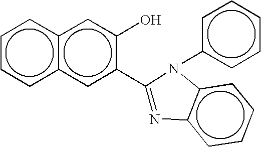 |
| 197 | 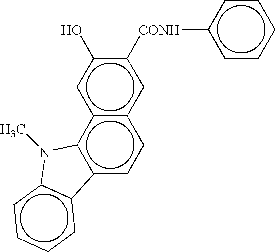 |
| 198 | 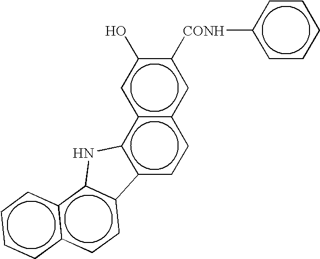 |
| 199 | 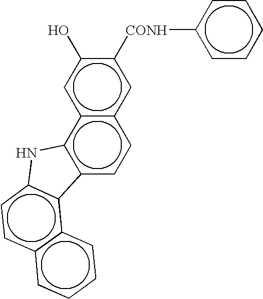 |
| 200 | 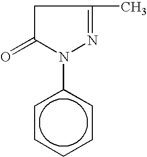 |

TABLE 12

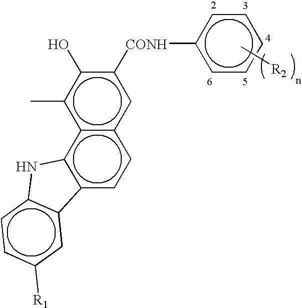

| Coupler No. | R₁ | (R₂)ₙ |
|---|---|---|
| 201 | Cl | H |
| 202 | Cl | 2-OCH₃ |
| 203 | Cl | 3-OCH₃ |
| 204 | Cl | 4-OCH₃ |
| 205 | Cl | 2-CH₃ |
| 206 | Cl | 3-CH₃ |
| 207 | Cl | 4-CH₃ |
| 208 | Cl | 2-Cl |
| 209 | Cl | 3-Cl |
| 210 | Cl | 4-Cl |
| 211 | Cl | 2-NO₂ |
| 212 | Cl | 3-NO₂ |
| 213 | Cl | 4-NO₂ |
| 214 | Cl | 2-CH₃, 4-Cl |
| 215 | Cl | 2-CH₃, 4-CH₃ |
| 216 | Cl | 2-C₂H₅ |
| 217 | CH₃ | H |
| 218 | CH₃ | 2-OCH₃ |
| 219 | CH₃ | 3-OCH₃ |
| 220 | CH₃ | 4-OCH₃ |
| 221 | CH₃ | 2-CH₃ |
| 222 | CH₃ | 3-CH₃ |
| 223 | CH₃ | 4-CH₃ |
| 224 | CH₃ | 2-Cl |
| 225 | CH₃ | 3-Cl |
| 226 | CH₃ | 4-Cl |
| 227 | CH₃ | 2-NO₂ |
| 228 | CH₃ | 3-NO₂ |
| 229 | CH₃ | 4-NO₂ |
| 230 | CH₃ | 2-CH₃, 4-Cl |
| 231 | CH₃ | 2-CH₃, 4-CH₃ |
| 232 | CH₃ | 2-C₂H₅ |
| 233 | OCH₃ | H |
| 234 | OCH₃ | 2-OCH₃ |
| 235 | OCH₃ | 3-OCH₃ |
| 236 | OCH₃ | 4-OCH₃ |
| 237 | OCH₃ | 2-CH₃ |
| 238 | OCH₃ | 3-CH₃ |
| 239 | OCH₃ | 4-CH₃ |
| 240 | OCH₃ | 2-Cl |
| 241 | OCH₃ | 3-Cl |
| 242 | OCH₃ | 4-Cl |
| 243 | OCH₃ | 2-NO₂ |
| 244 | OCH₃ | 3-NO₂ |
| 245 | OCH₃ | 4-NO₂ |
| 246 | OCH₃ | 2-C₂H₅ |

| Coupler No. | Structure |
|---|---|
| 247 | 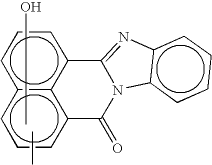 |
| 248 | 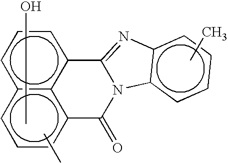 |
| 249 | 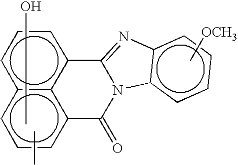 |
| 250 | 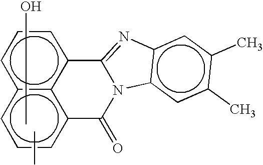 |
| 251 | 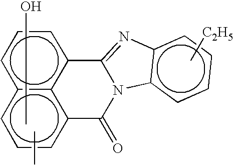 |
| 252 | 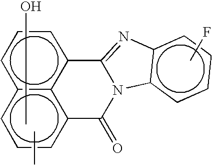 |
| 253 | 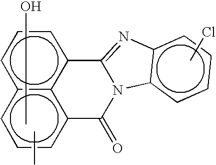 |
| 254 | 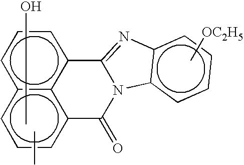 |
| 255 | 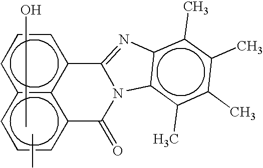 |
| 256 | 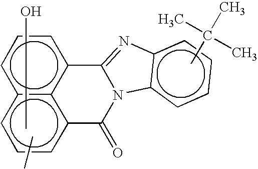 |
| 257 | 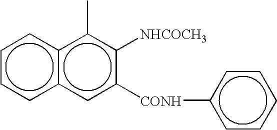 |
| 258 | 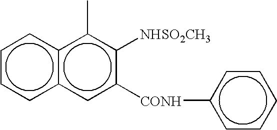 |

TABLE 13

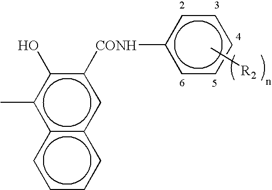

| Coupler No. | (R₂)ₙ |
|---|---|
| 259 | 2-Cl, 3-Cl |
| 260 | 2-Cl, 4-Cl |
| 261 | 3-Cl, 5-Cl |

TABLE 14

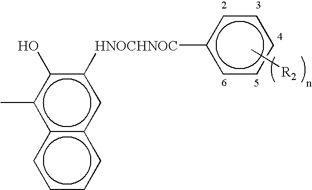

| Coupler No. | (R₂)ₙ |
|---|---|
| 262 | 4-CH₃ |
| 263 | 3-NO₂ |
| 264 | 2-Cl |
| 265 | 3-Cl |
| 266 | 4-Cl |
| 267 | 2-Cl, 3-Cl |
| 268 | 2-Cl, 4-Cl |
| 269 | 3-Cl, 5-Cl |
| 270 | 2-Cl, 5-Cl |
| 271 | 3-Cl, 4-Cl |

Specific examples of the phthalocyanine compounds for use as the CGM in the CGL include known phthalocyanine compounds having one of the following formulae (XX) to (XXII).

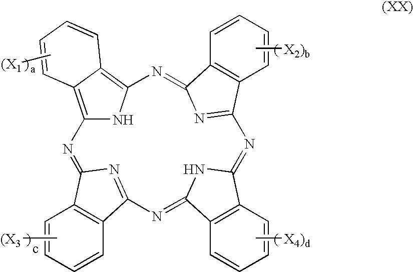

In formula (XX), X₁, X₂, X₃ and X₄ independently represent a halogen atom; and each of a, b, c and d is 0 or an integer of from 1 to 4. 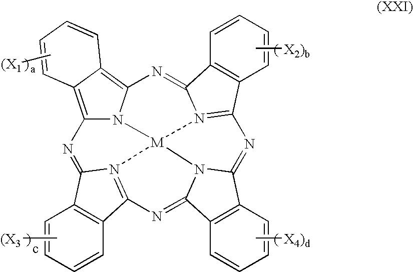
In formula (XXI), M represents a metal atom; X₁, X₂, X₃ and X₄ independently represent a halogen atom; and each of a, b, c and d is 0 or an integer of from 1 to 4. 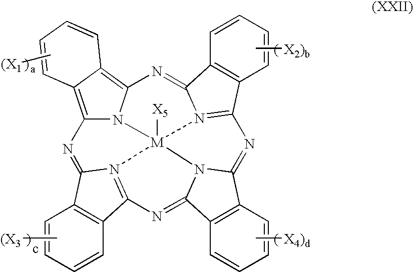
In formula (XXII), M represents a metal atom; X₅ represents a halogen atom or a hydroxyl group; X₁, X₂, X₃ and X₄ independently represent a halogen atom; and each of a, b, c and d is 0 or an integer of from 1 to 4.

Among these phthalocyanine compounds, gallium phthalocyanine compounds are preferably used. Chlorogallium phthalocyanine compounds are preferably used, and chlorogallium phthalocyanine compounds having an X-ray diffraction spectrum such that a strong peak is observed at each of Bragg (2 θ) angles (±0.2°) of 7.4°, 16.6°, 25.5° and 28.3° (described in Japanese Patent No. 3,123,185) are more particularly used.

Hydroxygallium phthalocyanine compounds are also preferably used. Among the hydroxygallium phthalocyanine compounds, hydroxygallium phthalocyanine compounds having an X-ray diffraction spectrum such that a strong peak is observed at each of Bragg (2 θ) angles (±0.2°) of 7.5°, 25.1° and 28.3° (described in Japanese Patent No. 3,166,293) are more particularly used.

Further, titanyl phthalocyanine compounds having an X-ray diffraction spectrum such that a maximum peak is observed at a Bragg (2 θ) angle (±0.2°) of 27.2° (described in JP-B 7-97221); an X-ray diffraction spectrum such that a strong peak is observed at each of Bragg (2 θ) angles (±0.2°) of 9.0°, 14.2°, 23.9° and 27.1° (described in Japanese Patent No. 3,005,052); or an X-ray diffraction spectrum such that a maximum peak is observed at a Bragg (2 θ) angle of 27.2±0.2°, a lowest angle peak at an angle of 7.3±0.2°, and a main peak at each of Bragg (2 θ) angles (±0.2°) of 9.4°, 9.6°, and 24.0°, wherein no peak is observed between the peaks of 7.3° and 9.4° and at an angle of 26.3 (±0.2°) (described in JP-A 2001-19871) are also preferably used.

The method for synthesizing the titanyl phthalocyanine compounds and for preparing a dispersion including the compounds are described in JP-As 2001-19871, 2004-78141 and 2004-83859, incorporated herein by reference.

The crystal form of the titanyl phthalocyanine compounds is described, for example, in JP-A 2001-19871. By using such titanyl phthalocyanine compounds, a photoreceptor which can maintain good charging properties while having a high sensitivity even after long repeated use can be provided.

The titanyl phthalocyanine compounds for use in the present photoreceptor are preferably synthesized by a method which is described in JP-A 06-293769 and which does not use a halogenated titanium as a raw material. The greatest advantage of this method is that the synthesized titanyl phthalocyanine is free from halogen. When a titanyl phthalocyanine compound including a halogenated titanyl phthalocyanine crystal as an impurity is used for a photoreceptor, the photoreceptor has low photosensitivity and poor charge properties as described in Japan Hardcopy '89 p. 103, 1989. The halogen-free titanyl phthalocyanine as described in JP-A 2001-19871 is preferably used for the photoreceptor in the present invention. A halogen-free titanyl phthalocyanine compound can be prepared using halogen-free raw materials. The method for preparing a halogen-free titanyl phthalocyanine is mentioned below.

Then the method for synthesizing the titanyl phthalocyanine compounds (hereinafter referred to as TiOPcs) having the above-mentioned specific X-ray diffraction spectrum will be explained.

At first, the method for synthesizing a crude titanyl phthalocyanine will be explained. The methods for synthesizing TiOPcs are well known and several methods have been disclosed in, for example, “Phthalocyanine Compounds” (1963) and “The Phthalocyanines” (1983), which were described by Moser, and JP-A 06-293769.

For example, one method is that a mixture of a phthalic anhydride compound, a metal or a halogenated metal, and urea is heated in the presence or absence of a solvent having a high boiling point. In this case, a catalyst such as ammonium molybdate is used if desired. The second method is that a mixture of a phthalonitrile compound and a halogenated metal is heated in the presence or absence of a solvent having a high boiling point. This method is used for synthesizing phthalocyanines such as aluminum phthalocyanines, indium phthalocyanines, oxovanadium phthalocyanines, oxotitanium phthalocyanines, zirconium phthalocyanines, etc., which cannot be synthesized by the first method. The third method is that phthalic anhydride or a phthalonitrile compound is reacted with ammonia to produce an intermediate such as 1,3-diiminoisoindoline, followed by reaction of the intermediate with a halogenated metal in a solvent having a high boiling point. The fourth method is that a phthalonitrile compound is reacted with a metal alkoxide in the presence of urea, etc. Since the fourth method has an advantage in that the benzene ring is not chlorinated (halogenated), the method is preferably used for synthesizing a TiOPc for use in electrophotography. Therefore, the method is preferably used in the present invention.

Then the method for preparing an amorphous TiOPc will be explained. An amorphous TiOPc (i.e., TiOpc having low crystallinity) can be typically prepared by a method such as acid paste methods (or acid slurry methods) in which a crude phthalocyanine is dissolved in sulfuric acid and the solution is diluted with water to re-precipitate the phthalocyanine.

Specifically, the procedure is as follows:

(1) the crude titanyl phthalocyanine prepared above is dissolved in concentrated sulfuric acid having a weight of from 10 to 50 times that of the crude titanyl phthalocyanine;

(2) materials remaining undissolved in sulfuric acid are removed therefrom by filtering, etc.;

(3) the solution is added to ice water having a weight of from 10 to 50 times that of the sulfuric acid used, to precipitate an amorphous titanyl phthalocyanine;

(4) after the amorphous titanyl phthalocyanine is separated by filtering, the titanyl phthalocyanine is repeatedly subjected to washing with ion-exchange water and filtering until the filtrate becomes neutral; and

(5) the amorphous titanyl phthalocyanine is washed with ion-exchange water, followed by filtering to prepare an aqueous paste having a solid content of from 5 to 15% by weight.

In this case, it is important to well wash the amorphous titanyl phthalocyanine so that the amount of sulfuric acid in the aqueous paste becomes as small as possible. Specifically, it is preferable to perform washing until the filtrate (i.e., water used for washing the amorphous titanyl phthalocyanine) has a pH of from 6 to 8 and/or a specific conductivity not greater than 8 μS/cm (preferably not greater than 5 μS/cm and more preferably not greater than 3 μS/cm). It is found that when the pH and/or the specific conductivity of the filtrate fall in the ranges mentioned above, the properties of the resultant photoreceptor are not affected by sulfuric acid remaining in the TiOPc. The pH and specific conductivity can be measured with a marketed pH meter and a marketed electric conductivity measuring instrument, respectively. The lower limit of the specific conductivity of the filtrate is the specific conductivity of the ion-exchange water used for washing.

When the pH and specific conductivity do not fall in the above-mentioned ranges (i.e., the amount of residual sulfuric acid is large), the resultant photoreceptor has low photosensitivity and poor charge properties.

The thus prepared amorphous titanyl phthalocyanine is used as a raw material for the TiOPc for use in the CGL of the photoreceptor of the present invention. The amorphous titanyl phthalocyanine preferably has an X-ray diffraction spectrum such that a maximum peak is observed at a Bragg (2 θ) angle of from 7.0° to 7.5° with a tolerance of ±0.2° when a Cu—K_{α} X-ray having a wavelength of 1.542 Å is used. In addition, the half width of the maximum peak is preferably not less than 1°. Further, the average particle diameter of the primary particles thereof is preferably not greater than 0.1 μm.

Then the method for changing the crystal form of the TiOPc will be explained.

In the crystal form changing process, the amorphous titanyl phthalocyanine is changed to a TiOPc which has an X-ray diffraction spectrum such that a maximum peak is observed at a Bragg (2 θ) angle of 27.2°±0.2°; a peak is observed at each of Bragg (2 θ) angles (±0.2°) of 9.4°, 9.6° and 24.0°; a lowest angle peak is observed at an angle of 7.3°±0.2°; no peak is observed between the lowest angle peak and the 9.4° peak; and no peak is observed at a Bragg (2 θ) angle of 26.3°±0.2°, when a Cu—K_{α} X-ray having a wavelength of 1.542 Å is used.

Specifically, the desired TiOPc can be prepared by mixing the above-prepared amorphous titanyl phthalocyanine, which is not dried, with an organic solvent in the presence of water while agitating.

Suitable solvents for use in the crystal form changing process include any known solvents by which the desired titanyl phthalocyanine crystal can be prepared. In particular, it is preferable to use one or more of tetrahydrofuran, toluene, methylene chloride, carbon disulfide, o-dichlorobenzene, and 1,1,2-trichloroethane. It is preferable to use one of these solvents alone, but mixtures thereof can also be used. In addition, other solvents can be added to the solvents.

The amount of the solvent used for the crystal form changing process is preferably not less than 10 times, and more preferably not less than 30 times, the weight of the titanyl phthalocyanine used. In this case, the crystal change can be rapidly performed and in addition the impurities included in the titanyl phthalocyanine can be well removed. As mentioned above, the amorphous titanyl phthalocyanine used for the crystal changing process is typically prepared by an acid paste method. In this case, it is preferable to fully wash the amorphous titanyl phthalocyanine to remove sulfuric acid therefrom. When sulfuric acid is not fully removed from the amorphous titanyl phthalocyanine, sulfate ions are included in the resultant TiOPc even after the TiOPc is well washed. When sulfate ions are included therein, the resultant photoreceptor has a low photosensitivity and poor charge properties.

For example, JP-A 08-110649 discloses a crystal changing method in a comparative example therein, in which a TiOPc which is dissolved in sulfuric acid and water are added to an organic solvent to change the crystal form of the TiOPc. The resultant TiOPc has an X-ray diffraction spectrum similar to that of the TiOPc for use in the present invention. However, the TiOPc includes sulfate ions at a high concentration. Therefore, the resultant photoreceptor has low photosensitivity. Namely, the TiOPc preparation method is not preferable and cannot be used for preparing the TiOPc for use in the present invention.

The above-mentioned crystal changing method for use in the present invention is similar to the method disclosed in JP-A 2001-19871. As mentioned above, it is preferable to control the average primary particle diameter of the TiOPc for use in the CGL of the present photoreceptor so as to be not greater than 0.25 μm, the effects of the TiOPc can be enhanced.

The methods for preparing such a small titanyl phthalocyanine crystal, which is described in JP-A 2004-83859) will be explained.

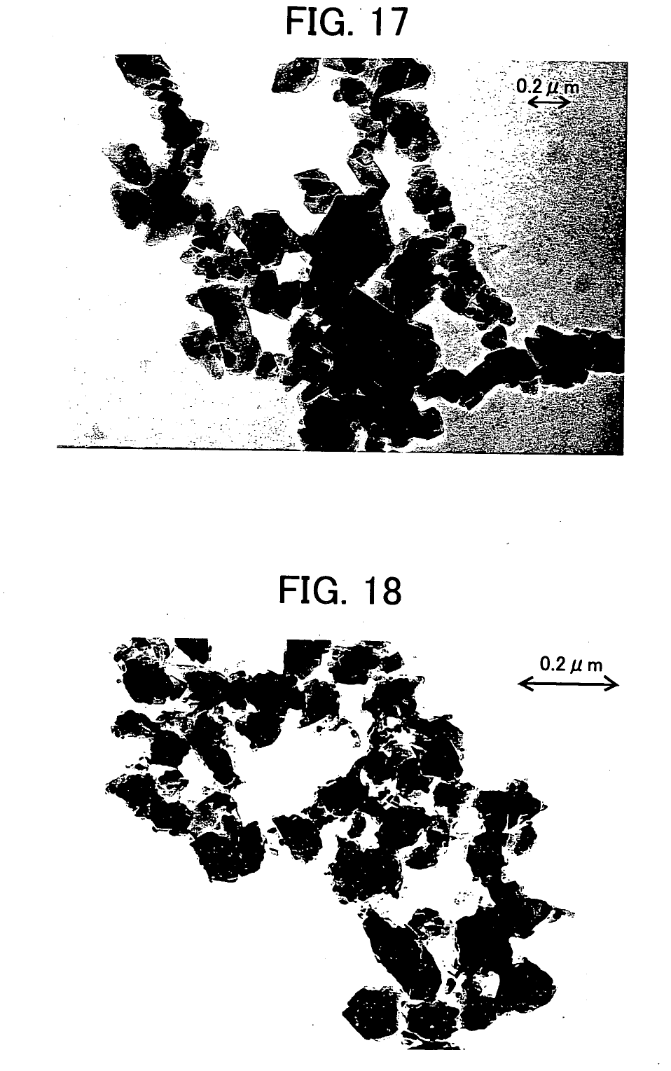

As a result of the present inventors' investigation of synthesizing a TiOPc having a small particle diameter, the following knowledge can be acquired. Specifically, it is found that the above-mentioned amorphous titanyl phthalocyanine having an irregular form (i.e., titanyl phthalocyanine with low crystallinity) typically has a primary particle diameter of not greater than 0.1 μm (almost all the particles have a primary particle diameter of from 0.01 to 0.05 μm) as can be understood from FIG. 16. In FIG. 16, the practical length of the scale bar is 0.2 μm. In addition, it is found that the crystal change is performed while crystal growth is also performed.

In general, in such a crystal changing process, the crystal changing operation is performed for a relatively long time to fully perform crystal changing, i.e., to prevent inclusion of the raw material in the product. Then the product is filtered to prepare a TiOPc having the desired crystal form. Therefore, even though the titanyl phthalocyanine raw material has a small particle diameter, the resultant TiOPc crystal typically has a relatively large particle diameter (from about 0.3 to about 0.5 μm) as can be understood from FIG. 17. In FIG. 17, the practical length of the scale bar is 0.2 μm. The thus prepared TiOPc is dispersed while applying a high shearing force thereto such that the particle diameter thereof becomes not greater than 0.25 μm (preferably not greater than 0.20 μm). In addition, the TiOPc crystal is pulverized if necessary. Therefore, a problem in that part of the crystal has a crystal form different from the desired crystal form occurs.

In contrast, in the present invention, the crystal changing operation is stopped at a time when the crystal change is completed while crystal growth is hardly caused. Specifically, the crystal changing operation is stopped at a time when the crystal change is completed and the resultant TiOPc, which is prepared by changing the amorphous titanyl phthalocyanine, has almost the same particle diameter (not greater than about 0.25 μm and preferably not greater than 0.20 μm) as that of the amorphous titanyl phthalocyanine (raw material), which is illustrated in FIG. 16. Since the crystal change of a TiOPc is typically accompanied by change of color or viscosity of the dispersion, the crystal change can be visually determined. The particle diameter of the crystal increases in proportion to the time during which the crystal changing operation is performed. Therefore, it is important that the crystal changing efficiency is enhanced to complete the crystal changing operation in a short time, and the following is the key points.

Specifically, one of the key points is to use the proper solvents as mentioned above for the crystal changing process. Another key point is to efficiently contact the aqueous paste of the amorphous titanyl phthalocyanine with a crystal changing solvent in the crystal changing process by performing strong agitation. Specifically, the amorphous titanyl phthalocyanine is preferably mixed with the crystal changing solvent using a dispersion machine which can perform strong agitation using a propeller, such as homogenizers (e.g., HOMOMIXER). By using these methods, the crystal changing operation can be completed in a short time. Namely, a TiOPc in which crystal change is fully performed (i.e., which hardly includes the raw material) while crystal growth is hardly caused can be prepared.

Even in this case, it is important to use a proper amount of solvent for crystal changing as mentioned above. Specifically, the amount of the solvent is preferably not less than 10 times, and more preferably not less than 30 times, the amount of the amorphous titanyl phthalocyanine (raw material) used. By using this method, the crystal changing can be completed in a short time while preventing the impurities, which are included in the titanyl phthalocyanine raw material, from remaining in the resultant TiOPc.

As mentioned above, the particle diameter of the TiOPc increases in proportion to the crystal changing time. Therefore, it is also effective to rapidly stop the crystal changing reaction soon after the crystal changing reaction is completed. In order to rapidly stop the reaction, it is preferable to add a large amount of second solvent, in which crystal changing is hardly caused, to the reaction system. Specific examples of such second solvents include alcohol solvents and ester solvents. The ratio of the second solvent to the crystal changing solvent is preferably about 10/1 to rapidly stop the crystal changing reaction.

With respect to the thus prepared TiOPc, the smaller particle diameter the crystal has, the better properties the resultant photoreceptor has. However, when the particle diameter is too small, problems in that the filtering operation takes a relatively long time and the dispersion stability of the dispersion including the crystal deteriorates (i.e., the primary particles aggregate because the surface area of the particles is large) tend to occur. Therefore, the particle diameter of the TiOPc is preferably from about 0.05 μm to about 0.2 μm.

FIG. 18 is a photograph showing a TiOPc which is prepared by performing crystal change in a short time. In FIG. 18, the practical length of the scale bar is 0.2 μm. As can be understood from FIGS. 17 and 18, the crystal as shown in FIG. 18 has a relatively small average particle diameter and the variation of the particle diameter is relatively small. In addition, the crystal as shown in FIG. 18 includes no coarse particles whereas the crystal as shown in FIG. 17 includes coarse particles.

The thus prepared TiOPc can be dispersed by applying a shearing force enough to dissociate secondary particles, which are formed due to aggregation of primary particles, into primary particles. Since a high shearing force is not applied, a dispersion including a crystal having an average particle diameter not greater than 0.25 μm (preferably not greater than 0.20 μm) can be easily prepared without causing a problem in that part of the crystal causes crystal change.

In this regard, the particle diameter means the volume average particle diameter, and can be determined by a centrifugal automatic particle diameter analyzer, CAPA-700 from Horiba Ltd. The volume average particle diameter means the cumulative 50% particle diameter (i.e., Median diameter). However, by using this particle diameter determining method, there is a case where a small amount of coarse particles cannot be detected. Therefore, it is preferable to directly observe the dispersion including a TiOPc crystal with an electron microscope, to determine the particle diameter of the crystal.

In addition, with respect to minute coating defects included in a layer formed using a titanyl phthalocyanine crystal dispersion, the following knowledge can be acquired. Whether coarse particles are present in the dispersion can be detected by a particle diameter measuring instrument if the concentration of coarse particles is on the order of a few percent or more. However, when the concentration is not greater than 1%, the presence of coarse particles cannot be detected by such an instrument. Therefore, even when it is confirmed that the average particle diameter of the crystal in a dispersion falls in the preferable range, a problem in that the resultant charge generation layer has minute coating defects can occur.

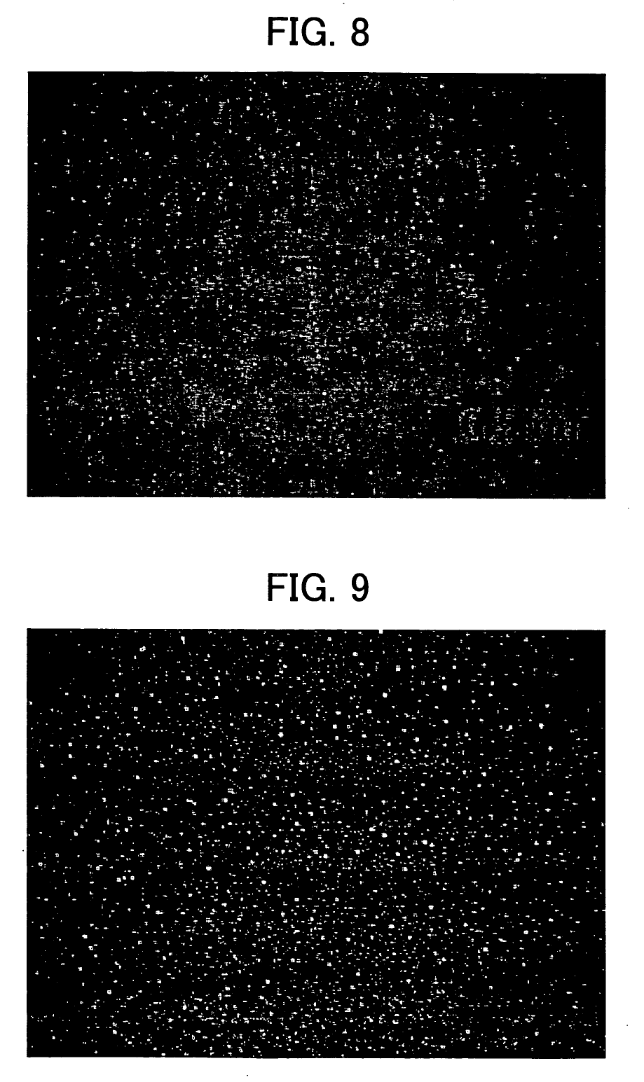

FIGS. 8 and 9 are photographs showing the dispersion state of the same titanyl phthalocyanine crystal in different dispersions A and B which are prepared by the same method except that the dispersion time is changed. The dispersion time for the dispersion A is shorter than that for the dispersion B. It is clear from the comparison of FIG. 8 with FIG. 9 that coarse particles are present in the dispersion A illustrated in FIG. 8. Coarse particles are observed as black spots in FIG. 8.

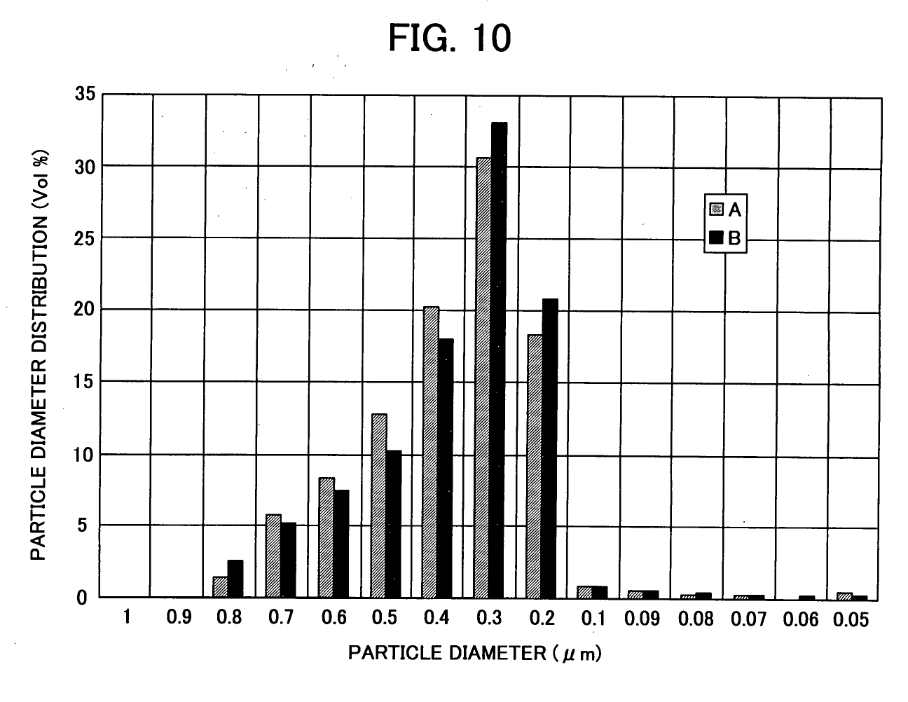

The particle diameter distributions of the dispersions A and B, which are measured with a centrifugal automatic particle diameter analyzer, CAPA-700 from Horiba Ltd., are illustrated in FIG. 10. In FIG. 10, characters A and B represent the particle diameter distributions of the dispersions A and B, respectively. As can be understood from the graph, the particle diameter distributions are almost the same. The average particle diameters of the dispersions A and B are 0.29 μm and 0.28 μm, respectively, which are the same when considering the measurement error. Thus, whether or not coarse particles are present cannot be determined using such a particle diameter measuring instrument. As mentioned above, whether coarse particles are present in a dispersion can be detected only by the method in which the dispersion is directly observed using a microscope.

Next, the method for removing coarse particles from a TiOPc dispersion will be explained.

A dispersion is prepared by dispersing the TiOPc crystal in a solvent, optionally together with a binder resin, using a ball mill, an attritor, a sand mill, a bead mill, an ultrasonic dispersing machine or the like. In this case, it is preferable that a proper binder resin is chosen in consideration of the electrostatic properties of the resultant photoreceptor and a proper solvent is chosen while considering its abilities to wet and disperse the crystal.

Specifically, the method is that the TiOPc prepared above is dispersed while applying a shear thereto such that the crystal does not cause crystal change, and the dispersion is then filtered using a filter with a proper pore size. By using this method, a small amount of coarse particles (which cannot be visually observed or cannot be detected by a particle diameter measuring instrument) can be removed from the dispersion. In addition, the particle diameter distribution of the particles in the dispersion can be properly controlled. Specifically, it is preferable to use a filter with an effective pore diameter not greater than 5 μm, and more preferably not greater than 3 μm. By using such a filter, a dispersion in which the TiOPc is dispersed while having an average particle diameter not greater than 0.25 μm (or not greater than 0.20 μm) can be prepared. By using this dispersion, a CGL can be formed without causing coating defects. Therefore, the effects of the present invention can be fully produced.

It is preferable that a proper filter is chosen depending on the size of coarse particles to be removed. As a result of the present inventors' investigation, it is found that coarse particles having a particle diameter not less than 3 μm affect the image qualities of images with a resolution of 600 dpi (600 dots/inch (25.4 mm)). Therefore, it is preferable to use a filter with a pore diameter not greater than 5 μm, and more preferably not greater than 3 μm. Filters with too small a pore diameter filter out TiOPc particles, which can be used for the CGL, as well as coarse particles to be removed. In addition, such filters cause problems in that filtering takes a long time, the filters are clogged with particles, and an excessive stress is applied to the pump used. Therefore, a filter with a proper pore diameter is preferably used. Needless to say, the filter preferably has good resistance to the solvent used for the dispersion.

When a dispersion including a large amount of coarse particles is filtered, the amount of particles removed by filtering increases, and thereby a problem in that the solid content of the resultant dispersion is seriously decreased. Therefore, it is preferable that the dispersion to be filtered has a proper particle diameter distribution (i.e., a proper particle diameter and a proper standard deviation of particle diameter). Specifically, in order to efficiently perform the filtering operation without causing the clogging problem of the filter at a little loss of the resultant TiOPc, it is preferable that the average particle diameter is not greater than 0.3 μm and the standard deviation of the particle diameter is not greater than 0.2 μm.

The CGMs for use in the present invention have a high intermolecular hydrogen bond force. Therefore, the dispersed pigment particles have a high interaction. As a result thereof, the dispersed CGM particles tend to aggregate. By performing the above-mentioned filtering using a filter having the specific pore diameter, such aggregates can be removed. In this regard, the dispersion has a thixotropic property, and thereby particles having a particle diameter less than the pore diameter of the filter used can be removed. Alternatively, a liquid having a structural viscosity can be changed to a Newtonian liquid by filtering. By removing coarse particles from a CGL coating liquid, a good CGL can be prepared and the effect of the present invention can be produced.

The CGL is typically prepared by coating a coating liquid, which is prepared by dispersing a CGM (preferably the TiOPc prepared above) in a solvent, optionally together with a binder resin, using a ball mill, an attritor, a sand mill or an ultrasonic dispersion machine, followed by drying. Suitable coating methods include dip coating, spray coating, bead coating, nozzle coating, spinner coating and ring coating.

Specific examples of the binder resins, which are optionally included in the CGL coating liquid, include polyamide, polyurethane, epoxy resins, polyketone, polycarbonate, silicone resins, acrylic resins, polyvinyl butyral, polyvinyl formal, polyvinyl ketone, polystyrene, polysulfone, poly-N-vinylcarbazole, polyacrylamide, polyvinyl benzal, polyester, phenoxy resins, vinyl chloride-vinyl acetate copolymers, polyvinyl acetate, polyphenylene oxide, polyamides, polyvinyl pyridine, cellulose resins, casein, polyvinyl alcohol, polyvinyl pyrrolidone, and the like resins. Among the binder resins, polyvinyl acetal represented by polyvinyl butyral is preferably used.

The content of the binder resin in the CGL is preferably from 0 to 500 parts by weight, and preferably from 10 to 300 parts by weight, per 100 parts by weight of the CGM included in the layer.

Specific examples of the solvents for use in the CGL coating liquid include isopropanol, acetone, methyl ethyl ketone, cyclohexanone, tetrahydrofuran, dioxane, ethyl cellosolve, ethyl acetate, methyl acetate, dichloromethane, dichloroethane, monochlorobenzene, cyclohexane, toluene, xylene, ligroin, and the like solvents. Among these solvents, ketones, esters and ethers are preferably used.

The CGL preferably has a thickness of from 0.01 to 5 μm, and more preferably from 0.1 to 2 μm.

Then the charge transport layer (CTL) 37 will be explained. The CTL is typically prepared by coating a coating liquid, which is prepared by dissolving or dispersing a charge transport material in a solvent optionally together with a binder resin, followed by drying. If desired, additives such as plasticizers, leveling agents and antioxidants can be added to the coating liquid.

Charge transport materials (CTMs) are classified into positive-hole transport materials and electron transport materials.

Specific examples of the electron transport materials include electron accepting materials such as chloranil, bromanil, tetracyanoethylene, tetracyanoquinodimethane, 2,4,7-trinitro-9-fluorenon, 2,4,5,7-tetranitro-9-fluorenon, 2,4,5,7-tetanitroxanthone, 2,4,8-trinitrothioxanthone, 2,6,8-trinitro-4H-indeno[1,2-b]thiophene-4-one, 1,3,7-trinitrodibenzothiphene-5,5-dioxide, benzoquinone derivatives and the like.

Specific examples of the positive-hole transport materials include known materials such as poly-N-vinyl carbazole and its derivatives, poly-γ-carbazolylethylglutamate and its derivatives, pyrene-formaldehyde condensation products and their derivatives, polyvinyl pyrene, polyvinyl phenanthrene, polysilane, oxazole derivatives, oxadiazole derivatives, imidazole derivatives, monoarylamines, diarylamines, triarylamines, stilbene derivatives, α-phenyl stilbene derivatives, benzidine derivatives, diarylmethane derivatives, triarylmethane derivatives, 9-styrylanthracene derivatives, pyrazoline derivatives, divinyl benzene derivatives, hydrazone derivatives, indene derivatives, butadiene derivatives, pyrene derivatives, bisstilbene derivatives, enamine derivatives, and the like.

These CTMs can be used alone or in combination.

Specific examples of the binder resins for use in the CTL include known thermoplastic resins and thermosetting resins, such as polystyrene, styrene-acrylonitrile copolymers, styrene-butadiene copolymers, styrene-maleic anhydride copolymers, polyester, polyvinyl chloride, vinyl chloride-vinyl acetate copolymers, polyvinyl acetate, polyvinylidene chloride, polyarylate, phenoxy resins, polycarbonate, cellulose acetate resins, ethyl cellulose resins, polyvinyl butyral resins, polyvinyl formal resins, polyvinyl toluene, poly-N-vinyl carbazole, acrylic resins, silicone resins, epoxy resins, melamine resins, urethane resins, phenolic resins, alkyd resins and the like.

The content of the CTM in the charge transport layer is preferably from 20 to 300 parts by weight, and more preferably from 40 to 150 parts by weight, per 100 parts by weight of the binder resin included in the CTL. The thickness of the CTL 8 is preferably from 5 to 100 μm.

Suitable solvents for use in the CTL coating liquid include tetrahydrofuran, dioxane, toluene, dichloromethane, monochlorobenzene, dichloroethane, cyclohexanone, methyl ethyl ketone, acetone and the like solvents. However, in view of environmental protection, non-halogenated solvents are preferably used. Specifically, cyclic ethers such as tetrahydrofuran, dioxolan and dioxane, aromatic hydrocarbons such as toluene and xylene, and their derivatives are preferably used.

A photosensitive layer in which a CTL is formed on a CTL often causes a problem in that discharging light cannot reach the CGL depending on the material constituting the CTL, resulting in insufficient discharging, although a single-layered photosensitive layer or a photosensitive layer in which a CGL is formed on a CTL does not cause this problem. In addition, when a CTM absorbs discharging light, the CTM is easily deteriorated by the light, resulting in occurrence of the residual potential increasing problem. Therefore, the CTL preferably has a transmittance of not less than 30%, more preferably not less than 50% and even more preferably not less than 85%, against the discharging light used.

In order that the CTL has such a transmittance, CTMs having a triarylamine structure are preferably used. This is because light having a wavelength less than 480 nm easily passes through the CTMs and in addition the CTMs have good mobility. Therefore such CTMs are preferably used for the CTL of the photoreceptor for use in the present invention.

Among the CTMs having a triarylamine structure, the CTMs having the following formula (XIII) are more preferably used. 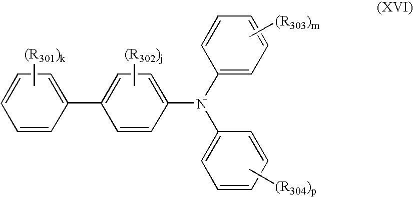
wherein R₃₀₁, R₃₀₃, and R₃₀₄ independently represent a hydrogen atom, an amino group, an alkoxyl group, a thioalkoxyl group, an aryloxy group, a methylenedioxy group, a substituted or unsubstituted alkyl group, a halogen atom, or a substituted or unsubstituted aryl group; R₃₀₂ represents a hydrogen atom, an alkoxyl group, a substituted or unsubstituted alkyl group or a halogen atom; and each of k, j, m and p is an integer of from 1 to 4, wherein when k, j, m or p is an integer of from 2 to 4, the plural groups in the corresponding group R₃₀₁, R₃₀₂, R₃₀₃ or R₃₀₄ may be the same or different from each other.

The method for synthesizing the CTMs is described in JP-A 02-36156, incorporated herein by reference. The materials listed therein can be used for synthesizing the CTMs.

Charge transport polymers, which have both a binder resin function and a charge transport function, can be preferably used for the charge transport layer because the resultant charge transport layer has good abrasion resistance.

Suitable charge transport polymers include known charge transport polymer materials. Among these materials, polycarbonate resins having a triarylamine group in their main chain and/or side chain are preferably used. In particular, charge transport polymers having the following formulae of from (1) to (10) are preferably used: 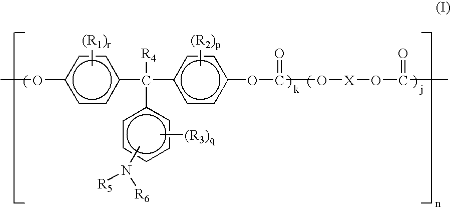
wherein R₁, R₂ and R₃ independently represent a substituted or unsubstituted alkyl group, or a halogen atom; R₄ represents a hydrogen atom, or a substituted or unsubstituted alkyl group; R₅, and R₆ independently represent a substituted or unsubstituted aryl group; r, p and q independently represent 0 or an integer of from 1 to 4; k is a number of from 0.1 to 1.0 and j is a number of from 0 to 0.9; n is an integer of from 5 to 5000; and X represents a divalent aliphatic group, a divalent alicyclic group or a divalent group having the following formula: 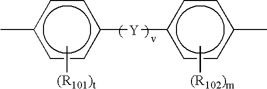
wherein R₁₀₁ and R₁₀₂ independently represent a substituted or unsubstituted alkyl group, a substituted or unsubstituted aryl group, or a halogen atom; t and m represent 0 or an integer of from 1 to 4; v is 0 or 1; and Y represents a linear alkylene group, a branched alkylene group, a cyclic alkylene group, —O—, —S—, —SO—, —SO₂—, —CO—, —CO—O-Z-O—CO— (Z represents a divalent aliphatic group), or a group having the following formula: 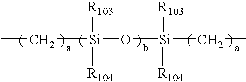
wherein a is an integer of from 1 to 20; b is an integer of from 1 to 2000; and R₁₀₃ and R₁₀₄ independently represent a substituted or unsubstituted alkyl group, or a substituted or unsubstituted aryl group, wherein R₁₀₁, R₁₀₂, R₁₀₃ and R₁₀₄ may be the same or different from the others. 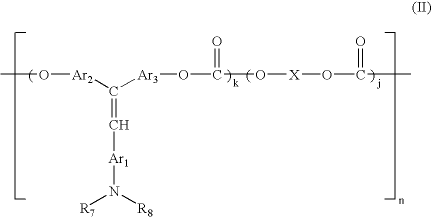
wherein R₇ and R₈ independently represent a substituted or unsubstituted aryl group; Ar₁, Ar₂ and Ar₃ independently represent an arylene group; and X, k, j and n are defined above in formula (I). 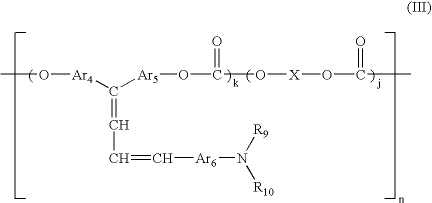
wherein R₉ and R₁₀ independently represent a substituted or unsubstituted aryl group; Ar₄, Ar₅ and Ar₆ independently represent an arylene group; and X, k, j and n are defined above in formula (I). 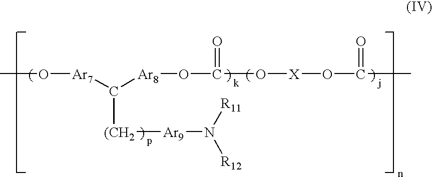
wherein R₁₁ and R₁₂ independently represent a substituted or unsubstituted aryl group; Ar₇, Ar₈ and Ar₉ independently represent an arylene group; p is an integer of from 1 to 5; and X, k, j and n are defined above in formula (I). 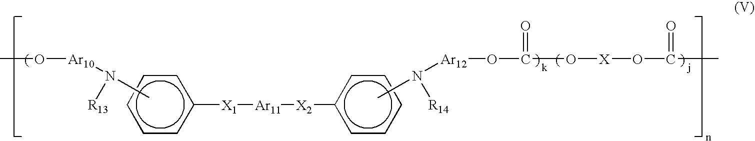
wherein R₁₃ and R₁₄ independently represent a substituted or unsubstituted aryl group; Ar₁₀, Ar₁₁, and Ar₁₂ independently represent an arylene group; X₁ and X₂ independently represent a substituted or unsubstituted ethylene group, or a substituted or unsubstituted vinylene group; and X, k, j and n are defined above in formula (I). 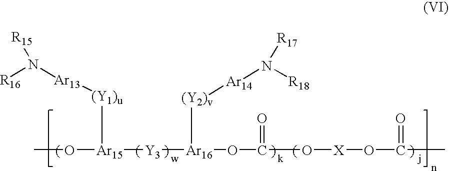
wherein R₁₅, R₁₆, R₁₇ and R₁₈ independently represent a substituted or unsubstituted aryl group; Ar₁₃, Ar₁₄, Ar₁₅ and Ar₁₆ independently represent an arylene group; Y₁, Y₂ and Y₃ independently represent a substituted or unsubstituted alkylene group, a substituted or unsubstituted cycloalkylene group, a substituted or unsubstituted alkylene ether group, an oxygen atom, a sulfur atom, or a vinylene group; u, v and w independently represent 0 or 1; and X, k, j and n are defined above in formula (I). 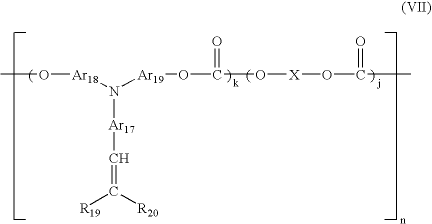
wherein R₁₉ and R₂₀ independently represent a hydrogen atom, or substituted or unsubstituted aryl group, and R₁₉ and R₂₀ optionally share bond connectivity to form a ring; Ar₁₇, Ar₁₈ and Ar₁₉ independently represent an arylene group; and X, k, j and n are defined above in formula (I). 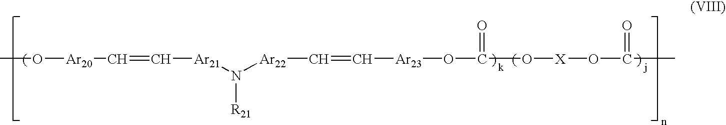
wherein R₂₁ represents a substituted or unsubstituted aryl group; Ar₂₀, Ar₂₁, Ar₂₂ and Ar₂₃ independently represent an arylene group; and X, k, j and n are defined above in formula (I). 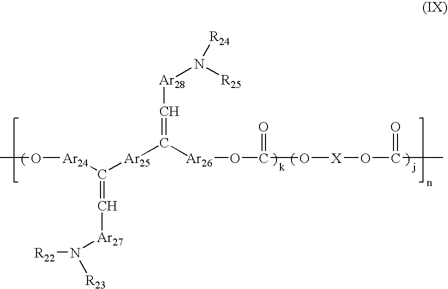
wherein R₂₂, R₂₃, R₂₄ and R₂₅ independently represent a substituted or unsubstituted aryl group; Ar₂₄, Ar₂₅, Ar₂₆, Ar₂₇ and Ar₂₈ independently represent an arylene group; and X, k, j and n are defined above in formula (I). 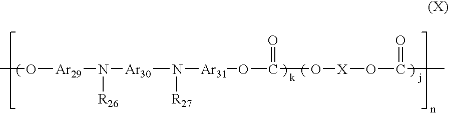
wherein R₂₆ and R₂₇ independently represent a substituted or unsubstituted aryl group; Ar₂₉, Ar₃₀ and Ar₃₁ independently represent an arylene group; and X, k, j and n are defined above in formula (I).

Formulae (I) to (X) are illustrated in the form of block copolymers, but the polymers are not limited thereto. The polymers may be random copolymers.

In addition, the CTL can also be formed by coating one or more monomers or oligomers, which have an electron donating group, and then subjecting the monomers or oligomers to a crosslinking reaction after forming the layer such that the layer has a two- or three-dimensional structure.

In order to prepare the above-mentioned charge transport polymers, monomers having a charge transport moiety in the entire part or a part thereof are preferably used. By using such monomers, the resultant CTL has the charge transport moiety in the three-dimensional network. Therefore, the CTL can fully exercise a charge transport function. Among the monomers, monomers having a triarylamine structure are preferably used.

The CTL having such a three-dimensional structure has good abrasion resistance but often forms a crack therein if the layer is too thick. In order to prevent occurrence of such cracking problem, a multi-layered CTL in which a crosslinked CTL is formed on a CTL in which a low molecular CTM is dispersed in a polymer can be used.

The CTL constituted of a polymer or a crosslinked polymer, which has an electron donating group, has good abrasion resistance. In electrophotographic image forming apparatus, the potential of the charges formed on a photoreceptor (i.e., the potential of a non-lighted area) is generally set to be constant. Therefore, the larger the abrasion loss of the photosensitive layer of the photoreceptor, the larger the electric field formed on the photoreceptor.

When the electric field increases, background development occurs in the resultant images. Namely a photoreceptor having good abrasion resistance hardly causes the background development problem. The above-mentioned charge transport layer constituted of a polymer having an electron donating group has good film formability because the layer itself a polymer. In addition, the charge transport layer has good charge transportability because of including charge transport moieties at a relatively high concentration compared to charge transport layers including a polymer and a low molecular weight CTM. Namely, the photoreceptor including a charge transport layer constituted of a charge transport polymer has high response.

Known copolymers, block polymers, graft polymers, and star polymers can also be used for the polymers having an electron donating group. In addition, crosslinking polymers including an electron donating group can also be used for the charge transport layer.

The CTL may include additives such as plasticizers and leveling agents. Specific examples of the plasticizers include known plasticizers such as dibutyl phthalate and dioctyl phthalate. The content of the plasticizer in the CTL is from 0 to 30% by weight based on the total weight of the binder resin included in the charge transport layer. Specific examples of the leveling agents include silicone oils such as dimethyl silicone oils and methyl phenyl silicone oils, and polymers and oligomers, which include a perfluoroalkyl group in their side chain. The content of the leveling agent in the CTL is from 0 to 1% by weight based on the total weight of the binder resin included in the charge transport layer.

It is also preferable for the CTL including a charge transport polymer to have a transmittance of not less than 30% and more preferably not less than 50% against the discharging light used.

The photoreceptor for use in the present invention optionally includes a protective layer 41, which is formed on the photosensitive layer to protect the photosensitive layer. Recently, computers are used in daily life, and therefore a need exists for a high-speed and small-sized printer. By forming a protective layer on the photosensitive layer, the resultant photoreceptor has good durability while having a high photosensitivity and producing images without abnormal images.

The protective layers for use in the present invention are classified into two types, one of which is a layer including a binder resin and a filler dispersed in the binder resin and the other of which is a layer including a crosslinked binder resin.

At first, the protective layer of the first type will be explained.

Specific examples of the materials for use in the protective layer include ABS resins, ACS resins, olefin-vinyl monomer copolymers, chlorinated polyether, aryl resins, phenolic resins, polyacetal, polyamide, polyamideimide, polyallysulfone, polybutylene, polybutyleneterephthalate, polycarbonate, polyarylate, polyethersulfone, polyethylene, polyethyleneterephthalate, polyimide, acrylic resins, polymethylpentene, polypropylene, polyphenyleneoxide, polysulfone, polystyrene, AS resins, butadiene-styrene copolymers, polyurethane, polyvinyl chloride, polyvinylidene chloride, epoxy resins, etc. Among these resins, polycarbonate and polyarylate are preferably used.

In addition, in order to impart good abrasion resistance to the protective layer, fluorine-containing resins such as polytetrafluoroethylene, and silicone resins can be used therefor. Further, materials in which such resins as mentioned above are mixed with an inorganic filler such as titanium oxide, aluminum oxide, tin oxide, zinc oxide, zirconium oxide, magnesium oxide, potassium titanate and silica or an organic filler can also be used therefor. These inorganic fillers may be subjected to a surface-treatment.

Suitable organic fillers for use in the protective layer include powders of fluorine-containing resins such as polytetrafluoroethylene, silicone resin powders, amorphous carbon powders, etc. Specific examples of the inorganic fillers for use in the protective layer include powders of metals such as copper, tin, aluminum and indium; metal oxides such as alumina, silica, tin oxide, zinc oxide, titanium oxide, alumina, zirconia, indium oxide, antimony oxide, bismuth oxide, calcium oxide, tin oxide doped with antimony, indium oxide doped with tin; potassium titanate, etc. In view of hardness, the inorganic fillers are preferable. In particular, silica, titanium oxide and alumina are preferable, and α-alumina is more preferable.

The content of the filler in the protective layer is preferably determined depending on the species of the filler used and the application of the resultant photoreceptor, but the content of a filler in the surface portion of the protective layer is preferably not less than 5% by weight, more preferably from 10 to 50% by weight, and even more preferably from 10 to 30% by weight, based on the total weight of the surface portion of the protective layer.

The filler included in the protective layer preferably has a volume average particle diameter of from 0.1 to 2 μm, and more preferably from 0.3 to 1 μm. When the average particle diameter is too small, good abrasion resistance cannot be imparted to the resultant photoreceptor. In contrast, when the average particle diameter is too large, the surface of the resultant protective layer is seriously roughened or a problem such that a protective layer itself cannot be formed occurs.

In the present application, the average particle diameter of a filler means a volume average particle diameter unless otherwise specified, and is measured using an instrument, CAPA-700 manufactured by Horiba Ltd. In this case, the cumulative 50% particle diameter (i.e., the median particle diameter) is defined as the average particle diameter. In addition, it is preferable that the standard deviation of the particle diameter distribution curve of the filler used in the protective layer is not greater than 1 μm. When the standard deviation is too large (i.e., when the filler has too broad particle diameter distribution), the effect of the present invention cannot be produced.

The pH of the filler used in the protective layer coating liquid largely influences on the dispersibility of the filler therein and the resolution of the images produced by the resultant photoreceptor. The reasons therefor are as follows. Fillers (in particular, metal oxides) typically include hydrochloric acid therein which is used when the fillers are produced. When the amount of residual hydrochloric acid is large, the resultant photoreceptor tends to produce blurred images. In addition, inclusion of too large an amount of hydrochloric acid causes the dispersibility of the filler to deteriorate.

Another reason therefor is that the charge properties of fillers (in particular, metal oxides) are largely influenced by the pH of the fillers. In general, particles dispersed in a liquid are charged positively or negatively. In this case, ions having a charge opposite to the charge of the particles gather around the particles to neutralize the charge of the particles, resulting in formation of an electric double layer, and thereby the particles are stably dispersed in the liquid. The potential (i.e., zeta potential) of a point around one of the particles decreases (i.e., approaches to zero) as the distance between the point and the particle increases. Namely, a point far apart from the particle is electrically neutral, i.e., the zeta potential thereof is zero. In this case, the higher the zeta potential, the better the dispersion of the particles. When the zeta potential is nearly equal to zero, the particles easily aggregate (i.e., the particles are unstably dispersed). The zeta potential of a system largely depends on the pH of the system. When the system has a certain pH, the zeta potential becomes zero. This pH point is called an isoelectric point. It is preferable to increase the zeta potential by setting the pH of the system to be far apart from the isoelectric point, in order to enhance the dispersion stability of the system.

It is preferable for the protective layer to include a filler having an isoelectric point at a pH of 5 or more, in order to prevent formation of blurred images. In other words, fillers having a highly basic property can be preferably used in the photoreceptor of the present invention because the effect of the present invention can be heightened. Fillers having a highly basic property have a high zeta potential (i.e., the fillers are stably dispersed) when the system for which the fillers are used is acidic.

In this application, the pH of a filler means the pH of the filler at the isoelectric point, which is determined by the zeta potential of the filler. Zeta potential can be measured by a laser beam potential meter manufactured by Ootsuka Electric Co., Ltd.

In addition, in order to prevent production of blurred images, fillers having a high electric resistance (i.e., not less than 1×10¹⁰ Ω·cm in resistivity) are preferably used. Further, fillers having a pH of not less than 5 and fillers having a dielectric constant of not less than 5 can be more preferably used. Fillers having a dielectric constant of not less than 5 and/or a pH of not less than 5 can be used alone or in combination. In addition, combinations of a filler having a pH of not less than 5 and a filler having a pH of less than 5, or combinations of a filler having a dielectric constant of not less than 5 and a filler having a dielectric constant of less than 5, can also be used. Among these fillers, α-alumina having a closest packing structure is preferably used. This is because α-alumina has a high insulating property, a high heat stability and a good abrasion resistance, and thereby formation of blurred images can be prevented and abrasion resistance of the resultant photoreceptor can be improved.

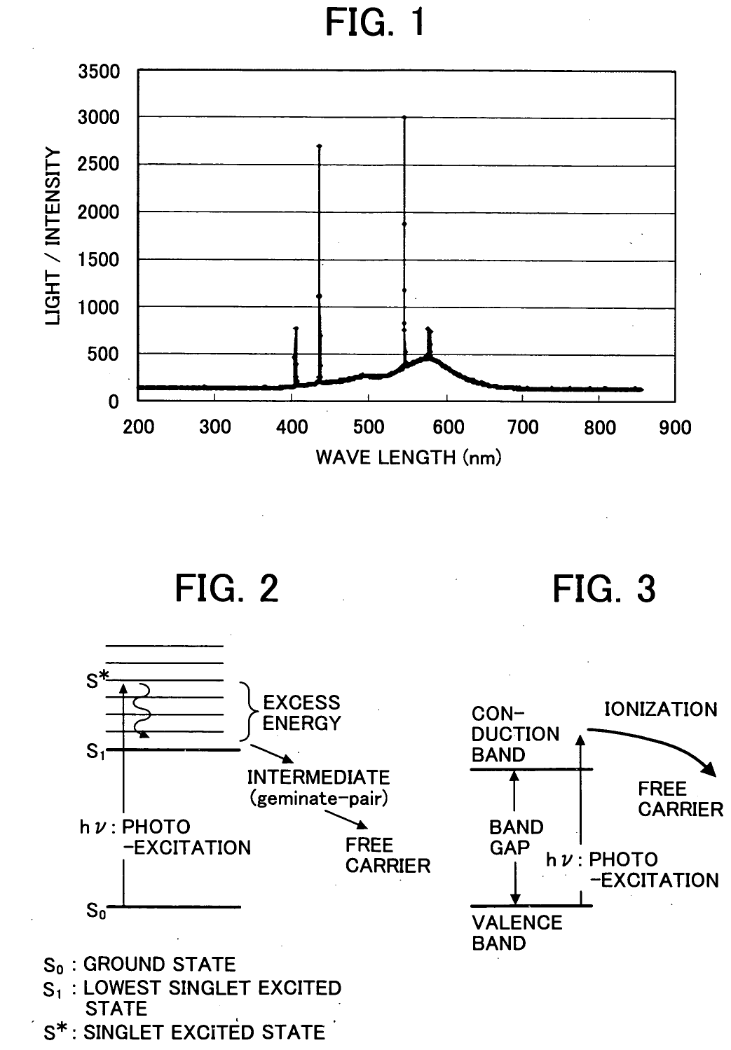

In the present application, the resistivity of a filler is defined as follows. The resistivity of a powder such as fillers largely changes depending on the filling factor of the powder when the resistivity is measured. Therefore, it is necessary to measure the resistivity under a constant condition. In the present application, the resistivity is measured by a device similar to the devices disclosed in FIG. 1 of 5-113688. The surface area of the electrodes of the device is 4.0 cm². Before the resistivity of a sample powder is measured, a load of 4 kg is applied to one of the electrodes for 1 minute and the amount of the sample powder is adjusted such that the distance between the two electrodes becomes 4 mm.

The resistivity of the sample powder is measured by pressing the sample powder only by the weight (i.e., 1 kg) of the upper electrode without applying any other load to the sample. The voltage applied to the sample powder is 100 V. When the resistivity is not less than 10⁶ Ω·cm, HIGH RESISTANCEMETER (from Yokogawa Hewlett-Packard Co.) is used to measure the resistivity. When the resistivity is less than 10⁶ Ω·cm, a digital multimeter (from Fluke Corp.) is used.

The dielectric constant of a filler is measured as follows. A cell similar to that used for measuring the resistivity is also used for measuring the dielectric constant. After a load is applied to a sample powder, the capacity of the sample powder is measured using a dielectric loss measuring instrument (from Ando Electric Co., Ltd.) to determine the dielectric constant of the powder.

The fillers to be included in the protective layer are preferably subjected to a surface treatment using a surface treatment agent in order to improve the dispersion of the fillers in the protective layer. When a filler is poorly dispersed in the protective layer, the following problems occur.

(1) the residual potential of the resultant photoreceptor increases;

(2) the transparency of the resultant protective layer decreases;

(3) coating defects are formed in the resultant protective layer;

(4) the abrasion resistance of the protective layer deteriorates;

(5) the durability of the resultant photoreceptor deteriorates; and

(6) the image qualities of the images produced by the resultant photoreceptor deteriorate.

Suitable surface treatment agents include known surface treatment agents. However, surface treatment agents which can maintain the highly insulating property of the fillers used are preferably used.

As for the surface treatment agents, titanate coupling agents, aluminum coupling agents, zircoaluminate coupling agents, higher fatty acids, combinations of these agents with a silane coupling agent, Al₂O₃, TiO₂, ZrO₂, silicones, aluminum stearate, and the like, can be preferably used to improve the dispersibility of fillers and to prevent formation of blurred images. These materials can be used alone or in combination.

When fillers treated with a silane coupling agent are used, the resultant photoreceptor tends to produce blurred images. However, combinations of a silane coupling agent with one of the surface treatment agents mentioned above can often produce good images without blurring.

The coating weight of the surface treatment agents is preferably from 3 to 30% by weight, and more preferably from 5 to 20% by weight, based on the weight of the filler to be treated, although the weight is determined depending on the average primary particle diameter of the filler.

When the content of the surface treatment agent is too low, the dispersibility of the filler cannot be improved. In contrast, when the content is too high, the residual potential of the resultant photoreceptor seriously increases.

These fillers can be dispersed using a proper dispersion machine. In this case, the fillers are preferably dispersed such that the aggregated particles are dissociated and primary particles of the fillers are dispersed, to improve the transparency of the resultant protective layer.

In addition, a CTM can be included in the protective layer to enhance the photo response and to reduce the residual potential of the resultant photoreceptor. The CTMs mentioned above for use in the charge transport layer can also be used for the protective layer.

When a low molecular weight CTM is used for the protective layer, the concentration of the CTM may be changed in the thickness direction of the protective layer. Specifically, it is preferable to reduce the concentration of the CTM at the surface portion of the protective layer in order to improve the abrasion resistance of the resultant photoreceptor. At this point, the concentration of the CTM means the ratio of the weight of the CTM to the total weight of the protective layer.

It is preferable to use one or more of the charge transport polymers mentioned above for use in the CTL for the protective layer in order to improve the durability and high speed charge transportability of the photoreceptor.

The protective layer 41 can be formed by any known coating methods. The thickness of the protective layer is preferably from 0.1 to 10 μm.

Next, the crosslinked protective layer will be explained. The crosslinked protective layer is preferably prepared by subjecting a reactive monomer having plural crosslinkable functional groups in a molecule to a crosslinking reaction upon application of light or heat thereto. By forming a protective layer having such a three-dimensional network, the photoreceptor has good abrasion resistance.

In order to prepare the above-mentioned protective layer, monomers having a charge transportable moiety in the entire part or a part thereof are preferably used. By using such monomers, the resultant protective layer has the charge transport moiety in the three-dimensional network. Therefore, the CTL can fully exercise a charge transport function. Among the monomers, monomers having a triarylamine structure are preferably used.

The protective layer having such a three-dimensional structure has good abrasion resistance but often forms a crack therein if the layer is too thick. In order to prevent occurrence of such cracking problem, a multi-layered protective layer in which a crosslinked protective layer is formed on a protective layer in which a low molecular CTM is dispersed in a polymer can be used.

The crosslinked protective layer having a charge transport structure is preferably prepared by reacting and crosslinking a radical polymerizable tri- or more-functional monomer having no charge transport structure and a radical polymerizable monofunctional monomer having a charge transport structure. This protective layer has high hardness and high elasticity because of having a well-developed three dimensional network and a high crosslinking density. In addition, since the surface of the protective layer is uniform and smooth, the protective layer has good abrasion resistance and scratch resistance.

Although it is important to increase the crosslinking density of the protective layer, a problem in that the protective layer has a high internal stress due to shrinkage in the crosslinking reaction tends to occur. The internal stress increases as the thickness of the protective layer increases. Therefore, when a thick protective layer is crosslinked, problems in that the protective layer is cracked and peeled occur. Even though these problems are not caused when a photoreceptor is new, the problems are easily caused when the photoreceptor receives various stresses after being repeatedly subjected to charging, developing, transferring and cleaning.

In order to prevent occurrence of the problems, the following techniques can be used.

(1) a polymeric component is added to the crosslinked protective layer;

(2) a large amount of mono- or di-functional monomers are used for forming the crosslinked protective layer; and

(3) a polyfunctional monomer having a group capable of imparting softness to the resultant crosslinked protective layer is used for forming the crosslinked protective layer.

However, all the crosslinked protective layers prepared using these techniques have a low crosslinking density. Therefore, a good abrasion resistance cannot be imparted to the resultant protective layers.

In contrast, the crosslinked protective layer of the photoreceptor for use in the present invention has a well-developed three-dimensional network, a high crosslinking density and a high charge transporting ability when having a thickness of from 1 to 10 μm. Therefore, the resultant photoreceptor has high abrasion resistance and hardly causes cracking and peeling problems. The thickness of the crosslinked protective layer is preferably from 2 to 8 μm. In this case, the margin for the above-mentioned problems can be improved and flexibility in choosing materials for forming a protective layer having a higher crosslinking density can be enhanced.

The reasons why the photoreceptor for use in the present invention hardly causes the cracking and peeling problems are as follows.

(1) a relatively thin crosslinked protective layer having a charge transport structure is formed and thereby increase of internal stress of the photoreceptor can be prevented; and

(2) since a CTL is formed below the crosslinked protective layer having a charge transport structure, the internal stress of the crosslinked protective layer can be relaxed.

Therefore, it is not necessary to increase the amount of polymer components in the protective layer. Accordingly, occurrence of problems in that the protective layer is scratched or a film (such as a toner film) is formed on the protective layer, which is caused by incomplete mixing of polymer components and the crosslinked material formed by reaction of radical polymerizable monomers, can be prevented.

In addition, when a protective layer is crosslinked by irradiating light, a problem in that the inner portion of the protective layer is incompletely reacted because the charge transport moieties absorb light occurs if the protective layer is too thick. However, since the protective layer of the photoreceptor for use in the present invention has a thickness of not greater than 10 μm, the inner portion of the protective layer can be completely crosslinked and thereby a good abrasion resistance can be imparted to the entire protective layer.

Further, since the crosslinked protective layer is prepared using a monofunctional monomer having a charge transport structure, the monofunctional monomer is incorporated in the crosslinking bonds formed by one or more tri- or more-functional monomers. When a crosslinked protective layer is formed using a low molecular weight CTM having no functional group, a problem in that the low molecular weight CTM is separated from the crosslinked resin, resulting in precipitation of the low molecular weight CTM and formation of a clouded protective layer, and thereby the mechanical strength of the protective layer is deteriorated. When a crosslinked protective layer is formed using di- or more-functional charge transport compounds as main components, the resultant protective layer is seriously distorted, resulting in increase of internal stress, because the charge transfer moieties are bulky, although the protective layer has a high crosslinking density.

Further, the photoreceptor of the present invention has good electric properties, good stability, and high durability. This is because the crosslinked protective layer has a structure in that a unit obtained from a monofunctional monomer having a charge transport structure is connected with the crosslinking bonds like a pendant. In contrast, the protective layer formed using a low molecular weight CTM having no functional group causes the precipitation and clouding problems, and thereby the photosensitivity of the photoreceptor is deteriorated and residual potential of the photoreceptor is increased (i.e., the photoreceptor has poor electric properties). In addition, in the crosslinked protective layer formed using di- or more-functional charge transport compounds as main components, the charge transport moieties are fixed in the crosslinked network, and thereby charges are trapped, resulting in deterioration of photosensitivity and increase of residual potential. When such electric properties of a photoreceptor are deteriorated, problems in that the resultant images have low image density and character images are narrowed occur.

Since a CTL having a high mobility and few charge traps can be formed as the CTL of the photoreceptor of the present invention, production of side effects in electric properties of the photoreceptor can be prevented even when the crosslinked protective layer is formed on the CTL.

Further, a crosslinked protective layer having a charge transport structure is insoluble in organic solvents and typically has an excellent abrasion resistance. The crosslinked protective layer prepared by reacting a tri- or more-functional polymerizable monomer having no charge transport structure with a monofunctional monomer having a charge transport structure has a well-developed three-dimensional network and a high crosslinking density. However, in a case where materials (such as mono- or di-functional monomers, polymer binders, antioxidants, leveling agents, and plasticizers) other than the above-mentioned polymerizable monomers are added and/or the crosslinking conditions are changed, problems in that the crosslinking density of the resultant protective layer is locally low and the resultant protective layer is constituted of aggregates of minute crosslinked material having a high crosslinking density tend to occur. Such a crosslinked protective layer has poor mechanical strength and poor resistance to organic solvents. Therefore, when the photoreceptor is repeatedly used, a problem in that a portion of the protective layer is seriously abraded or is released from the protective layer occurs.

In contrast, the crosslinked protective layer for use in the present photoreceptor has high molecular weight and good solvent resistance because of having a well-developed three dimensional network and a high crosslinking density. Therefore, the resultant photoreceptor has excellent abrasion resistance and does not cause the above-mentioned problems.

Then the constituents of the coating liquid for forming the crosslinked protective layer having a charge transport structure will be explained.

The tri- or more-functional monomers having no charge transport structure mean monomers which have three or more radical polymerizable groups and which do not have a charge transport structure (such as a positive hole transport structure (e.g., triarylamine, hydrazone, pyrazoline and carbazole structures); and an electron transport structure (e.g., condensed polycyclic quinine structure, diphenoquinone structure, a cyano group and a nitro group)). As the radical polymerizable groups, any radical polymerizable groups having a carbon-carbon double bond can be used. Suitable radical polymerizable groups include 1-substituted ethylene groups having the below-mentioned formula (XXIII) and 1,1-substituted ethylene groups having the below-mentioned formula (XXIV).

1-substituted Ethylene Groups
CH₂═CH—X¹— (XXIII)
wherein X¹ represents an arylene group (such as a phenylene group and a naphthylene group), which optionally has a substituent, a substituted or unsubstituted alkenylene group, a —CO— group, a —COO— group, a —CON(R¹⁰) group (wherein R¹⁰ represents a hydrogen atom, an alkyl group (e.g., a methyl group, and an ethyl group), an aralkyl group (e.g., a benzyl group, a naphthylmethyl group and a phenetyl group) or an aryl group (e.g., a phenyl group and a naphthyl group)), or a —S— group.

Specific examples of the groups having formula (═XII) include a vinyl group, a stylyl group, 2-methyl-1,3-butadienyl group, a vinylcarbonyl group, acryloyloxy group, acryloylamide, vinyl thio ether, etc.

1,1-substituted Ethylene Groups
CH₂═C(Y)—(X²)ₙ— (XXIV)
wherein Y represents a substituted or unsubstituted alkyl group, a substituted or unsubstituted aralkyl group, a substituted or unsubstituted aryl group (such as phenyl and naphthyl groups), a halogen atom, a cyano group, a nitro group, an alkoxyl group (such as methoxy and ethoxy groups), or a —COOR¹¹ group (wherein R¹¹ represents a hydrogen atom, a substituted or unsubstituted alkyl group (such as methyl and ethyl groups), a substituted or unsubstituted aralkyl group (such as benzyl and phenethyl groups), a substituted or unsubstituted aryl group (such as phenyl and naphthyl groups) or a —CONR¹²R¹³ group (wherein each of R¹² and R¹³ represents a hydrogen atom, a substituted or unsubstituted alkyl group (such as methyl and ethyl groups), a substituted or unsubstituted aralkyl group (such as benzyl, naphthylmethyl and phenethyl groups), a substituted or unsubstituted aryl group (such as phenyl and naphthyl groups))); X² represents a group selected from the groups mentioned above for use in X¹ and an alkylene group, wherein at least one of Y and X² is an oxycarbonyl group, a cyano group, an alkenylene group or an aromatic group; and n is 0 or 1.

Specific examples of the groups having formula (XXIV) include an α-chloroacryloyloxy group, a methacryloyloxy group, an α-cyanoethylene group, an α-cyanoacryloyloxy group, an α-cyanophenylene group, a methacryloylamino group, etc.

Specific examples of the substituents for use in the groups X¹, X² and Y include halogen atoms, a nitro group, a cyano group, alkyl groups (such as methyl and ethyl groups), alkoxy groups (such as methoxy and ethoxy groups), aryloxy groups (such as a phenoxy group), aryl groups (such as phenyl and naphthyl groups), aralkyl groups (such as benzyl and phenethyl groups), etc.

Among these radical polymerizable tri- or more-functional groups, acryloyloxy groups and methacryloyloxy groups having three or more functional groups are preferably used. Compounds having three or more acryloyloxy groups can be prepared by subjecting (meth)acrylic acid (salts), (meth)acrylhalides and (meth)acrylates, which have three or more hydroxyl groups, to an ester reaction or an ester exchange reaction. The three or more radical polymerizable groups included in a radical polymerizable tri- or more-functional monomer are the same as or different from the others therein.

Specific examples of the radical polymerizable tri- or more-functional monomers include trimethylolpropane triacrylate (TMPTA), trimethylolpropane trimethacylate, trimethylolpropane alkylene-modified triacrylate, trimethylolpropane ethyleneoxy-modified triacrylate, trimethylolpropane propyleneoxy-modified triacrylate, trimethylolpropane caprolactone-modified triacrylate, trimethylolpropane alkylene-modified trimethacrylate, pentaerythritol triacrylate, pentaerythritol tetraacrylate (PETTA), glycerol triacrylate, glycerol epichlorohydrin-modified triacrylate, glycerol ethyleneoxy-modified triacrylate, glycerol propyleneoxy-modified triacrylate, tris(acryloxyethyl)isocyanurate, dipentaerythritol hexaacrylate (DPHA), dipentaerythritol caprolactone-modified hexaacrylate, dipentaerythritol hydroxypentaacrylate, alkylated dipentaerythritol tetraacrylate, alkylated dipentaerythritol triacrylate, dimethylolpropane tetraacrylate (DTMPTA), pentaerhythritol ethoxytriacrylate, ethyleneoxy-modified triacryl phosphate, 2,2,5,5-tetrahydroxymethylcyclopentanone tetraacrylate, etc. These monmers are used alone or in combination.

In order to form a dense crosslinked network in the crosslinked protective layer, the ratio (Mw/F) of the molecular weight (Mw) of the tri- or more-functional monomer to the number of functional groups (F) included in a molecule of the monomer is preferably not greater than 250. When the number is too large, the resultant protective becomes soft and thereby the abrasion resistance of the layer slightly deteriorates. In this case, it is not preferable to use only one monomer having a functional group having a long chain group such as ethylene oxide, propylene oxide and caprolactone.

The content of the unit obtained from the tri- or more-functional monomers in the crosslinked protective layer is preferably from 20 to 80% by weight, and more preferably from 30 to 70% by weight based on the total weight of the protective layer. When the content is too low, the three dimensional crosslinking density is low, and thereby good abrasion resistance cannot be imparted to the protective layer. In contrast, when the content is too high, the content of the charge transport compound decreases, good charge transport property cannot be imparted to the protective layer. In order to balance the abrasion resistance and charge transport property of the crosslinked protective layer, the content of the unit obtained from the tri- or more-functional monomers in the protective layer is preferably from 30 to 70% by weight.

Suitable radical polymerizable monofunctional monomers having a charge transport structure for use in preparing the crosslinked protective layer include compounds having one radical polymerizable functional group and a charge transport structure such as positive hole transport groups (e.g., triarylamine, hydrazone, pyrazoline and carbazole structures) and electron transport groups (e.g., electron accepting aromatic groups such as condensed polycyclic quinine structure, diphenoquinone structure, and cyano and nitro groups). As the functional group of the radical polymerizable monofunctional monomers, acryloyloxy and methacryloyloxy groups are preferably used. Among the charge transport groups, triarylamine groups are preferably used. Among the compounds having a triarylamine group, compounds having the following formula (XVII) or (XVIII) are preferably used because of having good electric properties (i.e., high photosensitivity and low residual potential)

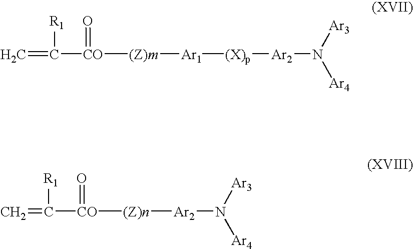

In formulae (XVII) and (XVIII), R¹ represents a hydrogen atom, a halogen atom, a substituted or unsubstituted alkyl group, a substituted or unsubstituted aralkyl group, a substituted or unsubstituted aryl group, a cyano group, a nitro group, an alkoxy group, a —COOR⁷ group (wherein R⁷ represents a hydrogen atom, a substituted or unsubstituted alkyl group, a substituted or unsubstituted aralkyl group and a substituted or unsubstituted aryl group), a halogenated carbonyl group or a —CONR⁸R⁹ (wherein each of R⁸ and R⁹ represents a hydrogen atom, a substituted or unsubstituted alkyl group, a substituted or unsubstituted aralkyl group and a substituted or unsubstituted aryl group); each of Ar¹ and Ar² represents a substituted or unsubstituted arylene group; each of Ar³ and Ar⁴ represents a substituted or unsubstituted arylene group; X represents a substituted or unsubstituted alkylene group, a substituted or unsubstituted cycloalkylene group, a substituted or unsubstituted alkylene ether group, an oxygen atom, a sulfur atom or a vinylene group; Z represents a substituted or unsubstituted alkylene group, a substituted or unsubstituted divalent alkylene ether group, or a substituted or unsubstituted divalent alkyleneoxy carbonyl group; each of m and n is 0 or an integer of from 1 to 3; and p is 0 or 1.

In formulae (XVII) and (XVIII), specific examples of the alkyl, aryl, aralkyl, and alkoxy groups for use in R¹ include the following.

Alkyl Group

Methyl, ethyl, propyl and butyl groups.

Aryl Group

Phenyl and naphthyl groups, etc.

Aralkyl Group

Benzyl, phenethyl and naphthylmethyl groups.

Alkoxy Group

Methoxy, ethoxy and propoxy groups.

These groups may be substituted with a halogen atom, a nitro group, a cyano group, an alkyl group (such as methyl and ethyl groups), an alkoxy group (such as methoxy and ethoxy groups), an aryloxy group (such as a phenoxy group), an aryl group (such as phenyl and naphthyl groups), an aralkyl group (such as benzyl and phenethyl groups), etc.

Among these groups, a hydrogen atom and a methyl group are preferable as R¹.

Suitable substituted or unsubstituted aryl groups for use as Ar³ and Ar⁴ include condensed polycyclic hydrocarbon groups, non-condensed cyclic hydrocarbon groups, and heterocyclic groups.

Specific examples of the condensed polycyclic hydrocarbon groups include compounds in which 18 or less carbon atoms constitute one or more rings, such as pentanyl, indecenyl, naphthyl, azulenyl, heptalenyl, biphenilenyl, as-indacenyl, s-indacenyl, fluorenyl, acenaphthylenyl, preiadenyl, acenaphthenyl, phenarenyl, phenanthoryl, anthoryl, fluorantenyl, acephenanthorylenyl, aceanthorylenyl, triphenylenyl, pyrenyl, chrysenyl, and naphthasenyl groups.

Specific examples of the non-condensed cyclic hydrocarbon groups include monovalent groups of benzene, diphenyl ether, polyethylene diphenyl ether, diphenyl thioether, and diphenyl sulfone; monovalent groups of non-condensed polycyclic hydrocarbon groups such as biphenyl, polyphenyl, diphenyl alkans, diphenylalkenes, diphenyl alkyne, triphenyl methane, distyryl benzene, 1,1-diphenylcycloalkanes, polyphenyl alkans, polyphenyl alkenes; and ring aggregation hydrocarbons such as 9,9-diphenyl fluorenone.

Specific examples of the heterocyclic groups include monovalent groups of carbazole, dibenzofuran, dibenzothiophene, oxadiazole, and thiadiazole.

The aryl groups for use as Ar³ and Ar⁴ may be substituted with the following groups.

(1) Halogen atoms, and cyano and nitro groups.

(2) Linear or branched alkyl groups which preferably have from 1 to 12 carbon atoms, more preferably from 1 to 8 carbon atoms and even more preferably from 1 to 4 carbon atoms. These alkyl groups can be further substituted with another group such as a fluorine atom, a hydroxyl group, a cyano group, an alkoxy group having 1 to 4 carbon atoms, and a phenyl group which may be further substituted with a halogen atom, an alkyl group having 1 to 4 carbon atoms, or an alkoxy group having 1 to 4 carbon atoms. Specific examples of the alkyl groups include methyl, ethyl, n-propyl, iso-propyl, n-butyl, sec-butyl, t-butyl, trifluoromethyl, 2-hydroxyethyl, 2-ethoxyethyl, 2-cyanoethyl, 2-methoxyethyl, benzyl, 4-chlorobenzyl, 4-methylbenzyl and 4-phenylbenzyl groups.

(3) Alkoxy groups (i.e., —OR₂). R₂ represents one of the alkyl groups defined above in paragraph (2). Specific examples of the alkoxy groups include methoxy, ethoxy, n-propoxy, iso-propoxy, t-butoxy, n-butoxy, s-butoxy, iso-butoxy, 2-hydroxyethoxy, benzyloxy and trifluoromethoxy groups.

(4) Aryloxy groups. Specific examples of the aryl group of the acryloxy groups include phenyl and naphthyl groups. The aryloxy groups may be substituted with an alkoxy group having from 1 to 4 carbon atoms, an alkyl group having from 1 to 4 carbon atoms, or a halogen atom. Specific examples of the groups include phenoxy, 1-naphthyloxy, 2-naphthyloxy, 4-methoxyphenoxy, and 4-methylphenoxy groups.

(5) Alkylmercapto or arylmercapto group. Specific examples of the groups include methylthio, ethylthio, phenylthio, and p-methylphenylthio groups

(6) Groups having the following formula. 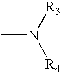
wherein each of R₃ and R₄ represents a hydrogen atom, one of the alkyl groups defined in paragraph (2) or an aryl group (such as phenyl, biphenyl, and naphthyl groups). These groups may be substituted with another group such as an alkoxy group having from 1 to 4 carbon atoms, an alkyl group having from 1 to 4 carbon atoms, and a halogen atom. In addition, R₃ and R₄ optionally share bond connectivity to form a ring.

Specific examples of the groups having the above-mentioned formula include amino, diethylamino, N-methyl-N-phenylamino, N,N-diphenylamino, N,N-di(tolyl)amino, dibenzylamino, piperidino, morpholino, and pyrrolidino groups.

(7) Alkylenedioxy or alkylenedithio groups such as methylenedioxy and methylenedithio groups.

(8) Substituted or unsubstituted styryl groups, substituted or unsubstituted β-phenylstyryl groups, diphenylaminophenyl groups, and ditolylaminophenyl groups.

As the arylene groups for use in Ar¹ and Ar², divalent groups delivered from the aryl groups mentioned above for use in Ar³ and Ar⁴ can be used.

The group X is a substituted or unsubstituted alkylene group, a substituted or unsubstituted cycloalkylene group, a substituted or unsubstituted alkylene ether, an oxygen atom, a sulfur atom, and a vinylene group.

Suitable groups for use as the substituted or unsubstituted alkylene group include linear or branched alkylene groups which preferably have from 1 to 12 carbon atoms, more preferably from 1 to 8 carbon atoms and even more preferably from 1 to 4 carbon atoms. These alkylene groups can be further substituted with another group such as a fluorine atom, a hydroxyl group, a cyano group, an alkoxy group having 1 to 4 carbon atoms, and a phenyl group which may be further substituted with a halogen atom, an alkyl group having 1 to 4 carbon atoms, or an alkoxy group having 1 to 4 carbon atoms. Specific examples of the alkylene groups include methylene, ethylene, n-propylene, iso-propylene, n-butylene, sec-butylene, t-butylene, trifluoromethylene, 2-hydroxyethylene, 2-ethoxyethylene, 2-cyanoethylene, 2-methoxyethylene, benzylidene, phenylethylene, 4-chlorophenylethylene, 4-methylphenylethylene and 4-biphenylethylene groups.

Suitable groups for use in the substituted or unsubstituted cycloalkylene groups include cyclic alkylene groups having from 5 to 7 carbon atoms, which may be substituted with a fluorine atom or another group such as a hydroxyl group, alkyl groups having from 1 to 4 carbon atoms, and alkoxy groups having 1 to 4 carbon atoms. Specific examples of the substituted or unsubstituted cycloalkylene groups include cyclohexylidene, cyclohexylene, and 3,3-dimethylcyclohexylidene groups.

Specific examples of the substituted or unsubstituted alkylene ether groups include ethyleneoxy, propyleneoxy, ethylene glycol, propylene glycol, diethylene glycol, tetraethylene glycol, and tripropylene glycol groups. The alkylene group of the alkylene ether groups may be substituted with another group such as hydroxyl, methyl and ethyl groups.

As the vinylene group, groups having one of the following formulae can be preferably used.

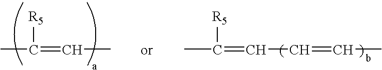

In the above-mentioned formulae, R₅ represents a hydrogen atom, one of the alkyl groups mentioned above for use in paragraph (2), or one of the aryl groups mentioned above for use in Ar³ and Ar⁴, wherein a is 1 or 2, and b is 1, 2 or 3.

In formulae (XVII) and (XVIII), Z represents a substituted or unsubstituted alkylene group, a substituted or unsubstituted divalent alkylene ether group, a divalent alkyleneoxycarbonyl group. Specific examples of the substituted or unsubstituted alkylene group include the alkylene groups mentioned above for use as X. Specific examples of the substituted or unsubstituted alkylene ether group include the divalent alkylene ether groups mentioned above for use as X. Specific examples of the divalent alkyleneoxycarbonyl group include divalent groups modified by caprolactone.

More preferably, monomers having the following formula (XIX) are used as the radical polymerizable monofunctional monomer having a charge transport structure.

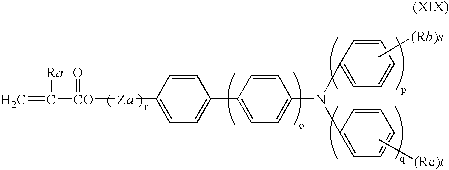

In formula (XIX), each of o, p and q is 0 or 1; Ra represents a hydrogen atom, or a methyl group; each of Rb and Rc represents an alkyl group having from 1 to 6 carbon atoms, wherein each of Rb and Rc can include plural groups which are the same as or different from each other; each of s and t is 0, 1, 2 or 3; r is 0 or 1; Za represents a methylene group, an ethylene group or a group having one of the following formulae.

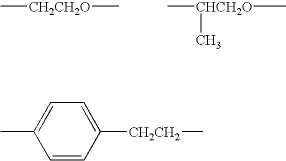

In formula (XIX), each of Rb and Rc is preferably a methyl group or an ethyl group.

The radical polymerizable monofunctional monomers having formula (XVII) or (XVIII) (preferably formula (XIX)), have the following property. Namely, a monofunctional monomer is polymerized while the double bond of a molecule is connected with the double bonds of other molecules. Therefore, the monomer is incorporated in a polymer chain, i.e., in a main chain or a side chain of the crosslinked polymer chain which is formed by the monomer and a radical polymerizable tri- or more-functional monomer. The side chain of the unit obtained from the monofunctional monomer is present between two main polymer chains which are connected by crosslinking chains. In this regard, the crosslinking chains are classified into intermolecular crosslinking chains and intramolecular crosslinking chains.

In any of these case, the triarylamine group which is a pendant of the main chain of the unit obtained from the monofunctional monomer is bulky and is connected with the main chain with a carbonyl group therebetween while not being fixed (i.e., while being fairly free three-dimensionally). Therefore, the crosslinked polymer has little strain, and in addition the crosslinked protective layer has good charge transport property.

Specific examples of the radical polymerizable monofunctional monomers include the following compounds Nos. 1-160, but are not limited thereto.

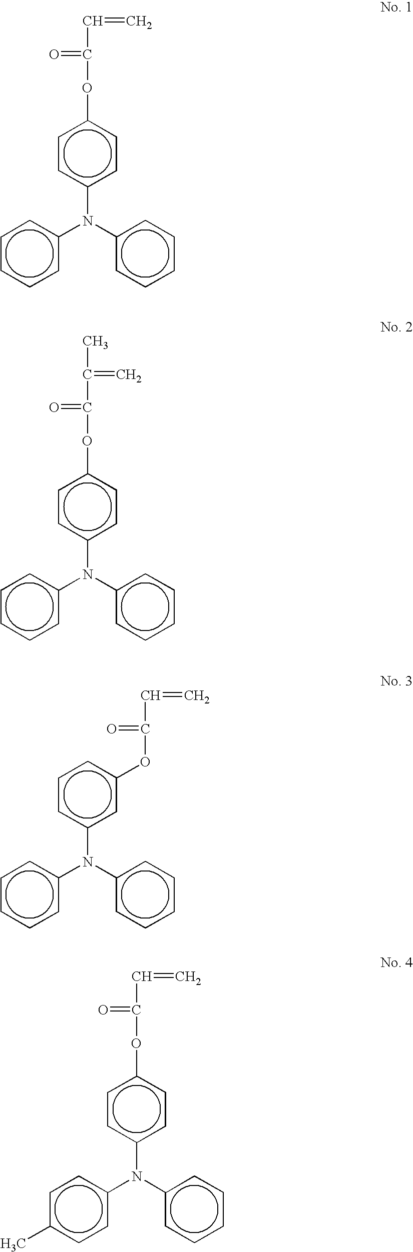

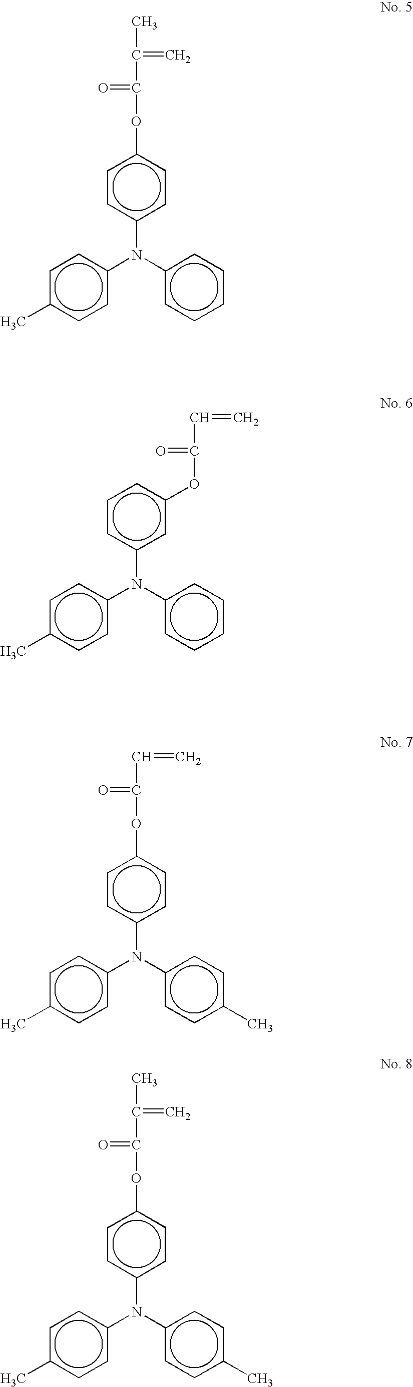

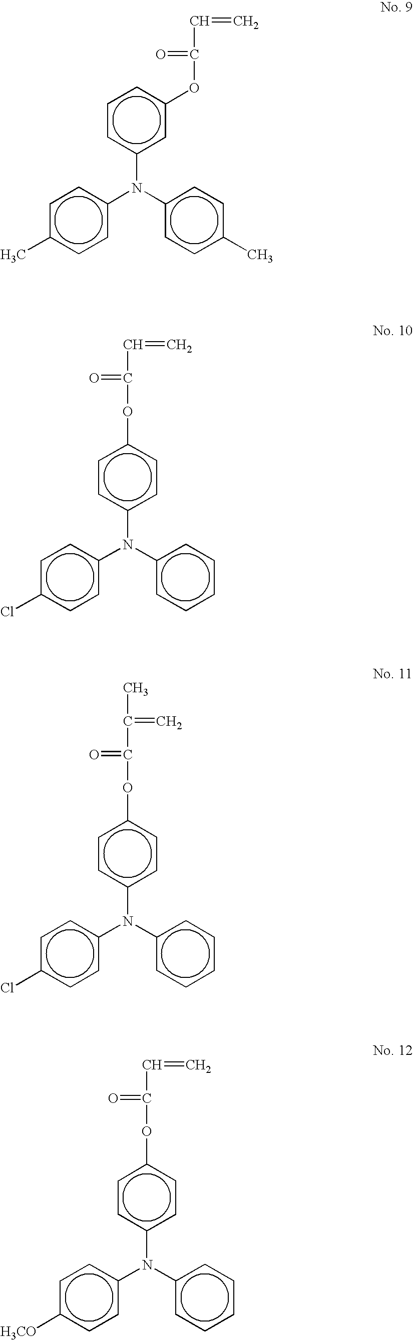

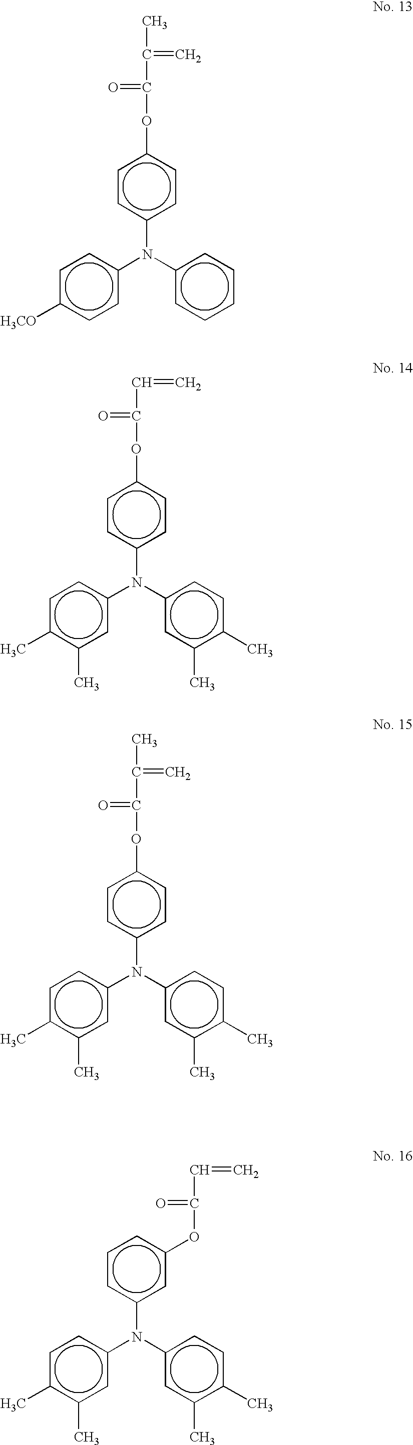

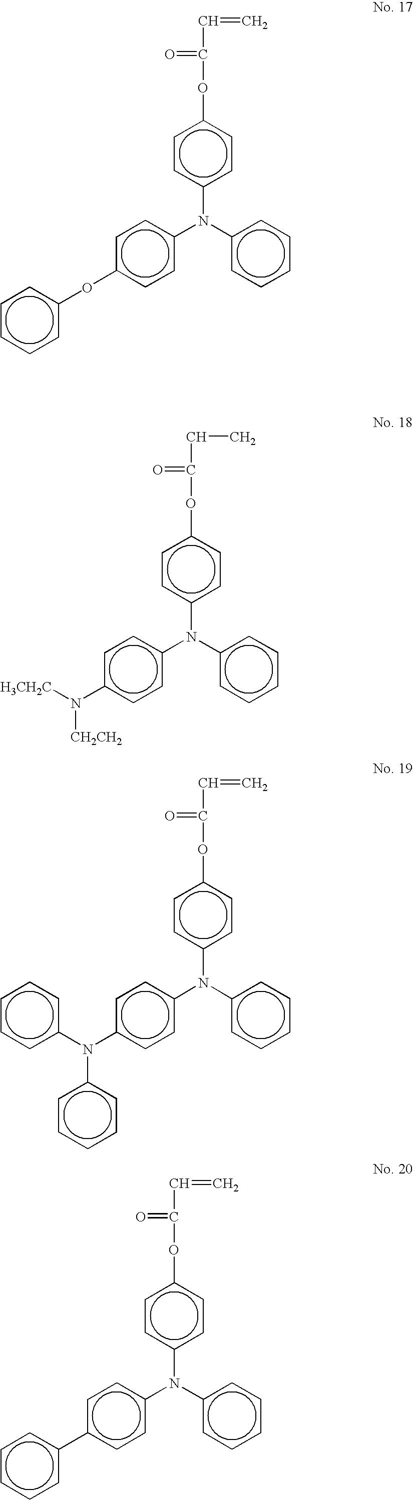

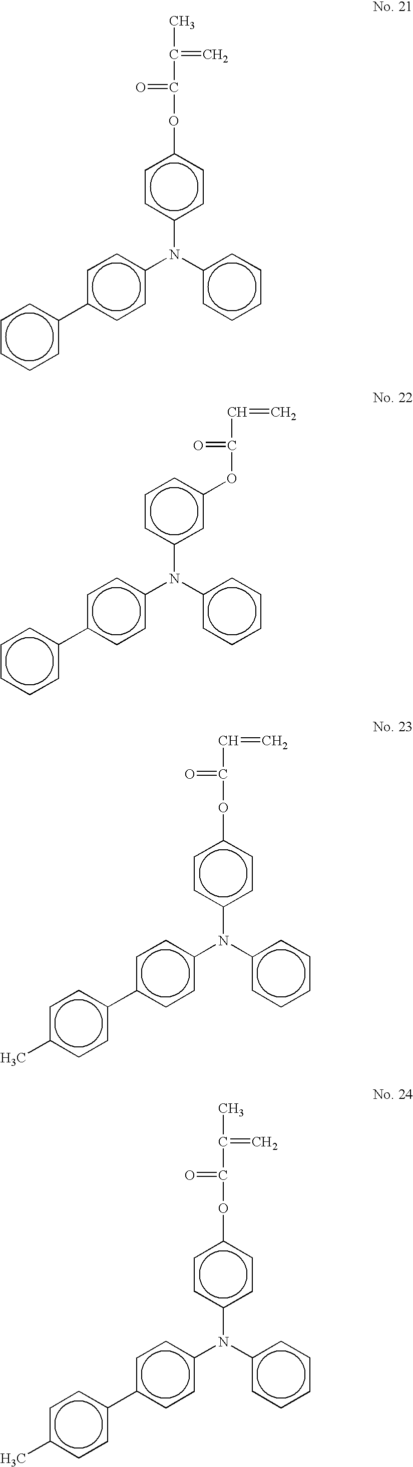

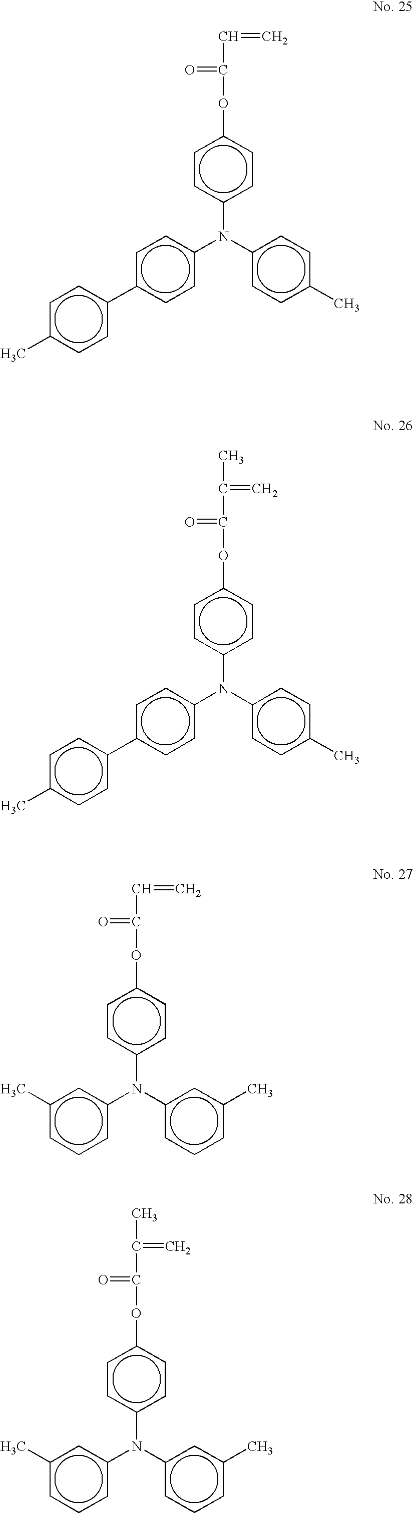

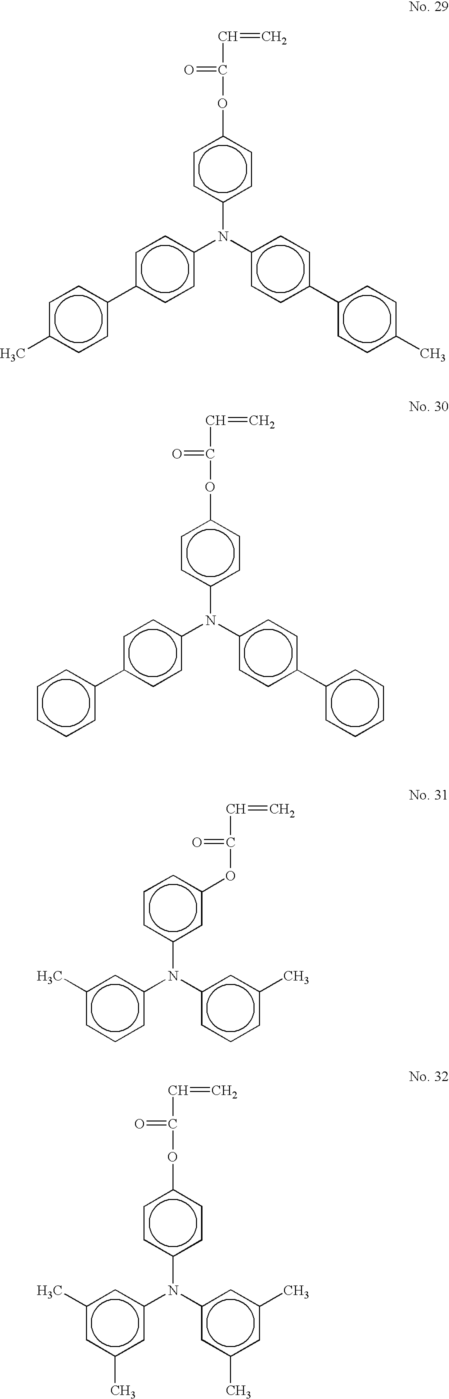

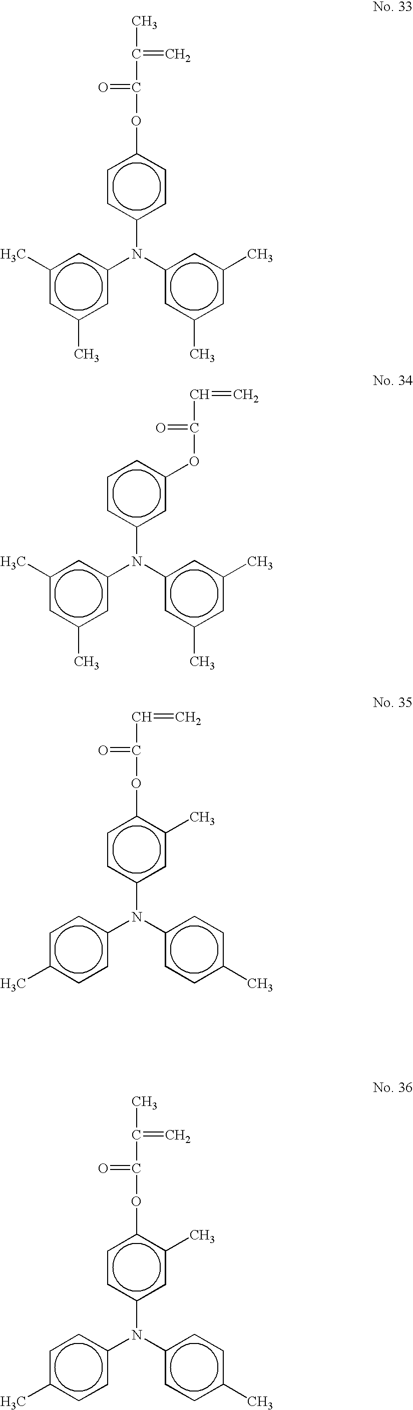

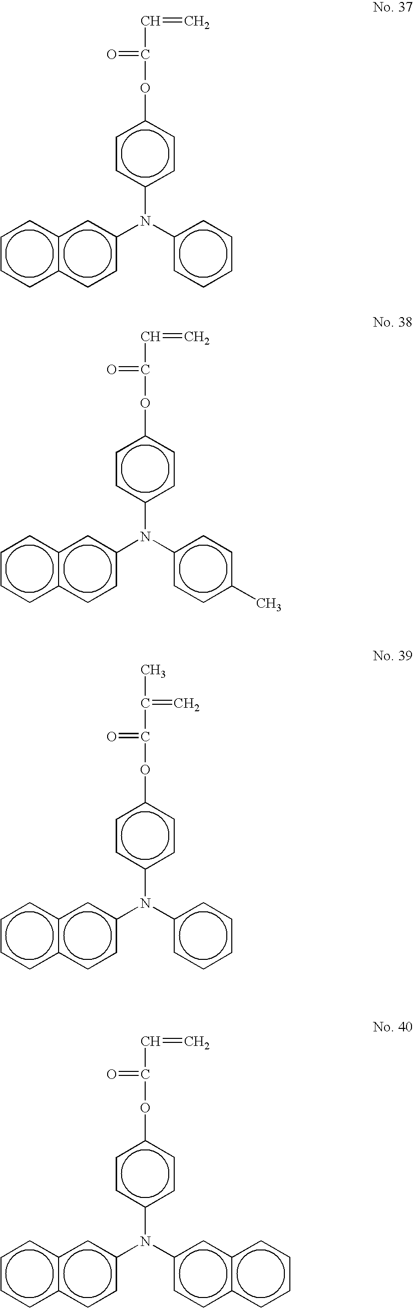

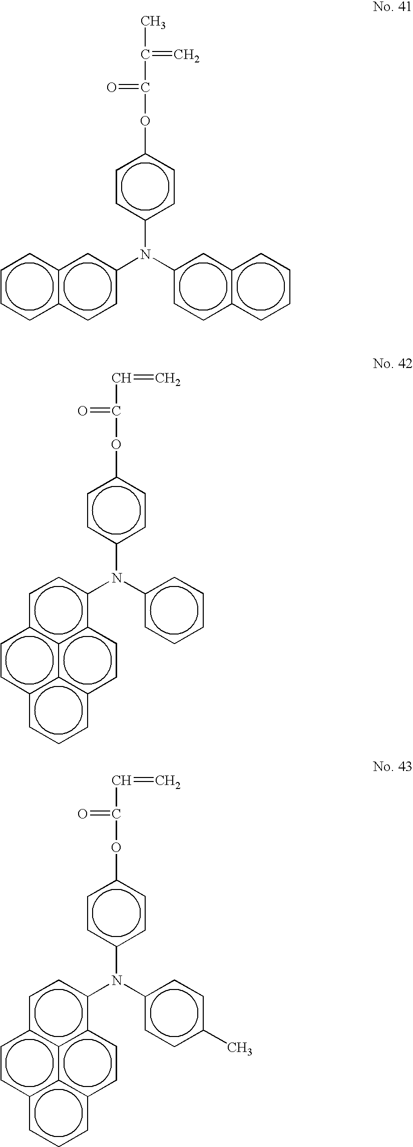

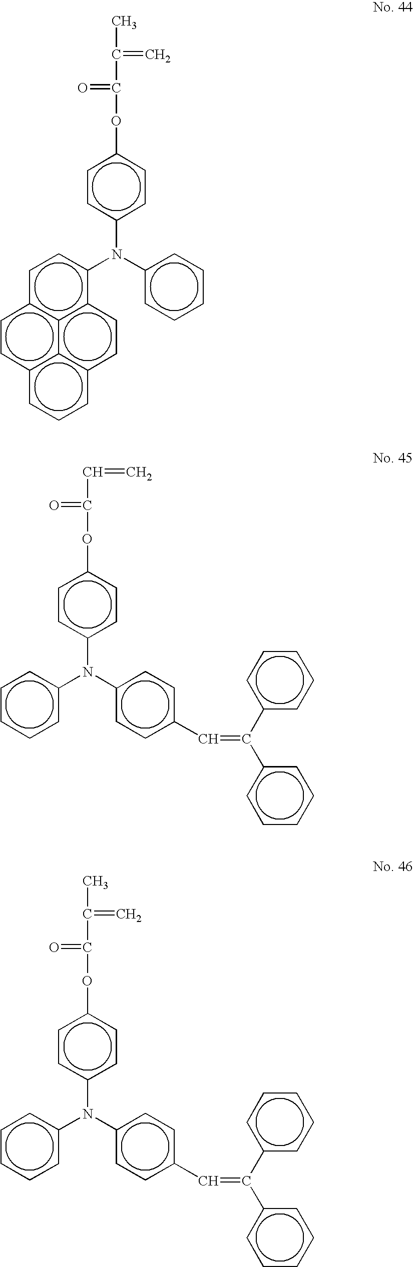

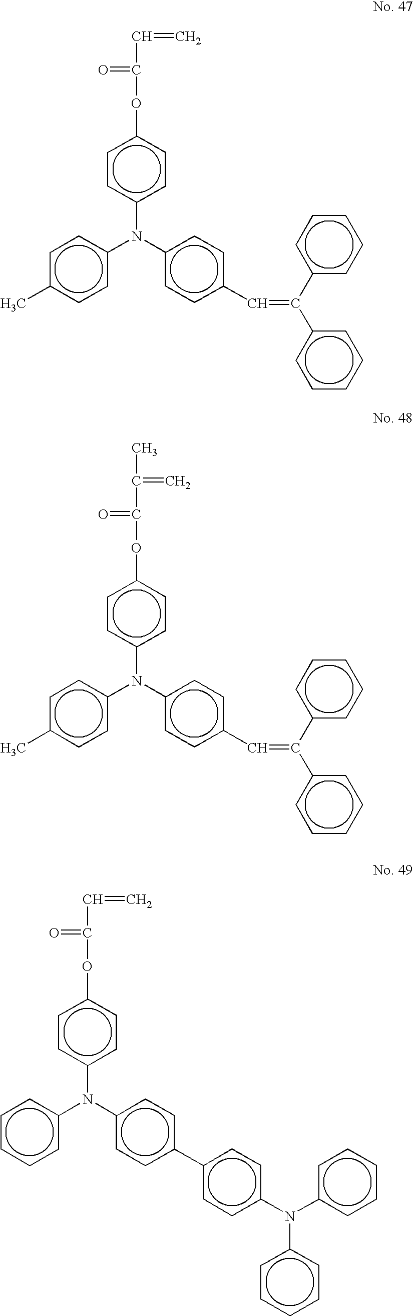

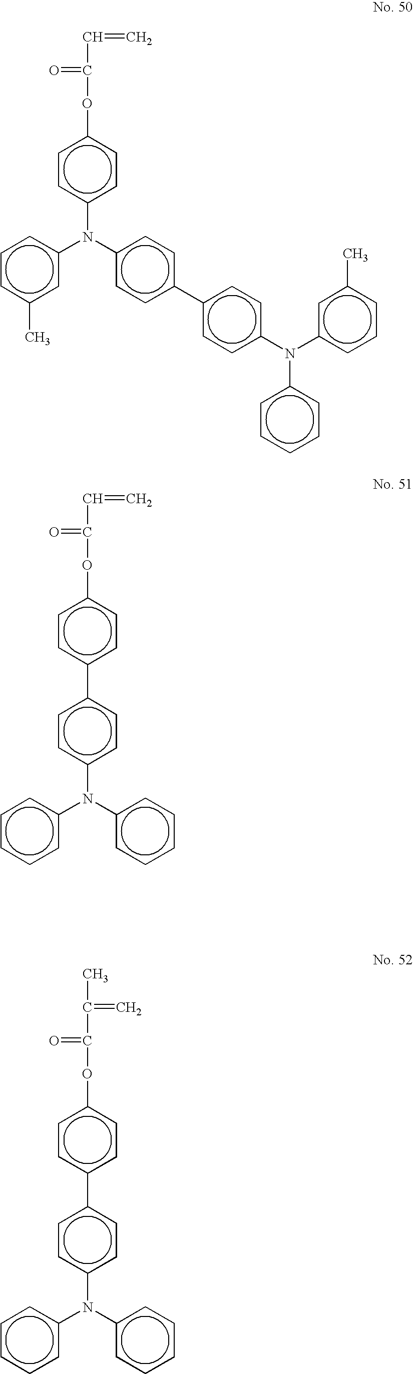

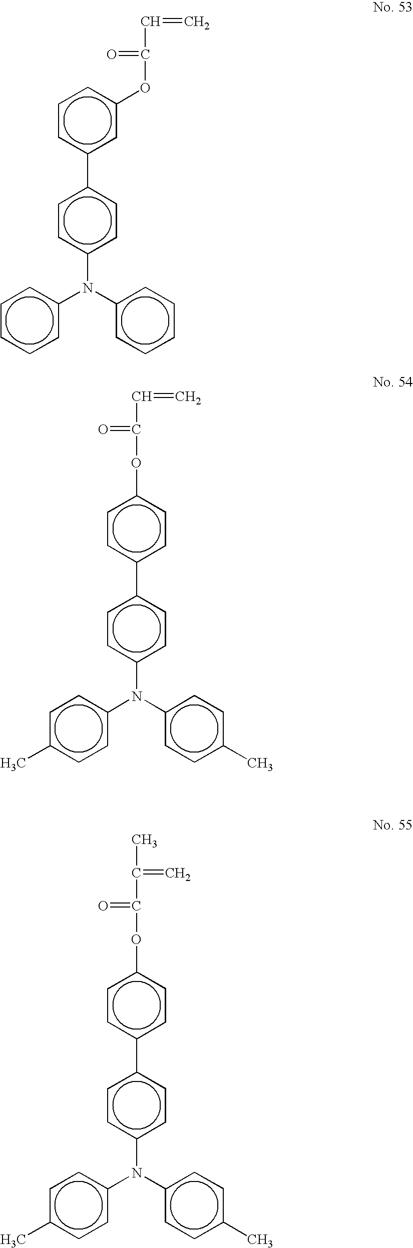

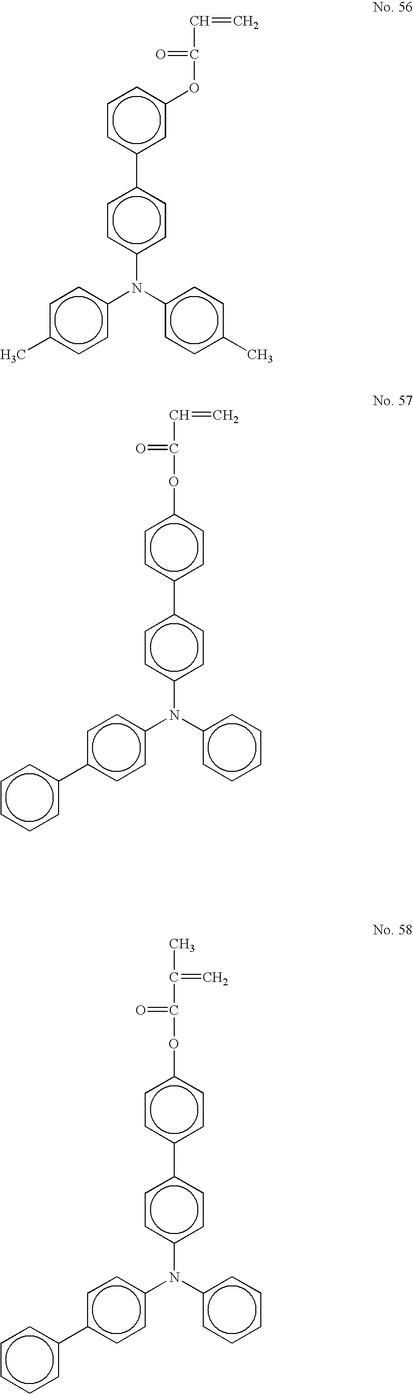

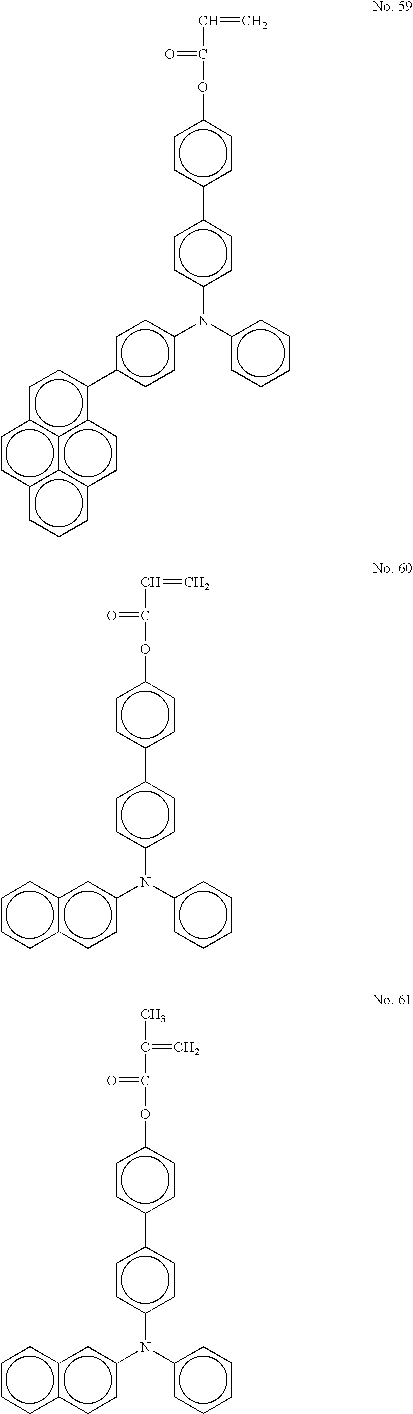

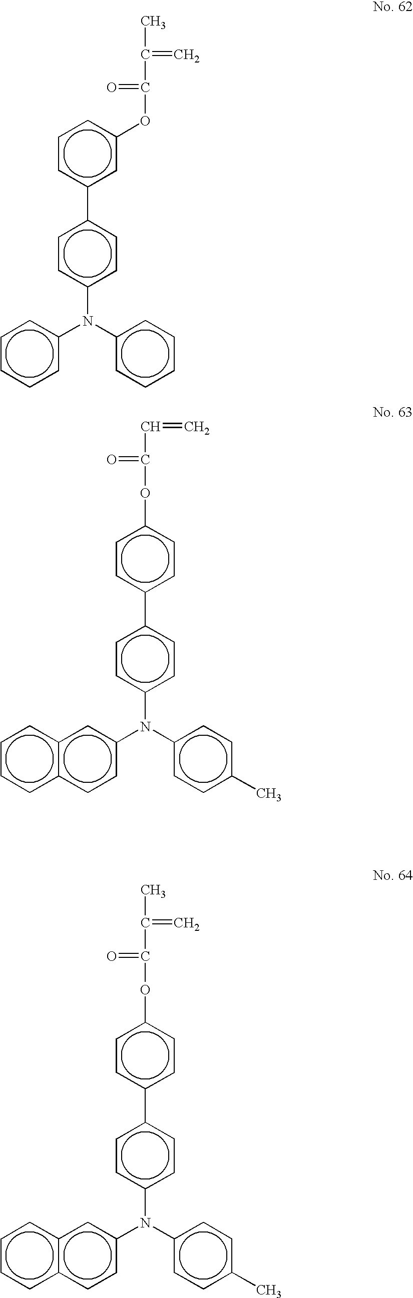

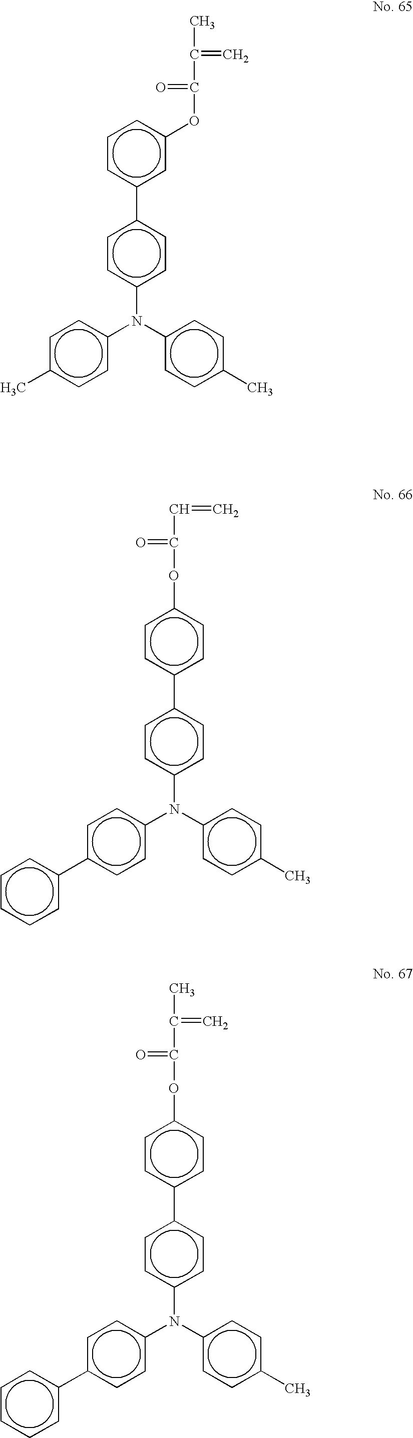

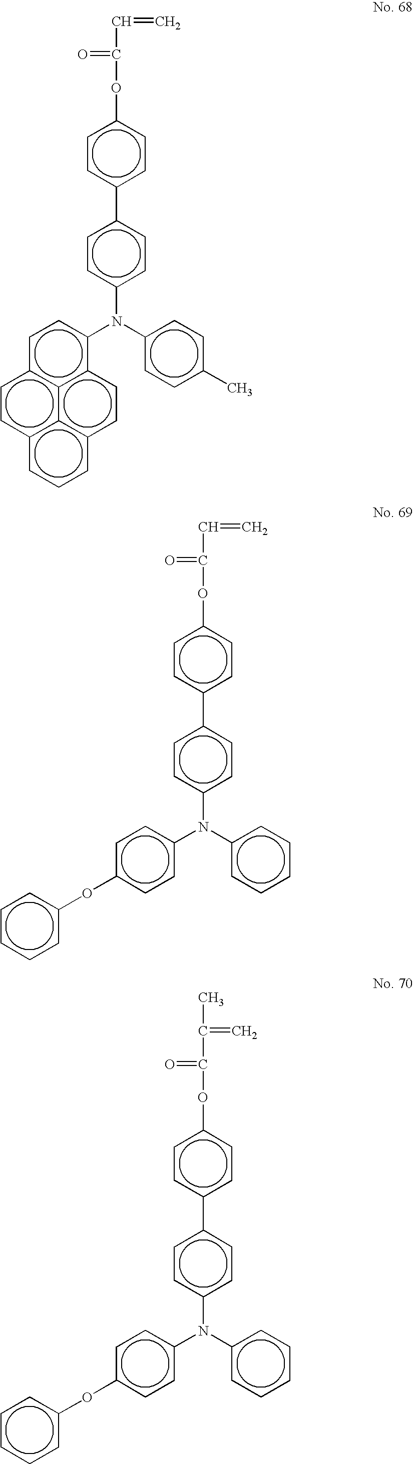

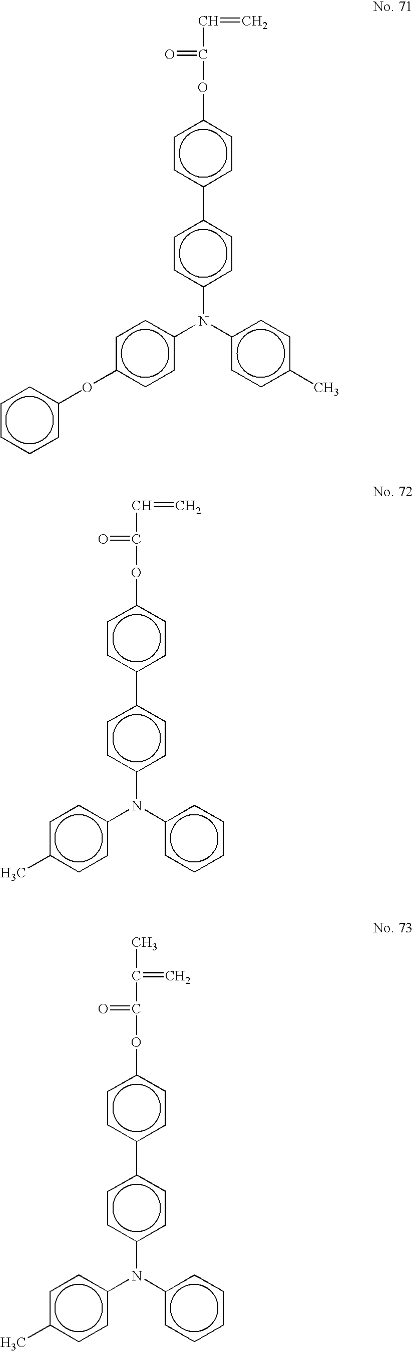

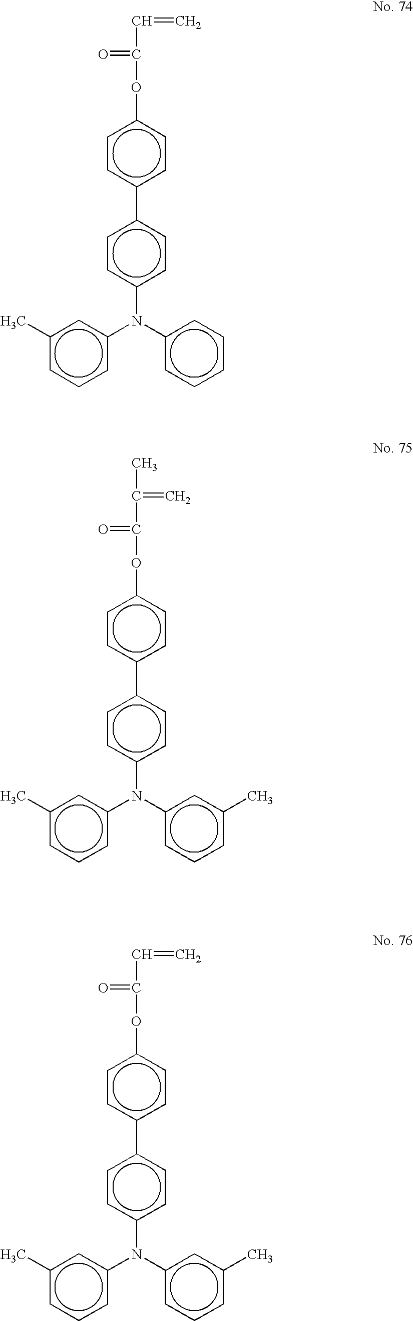

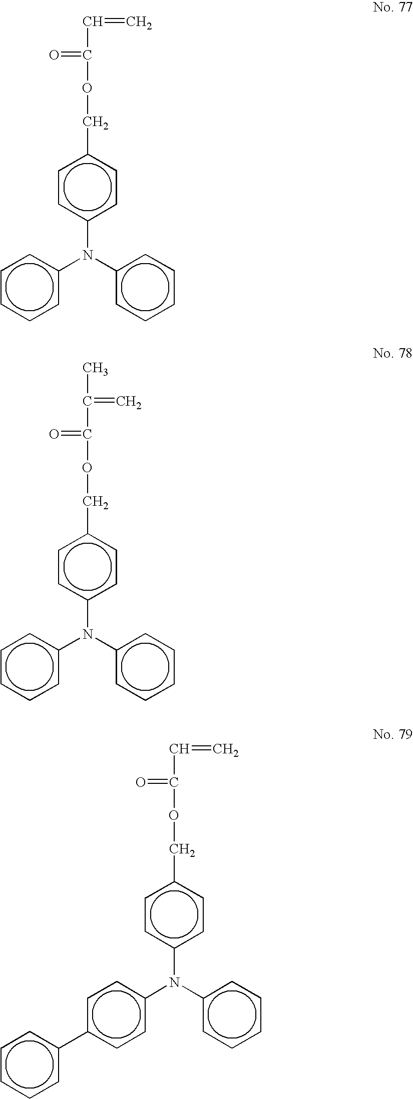

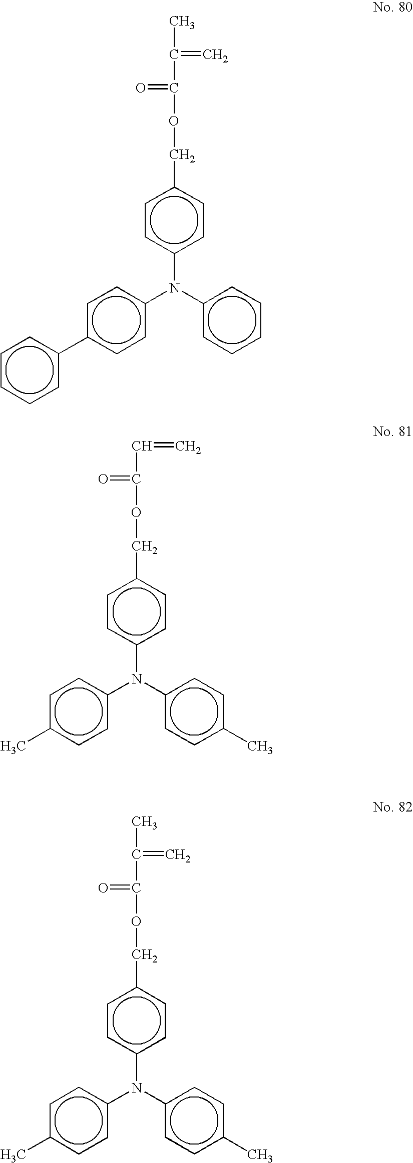

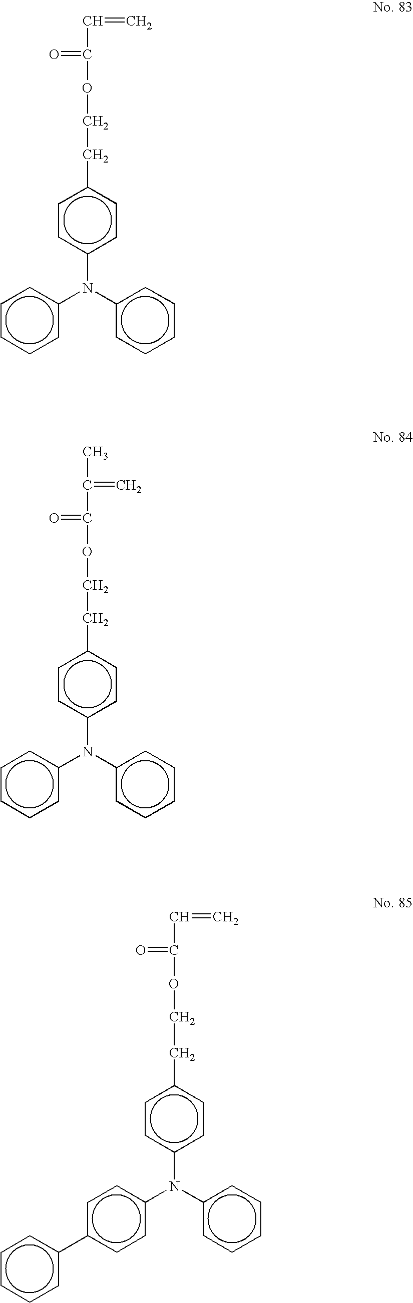

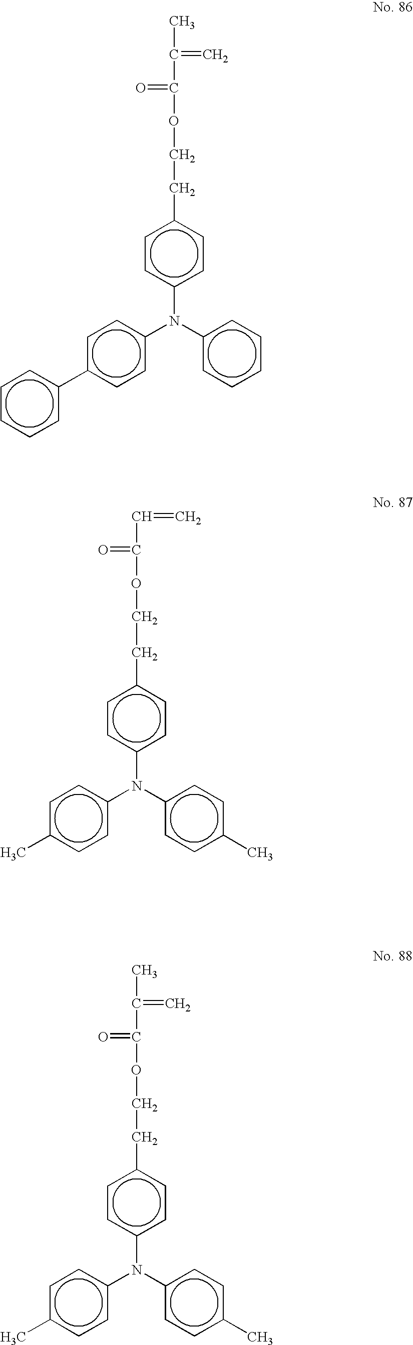

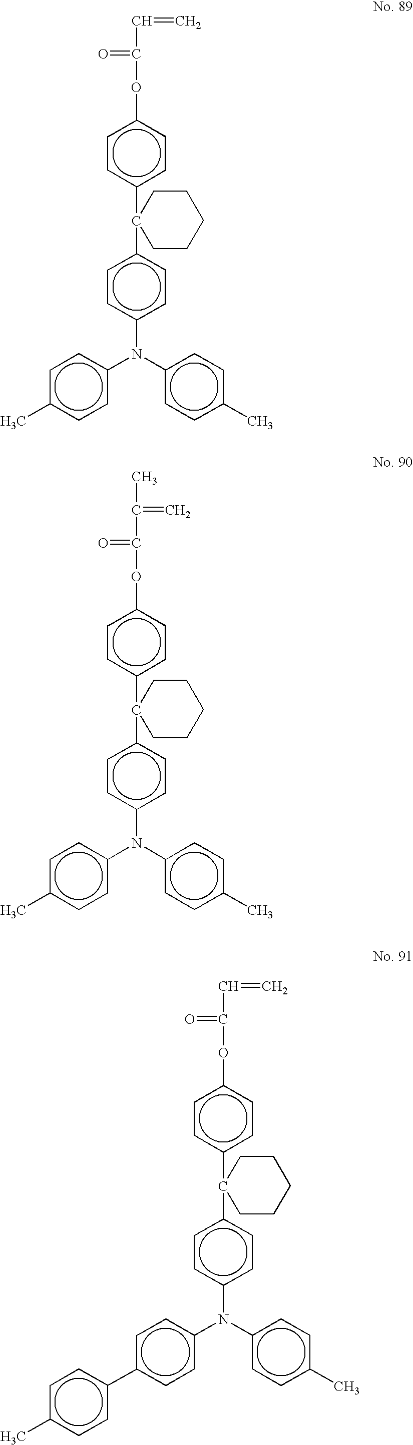

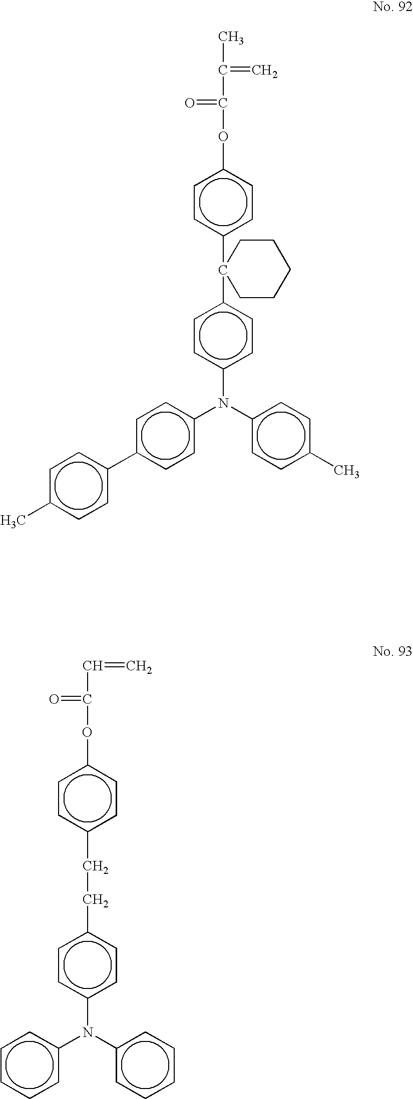

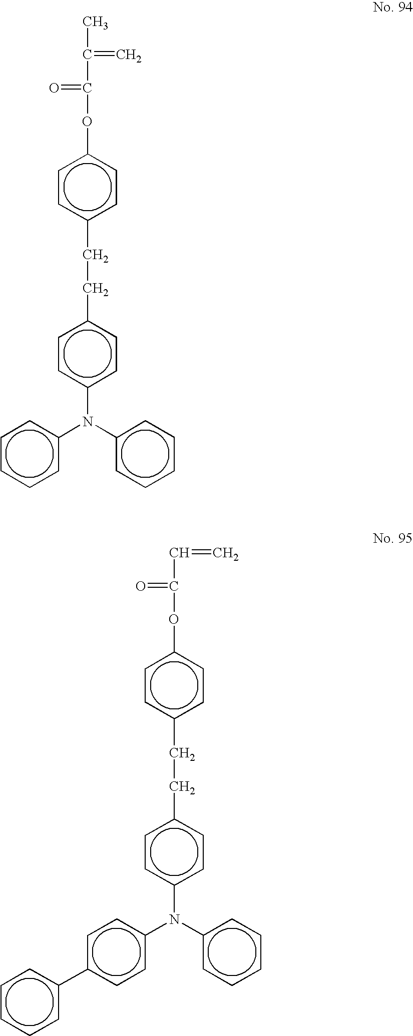

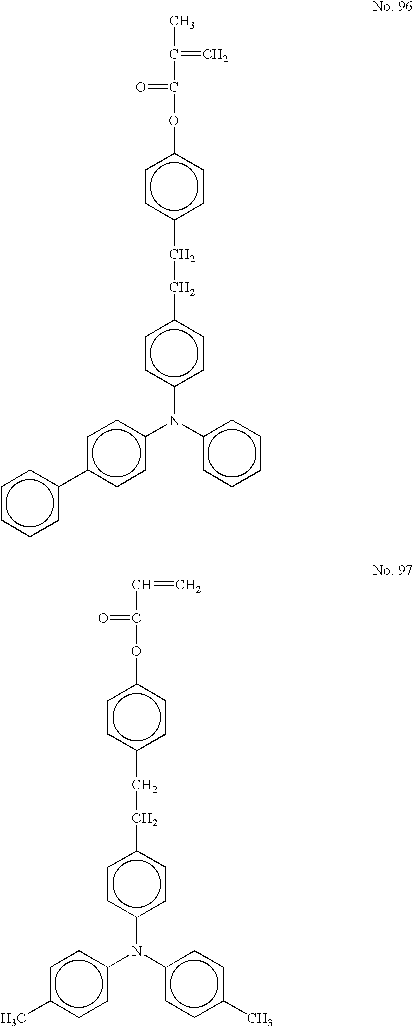

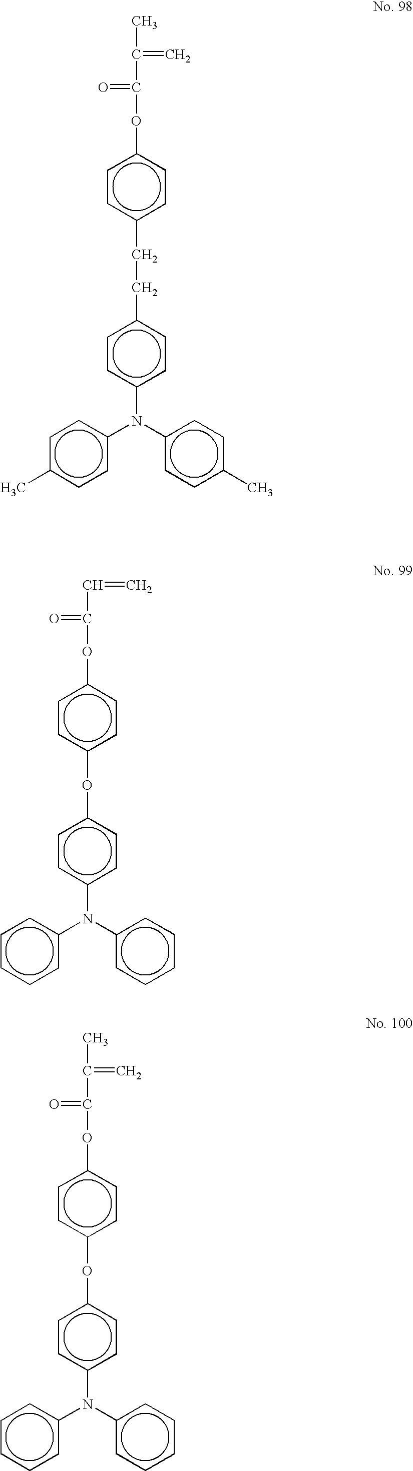

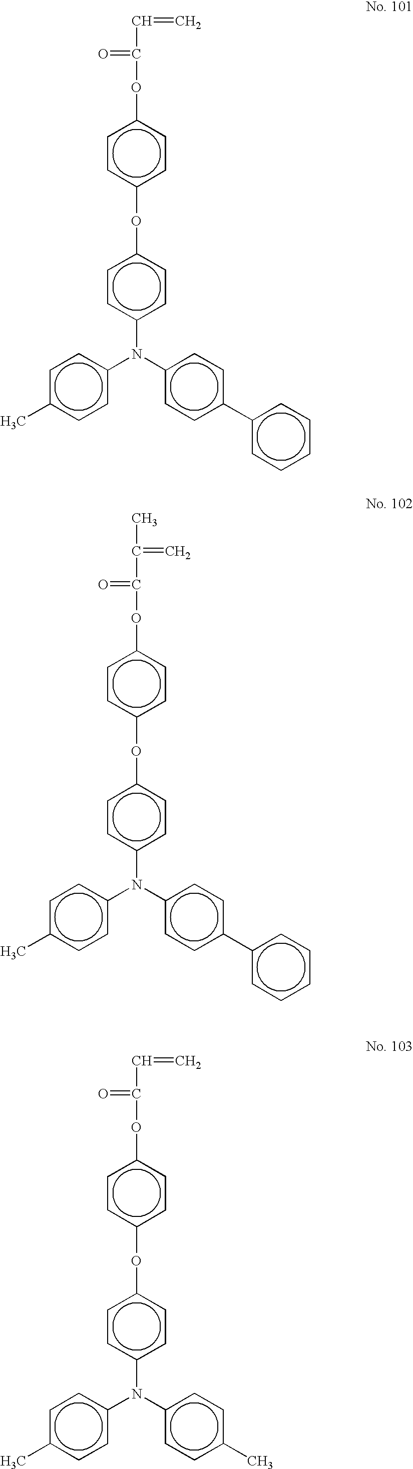

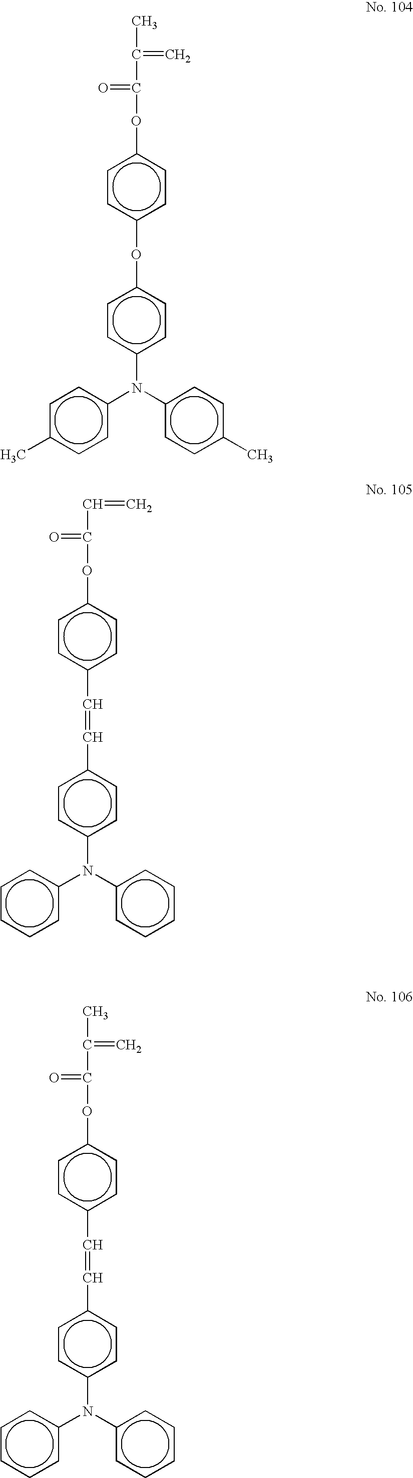

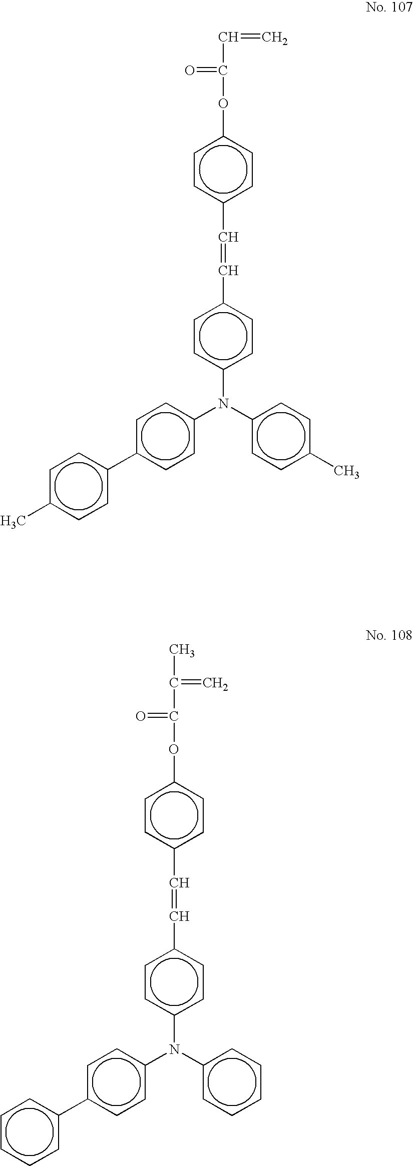

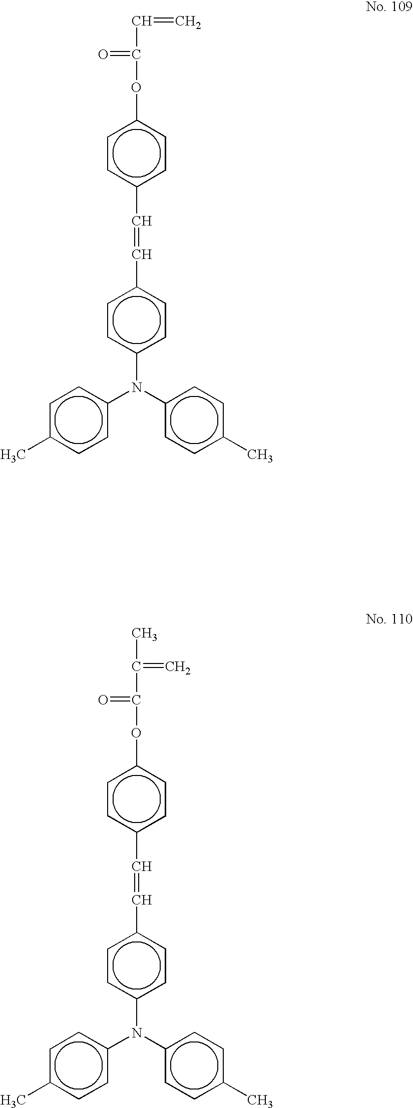

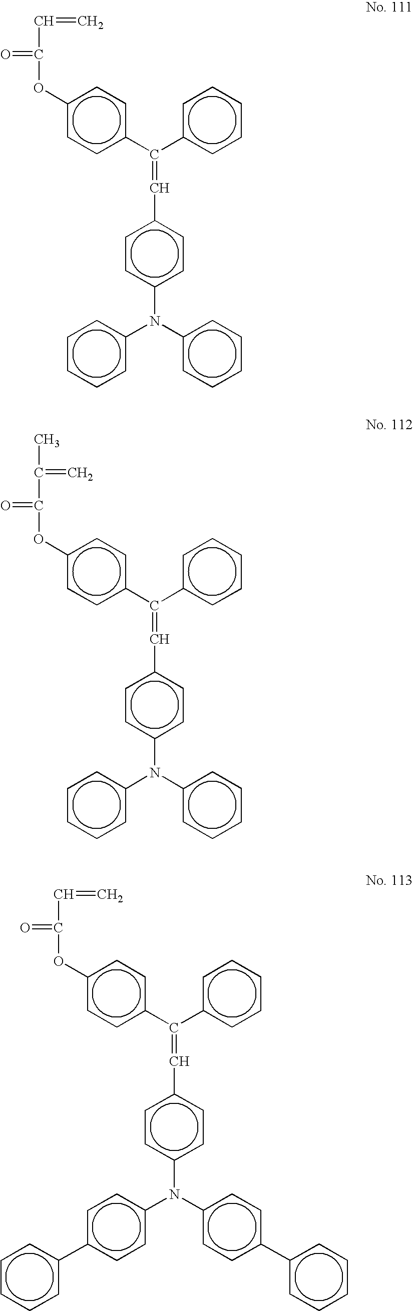

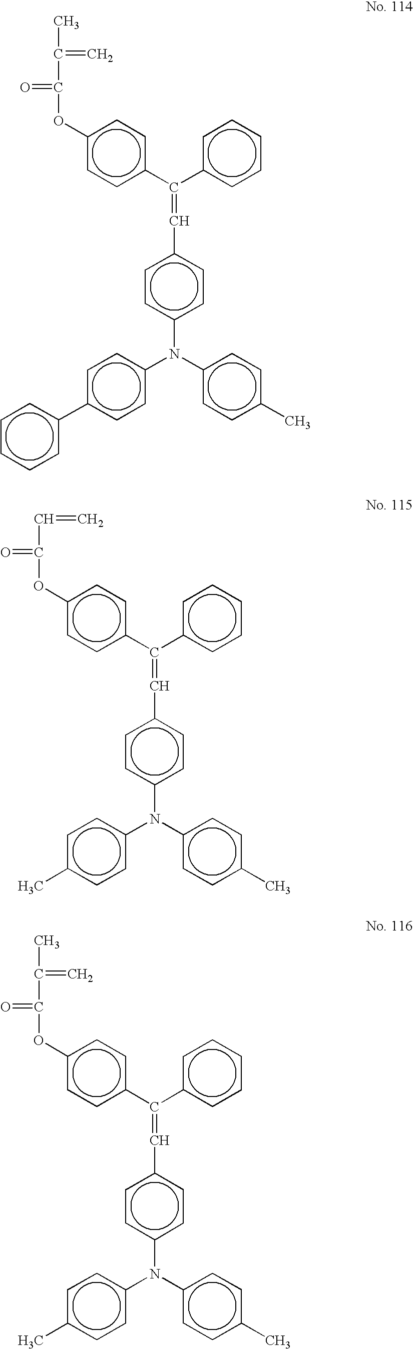

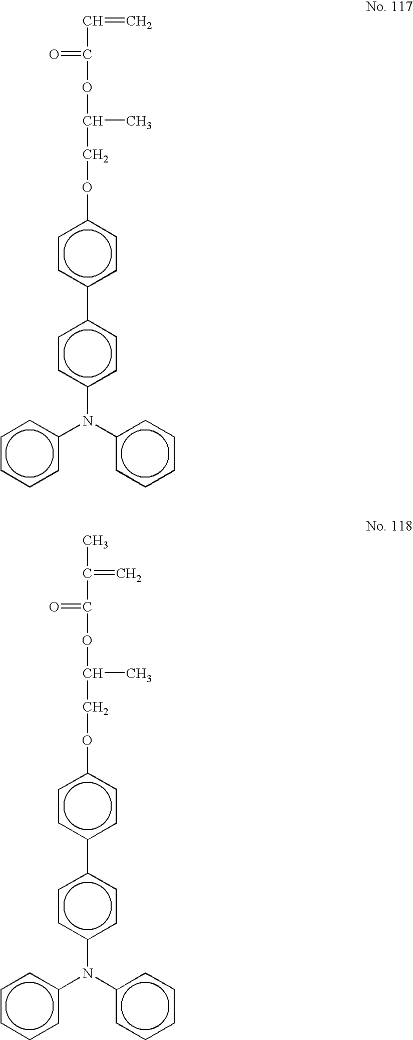

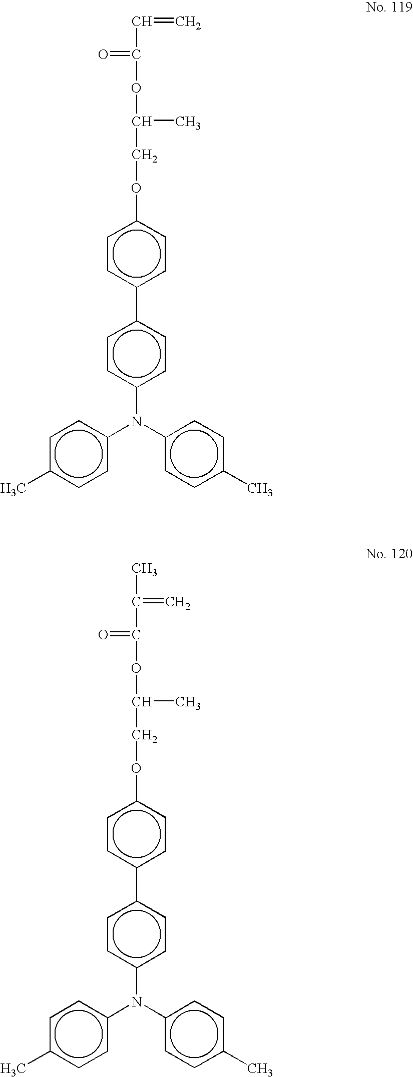

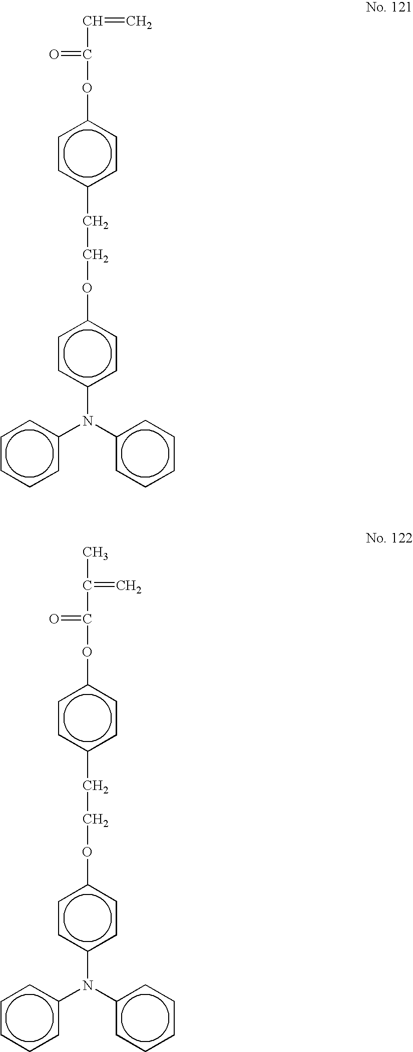

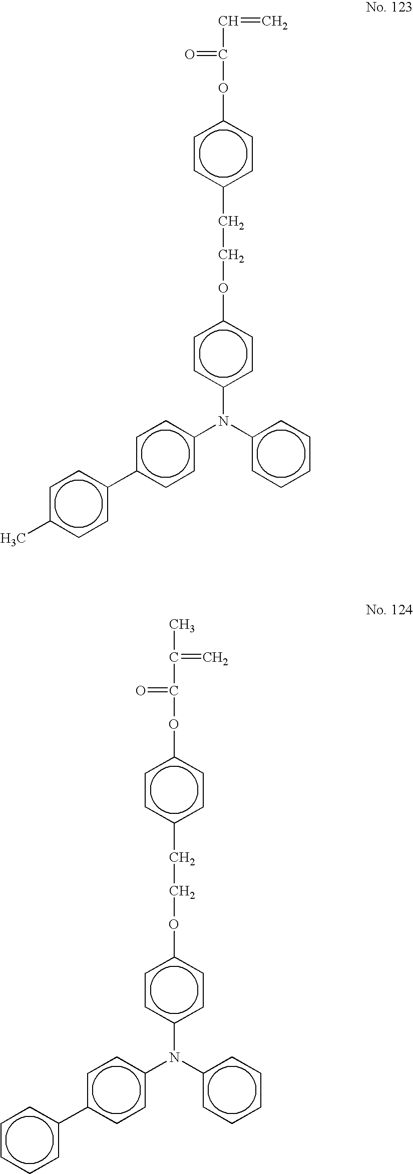

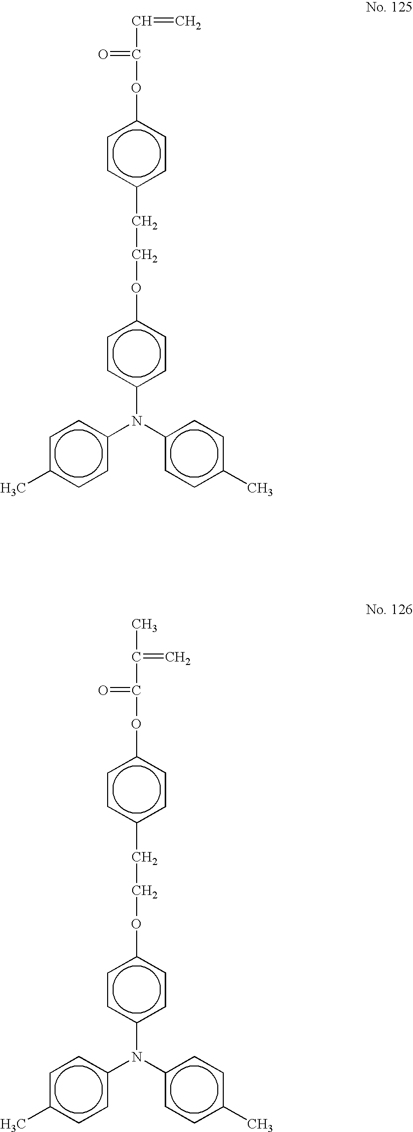

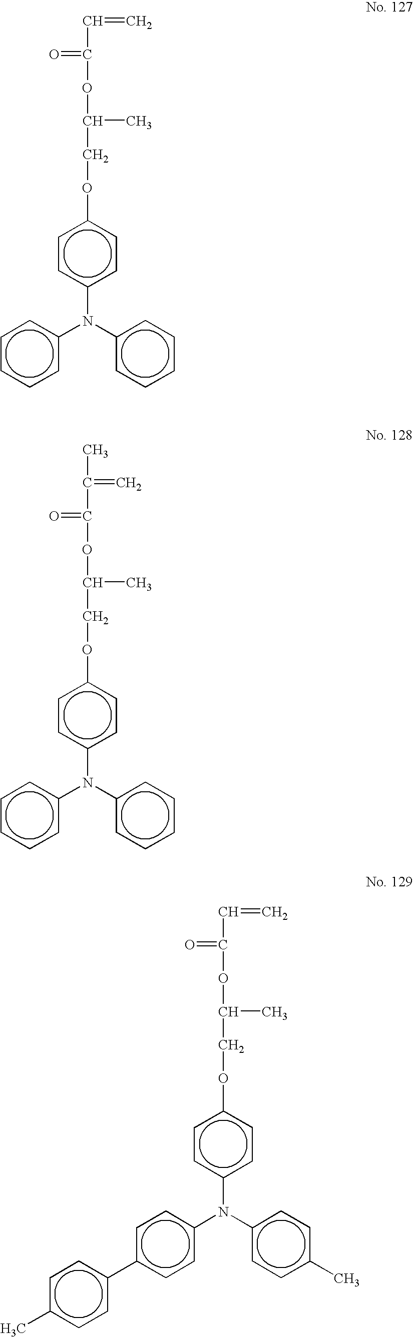

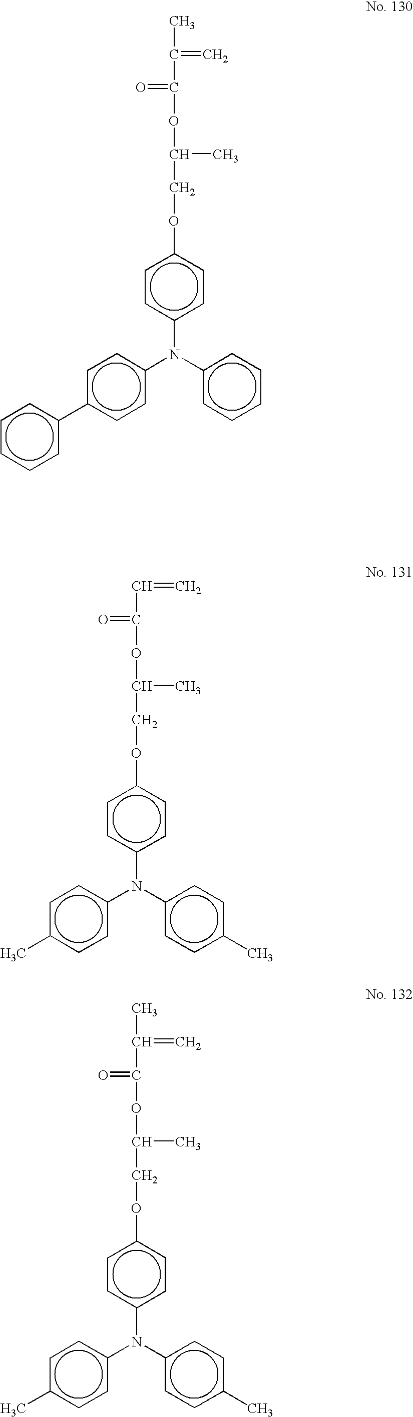

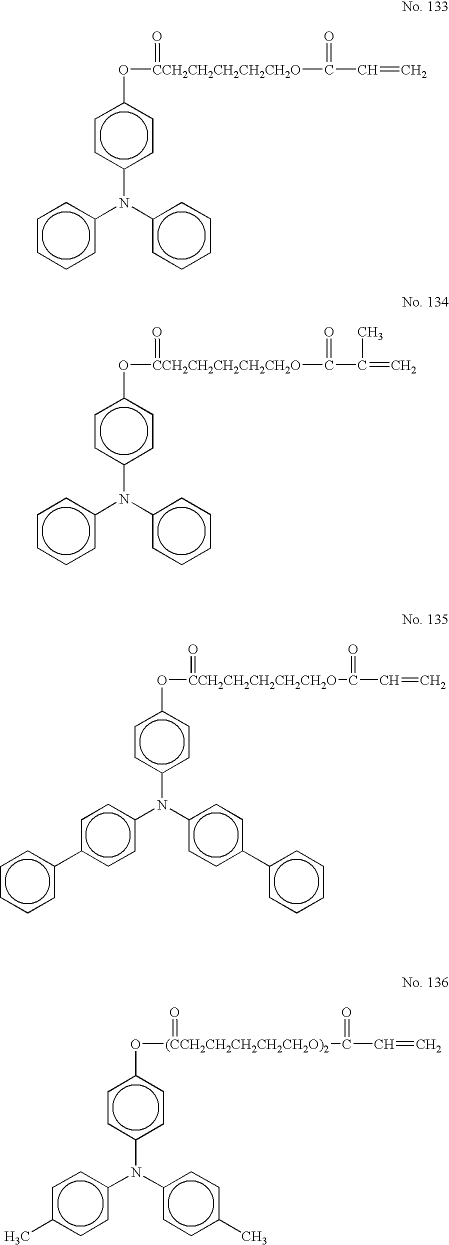

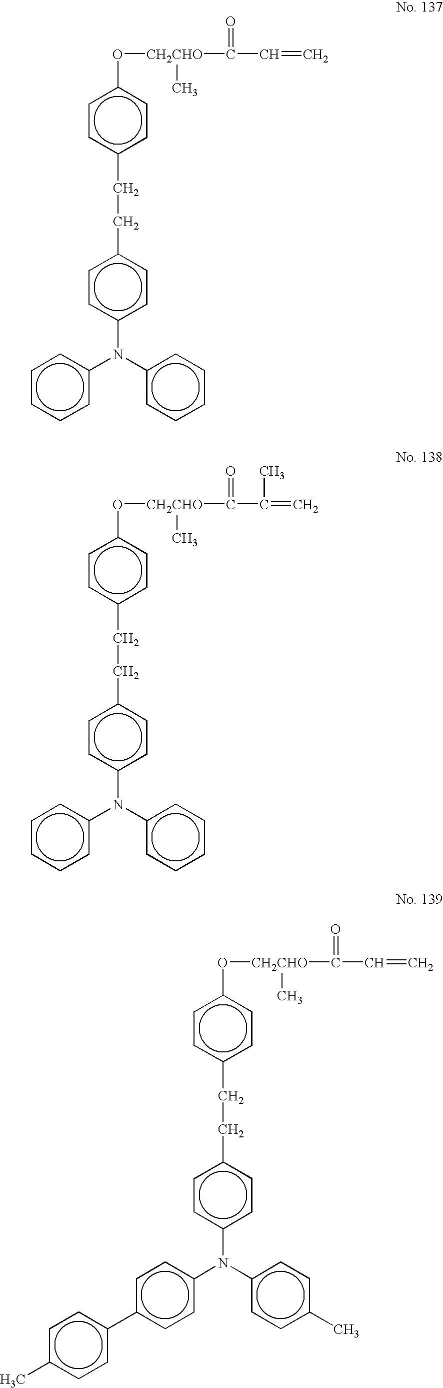

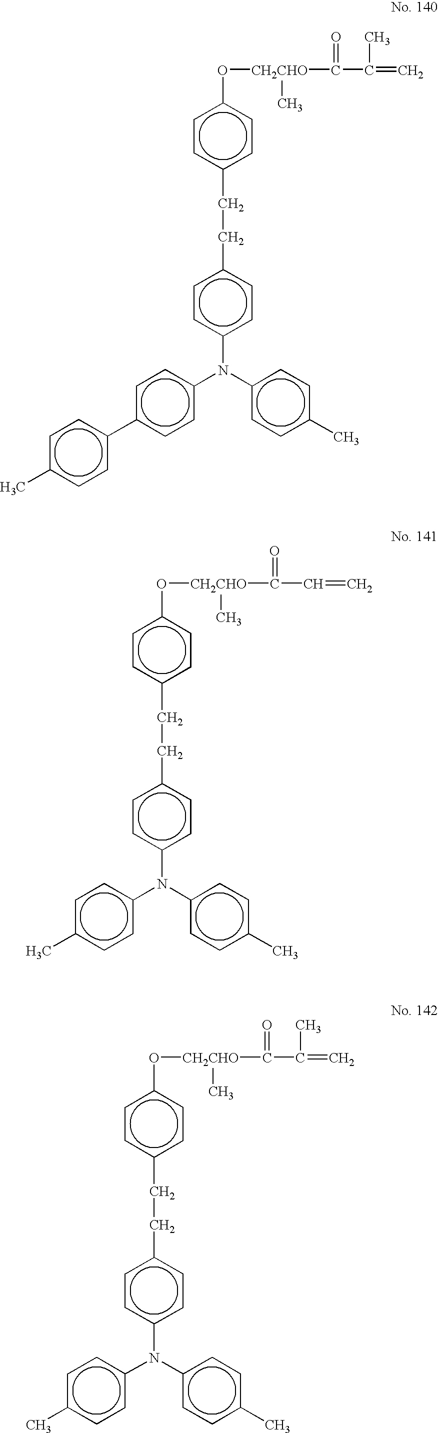

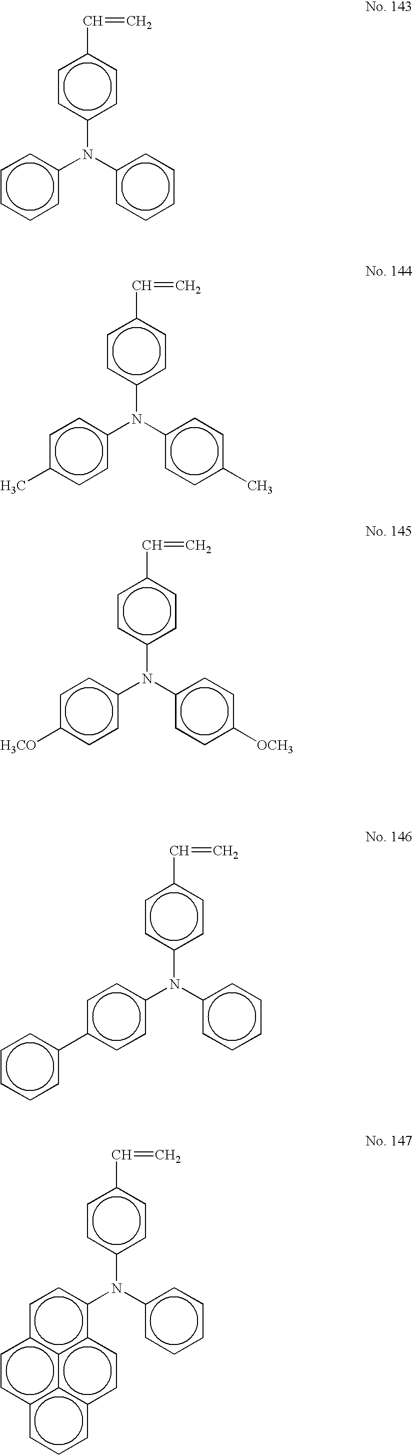

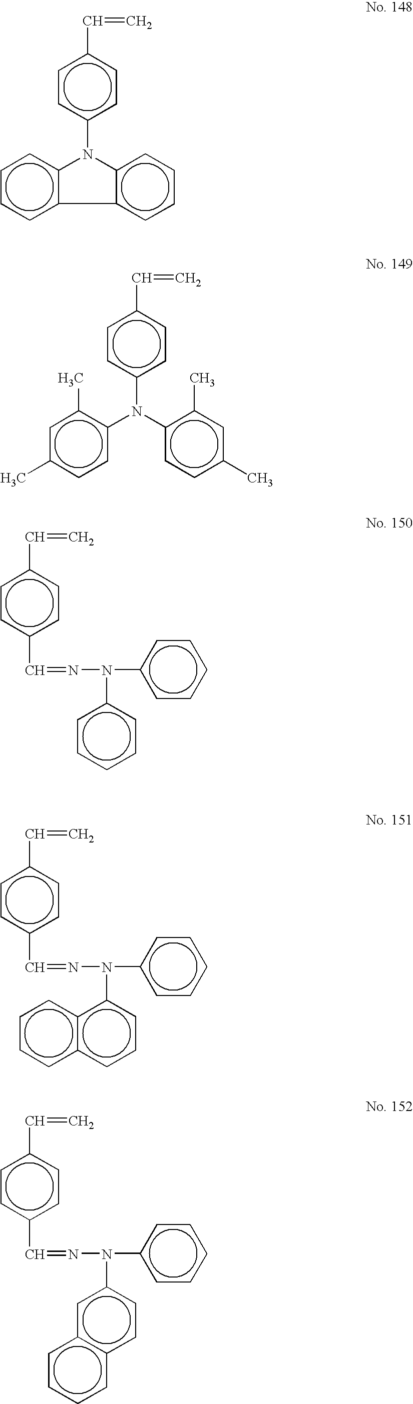

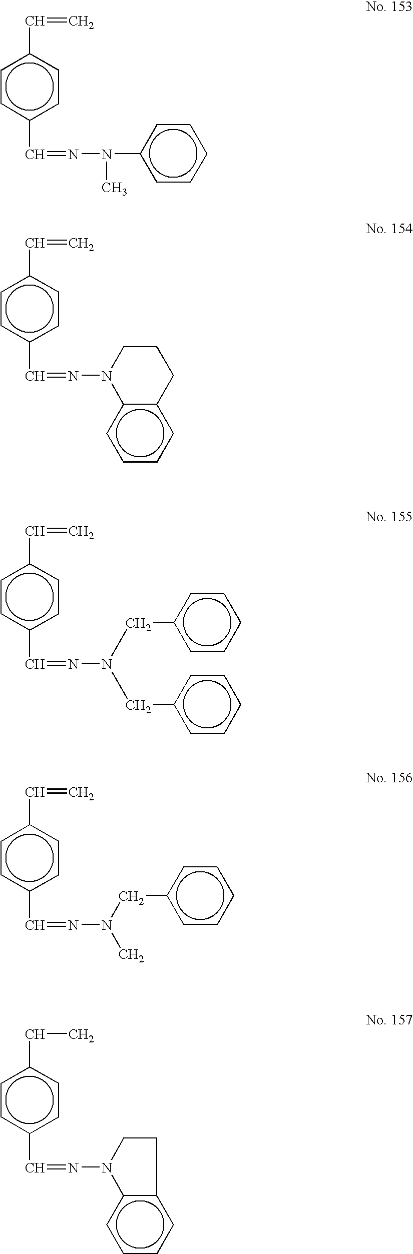

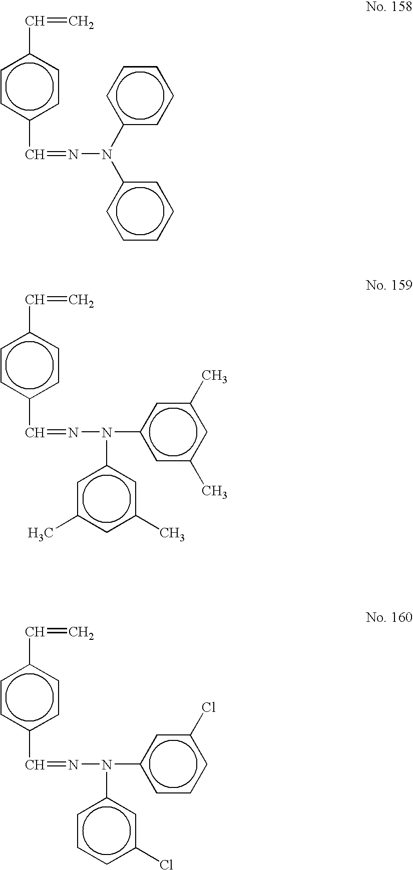

The radical polymerizable monofunctional monomers are used for imparting a charge transport property to the resultant protective layer. The added amount of the radical polymerizable monofunctional monomers is preferably from 20 to 80% by weight, and more preferably from 30 to 70% by weight, based on the total weight of the protective layer. When the added amount is too small, good charge transport property cannot be imparted to the resultant polymer, and thereby the electric properties (such as photosensitivity and residual potential) of the resultant photoreceptor deteriorate. In contrast, when the added amount is too large, the crosslinking density of the resultant protective layer decreases, and thereby the abrasion resistance of the resultant photoreceptor deteriorates. From this point of view, the added amount of the monofunctional monomers is from 30 to 70% by weight.

The crosslinked protective layer is typically prepared by reacting (crosslinking) at least a radical polymerizable tri- or more-functional monomer and a radical polymerizable monofunctional monomer. However, in order to reduce the viscosity of the coating liquid, to relax the stress of the protective layer, and to reduce the surface energy and friction coefficient of the protective layer, known radical polymerizable mono- or di-functional monomers and radical polymerizable oligomers having no charge transport structure can be used in combination therewith.

Specific examples of the radical polymerizable monofunctional monomers having no charge transport structure include 2-ethylhexyl acrylate, 2-hydroxyethyl acrylate, 2-hydroxypropyl acrylate, tetrahydrofurfuryl acrylate, 2-ethylhexylcarbitol acrylate, 3-methoxybutyl acrylate, benzyl acrylate, cyclohexyl acrylate, isoamyl acrylate, isobutyl acrylate, methoxytriethyleneglycol acrylate, phenoxytetraethyleneglycol acrylate, cetyl acrylate, isostearyl acrylate, stearyl acrylate, styrene, etc.

Specific examples of the radical polymerizable difunctional monomers having no charge transport structure include 1,3-butanediol diacrylate, 1,4-butanediol diacrylate, 1,4-butanediol dimethacrylate, 1,6-hexanediol diacrylate, 1,6-hexanediol dimethacrylate, diethylene glycol diacryalte, neopentylglycol diacrylate, binsphenol A—ethyleneoxy-modified diacrylate, bisphenol F—ethyleneoxy-modified diacrylate, neopentylglycol diacryalte, etc.

Specific examples of the mono- or di-functional monomers for use in imparting a function such as low surface energy and/or low friction coefficient to the crosslinked protective layer include fluorine-containing monomers such as octafluoropentyl acrylate, 2-perfluorooctylethyl acrylate, 2-perfluorooctylethyl methacrylate, and 2-perfluoroisononylethyl acrylate; and vinyl monomers, acrylates and methacrylates having a polysiloxane group such as siloxane units having a repeat number of from 20 to 70 which are described in JP-B 05-60503 and 06-45770 (e.g., acryloylpolydimethylsiloxaneethyl, methacryloylpolydimethylsiloxaneethyl, acryloylpolydimethylsiloxanepropyl, acryloylpolydimethylsiloxanebutyl, and diacryloylpolydimethylsiloxanediethyl).

Specific examples of the radical polymerizable oligomers include epoxyacryalte oligomers, urethane acrylate oligomers, polyester acrylate oligomers, etc.

The added amount of such mono- and di-functional monomers is preferably not greater than 50 parts by weight, and more preferably not greater than 30 parts by weight, per 100 parts by weight of the tri- or more-functional monomers used. When the added amount is too large, the crosslinking density decreases, and thereby the abrasion resistance of the resultant protective layer deteriorates.

In addition, in order to efficiently crosslink the protective layer, a polymerization initiator can be added to the protective layer coating liquid. Suitable polymerization initiators include heat polymerization initiators and photo polymerization initiators. The polymerization initiators can be used alone or in combination.

Specific examples of the heat polymerization initiators include peroxide initiators such as 2,5-dimethylhexane-2,5-dihydroperoxide, dicumyl peroxide, benzoyl peroxide, t-butylcumyl peroxide, 2,5-dimethyl-2,5-di(peroxybenzoyl)hexyne-3, di-t-butylperoxide, t-butylhydroperoxide, cumenehydroperoxide, lauroyl peroxide, and 2,2-bis(4,4-di-t-butylperoxycyclohexy)propane; and azo type initiators such as azobisisobutyronitrile, azobiscyclohexanecarbonitrile, azobisbutyric acid methyl ester, hydrochloric acid salt of azobisisobutylamidine, and 4,4′-azobis-cyanovaleric acid.

Specific examples of the photopolymerization initiators include acetophenone or ketal type photopolymerization initiators such as diethoxyacetophenone, 2,2-dimethoxy-1,2-diphenylethane-1-one, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenylpropane-1-one, 2-methyl-2-morpholino(4-methylthiophenyl)propane-1-one, and 1-phenyl-1,2-propanedione-2-(o-ethoxycarbonyl)oxime; benzoin ether type photopolymerization initiators such as benzoin, benzoin methyl ether, benzoin ethyl ether, benzoin isobutyl ether, and benzoin isopropyl ether; benzophenone type photopolymerization initiators such as benzophenone, 4-hydroxybenzophenone, o-benzoylbenzoic acid methyl ester, 2-benzoyl naphthalene, 4-benzoyl biphenyl, 4-benzoyl phenyl ether, acryalted benzophenone, and 1,4-benzoyl benzene; thioxanthone type photopolymerization initiators such as 2-isopropylthioxanthone, 2-chlorothioxanthone, 2,4-dimethylthioxanthone, 2,4-diethylthioxanthone, and 2,4-dichlorothioxanthone; and other photopolymerization initiators such as ethylanthraquinone, 2,4,6-trimethylbenzoyldiphenylphosphineoxide, 2,4,6-trimethylbenzoylphenylethoxyphosphineoxide, bis(2,4,6-trimethylbenzoyl)phenylphosphineoxide, bis(2,4-dimethoxybenzoyl)-2,4,4-trimethylpentylphosphineoxide, methylphenylglyoxyester, 9,10-phenanthrene, acridine compounds, triazine compounds, imidazole compounds, etc.

Photopolymerization accelerators can be used alone or in combination with the above-mentioned photopolymerization initiators. Specific examples of the photopolymerization accelerators include triethanolamine, methyldiethanolamine, ethyl 4-dimethylaminobenzoate, isoamyl 4-dimethylaminobenzoate, 2-dimethylaminoethyl benzoate, 4,4′-dimethylaminobenzophenone, etc.

The added amount of the polymerization initiators is preferably from 0.5 to 40 parts by weight, and more preferably from 1 to 20 parts by weight, per 100 parts by weight of the total weight of the radical polymerizable monomers used.

In order to relax the stress of the crosslinked protective layer and to improve the adhesion of the protective layer to the CTL, the protective layer coating liquid may include additives such as plasticizers, leveling agent, and low molecular weight charge transport materials having no radical polymerizability.

Specific examples of the plasticizers include known plasticizers for use in general resins, such as dibutyl phthalate, and dioctyl phthalate. The added amount of the plasticizers in the protective layer coating liquid is preferably not greater than 20% by weight, and more preferably not greater than 10% by weight, based on the total solid components included in the coating liquid.

Specific examples of the leveling agents include silicone oils (such as dimethylsilicone oils, and methylphenylsilicone oils), and polymers and oligomers having a perfluoroalkyl group in their side chains. The added amount of the leveling agents is preferably not greater than 3% by weight based on the total solid components included in the coating liquid.

The crosslinked protective layer is typically prepared by coating a coating liquid including a radical polymerizable tri- or more-functional monomer and a radical polymerizable monofunctional monomer on the CTL and then crosslinking the coated layer. When the monomers are liquid, it may be possible to dissolve other components in the monomers, resulting in preparation of the protective layer coating liquid. The coating liquid can optionally include a solvent to well dissolve the other components and/or to reduce the viscosity of the coating liquid.

Specific examples of the solvents include alcohols such as methanol, ethanol, propanol, and butanol; ketones such as acetone, methyl ethyl ketone, methyl isobutyl ketone, and cyclohexanone; esters such as ethyl acetate, and butyl acetate; ethers such as tetrahydrofuran, dioxane, and propyl ether; halogenated solvents such as dichloromethane, dichloroethane, trichloroethane, and chlorobenzene; aromatic solvents such as benzene, toluene, and xylene; cellosolves such as methyl cellosolve, ethyl cellosolve and cellosolve acetate; etc. These solvents can be used alone or in combination.

The added amount of the solvents is determined depending on the solubility of the solid components, the coating method used, and the target thickness of the protective layer. Coating methods such as dip coating methods, spray coating methods, bead coating methods, and ring coating methods can be used for forming the protective layer.

After coating a protective layer coating liquid, energy such as heat energy, photo energy and radiation energy is applied to the coated layer to crosslink the layer. Specific examples of the method for applying heat energy are as follows:

(1) applying heated gas (such as air and nitrogen gas) thereto;

(2) contacting a heated material thereto; and

(3) irradiating the coated layer with light or electromagnetic waves from the coated layer side or the opposite side.

The temperature at which the coated protective layer is heated is preferably from 100 to 170° C. When the temperature is too low, the crosslinking speed becomes too slow, and thereby a problem in that the coated layer is not sufficiently crosslinked is caused. When the temperature is too high, the crosslinking reaction is unevenly performed, and thereby a problem in that the resultant protective layer has a large strain or includes non-reacted functional groups is caused. In order to uniformly perform the crosslinking reaction, a method in which at first the coated layer is heated at a relatively low temperature (not higher than about 100° C.), followed by heating at a relatively high temperature (not lower than about 100° C.) is preferably used.

Specific examples of the light source for use in photo-crosslinking the coated layer include ultraviolet light emitting devices such as high pressure mercury lamps and metal halide lamps. In addition, visible light emitting lamps can also be used if the radical polymerizable monomers and the photopolymerization initiators used have absorption in a visible region. The illuminance intensity is preferably from 50 to 1000 mW/cm². When the illuminance intensity is too low, it takes a long time until the coated layer is crosslinked. In contrast, when the illuminance intensity is too high, a problem in that the crosslinking reaction is unevenly performed, thereby forming wrinkles in the resultant protective layer, or the layer includes non-reacted reaction groups therein is caused. In addition, a problem in that due to rapid crosslinking, the resultant protective layer causes cracks or peeling occurs.

Specific examples of the radiation energy applying methods include methods using electron beams.

Among these methods, the methods using heat or light are preferably used because the reaction speed is high and the energy applying devices have a simple structure.

The thickness of the crosslinked protective layer is preferably from 1 to 10 μm, and more preferably from 2 to 8 μm. When the crosslinked protective layer is too thick, the above-mentioned cracking and peeling problems occurs. When the thickness is not greater than 8 μm, the margin for the cracking and peeling problems can be increased. Therefore, a relatively large amount of energy can be applied to the coated layer, and thereby crosslinking density can be further increased. In addition, flexibility in choosing materials for imparting good abrasion resistance to the protective layer and flexibility in setting crosslinking conditions can be enhanced.

In general, radical polymerization reaction is obstructed by oxygen included in the air, namely, crosslinking is not well performed in the surface portion (from 0 to about 1 μm in the thickness direction) of the coated layer due to oxygen in the air, resulting in formation of unevenly-crosslinked layer. Therefore, if the crosslinked protective layer is too thin (i.e., the thickness of the protective layer is less than about 1 μm), the layer has poor abrasion resistance. Further, when the protective layer coating liquid is coated directly on a CTL, the components included in the CTL tends to be dissolved in the coated liquid, resulting in migration of the components into the protective layer. In this case, if the protective layer is too thin, the components are migrated into the entire protective layer, resulting in occurrence of a problem in that crosslinking cannot be well performed or the crosslinking density is low.

Thus, the thickness of the protective layer is preferably not less than 1 μm so that the protective layer has good abrasion resistance and scratch resistance. However, if the entire protective layer is abraded, the CTL located below the protective layer is abraded more easily than the protective layer. In this case, problems in that the photosensitivity of the photoreceptor seriously changes and uneven half tone images are produced occur. In order that the resultant photoreceptor can produce high quality images for a long period of time, the crosslinked protective layer preferably has a thickness not less than 2 μm.

When the crosslinked protective layer, which is formed as an outermost layer of a photoreceptor having a CGL, and CTL, is insoluble in organic solvents, the resultant photoreceptor has dramatically improved abrasion resistance and scratch resistance. The solvent resistance of a protective layer can be checked by the following method:

(1) dropping a solvent, which can well dissolve polymers, such as tetrahydrofuran and dichloromethane, on the surface of the protective layer;

(2) naturally drying the solvent;

(3) the surface of the protective layer is visually observed to determine whether the condition of the surface portion is changed.

If the protective layer has poor solvent resistance, the following phenomena are observed:

(1) the surface portion is recessed while the edge thereof is projected;

(2) the charge transport material in the protective layer is crystallized, and thereby the surface portion is clouded; or

(3) the surface portion is at first swelled, and then wrinkled.

If the protective layer has good solvent resistance, the above-mentioned phenomena are not observed.

In order to prepare a crosslinked protective layer having good resistance to organic solvents, the key points are as follows.

(1) to optimize the formula of the protective layer coating liquid, i.e., to optimize the content of each of the components included in the liquid;

(2) to choose a proper solvent for diluting the protective layer coating liquid, while properly controlling the solid content of the coating liquid;

(3) to use a proper method for coating the protective layer coating liquid;

(4) to crosslink the coated layer under proper crosslinking conditions; and

(5) to form a CTL which located below the protective layer and is hardly insoluble in the solvent included in the protective layer coating liquid.

It is preferable to use one or more of these techniques.

The protective layer coating liquid can include additives such as binder resins having no radical polymerizable group, antioxidants and plasticizers other than the radical polymerizable tri- or more-functional monomers having no charge transport structure and radical polymerizable monofunctional monomers having a charge transport structure.

Since the added amount of these additives is too large, the crosslinking density decreases and the protective layer causes a phase separation problem in that the crosslinked polymer is separated from the additives, and thereby the resultant protective layer becomes soluble in organic solvents. Therefore, the added amount of the additives is preferably not greater than 20% by weight based on the total weight of the solid components included in the protective layer coating liquid. In addition, in order not to decrease the crosslinking density, the total added amount of the mono- or di-functional monomers, reactive oligomers and reactive polymers in the protective layer coating liquid is preferably not greater than 20% by weight based on the weight of the radical polymerizable tri- or more-functional monomers. In particular, when the added amount of the di- or more-functional monomers having a charge transport structure is too large, units having a bulky structure are incorporated in the protective layer while the units are connected with plural chains of the protective layer, thereby generating strain in the protective layer, resulting in formation of aggregates of micro crosslinked materials in the protective layer. Such a protective layer is soluble in organic solvents. The added amount of a radical polymerizable di- or more-functional monomer having a charge transport structure is determined depending on the species of the monomer used, but is generally not greater than 10% by weight based on the weight of the radical polymerizable monofunctional monomer having a charge transport structure included in the protective layer.

When an organic solvent having a low evaporating speed is used for the protective layer coating liquid, problems which occur are that the solvent remaining in the coated layer adversely affects crosslinking of the protective layer; and a large amount of the components included in the CTL is migrated into the protective layer, resulting in deterioration of crosslinking density or formation of an unevenly crosslinked protective layer (i.e., the crosslinked protective layer becomes soluble in organic solvents). Therefore, it is preferable to use solvents such as tetrahydrofuran, mixture solvents of tetrahydrofuran and methanol, ethyl acetate, methyl ethyl ketone, and ethyl cellosolve. It is preferable that one or more proper solvents are chosen among the solvents in consideration of the coating method used.

When the solid content of the protective layer coating liquid is too low, similar problems occur. The upper limit of the solid content is determined depending on the target thickness of the protective layer and the target viscosity of the protective layer coating liquid, which is determined depending on the coating method used, but in general, the solid content of the protective layer coating liquid is preferably from 10 to 50% by weight.

Suitable coating methods for use in preparing the crosslinked protective layer include methods in which the weight of the solvent included in the coated layer is as low as possible, and the time during which the solvent in the coated layer contacts the CTL on which the coating liquid is coated is as short as possible. Specific examples of such coating methods include spray coating methods and ring coating methods in which the weight of the coated layer is controlled so as to be light. In addition, in order to control the amount of the components of the CTL migrating into the protective layer so as to be as small as possible, it is preferable to use a charge transport polymer for the CTL and/or to form an intermediate layer, which is hardly soluble in the solvent used for the protective layer coating liquid, between the CTL and the protective layer.

When the heating or irradiating energy is low in the crosslinking process, the coated layer is not completely crosslinked. In this case, the resultant layer becomes soluble in organic solvents. In contrast, when the energy is too high, uneven crosslinking is performed, resulting in increase of non-crosslinked portions or portions at which radical is terminated, or formation of aggregates of micro crosslinked materials. In this case, the resultant protective layer is soluble in organic solvents.

In order to make a protective layer insoluble in organic solvents, the crosslinking conditions are preferably as follows:

Heat Crosslinking Conditions

Temperature: 100 to 170° C.

Heating time: 10 minutes to 3 hours

UV Light Crosslinking Conditions

Illuminance intensity: 50 to 1000 mW/cm²

Irradiation time: 5 seconds to 5 minutes

Temperature of coated material: 50° C. or less

In order to make a protective layer insoluble in organic solvents in a case where an acrylate monomer having three acryloyloxy group and a triarylamine compound having one acryloyloxy group are used for the protective layer coating liquid, the weight ratio (A/T) of the acrylate monomer (A) to the triarylamine compound (T) is preferably 7/3 to 3/7. The added amount of a polymerization initiator is preferably from 3 to 20% by weight based on the total weight of the acrylate monomer (A) and the triarylamine compound (T). In addition, a proper solvent is preferably added to the coating liquid. Provided that the CTL, on which the protective layer coating liquid is coated, is formed of a triarylamine compound (serving as a CTM) and a polycarbonate resin (serving as a binder resin), and the protective layer coating liquid is coated by a spray coating method, the solvent of the protective layer coating liquid is preferably selected from tetrahydrofuran, 2-butanone, and ethyl acetate. The added amount of the solvent is preferably from 300 to 1000 parts by weight per 100 parts by weight of the acrylate monomer (A).

After the protective layer coating liquid is prepared, the coating liquid is coated by a spray coating method on a peripheral surface of a drum, which includes, for example, an aluminum cylinder and an undercoat layer, a CGL and a CTL which are formed on the aluminum cylinder. Then the coated layer is naturally dried, followed by drying for a short period of time (from 1 to 10 minutes) at a relatively low temperature (from 25 to 80° C.). Then the dried layer is heated or exposed to UV light to be crosslinked.

When crosslinking is performed using UV light, metal halide lamps are preferably used. In this case, the illuminance intensity of UV light is preferably from 50 mW/cm² to 1000 mW/cm². Provided that plural UV lamps emitting UV light of 200 mW/cm² are used, it is preferable that plural lamps uniformly irradiate the coated layer with UV light along the peripheral surface of the coated drum for about 30 seconds. In this case, the temperature of the drum is controlled so as not to exceed 50° C. When heat crosslinking is performed, the temperature is preferably from 100 to 170° C., and the heating device is preferably an oven with an air blower. When the heating temperature is 150° C., the heating time is preferably from 20 minutes to 3 hours.

It is preferable that after the crosslinking operation, the thus prepared photoreceptor is heated for a time of from 10 minutes to 30 minutes at a temperature of from 100 to 150° C. to remove the solvent remaining in the protective layer. Thus, a photoreceptor (i.e., an image bearing member) of the present invention is prepared.

In addition, protective layers in which an amorphous carbon layer or an amorphous SiC layer is formed by a vacuum thin film forming method such as sputtering can also be used for the photoreceptor for use in the present invention.

When a protective layer is formed as an outermost layer of the photoreceptor, there is a case where the discharging light hardly reaches the photosensitive layer if the protective layer greatly absorbs the discharging light, resulting in increase of residual potential and deterioration of the protective layer. Therefore, the protective layer preferably has a transmittance of not less than 30%, more preferably not less than 50% and even more preferably not less than 85% against the discharging light used.

As mentioned above, by using a charge transport polymer for the CTL and/or forming a protective layer as an outermost layer, the durability of the photoreceptor can be improved. In addition, when such a photoreceptor is used for the below-mentioned tandem type full color image forming apparatus, a new effect can be produced.

In the photoreceptor for use in the present invention, the following antioxidants can be added to the protective layer, CTL, CGL, charge blocking layer, moiré preventing layer, etc., to improve the stability to withstand environmental conditions (particularly, to avoid deterioration of sensitivity and increase of residual potential).

Suitable antioxidants for use in the layers of the photoreceptor include the following compounds but are not limited thereto.

(a) Phenolic Compounds

2,6-di-t-butyl-p-cresol, butylated hydroxyanisole, 2,6-di-t-butyl-4-ethylphenol, n-octadecyl-3-(4′-hydroxy-3′,5′-di-t-butylphenol), 2,2′-methylene-bis-(4-methyl-6-t-butylphenol), 2,2′-methylene-bis-(4-ethyl-6-t-butylphenol), 4,4′-thiobis-(3-methyl-6-t-butylphenol), 4,4′-butylidenebis-(3-methyl-6-t-butylphenol), 1,1,3-tris-(2-methyl-4-hydroxy-5-t-butylphenyl)butane, 1,3,5-trimethyl-2,4,6-tris(3,5-di-t-butyl-4-hydroxybenzyl)benzene, tetrakis-[methylene-3-(3′,5′-di-t-butyl-4′-hydroxyphenyl)propionate]methane, bis[3,3′-bis(4′-hydroxy-3′-t-butylphenyl)butyric acid]glycol ester, tocopherol compounds, and the like.

(b) Paraphenylenediamine Compounds

N-phenyl-N′-isopropyl-p-phenylenediamine, N,N′-di-sec-butyl-p-phenylenediamine, N-phenyl-N-sec-butyl-p-phenylenediamine, N,N′-di-isopropyl-p-phenylenediamine, N,N′-dimethyl-N,N′-di-t-butyl-p-phenylenediamine, and the like.

(c) Hydroquinone Compounds

2,5-di-t-octylhydroquinone, 2,6-didodecylhydroquinone, 2-dodecylhydroquinone, 2-dodecyl-5-chlorohydroquinone, 2-t-octyl-5-methylhydroquinone, 2-(2-octadecenyl)-5-methylhydroquinone and the like.

(d) Organic Sulfur-Containing Compounds

dilauryl-3,3′-thiodipropionate, distearyl-3,3′-thiodipropionate, ditetradecyl-3,3′-thiodipropionate, and the like.

(e) Organic Phosphorus-Containing Compounds

triphenylphosphine, tri(nonylphenyl)phosphine, tri(dinonylphenyl)phosphine, tricresylphosphine, tri(2,4-dibutylphenoxy)phosphine and the like.

These compounds have been used as antioxidants for rubbers, resins and oils and fats, and commercially available. The content of the antioxidants in a layer is from 0.01 to 10% by weight based on the total weight of the layer.

When full color images are formed, color images of various patterns are produced. In this case, all the portions of the photoreceptor are subjected to image forming processes such as imagewise irradiating and developing. In contrast, there are original documents having a fixed color image (such as stamp of approval). Stamp of approval is typically located on an edge portion of a document, and the color thereof is limited. When such images are formed on a photoreceptor, a specific portion of a photoreceptor is mainly used for image formation. In this case, the portion is deteriorated faster than the other portions of the photoreceptor. If a photoreceptor having insufficient durability (i.e., insufficient physical, chemical and mechanical durability) is used therefor, an image problem tends to be caused. However, the photoreceptor for use in the present invention has good durability, and therefore such an image problem is hardly caused.

Electrostatic Latent Image Forming Device

After the image bearing member (i.e., the photoreceptor) is charged with a charger, a light irradiator irradiates the charged photoreceptor with imagewise light to form an electrostatic latent image on the photoreceptor, wherein the charger and the light irradiator serve as an electrostatic latent image forming device.

The electrostatic latent image forming device typically includes a charger configured to uniformly charge the photoreceptor and a light irradiator.

The charger for use in the image forming apparatus of the present invention is not particularly limited, and known chargers can be used. Specific examples thereof include contact chargers (e.g., conductive or semi-conductive rollers, brushes, films, and rubber blades); short-range chargers which a charging member charges a photoreceptor with a gap on the order of 100 μm; non-contact chargers such as chargers utilizing corona discharging (e.g., corotrons and scorotrons); etc. The strength of the electric field formed on a photoreceptor by a charger is preferably from 20 to 60 V/μm and more preferably from 30 to 50 V/μm. In this regard, the greater the electric field strength, the better dot reproducibility the resultant image has. However, when the electric field strength is too high, problems in that the photoreceptor causes dielectric breakdown and carrier particles are adhered to an electrostatic latent image occur.

The electric field strength (E) is represented by the following equation.
E(V/μm)=SV/G
wherein SV represents the potential (V) of a non-lighted portion of a photoreceptor at a developing position; and G represents the thickness of the photosensitive layer of the photoreceptor, which includes at least a CGL and a CTL.

Image irradiation is performed by irradiating the charged photoreceptor with imagewise light using a light irradiating device. Known light irradiators can be used and a proper light irradiator is chosen and used for the image forming apparatus for which the toner of the present invention is used. Specific examples thereof include optical systems for use in reading images in copiers; optical systems using rod lens arrays; optical systems using laser; and optical systems using a liquid crystal shutter.

It is possible to irradiate the photoreceptor from the backside of the photoreceptor.

Specific examples of the light sources for use in the light irradiator include light emitting diodes (LEDs), laser diodes (LDs) and electroluminescence devices (ELs)

The resolution of an electrostatic latent image (and a toner image) depends on the resolution of the image writing light. Namely, the higher the resolution of the image writing light, the better the resolution of the resultant electrostatic latent image. However, when the resolution of the image writing light is high, it takes a long time to write an image. When only one light source is used for image writing, the image processing speed (i.e., the speed of the image bearing member) depends on the image writing speed. Therefore, when only one light source is used for image writing, the upper limit of the resolution is about 1200 dpi (dots per inch) and preferably 2400 dpi. When plural light sources (n pieces) are used, the upper limit of the resolution is 1200 (or 2400) dpi×n.

Among these light sources, LEDs and LDs are preferably used.

By using a light source emitting light with a wavelength less than 450 nm, high resolution images can be formed. Therefore, such a light source is preferably used for the image forming apparatus of the present invention. In order to emit laser light with such a short wavelength, a technique in that the wavelength of laser light is reduced to one half using a second harmonic generation (SHG) technique or a technique using a wide gap semiconductor is used. In recent years, laser diodes emitting light with a wavelength of from 400 to 410 nm have been developed, and optical devices using such a LD have been developed. These devices can be preferably used for the image forming apparatus of the present invention. From the viewpoint of the materials constituting the CTL and protective layer, the lower limit of the wavelength of the light used for image writing is about 350 nm. It is expected the limit will be lowered by developing new materials and new laser.

Developing Device

The electrostatic latent image formed on the photoreceptor is developed with a developing device using a developer including a toner, and a toner image is formed on the photoreceptor. In this regard, a nega-posi developing method is typically used. Therefore a toner having the same polarity as that of the charges formed on the photoreceptor is used. Both one component developers including only a toner, and two component developers including a toner and a carrier can be used for the image forming apparatus of the present invention.

The developing device includes at least a developing sleeve.

Transferring Device

The transferring device transfers the toner image onto a receiving material. The transfer method is classified into a direct transfer method in which the toner image is directly transferred to a receiving material; and an indirect transfer method in which the toner image is transferred to an intermediate transfer medium (primary transfer) and then transferred to a receiving material (secondary transfer). Both the transfer methods can be used for the image forming apparatus of the present invention. When high resolution images are produced, the direct transfer method is preferably used.

When a toner image is transferred, the photoreceptor is typically charged with a transfer charger which is included in the transferring device. The transferring device is not limited thereto, and known transferring devices such as transfer belts and rollers can also be used.

Suitable transferring devices for use in the transfer device (primary and secondary transferring members) of the image forming apparatus of the present invention include transfer members which charge toner images so as to be easily transferred to a receiving material. Specific examples of the transfer members include corona-charge transfer members, transfer belts, transfer rollers, pressure transfer rollers, adhesion transfer members, etc. The transferring device may include one or more transfer members.

The receiving material is not particularly limited, and known receiving materials such as papers and films can be used.

Suitable transfer chargers for use in the transferring device include transfer belt chargers and transfer roller chargers. In this regard, in view of the amount of ozone generated, contact type transfer belt chargers and transfer roller chargers are preferably used. Both constant voltage type charging methods and constant current type charging methods can be used in the present invention, but constant current type charging methods are preferably used because constant transfer charges can be applied and thereby charging can be stably performed.

As mentioned above, the quantity of charges passing through the photoreceptor in one image formation cycle largely changes depending on the residual potential of the photoreceptor after the transfer process. Namely, the higher residual potential a photoreceptor has, the faster the photoreceptor deteriorates.

In this regard, the charge quantity means the quantity of charges passing in the thickness direction of the photoreceptor. Specifically, the photoreceptor is (negatively) charged with a main charger so as to have a predetermined potential. Then imagewise light irradiation is performed on the charged photoreceptor. In this case, the lighted portion of the photoreceptor generates photo-carriers, and thereby the charges on the surface of the photoreceptor are decayed. In this case, a current corresponding to the quantity of the generated carriers flows in the thickness direction of the photoreceptor. In contrast, a non-lighted portion of the photoreceptor is fed to the discharging position after the developing and transferring processes (and optionally a cleaning process). If the potential of the non-lighted portion is near the potential thereof just after the charging process, charges whose quantity is almost the same as that of charges passing through the photoreceptor in the imagewise light irradiation process pass through the photoreceptor in the discharging process.

In general, images to be produced have a small image area proportion, and therefore almost all charges pass through the photoreceptor in the discharging process in one image formation cycle. Provided that the image area proportion is 10%, 90% of the current flown in the discharging process.

The electrostatic properties of a photoreceptor are largely influenced by the charges passing through the photoreceptor if the materials constituting the photoreceptor are deteriorated by the charges. Specifically, the residual potential of the photoreceptor increases depending on the quantity of the charges passing through the photoreceptor. If the residual potential increases, a problem in that the image density of the resultant toner image decreases occurs when a nega-posi developing method is used. Therefore, in order to prolong the life of a photoreceptor, the quantity of charges passing through the photoreceptor has to be reduced.

There is a proposal such that image forming is performed without performing a discharging process. In this case, it is impossible to uniformly charge all the portions of the photoreceptor (which results in formation of a ghost image) unless a high power charging device is used.

In order to reduce the quantity of charges passing through a photoreceptor, it is preferable to discharge the charges on the photoreceptor without using light. Accordingly, it is effective to reduce the potential of a non-lighted portion of the photoreceptor by controlling the transfer bias. Specifically, it is preferable to reduce the potential of a non-lighted portion of the photoreceptor to about (−)100V (preferably 0V) before the discharging process. In this case, the quantity of charges passing through the photoreceptor can be reduced. It is more preferable to charge the photoreceptor so as to have a potential with a polarity opposite to that of charges formed on the photoreceptor in the main charging process because photo-carriers are not generated in this case. However, in this case problems in that the toner image is scattered and the photoreceptor cannot be charged so as to have the predetermined potential unless a high power charger is used as the main charger occur. Therefore, the potential of the photoreceptor is preferably not greater than 100V after the transferring process.

Fixing Device

When plural color images are transferred to form a multi-color (or full color) image, the fixing operation can be performed on each color image or on overlaid color images.

Known fixing devices can be used for the image forming apparatus of the present invention. Among the fixing devices, heat/pressure fixing devices including a combination of a heat roller and a pressure roller or a combination of a heat roller, a pressure roller and an endless belt are preferably used. The temperature of the heating member is preferably from 80 to 200° C. The fixing device is not limited thereto, and known light fixing devices can also be used.

Discharging Device

The discharging device for use in the image forming apparatus of the present invention is not particularly limited, and known devices such as laser diodes, electroluminescence devices can be used as long as the devices can emit light with a wavelength of less than 500 nm, preferably less than 480 nm and more preferably less than 450 nm.

Specifically, for example, the following devices can be used.

(1) laser diodes and electroluminescence devices emitting light having a wavelength of less than 500 nm; and

(2) combinations of a light source (such as fluorescent lamps, tungsten lamps, halogen lamps, mercury lamps, sodium lamps, and xenon lamps) and an optical filter capable of selectively obtaining light having a wavelength of less than 500 nm (such as sharp-cut filters, band pass filters, near-infrared cutting filters, dichroic filters, interference filters, and color temperature converting filters).

In order to obtain laser light with such a short wavelength, techniques in that the wavelength of laser light is reduced to one half using a second harmonic generation (SHG) technique and a non-linear optical material (disclosed in JP-As 09-275242, 09-189930, and 05-313033), or techniques using a wide gap semiconductor can be used.

The first-mentioned techniques have advantages in that GaAs laser diodes and YAG lasers, which have been technically established and have a high power, can be used and thereby a high power discharging device having a long life can be provided. The second-mentioned techniques have an advantage in that the discharging device can be miniaturized. In this case, laser diodes using ZnSe based semiconductors (disclosed in JP-As 07-321409 and 06-334272), or GaN based semiconductors (disclosed in JP-As 08-88441, and 07-335975) can be used. In recent years, GaN based laser diodes emitting light with a wavelength of from 405 nm have been developed, and optical devices using such a LD have been developed. These devices can be used for the discharging device of the image forming apparatus of the present invention.

In addition, LED lamps using the above-mentioned materials are commercialized. These lamps can also be used for the discharging device.

At the present time, the lower limit of the wavelength of the discharging light is about 350 nm. This is because CTMs for use in the protective layer and the CTL typically have a low transmittance against light with a wavelength less than about 350 nm. This is because CTMs having a triarylamine structure have absorption at a wavelength range of from 300 to 350 nm. If a CTM having absorption at a shorter wavelength is developed, the limit can be further lowered.

Other Devices

The image forming apparatus of the present invention can include a cleaning device configured to remove toner particles remaining on the surface of the photoreceptor even after the transfer process. The cleaning device is not particularly limited, and known cleaning devices such as magnetic brush cleaners, electrostatic brush cleaners, magnetic roller cleaners, blade cleaners, brush cleaners and web cleaners can be used.

The image forming apparatus of the present invention can include a toner recycling device configured to feed the toner particles collected by the cleaning device to the developing device. The toner recycling device is not particularly limited, and known powder feeding devices can be used therefor.

The image forming apparatus of the present invention can include a controller configured to control the processes mentioned above. Any known controllers such as sequencers and computers can be used therefor.

The image forming apparatus of the present invention will be explained referring to drawings.

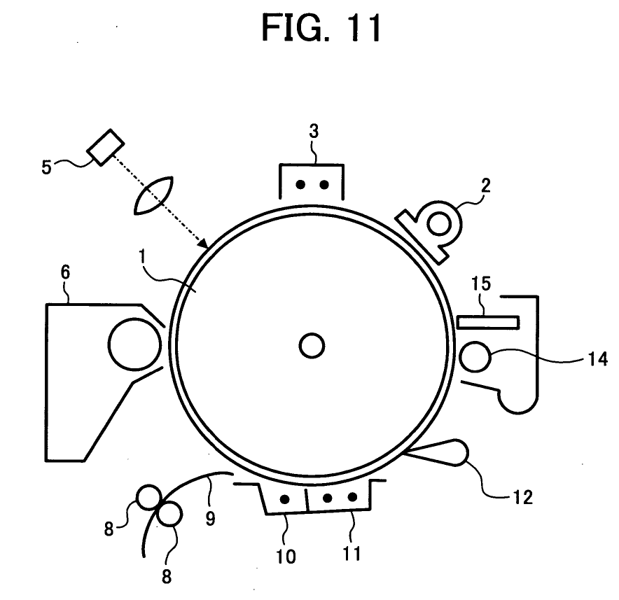

FIG. 11 is a schematic view illustrating an embodiment of the image forming apparatus. The image forming apparatus includes a photoreceptor 1 which includes at least an electroconductive substrate, a CGL including an organic CGM and located overlying the substrate and a CTL located overlying the CGL. Although a photoreceptor 1 has a drum-form, the shape is not limited thereto and sheet-form and endless belt-form photoreceptors can also be used.

Around the photoreceptor 1, a discharging lamp 2 configured to discharge the charges remaining on the photoreceptor 1, a charger 3 configured to charge the photoreceptor 1, a light irradiator 5 configured to irradiate the photoreceptor 1 with imagewise light to form an electrostatic latent image on the photoreceptor 1, a developing device 6 configured to develop the latent image with a toner to form a toner image on the photoreceptor 1, and a cleaning device including a fur brush 14 and a cleaning blade 15 configured to clean the surface of the photoreceptor 1 are arranged while contacting or being set closely to the photoreceptor 1. The toner image formed on the photoreceptor 1 is transferred on a receiving paper 9 fed by a pair of registration rollers 8 at a transferring device (i.e., a pair of a transfer charger 10 and a separating charger 11). The receiving paper 9 having the toner image thereon is separated from the photoreceptor 1 by a separating pick 12.

As the charger 3, wire chargers and roller chargers are preferably used. When high speed charging is needed, scorotron chargers are preferably used. Roller chargers are preferably used for compact image forming apparatuses and tandem type image forming apparatuses because the amount of acidic gases such as NOx and SOx and ozone generated by charging is small. The strength of the electric field formed on the photoreceptor by the charger is preferably not less than 20 V/μm. In this regard, the greater the electric field strength, the better dot reproducibility the resultant image has. However, when the electric field strength is too high, problems in that the photoreceptor causes dielectric breakdown and carrier particles are adhered to an electrostatic latent image occur. Therefore, the electric field strength is preferably not greater than 60 V/μm and more preferably not greater than 50 V/μm.

Suitable light sources for use in the light irradiator include light emitting diodes (LEDs), laser diodes (LDs) and electroluminescence devices (ELs), which are high intensity light sources and which can form latent images with a resolution not less than 600 dpi. The resolution of an electrostatic latent image (and a toner image) depends on the resolution of the image writing light. Namely, the higher the resolution of the image writing light, the better the resolution of the resultant electrostatic latent image. However, when the resolution of the image writing light is high, it takes a long time to write an image. When only one light source is used for image writing, the image processing speed (i.e., the speed of the image bearing member) depends on the image writing speed. Therefore, when only one light source is used for image writing, the upper limit of the resolution is about 1200 dpi (dots per inch) and preferably 2400 dpi. When plural light sources (n pieces) are used, the upper limit of the resolution is 1200 (or 2400) dpi×n.

Among these light sources, LEDs and LDs are preferably used because of having high illuminance. By using a light source emitting light with a wavelength of less than 450 nm, high resolution images can be formed.

The developing device 6 includes at least one developing sleeve. The developing device develops an electrostatic latent image formed on the photoreceptor with a developer including a toner, using a nega-posi developing method. The current digital image forming apparatus uses a nega-posi developing method in which a toner is adhered to a lighted portion because the image area proportion of original images is low and therefore it is preferable for the light irradiating device to irradiate the image portion of a photoreceptor with light in view of the life of the light irradiator. With respect to the developer, both one component developers including only a toner, and two component developers including a toner and a carrier can be used for the image forming apparatus of the present invention.

With respect to the transferring device, transfer belts and transfer rollers can also be used therefor. Particularly, contact transfer belts and transfer rollers are preferably used because the amount of ozone generated during the transferring process is small. Both constant voltage type charging methods and constant current type charging methods can be used in the present invention, but constant current type charging methods are preferably used because constant transfer charges can be applied and thereby charging can be stably performed. In the transferring process, it is preferable to control the current flowing in the photoreceptor through the transfer member in the transferring process when a voltage is applied from a power source to the transferring device.

The transfer current is flown due to application of charges to remove the toner, which is electrostatically adhered to the photoreceptor, from the photoreceptor and transfer the toner to a receiving material. In order to prevent occurrence of a transfer problem in that a part of a toner image is not transferred, the transfer current is increased. However, when a nega-posi developing method is used, a voltage having a polarity opposite to that of the charge formed on the photoreceptor is applied in the transferring process, and thereby the photoreceptor suffers a serious electrostatic fatigue. In the transferring process, the higher the transfer current, the better the transfer efficiency of a toner image, but a discharging phenomenon occurs between the photoreceptor and the receiving material if the current is greater than a threshold, resulting in formation of scattered toner images. Therefore, the transfer current is preferably controlled so as not to exceed the threshold current. The threshold current changes depending on the factors such as distance between the photoreceptor and the receiving material, and materials constituting the photoreceptor and the receiving material, but is generally about 200 μA to prevent occurrence of a discharging phenomenon.

The transfer method is classified into a direct transfer method in which the toner image is directly transferred to a receiving material; and an indirect transfer method in which the toner image is transferred to an intermediate transfer medium (primary transfer) and then transferred to a receiving material (secondary transfer). Both the transfer methods can be used for the image forming apparatus of the present invention.

As mentioned above, it is preferable to control the transfer current to decrease the potential of a non-lighted portion of the photoreceptor, which results in decrease of quantity of charges passing through the photoreceptor in one image forming cycle.

Suitable light sources for use in the discharging device 2 include light sources capable of emitting light with a wavelength of less than 500 nm, preferably less than 480 nm and more preferably less than 450 nm. Known light sources such as laser diodes (LDs) and electroluminescence devices (LEDs) can be used therefor.

Specifically, for example, the following devices can be used.

(1) laser diodes and electroluminescence devices emitting light having a wavelength of less than 500 nm; and

(2) combinations of a light source (such as fluorescent lamps, tungsten lamps, halogen lamps, mercury lamps, sodium lamps, and xenon lamps) and an optical filter capable of selectively obtaining light having a wavelength of less than 500 nm (such as sharp-cut filters, band pass filters, near-infrared cutting filters, dichroic filters, interference filters, and color temperature converting filters).

The lower limit of the light used for discharging is from about 300 nm to about 350 nm, which depends on the transmittance of the CTL and the protective layer against the discharging light.

In FIG. 11 the cleaning device uses a fur brush and a cleaning blade, but cleaning may be performed only by a cleaning brush. Known brushes such as fur brushes and mag-fur brushes can be used for the cleaning brush.

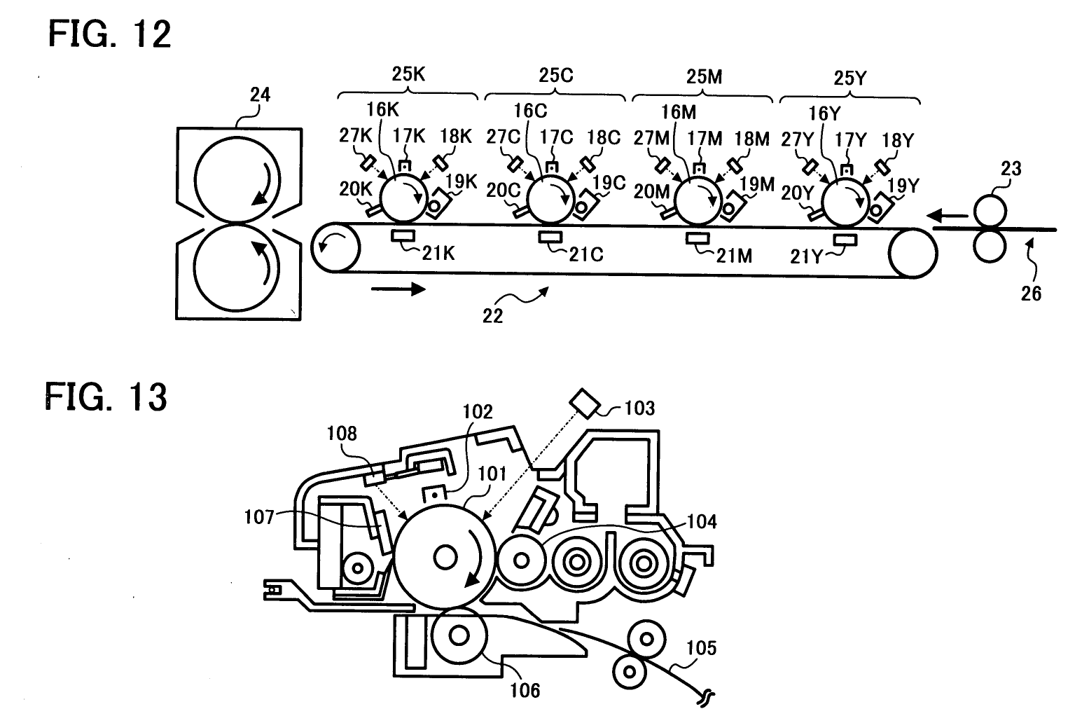

FIG. 12 is a schematic view illustrating another embodiment of the image forming apparatus (i.e., a tandem type image forming apparatus) of the present invention.

In FIG. 12, the tandem type image forming apparatus has a yellow image forming unit 25Y, a magenta image forming unit 25M, a cyan image forming unit 25C, and a black image forming unit 25K. Drum photoreceptors 16Y, 16M, 16C and 16K, which are the photoreceptor mentioned above, rotate in the direction indicated by respective arrows. Around the photoreceptors 16Y, 16M, 16C and 16K, chargers 17Y, 17M, 17C and 17K, light irradiators 18Y, 18M, 18C and 18K, developing devices 19Y, 19M, 19C and 19K, cleaners 20Y, 20M, 20C and 20K and discharging devices 27Y, 27M, 27C and 27K are arranged respectively in this order in the clockwise direction. As the chargers, the above-mentioned chargers which can uniformly charge the surfaces of the photoreceptors are preferably used. The light irradiators 18 irradiate the surfaces of the respective photoreceptors with laser light beams at points between the chargers and the image developers to form electrostatic latent images on the respective photoreceptors. The four image forming units 25 are arranged along a transfer belt 22. The transfer belt 22 contacts the respective photoreceptors 16 at image transfer points located between the respective image developers and the respective cleaners to receive color images formed on the photoreceptors. At the backsides of the image transfer points of the transfer belt 22, transfer brushes 21Y, 21M, 21C and 21K are arranged to apply a transfer bias to the transfer belt 22. The image forming units have substantially the same configuration except that the color of the toner is different from each other.

The image forming process will be explained referring to FIG. 12.

At first, in each of the image forming units 25, the photoreceptor 16 is charged with the charger 17 which rotates in the direction indicated by the arrow. Then the light irradiator 18 irradiates the photoreceptors 16 with an imagewise laser beam to form an electrostatic latent image on each photoreceptor, which typically has a resolution of not less than 1200 dpi (and preferably not less than 2400 dpi).

Then the electrostatic latent image formed on the photoreceptor is developed with the developing device 19 using a yellow, a magenta, a cyan or a black toner to form different color toner images on the respective photoreceptors. The thus prepared color toner images are transferred onto a receiving material 26, which has been fed to a pair of registration rollers 23 from a paper tray and which is timely fed to the transfer belt 22 by the registration rollers 23.

Each of the toner images on the photoreceptors is transferred onto the receiving material 26 at the contact point (i.e., the transfer position) of the photoreceptor 16 and the receiving material 26.

The toner image on each photoreceptor is transferred onto the receiving material 26 due to an electric field which is formed due to the difference between the transfer bias voltage applied to the transfer members 21Y, 21M, 21C and 21K and the potential of the respective photoreceptors 16. After passing through the four transfer positions, the receiving material 26 having the color toner images thereon is then transported to a fixer 24 so that the color toner images are fixed to the receiving material 26. Then the receiving material 26 is discharged from the main body of the image forming apparatus. Toner particles, which remain on the photoreceptors even after the transfer process, are collected by the respective cleaners 20Y, 20M, 20C and 20K.

Then the discharging devices 27 irradiate the respective photoreceptor 16 with light having a wavelength of less than 500 nm. Thus, the photoreceptors 16 are ready for the next image forming operation.

In the image forming apparatus, the image forming units 25Y, 25M, 25C and 25K are arranged in this order in the paper feeding direction, but the order is not limited thereto. In addition, when a black color image is produced, the operation of the photoreceptors 16Y, 16M and 16C other than the photoreceptor 16K may be stopped.

As mentioned above, it is preferable for the photoreceptors 16 to have a potential of not higher than 100V (i.e., −100V when the photoreceptor is negatively charged by a main charger). More preferably, the photoreceptor is charged so as to have a potential of not lower than +100V in the transferring process when the photoreceptor is negatively charged by a main charger (i.e., 100V with a polarity opposite to that of the charge formed on the photoreceptor). In this case, occurrence of the residual potential increasing problem can be well prevented.

The above-mentioned image forming unit may be fixedly set in an image forming apparatus such as copiers, facsimiles and printers. However, the image forming unit may be set therein as a process cartridge. The process cartridge means an image forming unit which includes at least the photoreceptor mentioned above and one or more of the charging device, light irradiating device, a developing device, a transferring device, a cleaning device and a discharging device.

FIG. 13 is a schematic view illustrating an embodiment of the process cartridge of the present invention. In FIG. 13, the process cartridge includes a photoreceptor 101 which is the photoreceptor mentioned above, a charger 102 configured to charge the photoreceptor 101, a light irradiating device 103 configured to irradiate the photoreceptor 101 with imagewise light to form an electrostatic latent image on the photoreceptor, a developing device including a developing sleeve 104 configured to develop the latent image with a toner, an image transfer device 106 configured to transfer the toner image onto a receiving paper 105, a cleaning device 107 configured to clean the surface of the photoreceptor 101, and a discharging device 108 including a light source emitting light with a wavelength of less than 500 nm.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Dispersion Preparation Example 1

Formula of Dispersion

| | |
|---|---|
| Azo pigment having the following formula AZO-1 | 5 parts |
| 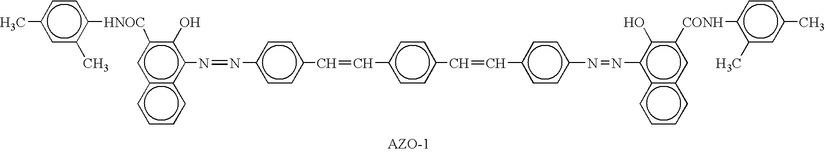 | |
| Polyvinyl butyral | 2 parts |
| (BX-1 from Sekisui Chemical Co., Ltd.) | |
| Cyclohexanone | 250 parts |
| 2-Butanone | 100 parts |

At first, the polyvinyl butyral resin was dissolved in the solvents. The solution was mixed with the azo pigment and the mixture was subjected to a dispersion treatment for 3 days using a ball mill which includes PSZ balls having a diameter of 10 mm and which is rotated at a revolution of 85 rpm. Thus, a dispersion 1 was prepared.

### Dispersion Preparation Example 2

The procedure for preparation of dispersion 1 in Dispersion Preparation Example 1 was repeated except that the azo pigment was replaced with an azo pigment having the following formula AZO-2.

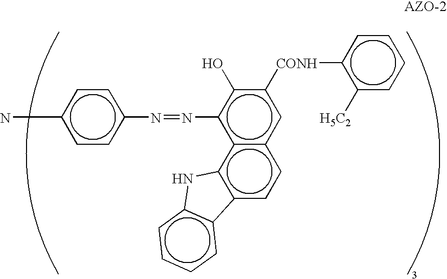

Thus, a dispersion 2 was prepared.

### Dispersion Preparation Example 3

The procedure for preparation of dispersion 2 in Dispersion Preparation Example 2 was repeated except that dispersion 2 was filtered with a cotton wind cartridge filter (TCW-3-CS from Advantech Co., Ltd.) having an effective pore diameter of 3 μm. Filtering was performed under pressure using a pump.

Thus, a dispersion 3 was prepared.

### Dispersion Preparation Example 4

The procedure for preparation of dispersion 3 in Dispersion Preparation Example 3 was repeated except that the filter was replaced with a cotton wind cartridge filter (TCW-5-CS from Advantech Co., Ltd.) having an effective pore diameter of 5 μm.

Thus, a dispersion 4 was prepared.

The particle diameter distribution of the thus prepared dispersions 1 to 4 was measured with a particle diameter measuring instrument (CAPA 700 from Horiba Ltd.). The results are shown in Table 15.

TABLE 15

| | Average particle diameter | Standard deviation of |
|---|---|---|
| Dispersion | (μm) | particle diameter (μm) |
| 1 | 0.28 | 0.18 |
| 2 | 0.24 | 0.17 |
| 3 | 0.21 | 0.15 |
| 4 | 0.25 | 0.17 |

### Photoreceptor Preparation Example 1

On an aluminum drum of JIS 1050, the following intermediate layer coating liquid, CGL coating liquid, and CTL coating liquid were coated and dried one by one. Thus, a multi-layered photoreceptor (hereinafter referred to as a photoreceptor 1) having an intermediate transfer layer having a thickness of 3.5 μm, a CGL having a thickness of 0.3 μm, and a CTL having a thickness of 25 μm was prepared.

Formula of Intermediate Layer Coating Liquid

| | | |
|---|---|---|
| Titanium oxide | 112 | parts |
| (CR-EL from Ishihara Sangyo Kaisha Ltd., | | |
| average particle diameter of 0.25 μm) | | |
| Alkyd resin | 33.6 | parts |
| (BEKKOLITE M6401-50-S from Dainippon Ink & | | |
| Chemicals, Inc., solid content of 50%) | | |
| Melamine resin | 18.7 | parts |
| (SUPER BEKKAMIN L-121-60 from Dainippon Ink & | | |
| Chemicals, Inc., solid content of 60%) | | |
| 2-Butanone | 260 | parts |

Formula of CGL Coating Liquid

Dispersion 1 prepared above was used as the CGL coating liquid.

Formula of CTL Coating Liquid

| | |
|---|---|
| Polycarbonate | 10 parts |
| (TS2050 from Teijin Chemicals Ltd.) | |
| CTM having the following formula CTM-1 | 7 parts |
| 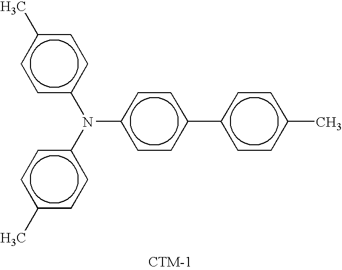 | |
| Methylene chloride | 80 parts |

Thus, a photoreceptor 1 was prepared.

### Example 1

Photoreceptor 1 prepared above was set in an image forming apparatus having a structure illustrated in FIG. 11, and a running test in which 30,000 copies of an original character image with image area proportion of 6% are continuously produced was performed under the following conditions.

Light irradiator: Irradiator having a light source including a laser diode emitting light of 655 nm, and a polygon mirror used

Charger: Scorotron charger

Transfer device: Transfer belt

Discharger: Discharging lamp including a LED (from Rohm Co., Ltd.) which emits light with a wavelength of 428 nm and a half width of 65 nm.

Potential of charged photoreceptor: −900 V

(potential of non-lighted portion)

Developing method: Nega-posi developing method

Developing bias: −650 V

Potential of non-lighted portion of photoreceptor

after discharging process: −100 V

Evaluation Method

The potentials of a lighted portion and a non-lighted portion of the photoreceptor were measured at the beginning of the running test and after the running test. Specifically, the photoreceptor was charged so as to have a potential of −900 V, and then the light irradiator irradiates the charged photoreceptor to form a solid electrostatic latent image. Then the potential of the lighted portion (V_{L}) and a non-lighted portion (V_{D}) were measured with a potential meter set in the developing position illustrated in FIG. 11.

The evaluation results are shown in Table 16.

### Example 2

The procedure for the running test and the evaluation in Example 1 was repeated except that the discharging lamp was replaced with a discharging lamp including a LED (from Seiwa Electric Mfg. Co., Ltd.) which emits light with a wavelength of 472 nm and a half width of 15 nm. In this regard, the light intensity of the discharging lamp was controlled so that the potential of the non-lighted portion of the photoreceptor after the discharging process is the same as that in Example 1.

The evaluation results are shown in Table 16.

### Comparative Example 1

The procedure for the running test and the evaluation in Example 1 was repeated except that the discharging lamp was replaced with a discharging lamp including a LED (from Seiwa Electric Mfg. Co., Ltd.) which emits light with a wavelength of 502 nm and a half width of 15 nm. In this regard, the light intensity of the discharging lamp was controlled so that the potential of the non-lighted portion of the photoreceptor after the discharging process is the same as that in Example 1.

The evaluation results are shown in Table 16.

### Comparative Example 2

The procedure for the running test and the evaluation in Example 1 was repeated except that the discharging lamp was replaced with a discharging lamp including a LED (from Seiwa Electric Mfg. Co., Ltd.) which emits light with a wavelength of 591 nm and a half width of 15 nm. In this regard, the light intensity of the discharging lamp was controlled so that the potential of the non-lighted portion of the photoreceptor after the discharging process is the same as that in Example 1.

The evaluation results are shown in Table 16.

### Comparative Example 3

The procedure for the running test and the evaluation in Example 1 was repeated except that the discharging lamp was replaced with a discharging lamp including a LED (from Rohm Co., Ltd.) which emits light with a wavelength of 630 nm and a half width of 20 nm. In this regard, the light intensity of the discharging lamp was controlled so that the potential of the non-lighted portion of the photoreceptor after the discharging process is the same as that in Example 1.

The evaluation results are shown in Table 16.

### Comparative Example 4

The procedure for the running test and the evaluation in Example 1 was repeated except that the discharging lamp was replaced with a fluorescent lamp which emits light having a spectrum as illustrated in FIG. 1. In this regard, the light intensity of the discharging lamp was controlled so that the potential of the non-lighted portion of the photoreceptor after the discharging process is the same as that in Example 1.

The evaluation results are shown in Table 16.

### Comparative Example 5

The procedure for the running test and the evaluation in Example 1 was repeated except that the discharging lamp was replaced with a discharging lamp including a combination of a LED (from Rohm Co., Ltd.) which emits light with a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the non-lighted portion of the photoreceptor after the discharging process is the same as that in Example 1.

The evaluation results are shown in Table 16.

TABLE 16

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 1 | 428 | 86 | 900 | 120 | 900 | 130 |
| Ex. 2 | 472 | 87 | 900 | 120 | 900 | 140 |
| Comp. Ex. 1 | 502 | 87 | 900 | 120 | 900 | 170 |
| Comp. Ex. 2 | 591 | 88 | 900 | 120 | 900 | 175 |
| Comp. Ex. 3 | 630 | 89 | 900 | 120 | 900 | 180 |
| Comp. Ex. 4 | White | — | 900 | 120 | 900 | 165 |
| | light | | | | | |
| Comp. Ex. 5 | 428, | 86, | 900 | 120 | 900 | 170 |
| | 630 | 89 | | | | |

λ: The wavelength of the discharging light emitted by the discharging lamp.
T: Transmittance of the CTL against the discharging light.
V_{D}: Potential of non-lighted portion.
V_{L}: Potential of lighted portion.

It is clear from Table 16 that when the wavelength of the discharging light is less than 500 nm (Examples 1 and 2), increase in potential (V_{L}) of the lighted portion is lower than that in the cases where the wavelength of the discharging light is not less than 500 nm (Comparative Examples 1-3). In particular, when the wavelength of the discharging light is less than 450 nm (i.e., Example 1), increase in potential (V_{L}) of the lighted portion is lower than that in the case where the wavelength of the discharging light is from 450 nm to 500 nm (i.e., Example 2).

In addition, it is also found that when discharging light having a wide wavelength range and including light with a relatively long wavelength is used (i.e., Comparative Example 4), such an effect as produced in Examples 1 and 2 cannot be produced. Further, it is found that when a combination of two light sources emitting light with different wavelengths is used (Comparative Example 5), the effect of the light with a relatively short wavelength is reduced.

### Photoreceptor Preparation Example 2

The procedure for preparation of photoreceptor 1 in Photoreceptor Preparation Example 1 was repeated except that dispersion 1 used as the CGL coating liquid was replaced with dispersion 2.

Thus, photoreceptor 2 was prepared.

### Example 3

The procedure for the running test and the evaluation in Example 1 was repeated except that photoreceptor 1 was replaced with photoreceptor 2 and the laser diode used for the light irradiator was replaced with a laser diode emitting light with a wavelength of 780 nm.

The evaluation results are shown in Table 17.

### Example 4

The procedure for the running test and the evaluation in Example 2 was repeated except that photoreceptor 1 was replaced with photoreceptor 2 and the laser diode used for the light irradiator was replaced with a laser diode emitting light with a wavelength of 780 nm.

The evaluation results are shown in Table 17.

### Comparative Example 6

The procedure for the running test and the evaluation in Comparative Example 1 was repeated except that photoreceptor 1 was replaced with photoreceptor 2 and the laser diode used for the light irradiator was replaced with a laser diode emitting light with a wavelength of 780 nm.

The evaluation results are shown in Table 17.

### Comparative Example 7

The procedure for the running test and the evaluation in Comparative Example 2 was repeated except that photoreceptor 1 was replaced with photoreceptor 2 and the laser diode used for the light irradiator was replaced with a laser diode emitting light with a wavelength of 780 nm.

The evaluation results are shown in Table 17.

### Comparative Example 8

The procedure for the running test and the evaluation in Comparative Example 3 was repeated except that photoreceptor 1 was replaced with photoreceptor 2 and the laser diode used for the light irradiator was replaced with a laser diode emitting light with a wavelength of 780 nm.

The evaluation results are shown in Table 17.

### Comparative Example 9

The procedure for the running test and the evaluation in Comparative Example 4 was repeated except that photoreceptor 1 was replaced with photoreceptor 2 and the laser diode used for the light irradiator was replaced with a laser diode emitting light with a wavelength of 780 nm.

The evaluation results are shown in Table 17.

TABLE 17

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 3 | 428 | 86 | 900 | 140 | 900 | 145 |
| Ex. 4 | 472 | 87 | 900 | 140 | 900 | 150 |
| Comp. Ex. 6 | 502 | 87 | 900 | 140 | 900 | 175 |
| Comp. Ex. 7 | 591 | 88 | 900 | 140 | 900 | 180 |
| Comp. Ex. 8 | 630 | 89 | 900 | 140 | 900 | 190 |
| Comp. Ex. 9 | White | — | 900 | 140 | 900 | 170 |
| | light | | | | | |

It is clear from Table 17 that when the wavelength of the discharging light is less than 500 nm (Examples 3 and 4), increase in potential (V_{L}) of the lighted portion is lower than that in the other cases where the wavelength of the discharging light is not less than 500 nm (Comparative Examples 6 to 8). In particular, when the wavelength of the discharging light is less than 450 nm (i.e., Example 3), increase in potential (V_{L}) of the lighted portion is lower than that in the case where the wavelength of the discharging light is from 450 nm to 500 nm (i.e., Example 4).

In addition, it is also found that when discharging light having a wide wavelength range and including light with a relatively long wavelength is used (i.e., Comparative Example 9), such an effect as produced in Examples 3 and 4 cannot be produced.

### Example 5

The procedure for the running test and the evaluation in Example 1 was repeated except that the laser diode used for the light irradiator was replaced with a laser diode emitting light with a wavelength of 408 nm, and a dot image constituted of one-dot images with a diameter of 60 μm was produced and observed with a microscope of 150 power magnification.

The evaluation results are shown in Table 18.

TABLE 18

| | | | At beginning of | | After | |
|---|---|---|---|---|---|---|
| | λ | T | running test | | running test | |
| | (%) | (%) | V_{D} (−V) | V_{L} (−V) | V_{D} (−V) | V_{L} (−V) |
| Ex. 1 | 428 | 86 | 900 | 140 | 900 | 130 |
| Ex. 5 | 428 | 86 | 900 | 140 | 900 | 125 |

The outline of the one-dot image produced in Example 5 is clearer than that of the one-dot image produced in Example 1.

It is clear from Table 18 that increase in potential (V_{L}) of the lighted portion after the running test in Example 5 (using a laser diode emitting light with a relatively short wavelength of 408 nm) is lower than that in Example 1.

### Photoreceptor Preparation Example 3

The procedure for preparation of photoreceptor 1 in Photoreceptor Preparation Example 1 was repeated except that the CTL coating liquid was replaced with a CTL coating liquid having the following formula.

Formula of CTL Coating Liquid

| | |
|---|---|
| Polycarbonate | 10 parts |
| (TS2050 from Teijin Chemicals Ltd.) | |
| CTM having the following formula CTM-2 | 7 parts |
| 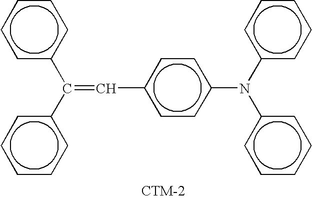 | |
| Methylene chloride | 80 parts |

Thus, a photoreceptor 3 was prepared.

### Example 6

The procedure for the running test and the evaluation in Example 1 was repeated except that photoreceptor 1 was replaced with photoreceptor 3, and the discharger was replaced with a discharger including a xenon lamp; a monochrometor configured to emit slit light with a wavelength of 461 nm from the light emitted by the xenon lamp; and an optical fiber configured to lead the slit homogenous light to irradiate the photoreceptor with the light.

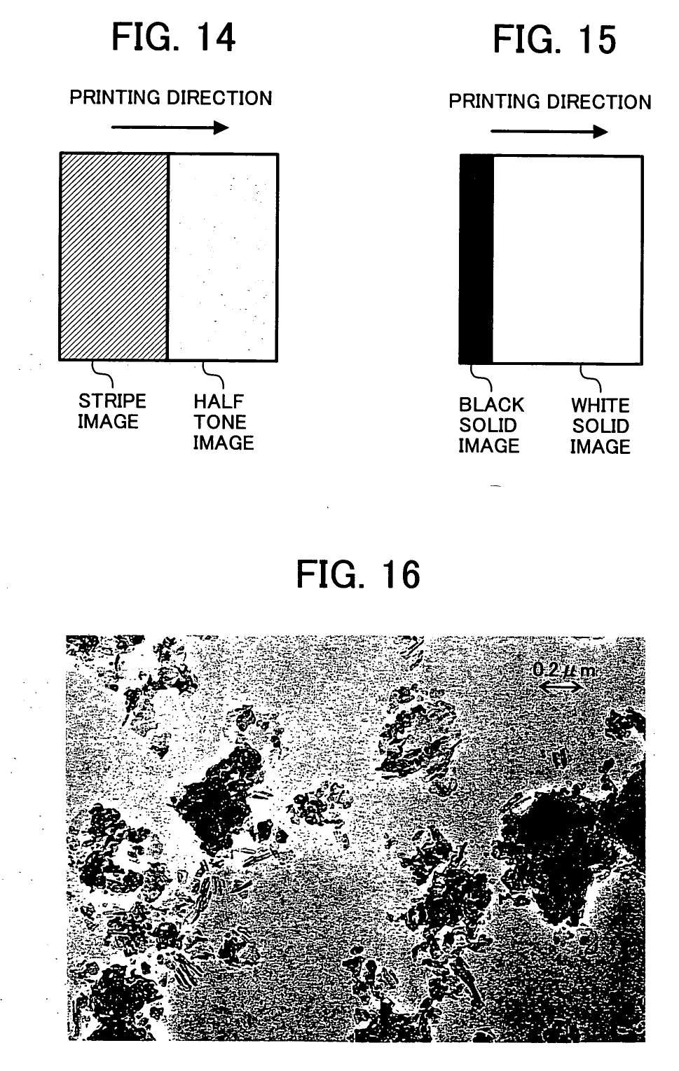

In addition, after the running test, a copy of an original image illustrated in FIG. 14, which includes a stripe image located on an upper portion of the original image and a half tone image located on a lower portion of the original image, was produced and observed to determine whether the half tone image is uniform.

The evaluation results are shown in Table 19.

### Example 7

The procedure for the running test and the evaluation in Example 6 was repeated except that the homogenous light used as the discharging light was changed to homogeneous light with a wavelength of 443 nm by changing the conditions of the monochrometor.

The evaluation results are shown in Table 19.

### Example 8

The procedure for the running test and the evaluation in Example 6 was repeated except that the homogenous light used as the discharging light was changed to homogeneous light with a wavelength of 437 nm by changing the conditions of the monochrometor.

The evaluation results are shown in Table 19.

### Example 9

The procedure for the running test and the evaluation in Example 6 was repeated except that the homogenous light used as the discharging light was changed to homogeneous light with a wavelength of 433 nm by changing the conditions of the monochrometor.

The evaluation results are shown in Table 19.

### Example 10

The procedure for the running test and the evaluation in Example 6 was repeated except that the homogenous light used as the discharging light was changed to homogeneous light with a wavelength of 429 nm by changing the conditions of the monochrometor.

The evaluation results are shown in Table 19.

TABLE 19

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 6 | 461 | 85 | 900 | 130 | 900 | 135 |
| Ex. 7 | 443 | 69 | 900 | 130 | 900 | 135 |
| Ex. 8 | 437 | 49 | 900 | 130 | 900 | 135 |
| Ex. 9 | 433 | 29 | 900 | 130 | 900 | 145 |
| Ex. 10 | 429 | 9 | 900 | 130 | 900 | 145 |

It is clear from Table 19 that when the transmittance of the CTL against the discharging light is less than about 30%, the discharging effect slightly deteriorates.

In addition, it is found that the half tone images produced in Examples 6 to 8 are normal but the half tone images produced in Examples 9 and 10 includes a slight ghost image of the stripe image although the quality of the half tone images is still acceptable. The ghost image in the image produced in Example 10 is relatively noticeable compared to that in Example 9.

Thus, it is discovered that even when light with a wavelength of less than 500 nm is used as the discharging light, a minor side effect is produced if the transmittance of the CTL against the light is less than 30%.

### Photoreceptor Preparation Example 4

The procedure for preparation of photoreceptor 1 in Photoreceptor Preparation Example 1 was repeated except that dispersion 1 used as the CGL coating liquid was replaced with dispersion 3.

Thus, a photoreceptor 4 was prepared.

### Photoreceptor Preparation Example 5

The procedure for preparation of photoreceptor 1 in Photoreceptor Preparation Example 1 was repeated except that dispersion 1 used as the CGL coating liquid was replaced with dispersion 4.

Thus, a photoreceptor 5 was prepared.

### Example 11

The procedure for the running test and the evaluation in Example 1 was repeated except that photoreceptor 1 was replaced with photoreceptor 4.

In addition, after the running test, a copy of a white solid image was produced and observed to determine whether the white solid image has background fouling (i.e., whether the white solid image is soiled with toner particles).

The evaluation results are shown in Table 20.

### Example 12

The procedure for the running test and the evaluation in Example 11 was repeated except that photoreceptor 4 was replaced with photoreceptor 5.

The evaluation results are shown in Table 20.

TABLE 20

| | At beginning of | | | | |
|---|---|---|---|---|---|
| | running test | | After running test | | Background |
| | V_{D} (−V) | V_{L} (−V) | V_{D} (−V) | V_{L} (−V) | fouling |
| Ex. 1 | 900 | 120 | 900 | 130 | Δ-◯ |
| Ex. 11 | 900 | 115 | 900 | 120 | ⊚ |
| Ex. 12 | 900 | 115 | 900 | 125 | ◯ |

The level of background fouling is classified into the following four grades while considering the number and size of black spots formed on the white solid image.

⊚: Excellent

◯: Good

Δ: Acceptable

X: Bad

It is clear from Table 20 that when the average particle diameter of the CGM dispersed in the CGL coating liquid is less than 0.25 μm (Examples 11 and 12), the initial potential of a lighted portion (V_{L}) can be reduced and in addition occurrence of background fouling can be prevented without increasing the potential of a lighted portion even after long repeated use.

### Photoreceptor Preparation Example 6

The procedure for preparation of photoreceptor 1 in Photoreceptor Preparation Example 1 was repeated except that the CTL coating liquid was replaced with a CTL coating liquid having the following formula.

Formula of CTL Coating Liquid

| | |
|---|---|
| Charge transport polymer | 10 parts |
| having the following formula CTM-3 | |
| (weight average molecular weight of about 140,000) | |
| 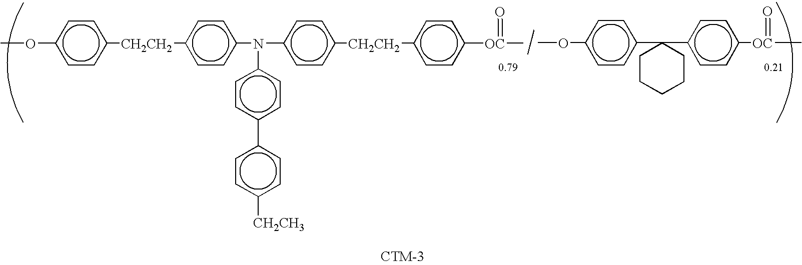 | |
| Additive having the following formula A-1 | 0.5 parts |
| 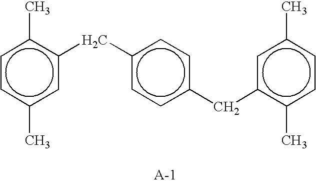 | |
| Methylene chloride | 100 parts |

Thus, a photoreceptor 6 was prepared.

### Photoreceptor Preparation Example 7

The procedure for preparation of photoreceptor 1 in Photoreceptor Preparation Example 1 was repeated except that the thickness of the CTL was changed to 22 μm and a protective layer having a thickness of 3 μm was formed on the CTL by coating and drying a protective layer coating liquid having the following formula.

Formula of Protective Layer Coating Liquid

| | | |
|---|---|---|
| Polycarbonate | 10 | parts |
| (TS2050 from Teijin Chemicals Ltd.) | | |
| CTM having formula CTM-1 mentioned above | 7 | parts |
| Particulate alumina | 4 | parts |
| (resistivity of 2.5 × 10¹² Ω · cm, | | |
| average primary particle diameter of 0.4 μm) | | |
| Cyclohexanone | 500 | parts |
| Tetrahydrofuran | 150 | parts |

Thus, a photoreceptor 7 was prepared.

### Photoreceptor Preparation Example 8

The procedure for preparation of photoreceptor 7 in Photoreceptor Preparation Example 7 was repeated except that the particulate alumina was replaced with 4 parts of a particulate titanium oxide having a resistivity of 1.5×10¹⁰ Ω·cm, and an average primary particle diameter of 0.5 μm.

Thus, a photoreceptor 8 was prepared.

### Photoreceptor Preparation Example 9

The procedure for preparation of photoreceptor 7 in Photoreceptor Preparation Example 7 was repeated except that the particulate alumina was replaced with 4 parts of a particulate tin oxide—antimony oxide having a resistivity of 1×10⁶ Ω·cm, and an average primary particle diameter of 0.4 μm.

Thus, a photoreceptor 9 was prepared.

### Photoreceptor Preparation Example 10

The procedure for preparation of photoreceptor 7 in Photoreceptor Preparation Example 7 was repeated except that the protective layer coating liquid was replaced with a protective layer coating liquid having the following formula.

Formula of CTL Coating Liquid

| | | |
|---|---|---|
| Charge transport polymer | 17 | parts |
| having formula CTM-3 mentioned above | | |
| (weight average molecular weight of about 140,000) | | |
| Particulate alumina | 4 | parts |
| (resistivity of 2.5 × 10¹² Ω · cm, average | | |
| primary particle diameter of 0.4 μm) | | |
| Cyclohexanone | 500 | parts |
| Tetrahydrofuran | 150 | parts |

Thus, a photoreceptor 10 was prepared.

### Photoreceptor Preparation Example 11

The procedure for preparation of photoreceptor 7 in Photoreceptor Preparation Example 7 was repeated except that the protective layer coating liquid was replaced with a protective layer coating liquid having the following formula.

Formula of CTL Coating Liquid

| | |
|---|---|
| Methyltrimethoxysilane | 100 parts |
| 3% acetic acid | 20 parts |
| CTM having the following formula CTM-4 | 35 parts |
| 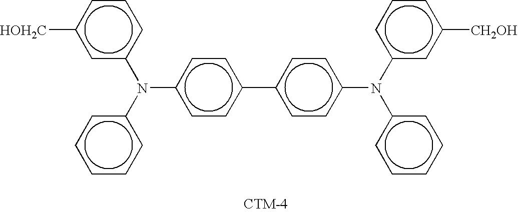 | |
| Antioxidant | 1 part |
| (SANOL LS2626 from Sankyo Lifetech Co., Ltd.) | |
| Crosslinking agent | 1 part |
| (dibutyltin acetate) | |
| 2-Propanol | 200 parts |

Thus, a photoreceptor 11 was prepared.

### Photoreceptor Preparation Example 12

The procedure for preparation of photoreceptor 7 in Photoreceptor Preparation Example 7 was repeated except that the protective layer coating liquid was replaced with a protective layer coating liquid having the following formula.

Formula of CTL Coating Liquid

| | | |
|---|---|---|
| Methyltrimethoxysilane | 100 | parts |
| 3% acetic acid | 20 | parts |
| CTM having formula CTM-4 mentioned above | 35 | parts |
| Particulate alumina | 15 | parts |
| (resistivity of 2.5 × 10¹² Ω · cm, | | |
| average primary particle diameter of 0.4 μm) | | |
| Antioxidant | 1 | part |
| (SANOL LS2626 from Sankyo Lifetech Co., Ltd.) | | |
| Polycarboxylic acid | 0.4 | parts |
| (BYK P104 from Byk Chemie) | | |
| Crosslinking agent | 1 | part |
| (dibutyltin acetate) | | |
| 2-Propanol | 200 | parts |

Thus, a photoreceptor 12 was prepared.

### Photoreceptor Preparation Example 13

The procedure for preparation of photoreceptor 7 in Photoreceptor Preparation Example 7 was repeated except that the protective layer coating liquid was replaced with a protective layer coating liquid having the following formula.

Formula of CTL Coating Liquid

| | |
|---|---|
| Tri- or more-functional radical polymerizable monomer | 10 parts |
| having no charge transport structure | |
| (trimethylol propane triacrylate, KAYARAD TMPTA | |
| fro Nippon Kayaku Co., Ltd., | |
| having a molecular weight (M) of 296, three | |
| functional groups (F) and ratio (M/F) of 99) | |
| Monofunctional radical polymerizable monomer having | 10 parts |
| charge transport structure and the following formula M-1 | |
| (i.e., compound No. 54 mentioned above) | |
| 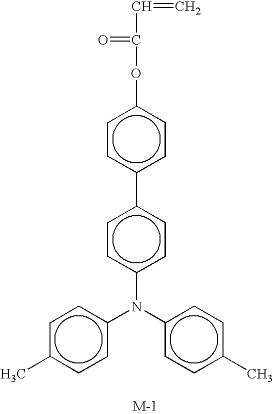 | |
| Photopolymerization initiator | 1 part |
| (1-hydroxycycolhexyl-phenyl-ketone, | |
| IRGACURE 184 from Ciba Specialty Chemicals) | |
| Tetrahydrofuran | 100 parts |

The protective layer coating liquid was coated by a spray coating method and the coated liquid was naturally dried for 20 minutes. Then the coated layer was subjected to a photo-crosslinking treatment using a metal halide lamp with a power of 160 W/cm to be crosslinked. The crosslinking conditions are as follows.

Light intensity: 500 mW/cm²

Irradiation time: 60 seconds

Thus, a photoreceptor 13 was prepared.

### Photoreceptor Preparation Example 14

The procedure for preparation of photoreceptor 13 in Photoreceptor Preparation Example 13 was repeated except that the tri- or more-functional radical polymerizable monomer was replaced with 10 parts of a tetrafunctional radical polymerizable monomer having no charge transport structure, pentaerythritol tetraacrylate (SR-295 from Sartomer Company Inc., having molecular weight (M) of 352, four functional groups (F) and ratio (M/F) of 88).

Thus, a photoreceptor 14 was prepared.

### Photoreceptor Preparation Example 15

The procedure for preparation of photoreceptor 13 in Photoreceptor Preparation Example 13 was repeated except that the tri- or more-functional polymerizable monomer was replaced with 10 parts of a difunctional radical polymerizable monomer having no charge transport structure, 1,6-hexanediol diacrylate (Wako Pure Chemical Industries Ltd., having molecular weight (M) of 226, two functional groups (F) and ratio (M/F) of 113).

Thus, a photoreceptor 15 was prepared.

### Photoreceptor Preparation Example 16

The procedure for preparation of photoreceptor 13 in Photoreceptor Preparation Example 13 was repeated except that the tri- or more-functional polymerizable monomer was replaced with 10 parts of a hexafunctional radical polymerizable monomer having no charge transport structure, caprolactone-modified dipentaerythritol hexaacrylate (KAYARAD DPCA-120 from Nippon Kayaku Co., Ltd., having molecular weight (M) of 1946, six functional groups (F) and ratio (M/F) of 325).

Thus, a photoreceptor 16 was prepared.

### Photoreceptor Preparation Example 17

The procedure for preparation of photoreceptor 13 in Photoreceptor Preparation Example 13 was repeated except that the monofunctional polymerizable monomer having a charge transport structure was replaced with 10 parts of a difunctional radical polymerizable monomer having a charge transport structure, which has the following formula M-2.

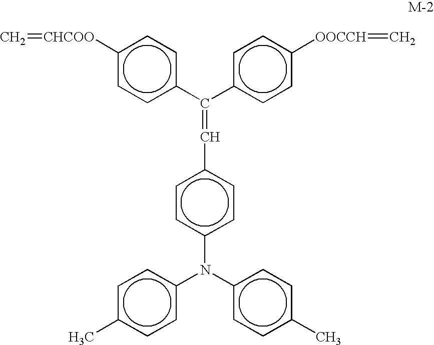

Thus, a photoreceptor 17 was prepared.

### Photoreceptor Preparation Example 18

The procedure for preparation of photoreceptor 13 in Photoreceptor Preparation Example 13 was repeated except that the protective layer coating liquid was replaced with a protective layer coating liquid having the following formula.

Formula of Protective Layer Coating Liquid

| | | |
|---|---|---|
| Tri- or more-functional radical polymerizable monomer | 6 | parts |
| having no charge transport structure | | |
| (trimethylol propane triacrylate, KAYARAD TMPTA | | |
| fro Nippon Kayaku Co., Ltd., having a molecular | | |
| weight (M) of 296, three functional groups (F) and | | |
| ratio (M/F) of 99) | | |
| Monofunctional radical polymerizable monomer having | 14 | parts |
| charge transport structure (M-1, i.e., compound No. | | |
| 54 mentioned above) | | |
| Photopolymerization initiator | 1 | part |
| (1-hydroxylcycolhexyl-phenyl-ketone, IRGACURE 184 | | |
| from Ciba Specialty Chemicals) | | |
| Tetrahydrofuran | 100 | parts |

Thus, a photoreceptor 18 was prepared.

### Photoreceptor Preparation Example 19

The procedure for preparation of photoreceptor 13 in Photoreceptor Preparation Example 13 was repeated except that the protective layer coating liquid was replaced with a protective layer coating liquid having the following formula.

Formula of Protective Layer Coating Liquid

| | | |
|---|---|---|
| Tri- or more-functional radical polymerizable monomer | 14 | parts |
| having no charge transport structure | | |
| (trimethylol propane triacrylate, KAYARAD TMPTA | | |
| fro Nippon Kayaku Co., Ltd., having a molecular | | |
| weight (M) of 296, three functional groups (F) and | | |
| ratio (M/F) of 99) | | |
| Monofunctional radical polymerizable monomer having | 6 | parts |
| charge transport structure (M-1, i.e., compound No. 54 | | |
| mentioned above) | | |
| Photopolymerization initiator | 1 | part |
| (1-hydroxylcycolhexyl-phenyl-ketone, IRGACURE 184 | | |
| from Ciba Specialty Chemicals) | | |
| Tetrahydrofuran | 100 | parts |

Thus, a photoreceptor 19 was prepared.

### Photoreceptor Preparation Example 20

The procedure for preparation of photoreceptor 13 in Photoreceptor Preparation Example 13 was repeated except that the protective layer coating liquid was replaced with a protective layer coating liquid having the following formula.

Formula of Protective Layer Coating Liquid

| | | |
|---|---|---|
| Tri- or more-functional radical polymerizable monomer | 2 | parts |
| having no charge transport structure | | |
| (trimethylol propane triacrylate, KAYARAD TMPTA | | |
| fro Nippon Kayaku Co., Ltd., having a molecular | | |
| weight (M) of 296, three functional groups (F) and | | |
| ratio (M/F) of 99) | | |
| Monofunctional radical polymerizable monomer having | 8 | parts |
| charge transport structure (M-1, i.e., compound No. 54 | | |
| mentioned above) | | |
| Photopolymerization initiator | 1 | part |
| (1-hydroxyl-cycolhexyl-phenyl-ketone, IRGACURE 184 | | |
| from Ciba Specialty Chemicals) | | |
| Tetrahydrofuran | 100 | parts |

Thus, a photoreceptor 20 was prepared.

### Photoreceptor Preparation Example 21

The procedure for preparation of photoreceptor 13 in Photoreceptor Preparation Example 13 was repeated except that the protective layer coating liquid was replaced with a protective layer coating liquid having the following formula.

Formula of Protective Layer Coating Liquid

| | | |
|---|---|---|
| Tri- or more-functional radical polymerizable monomer | 18 | parts |
| having no charge transport structure | | |
| (trimethylol propane triacrylate, KAYARAD TMPTA | | |
| fro Nippon Kayaku Co., Ltd., having a molecular | | |
| weight (M) of 296, three functional groups (F) and | | |
| ratio (M/F) of 99) | | |
| Monofunctional radical polymerizable monomer having | 2 | parts |
| charge transport structure (M-1, i.e., compound No. 54 | | |
| mentioned above) | | |
| Photopolymerization initiator | 1 | part |
| (1-hydroxyl-cycolhexyl-phenyl-ketone, IRGACURE 184 | | |
| from Ciba Specialty Chemicals) | | |
| Tetrahydrofuran | 100 | parts |

Thus, a photoreceptor 21 was prepared.

### Example 13

The procedure for the running test in Example 2 was repeated except that 50,000 copies of the original character image were produced. The evaluation items and methods are as follows.

(1) Potential (V_{L}) of Photoreceptor

The potential (V_{L}) of a lighted portion of the photoreceptor was measured at the beginning of the running test and after the running test. The measuring method is the same as that performed in Example 1.

(2) Background Fouling (BF)

After the running test, a white solid image was produced under an environmental condition of 22° C. and 50% RH and observed to determine whether the white solid image has background fouling. The quality is classified into the following four grades.

⊚: Excellent

◯: Good

Δ: Acceptable

X: Bad

(3) Cleanability of Photoreceptor (CL)

After the evaluation of background fouling, 50 copies of an original image illustrated in FIG. 15 were produced under an environmental condition of 10° C. and 15% RH and the white solid image portion of the 50^{th} image was visually observed to evaluate the cleanability of the photoreceptor. The cleanability of the photoreceptor is classified into the following four grades.

⊚: Excellent (no streak image was observed in the white solid image)

◯: Good (one or two slight black streaks were observed in the white solid image)

Δ: Acceptable (three or four slight black streaks were observed in the white solid image)

X: Bad (clear black streaks were observed in the white solid image)

(4) Dot Reproducibility (DOT)

After the evaluation of cleanability, 1,000 copies of the original character image were produced a high temperature and high humidity condition of 30° C. and 90% RH and then an image including one dot images was produced. The one dot images were observed with a microscope with 150 power magnification whether the outline of the one dot images is clear. The dot reproducibility of the photoreceptor is classified into the following four grades.

⊚: Excellent

◯: Good

Δ: Acceptable

X: Bad

(5) Abrasion Loss

The thickness of the photosensitive layer (including the protective layer and the intermediate layer) of each photoreceptor before the running test and after the tests mentioned above in (1) to (4) was measured to determine the thickness difference, i.e., the abrasion loss of the photoreceptor. The thickness of several points of the photoreceptor in the longitudinal direction thereof was measured at intervals of 1 cm except for both the edge portions having a width of 5 cm, and the thickness data were averaged.

The evaluation results are shown in Table 21.

### Examples 14 to 29

The procedure for evaluation in Example 13 was repeated except that photoreceptor 1 was replaced with each of photoreceptors 6 to 21.

The evaluation results are shown in Table 21.

TABLE 21

| | | | V_{L} (−V) | | | | | |
|---|---|---|---|---|---|---|---|---|
| | | | | After | | | | |
| | | T | Initial | 50,000 | | | | Abrasion Loss |
| | No. | (%) | potential | copies | BF | CL | DOT | (μm) |
| Ex. 13 | 1 | 87 | 120 | 140 | Δ | ◯ | ⊚ | 7.0 |
| Ex. 14 | 6 | 85 | 120 | 140 | Δ-◯ | ◯-⊚ | ⊚ | 4.0 |
| Ex. 15 | 7 | 80 | 125 | 150 | ⊚ | Δ-◯ | ◯-⊚ | 2.0 |
| Ex. 16 | 8 | 78 | 130 | 155 | ⊚ | Δ-◯ | ◯ | 1.8 |
| Ex. 17 | 9 | 80 | 120 | 145 | ◯ | Δ-◯ | Δ-◯ | 2.0 |
| Ex. 18 | 10 | 77 | 130 | 150 | ⊚ | Δ-◯ | ◯ | 1.6 |
| Ex. 19 | 11 | 85 | 130 | 150 | ◯-⊚ | ◯ | ◯ | 2.5 |
| Ex. 20 | 12 | 81 | 135 | 155 | ⊚ | Δ-◯ | Δ-◯ | 1.6 |
| Ex. 21 | 13 | 85 | 130 | 150 | ⊚ | ⊚ | ⊚ | 1.4 |
| Ex. 22 | 14 | 85 | 130 | 150 | ◯ | ⊚ | ⊚ | 1.2 |
| Ex. 23 | 15 | 85 | 130 | 150 | ⊚ | Δ-◯ | ⊚ | 2.6 |
| Ex. 24 | 16 | 85 | 130 | 150 | ⊚ | ⊚ | ⊚ | 1.4 |
| Ex. 25 | 17 | 83 | 130 | 155 | ⊚ | Δ-◯ | ⊚ | 1.2 |
| Ex. 26 | 18 | 84 | 125 | 145 | ◯-⊚ | ⊚ | ⊚ | 1.6 |
| Ex. 27 | 19 | 84 | 135 | 155 | ⊚ | ⊚ | ⊚ | 1.4 |
| Ex. 28 | 20 | 80 | 120 | 140 | ◯-⊚ | ⊚ | ⊚ | 1.8 |
| Ex. 29 | 21 | 85 | 140 | 155 | ⊚ | ⊚ | ⊚ | 1.4 |

No.: Number of photoreceptor used
T: Transmittance of protective layer or CTL against the discharging light

It is clear from Table 21 that even when a protective layer is formed, the following knowledge can be obtained.

(1) The residual potential increasing problem can be avoided if light with a wavelength less than 500 nm is used as the discharging light;

(2) The photoreceptor (Example 14) including a charge transport polymer in the CTL has better abrasion resistance than the photoreceptor (Example 13) including a low molecular weight CTM in the CTL;

(3) The photoreceptors (Examples 15-29) including a protective layer have better abrasion resistance than the photoreceptor (Examples 13 and 14) including no protective layer;

(4) Among the photoreceptors having a protective layer including a particulate inorganic material (Examples 15-17), the photoreceptors (Examples 15 and 16) having a protective layer including a particulate inorganic material having a resistivity not less than 10¹⁰ Ω·cm have good dot reproducibility even under high temperature and high humidity conditions;

(5) The photoreceptors having a crosslinked protective layer have better abrasion resistance than the photoreceptor having a non-crosslinked protective layer, in particular, the photoreceptors (Examples 21, 22, 24, and 26-29) having a crosslinked protective layer which is prepared using a tri- or more-functional monomer having no charge transport structure and a monofunctional monomer having a charge transport structure have excellent abrasion resistance; and

(6) the photoreceptors (Examples 21, 22, 24, and 26-29) also have excellent cleanability.

### Comparative Example 10

The procedure for the running test and the evaluation of the images in Example 21 was repeated except that the laser diode was replaced with a laser diode (from Seiwa Electric Mfg. Co., Ltd.) emitting light with a wavelength of 502 nm and a half width of 15 nm. The light intensity was controlled so that the initial potential (V_{L}) of a lighted portion is the same as that in Example 21.

The evaluation results are shown in Table 22.

### Comparative Example 11

The procedure for the running test and the evaluation of the images in Example 21 was repeated except that the laser diode was replaced with a laser diode (from Rohm Co., Ltd.) emitting light with a wavelength of 591 nm and a half width of 15 nm. The light intensity was controlled so that the initial potential (V_{L}) of a lighted portion is the same as that in Example 21.

The evaluation results are shown in Table 22.

### Comparative Example 12

The procedure for the running test and the evaluation of the images in Example 21 was repeated except that the laser diode was replaced with a laser diode (from Rohm Co., Ltd.) emitting light with a wavelength of 630 nm and a half width of 20 nm. The light intensity was controlled so that the initial potential (V_{L}) of a lighted portion is the same as that in Example 21.

The evaluation results are shown in Table 22.

### Comparative Example 13

The procedure for the running test and the evaluation of the images in Example 21 was repeated except that the laser diode was replaced with a fluorescent lamp emitting light having a spectrum illustrated in FIG. 1. The light intensity was controlled so that the initial potential (V_{L}) of a lighted portion is the same as that in Example 21.

The evaluation results are shown in Table 22.

TABLE 22

| | | Transmittance | Potential of | |
|---|---|---|---|---|
| | | (T) of | lighted portion (V_{L}) | |
| | Wavelength | protective layer | (−V) | |
| | (λ) of | against | At beginning | After |
| | discharging | discharging | of | running |
| | light (nm) | light | running test | test |
| Ex. 21 | 472 | 85 | 130 | 150 |
| Comp. Ex. 10 | 502 | 85 | 130 | 180 |
| Comp. Ex. 11 | 591 | 89 | 130 | 185 |
| Comp. Ex. 12 | 630 | 90 | 130 | 190 |
| Comp. Ex. 13 | White light | — | 130 | 175 |

It is clear from Table 22 that when the wavelength of the discharging light is less than 500 nm (Example 21), increase in the potential (V_{L}) is smaller than in Comparative Examples 10-12 using discharging light with a wavelength of not less than 500 nm. In addition, when the discharging light has light including components with a relatively long wavelength of not less than 500 nm (Comparative Example 13), the effect as produced in Example 21 cannot be produced.

### Example 30

The procedure for the running test and evaluation in Example 6 was repeated except that photoreceptor 3 was replaced with photoreceptor 13; 50,000 copies were produced in the running test; and the homogeneous discharging light, which was obtained from the light emitted by the xenon lamp using the monochrometer, has a wavelength of 450 nm.

The evaluation results are shown in Table 23.

### Example 31

The procedure for the running test and the evaluation in Example 30 was repeated except that the homogenous light used as the discharging light was changed to homogeneous light with a wavelength of 400 nm by changing the conditions of the monochrometor.

The evaluation results are shown in Table 23.

### Example 32

The procedure for the running test and the evaluation in Example 30 was repeated except that the homogenous light used as the discharging light was changed to homogeneous light with a wavelength of 393 nm by changing the conditions of the monochrometor.

The evaluation results are shown in Table 23.

### Example 33

The procedure for the running test and the evaluation in Example 30 was repeated except that the homogenous light used as the discharging light was changed to homogeneous light with a wavelength of 390 nm by changing the conditions of the monochrometor.

The evaluation results are shown in Table 23.

### Example 34

The procedure for the running test and the evaluation in Example 30 was repeated except that the homogenous light used as the discharging light was changed to homogeneous light with a wavelength of 385 nm by changing the conditions of the monochrometor.

The evaluation results are shown in Table 23.

TABLE 23

| | | Transmittance | | |
|---|---|---|---|---|
| | | (T) of | Potential of | |
| | Wavelength | protective layer | lighted portion (V_{L}) | |
| | (λ) of | against | (−V) | |
| | discharging | discharging | At beginning of | After running |
| | light (nm) | light | running test | test |
| Ex. 30 | 450 | 85 | 130 | 150 |
| Ex. 31 | 400 | 73 | 130 | 150 |
| Ex. 32 | 393 | 50 | 130 | 150 |
| Ex. 33 | 390 | 29 | 130 | 155 |
| Ex. 34 | 385 | 9 | 130 | 155 |

It is clear from Table 23 that when the transmittance of the protective layer against the discharging light is less than about 30%, the discharging effect slightly deteriorates.

In addition, it is found that the half tone images produced in Examples 30 to 32 are normal but the half tone images produced in Examples 33 and 34 include a slight ghost image of the stripe image formed on an upper portion of each copy although the quality of the half tone images is still acceptable. The ghost image in the image produced in Example 34 is relatively noticeable compared to that in Example 33.

Thus, it is discovered that even when light with a wavelength of less than 500 nm is used as the discharging light, a minor side effect is produced if the transmittance of the protective layer against the light is less than 30%.

### Photoreceptor Preparation Example 22

The procedure for preparation of photoreceptor 1 in Photoreceptor Preparation Example 1 was repeated except that the intermediate layer was replaced with a combination of a charge blocking layer with a thickness of 1.0 μm and a moiré preventing layer with a thickness of 3.5 μm located on the charge blocking layer, which were formed by coating the respective coating liquids having the following formulae, followed by drying.

Formula of Charge Blocking Layer Coating Liquid

| | |
|---|---|
| N-methoxymethylated nylon | 4 parts |
| (FINE RESIN FR-101 from Namariichi Co., Ltd.) | |
| Methanol | 70 parts |
| n-Butanol | 30 parts |

Formula of Moiré Preventing Layer Coating Liquid

| | |
|---|---|
| Titanium oxide | 126 parts |
| (CR-EL from Ishihara Sangyo Kaisha, Ltd., average particle | |
| diameter of 0.25 μm) | |
| Alkyd resin | 33.6 parts |
| (BEKKOLITE M6401-50-S from Dainippon Ink & | |
| Chemicals, Inc., solid content of 50%) | |
| Melamine resin | 18.7 parts |
| (SUPER BEKKAMIN L-121-60 from Dainippon Ink & | |
| Chemicals, Inc., solid content of 60%) | |
| 2-Butanone | 100 parts |

In the moiré preventing layer, the volume ratio (P/R) of the inorganic pigment (P) to the binder resin (R) is 1.5/1, and the weight ratio (A/M) of the alkyd resin (A) to the melamine resin (M) is 6/4.

Thus, a photoreceptor 22 was prepared.

### Photoreceptor Preparation Example 23

The procedure for preparation of photoreceptor 22 in Photoreceptor Preparation Example 22 was repeated except that the thickness of the charge blocking layer was changed to 0.3 μm.

Thus, a photoreceptor 23 was prepared.

### Photoreceptor Preparation Example 24

The procedure for preparation of photoreceptor 22 in Photoreceptor Preparation Example 22 was repeated except that the thickness of the charge blocking layer was changed to 1.8 μm.

Thus, a photoreceptor 24 was prepared.

### Photoreceptor Preparation Example 25

The procedure for preparation of photoreceptor 22 in Photoreceptor Preparation Example 22 was repeated except that the charge blocking layer coating liquid was replaced with a charge blocking layer coating liquid having the following formula.

Formula of Charge Blocking Layer Coating Liquid

| | |
|---|---|
| Alcohol-soluble nylon | 4 parts |
| (AMILAN CM8000 from Toray Industries Inc.) | |
| Methanol | 70 parts |
| n-Butanol | 30 parts |

Thus, a photoreceptor 25 was prepared.

### Photoreceptor Preparation Example 26

The procedure for preparation of photoreceptor 22 in Photoreceptor Preparation Example 22 was repeated except that the moiré preventing layer coating liquid was replaced with a moiré preventing layer coating liquid having the following formula.

Formula of Moiré Preventing Layer Coating Liquid

| | |
|---|---|
| Titanium oxide | 252 parts |
| (CR-EL from Ishihara Sangyo Kaisha, Ltd., average particle | |
| diameter of 0.25 μm) | |
| Alkyd resin | 33.6 parts |
| (BEKKOLITE M6401-50-S from Dainippon Ink & | |
| Chemicals, Inc., solid content of 50%) | |
| Melamine resin | 18.7 parts |
| (SUPER BEKKAMIN L-121-60 from Dainippon Ink & | |
| Chemicals, Inc., solid content of 60%) | |
| 2-Butanone | 100 parts |

In the moiré preventing layer, the volume ratio (P/R) of the inorganic pigment (P) to the binder resin (R) is 3/1, and the weight ratio (AIM) of the alkyd resin (A) to the melamine resin (M) is 6/4.

Thus, a photoreceptor 26 was prepared.

### Photoreceptor Preparation Example 27

The procedure for preparation of photoreceptor 22 in Photoreceptor Preparation Example 22 was repeated except that the moiré preventing layer coating liquid was replaced with a moiré preventing layer coating liquid having the following formula.

Formula of Moiré Preventing Layer Coating Liquid

| | |
|---|---|
| Titanium oxide | 84 parts |
| (CR-EL from Ishihara Sangyo Kaisha, Ltd., average particle | |
| diameter of 0.25 μm) | |
| Alkyd resin | 33.6 parts |
| (BEKKOLITE M6401-50-S from Dainippon Ink & | |
| Chemicals, Inc., solid content of 50%) | |
| Melamine resin | 18.7 parts |
| (SUPER BEKKAMIN L-121-60 from Dainippon Ink & | |
| Chemicals, Inc., solid content of 60%) | |
| 2-Butanone | 100 parts |

In the moiré preventing layer, the volume ratio (P/R) of the inorganic pigment (P) to the binder resin (R) is 1/1, and the weight ratio (A/M) of the alkyd resin (A) to the melamine resin (M) is 6/4.

Thus, a photoreceptor 27 was prepared.

### Examples 35 to 40

The procedure for the running test and evaluation in Example 13 was repeated except that photoreceptor 1 was replaced with each of photoreceptors 22-27.

The evaluation results are shown in Table 24.

TABLE 24

| | | | V_{L} (−V) | | | | | |
|---|---|---|---|---|---|---|---|---|
| | | | | After | | | | Abrasion |
| | | T | | 50,000 | | | | loss |
| | No. | (%) | Initial | copies | BF | CL | DOT | (μm) |
| Ex. 13 | 1 | 87 | 120 | 140 | Δ | ◯ | ⊚ | 7.0 |
| Ex. 35 | 22 | 87 | 120 | 155 | ⊚ | ◯ | ⊚ | 7.0 |
| Ex. 36 | 23 | 87 | 120 | 150 | ◯ | ◯ | ⊚ | 7.0 |
| Ex. 37 | 24 | 87 | 125 | 160 | ⊚ | ◯ | ⊚ | 7.0 |
| Ex. 38 | 25 | 87 | 130 | 170 | ⊚ | ◯ | ⊚ | 7.0 |
| Ex. 39 | 26 | 87 | 120 | 150 | ◯ | ◯ | ⊚ | 7.0 |
| Ex. 40 | 27 | 87 | 130 | 160 | ⊚ | ◯ | ⊚ | 7.0 |

It is clear from Table 24 that by using a combination of a charge blocking layer and a moiré preventing layer as the intermediate layer, the photoreceptors have good resistance to background fouling.

### Example 41

The procedure for the running test and evaluation in Example 1 was repeated except that photoreceptor 1 was set in a process cartridge having a structure as illustrated in FIG. 13 and four of the process cartridge were set in a full color image forming apparatus having a structure as illustrated in FIG. 12. In addition, after the running test, a copy of an ISO/JIS-SCID N1 portrait image was produced to evaluate the color reproducibility of the photoreceptor.

The evaluation results are shown in Table 25.

### Example 42

The procedure for the running test and evaluation in Example 41 was repeated except that the discharging lamp was replaced with a discharging lamp including a LED (from Seiwa Electric Mfg. Co., Ltd.) which emits light with a wavelength of 472 nm and a half width of 15 nm. In this regard, the light intensity of the discharging lamp was controlled so that the potential of the non-lighted portion of the photoreceptor after the discharging process is the same as that in Example 41.

The evaluation results are shown in Table 25.

### Comparative Example 14

The procedure for the running test and evaluation in Example 41 was repeated except that the discharging lamp was replaced with a discharging lamp including a LED (from Seiwa Electric Mfg. Co., Ltd.) which emits light with a wavelength of 502 nm and a half width of 15 nm. In this regard, the light intensity of the discharging lamp was controlled so that the potential of the non-lighted portion of the photoreceptor after the discharging process is the same as that in Example 41.

The evaluation results are shown in Table 25.

### Comparative Example 15

The procedure for the running test and evaluation in Example 41 was repeated except that the discharging lamp was replaced with a discharging lamp including a LED (from Rohm Co., Ltd.) which emits light with a wavelength of 591 nm and a half width of 15 nm. In this regard, the light intensity of the discharging lamp was controlled so that the potential of the non-lighted portion of the photoreceptor after the discharging process is the same as that in Example 41.

The evaluation results are shown in Table 25.

### Comparative Example 16

The procedure for the running test and evaluation in Example 41 was repeated except that the discharging lamp was replaced with a discharging lamp including a LED (from Rohm Co., Ltd.) which emits light with a wavelength of 630 nm and a half width of 20 nm. In this regard, the light intensity of the discharging lamp was controlled so that the potential of the non-lighted portion of the photoreceptor after the discharging process is the same as that in Example 41.

The evaluation results are shown in Table 25.

### Comparative Example 17

The procedure for the running test and the evaluation in Example 41 was repeated except that the discharging lamp was replaced with a fluorescent lamp which emits light having a spectrum as illustrated in FIG. 1. In this regard, the light intensity of the discharging lamp was controlled so that the potential of the non-lighted portion of the photoreceptor after the discharging process is the same as that in Example 41.

The evaluation results are shown in Table 25.

### Comparative Example 18

The procedure for the running test and the evaluation in Example 41 was repeated except that the discharging lamp was replaced with a discharging lamp including a combination of a LED (from Rohm Co., Ltd.) which emits light with a wavelength of 428 nm and a half width of 65 nm and a LED (from Rohm Co., Ltd.) which emits light with a wavelength of 630 nm and a half width of 20 nm. In this regard, the light intensity of the discharging lamp was controlled so that the potential of the non-lighted portion of the photoreceptor after the discharging process is the same as that in Example 41.

The evaluation results are shown in Table 25.

TABLE 25

| | | Transmittance | Potential of | |
|---|---|---|---|---|
| | | (T) of | lighted portion (V_{L}) | |
| | Wavelength | protective layer | (−V) | |
| | (λ) of | against | At | After |
| | discharging | discharging | beginning of | running |
| | light (nm) | light | running test | test |
| Ex. 41 | 428 | 86 | 130 | 133 |
| Ex. 42 | 472 | 87 | 130 | 140 |
| Comp. Ex. 14 | 502 | 87 | 130 | 170 |
| Comp. Ex. 15 | 591 | 88 | 130 | 175 |
| Comp. Ex. 16 | 630 | 89 | 130 | 180 |
| Comp. Ex. 17 | White light | — | 130 | 165 |
| Comp. Ex. 18 | 428 and 630 | 86 and 89 | 130 | 170 |

It is clear from Table 25 that when the wavelength of the discharging light is less than 500 nm (Examples 41 and 42), increase in potential (V_{L}) of the lighted portion is lower than that in the cases where the wavelength of the discharging light is not less than 500 nm (Comparative Examples 14-16). In particular, when the wavelength of the discharging light is less than 450 nm (i.e., Example 41), increase in potential (V_{L}) of the lighted portion is lower than that in the case where the wavelength of the discharging light is from 450 nm to 500 nm (i.e., Example 42).

In addition, it is also found that when discharging light having a wide wavelength range and including light with a relatively long wavelength is used (i.e., Comparative Example 17), such an effect as produced in Examples 41 and 42 cannot be produced. Further, it is found that when a combination of two light sources emitting light with different wavelengths is used (Comparative Example 18), the effect of the light with a relatively short wavelength is reduced.

The image qualities of the color images produced in Examples 41 and 42 were hardly changed before and after the running test. However, the color images produced in Comparative Examples 14-18 after the running test have slightly poor color reproducibility (i.e., the color tones of the color images are changed after the running test).

The azo pigments having formula (XI) used for the following examples were prepared by the methods described in Japanese Patent No. 2,667,936, published examined Japanese patent application No. (hereinafter referred to as JP-B) 61-30265 and Japanese Patent No. 2,800,938, incorporated herein by reference.

### Dispersion Preparation Example 5

Formula of Dispersion

| | |
|---|---|
| Azo pigment having the following formula AZO-3 | 5 parts |

| | |
|---|---|
| | AZO-3 |
| 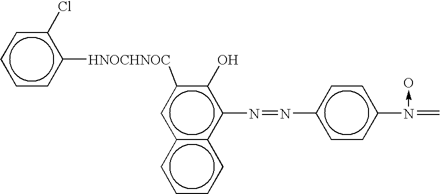 | |

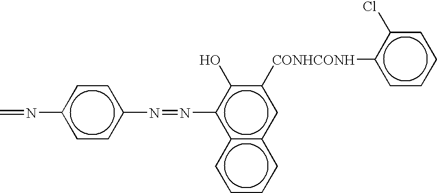

| | |
|---|---|
| Polyvinyl butyral | 2 parts |
| (BX-1 from Sekisui Chemical Co., Ltd.) | |
| Cyclohexanone | 250 parts |
| 2-Butanone | 100 parts |

At first, the polyvinyl butyral resin was dissolved in the solvents. The solution was mixed with the azo pigment and the mixture was subjected to a dispersion treatment for 7 days using a ball mill which includes PSZ balls having a diameter of 10 mm and which is rotated at a revolution of 85 rpm. Thus, a dispersion 5 was prepared.

### Dispersion Preparation Example 6

The procedure for preparation of dispersion 5 in Dispersion Preparation Example 5 was repeated except that the azo pigment was replaced with an azo pigment having the following formula AZO-4.

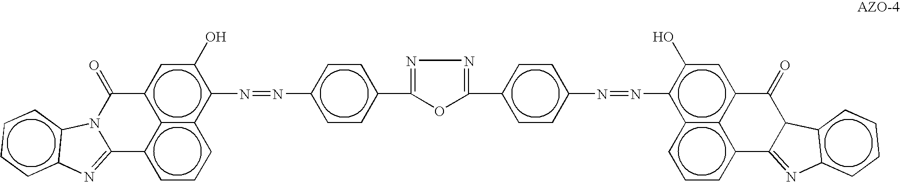

Thus, a dispersion 6 was prepared.

### Dispersion Preparation Example 7

The procedure for preparation of dispersion 5 in Dispersion Preparation Example 5 was repeated except that the azo pigment was replaced with an azo pigment having the following formula AZO-5.

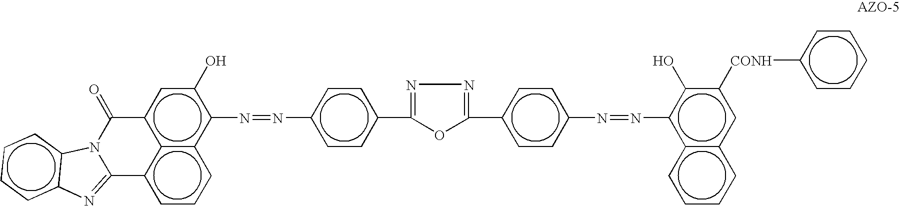

Thus, a dispersion 7 was prepared

### Dispersion Preparation Example 8

The procedure for preparation of dispersion 6 was repeated except that dispersion 6 was filtered with a cotton wind cartridge filter (TCW-3-CS from Advantech Co., Ltd.) having an effective pore diameter of 3 μm. Filtering was performed under pressure using a pump.

Thus, a dispersion 8 was prepared.

### Dispersion Preparation Example 9

The procedure for preparation of dispersion 8 was repeated except that the filter was replaced with a cotton wind cartridge filter (TCW-5-CS from Advantech Co., Ltd.) having an effective pore diameter of 5 μm.

Thus, a dispersion 9 was prepared.

The particle diameter distribution of the thus prepared dispersions 5 to 9 was measured with a particle diameter measuring instrument (CAPA 700 from Horiba Ltd.). The results are shown in Table 26.

TABLE 26

| | Average particle diameter | Standard deviation of |
|---|---|---|
| Dispersion | (μm) | particle diameter (μm) |
| 5 | 0.25 | 0.18 |
| 6 | 0.28 | 0.17 |
| 7 | 0.24 | 0.16 |
| 8 | 0.23 | 0.15 |
| 9 | 0.25 | 0.16 |

### Photoreceptor Preparation Example 28

The procedure for preparation of photoreceptor 1 in Photoreceptor Preparation Example 1 was repeated except that dispersion 1 used as the CGL coating liquid was replaced with dispersion 5.

Thus, a photoreceptor 28 was prepared.

### Example 43

The procedure for the running test and evaluation in Example 1 was repeated except that photoreceptor 1 was replaced with photoreceptor 28.

The evaluation results are shown in Table 27.

### Example 44

The procedure for the running test and evaluation in Example 43 was repeated except that the discharging lamp was replaced with a discharging lamp including a LED (from Seiwa Electric Mfg. Co., Ltd.) which emits light with a wavelength of 472 nm and a half width of 15 nm. In this regard, the light intensity of the discharging lamp was controlled so that the potential of the non-lighted portion of the photoreceptor after the discharging process is the same as that in Example 43.

The evaluation results are shown in Table 27.

### Comparative Example 19

The procedure for the running test and evaluation in Example 43 was repeated except that the discharging lamp was replaced with a discharging lamp including a LED (from Seiwa Electric Mfg. Co., Ltd.) which emits light with a wavelength of 502 nm and a half width of 15 nm. In this regard, the light intensity of the discharging lamp was controlled so that the potential of the non-lighted portion of the photoreceptor after the discharging process is the same as that in Example 43.

The evaluation results are shown in Table 27.

### Comparative Example 20

The procedure for the running test and evaluation in Example 43 was repeated except that the discharging lamp was replaced with a discharging lamp including a LED (from Seiwa Electric Mfg. Co., Ltd.) which emits light with a wavelength of 591 nm and a half width of 15 nm. In this regard, the light intensity of the discharging lamp was controlled so that the potential of the non-lighted portion of the photoreceptor after the discharging process is the same as that in Example 43.

The evaluation results are shown in Table 27.

### Comparative Example 21

The procedure for the running test and evaluation in Example 43 was repeated except that the discharging lamp was replaced with a discharging lamp including a LED (from Rohm Co., Ltd.) which emits light with a wavelength of 630 nm and a half width of 20 nm. In this regard, the light intensity of the discharging lamp was controlled so that the potential of the non-lighted portion of the photoreceptor after the discharging process is the same as that in Example 43.

The evaluation results are shown in Table 27.

### Comparative Example 22

The procedure for the running test and evaluation in Example 43 was repeated except that the discharging lamp was replaced with a fluorescent lamp which emits light having a spectrum as illustrated in FIG. 1. In this regard, the light intensity of the discharging lamp was controlled so that the potential of the non-lighted portion of the photoreceptor after the discharging process is the same as that in Example 43.

The evaluation results are shown in Table 27.

### Comparative Example 23

The procedure for the running test and evaluation in Example 43 was repeated except that the discharging lamp was replaced with a discharging lamp including a combination of a LED (from Rohm Co., Ltd.) which emits light with a wavelength of 428 nm and a half width of 65 nm and a LED (from Rohm Co., Ltd.) which emits light with a wavelength of 630 nm and a half width of 20 nm. In this regard, the light intensity of the discharging lamp was controlled so that the potential of the non-lighted portion of the photoreceptor after the discharging process is the same as that in Example 43.

The evaluation results are shown in Table 27.

TABLE 27

| | | | At beginning of | | After | |
|---|---|---|---|---|---|---|
| | λ | T | running test | | running test | |
| | (%) | (%) | V_{D} (−V) | V_{L} (−V) | V_{D} (−V) | V_{L} (−V) |
| Ex. 43 | 428 | 86 | 900 | 90 | 900 | 105 |
| Ex. 44 | 472 | 87 | 900 | 90 | 900 | 110 |
| Comp. Ex. | 502 | 87 | 900 | 90 | 900 | 135 |
| 19 | | | | | | |
| Comp. Ex. | 591 | 88 | 900 | 90 | 900 | 140 |
| 20 | | | | | | |
| Comp. Ex. | 630 | 89 | 900 | 90 | 900 | 145 |
| 21 | | | | | | |
| Comp. Ex. | White | — | 900 | 90 | 900 | 130 |
| 22 | light | | | | | |
| Comp. Ex. | 428, | 86, | 900 | 90 | 900 | 135 |
| 23 | 630 | 89 | | | | |

It is clear from Table 27 that when the wavelength of the discharging light is less than 500 nm (Examples 43 and 44), increase in potential (V_{L}) of the lighted portion is lower than that in the cases where the wavelength of the discharging light is not less than 500 nm (Comparative Examples 19-21). In particular, when the wavelength of the discharging light is less than 450 nm (i.e., Example 43), increase in potential (V_{L}) of the lighted portion is lower than that in the case where the wavelength of the discharging light is from 450 to 500 nm (i.e., Example 44).

In addition, it is also found that when discharging light having a wide wavelength range and including light with a relatively long wavelength is used (i.e., Comparative Example 22), such an effect as produced in Examples 43 and 44 cannot be produced. Further, it is found that when a combination of two light sources emitting light with different wavelengths is used (Comparative Example 23), the effect of the light with a relatively short wavelength is reduced.

### Photoreceptor Preparation Example 29

The procedure for preparation of photoreceptor 28 in Photoreceptor Preparation Example 28 was repeated except that dispersion 5 used as the CGL coating liquid was replaced with dispersion 6.

Thus, a photoreceptor 29 was prepared.

### Photoreceptor Preparation Example 30

The procedure for preparation of photoreceptor 28 in Photoreceptor Preparation Example 28 was repeated except that dispersion 5 used as the CGL coating liquid was replaced with dispersion 7.

Thus, a photoreceptor 30 was prepared.

### Example 45

The procedure for the running test and evaluation in Example 43 was repeated except that photoreceptor 28 was replaced with photoreceptor 29.

The evaluation results are shown in Table 28.

### Example 46

The procedure for the running test and evaluation in Example 44 was repeated except that photoreceptor 28 was replaced with photoreceptor 29.

The evaluation results are shown in Table 28.

### Comparative Example 24

The procedure for the running test and evaluation in Comparative Example 19 was repeated except that photoreceptor 28 was replaced with photoreceptor 29.

The evaluation results are shown in Table 28.

### Comparative Example 25

The procedure for the running test and evaluation in Comparative Example 20 was repeated except that photoreceptor 28 was replaced with photoreceptor 29.

The evaluation results are shown in Table 28.

### Comparative Example 26

The procedure for the running test and evaluation in Comparative Example 21 was repeated except that photoreceptor 28 was replaced with photoreceptor 29.

The evaluation results are shown in Table 28.

### Comparative Example 27

The procedure for the running test and evaluation in Comparative Example 22 was repeated except that photoreceptor 28 was replaced with photoreceptor 29.

The evaluation results are shown in Table 28.

### Comparative Example 28

The procedure for the running test and evaluation in Comparative Example 23 was repeated except that photoreceptor 28 was replaced with photoreceptor 29.

The evaluation results are shown in Table 28.

### Example 47

The procedure for the running test and evaluation in Example 43 was repeated except that photoreceptor 28 was replaced with photoreceptor 30.

The evaluation results are shown in Table 28.

### Example 48

The procedure for the running test and evaluation in Example 44 was repeated except that photoreceptor 28 was replaced with photoreceptor 30.

The evaluation results are shown in Table 28.

### Comparative Example 29

The procedure for the running test and evaluation in Comparative Example 19 was repeated except that photoreceptor 28 was replaced with photoreceptor 30.

The evaluation results are shown in Table 28.

### Comparative Example 30

The procedure for the running test and evaluation in Comparative Example 20 was repeated except that photoreceptor 28 was replaced with photoreceptor 30.

The evaluation results are shown in Table 28.

### Comparative Example 31

The procedure for the running test and evaluation in Comparative Example 21 was repeated except that photoreceptor 28 was replaced with photoreceptor 30.

The evaluation results are shown in Table 28.

### Comparative Example 32

The procedure for the running test and evaluation in Comparative Example 22 was repeated except that photoreceptor 28 was replaced with photoreceptor 30.

The evaluation results are shown in Table 28.

### Comparative Example 33

The procedure for the running test and evaluation in Comparative Example 23 was repeated except that photoreceptor 28 was replaced with photoreceptor 30.

The evaluation results are shown in Table 28.

TABLE 28

| | | | At beginning of | | After | |
|---|---|---|---|---|---|---|
| | λ | T | running test | | running test | |
| | (%) | (%) | V_{D} (−V) | V_{L} (−V) | V_{D} (−V) | V_{L} (−V) |
| Ex. 45 | 428 | 86 | 900 | 80 | 900 | 90 |
| Ex. 46 | 472 | 87 | 900 | 80 | 900 | 95 |
| Comp. Ex. | 502 | 87 | 900 | 80 | 900 | 120 |
| 24 | | | | | | |
| Comp. Ex. | 591 | 88 | 900 | 80 | 900 | 125 |
| 25 | | | | | | |
| Comp. Ex. | 630 | 89 | 900 | 80 | 900 | 130 |
| 26 | | | | | | |
| Comp. Ex. | White | — | 900 | 80 | 900 | 115 |
| 27 | light | | | | | |
| Comp. Ex. | 428, | 86, | 900 | 80 | 900 | 120 |
| 28 | 630 | 89 | | | | |
| Ex. 47 | 428 | 86 | 900 | 60 | 900 | 70 |
| Ex. 48 | 472 | 87 | 900 | 60 | 900 | 75 |
| Comp. Ex. | 502 | 87 | 900 | 60 | 900 | 100 |
| 29 | | | | | | |
| Comp. Ex. | 591 | 88 | 900 | 60 | 900 | 105 |
| 30 | | | | | | |
| Comp. Ex. | 630 | 89 | 900 | 60 | 900 | 110 |
| 31 | | | | | | |
| Comp. Ex. | White | — | 900 | 60 | 900 | 105 |
| 32 | light | | | | | |
| Comp. Ex. | 428, | 86, | 900 | 60 | 900 | 100 |
| 33 | 630 | 89 | | | | |

It is clear from Table 28 that when the wavelength of the discharging light is less than 500 nm (Examples 45 to 48), increase in potential (V_{L}) of the lighted portion is lower than that in the cases where the wavelength of the discharging light is not less than 500 nm (Comparative Examples 24-26 and 29-31). In particular, when the wavelength of the discharging light is less than 450 nm (i.e., Examples 45 and 47), increase in residual potential (V_{L}) of the lighted portion is lower than that in the cases where the wavelength of the discharging light is from 450 to 500 nm (i.e., Examples 46 and 48).

In addition, it is also found that when discharging light having a wide wavelength range and including light with a relatively long wavelength is used (i.e., Comparative Examples 27 and 32), such an effect as produced in Examples 45 to 48 cannot be produced. Further, it is found that when a combination of two light sources emitting light with different wavelengths is used (Comparative Examples 23), the effect of the light with a relatively short wavelength is reduced.

In addition, the residual potentials (V_{L}) in Examples 47 and 48 are lower than those in Examples 45 and 46. This is because the azo dye which is used for photoreceptor 30 used in Examples 47 and 48 and which includes an asymmetric coupler component enhances the photosensitivity of the photoreceptor.

### Example 49

The procedure for the running test and evaluation in Example 47 was repeated except that the laser diode used as the image writing light source was replaced with a laser diode emitting light with a wavelength of 408 nm.

The evaluation results are shown in Table 29.

TABLE 29

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 47 | 428 | 86 | 900 | 60 | 900 | 70 |
| Ex. 49 | 428 | 86 | 900 | 60 | 900 | 65 |

When electrostatic latent images are written using light with a relatively short wavelength of 408 nm (Example 49), increase in residual potential (V_{L}) can be reduced. In addition, it is found that the dot images produced in Example 49 have clearer outline than the dot images produced in Example 47.

### Photoreceptor Preparation Example 31

The procedure for preparation of photoreceptor 30 in Photoreceptor Preparation Example 30 was repeated except that the CTL coating liquid was replaced with a CTL coating liquid having the following formula.

Formula of CTL Coating Liquid

| | |
|---|---|
| Polycarbonate | 10 parts |
| (TS2050 from Teijin Chemicals Ltd.) | |
| CTM having formula CTM-2 mentioned above | 7 parts |
| Methylene chloride | 80 parts |

Thus, a photoreceptor 31 was prepared.

### Example 50

The procedure for the running test and the evaluation in Example 6 was repeated except that photoreceptor 3 was replaced with photoreceptor 31.

The evaluation results are shown in Table 30.

### Example 51

The procedure for the running test and the evaluation in Example 50 was repeated except that the homogenous light used as the discharging light was changed to homogeneous light with a wavelength of 443 nm by changing the conditions of the monochrometor.

The evaluation results are shown in Table 30.

### Example 52

The procedure for the running test and the evaluation in Example 50 was repeated except that the homogenous light used as the discharging light was changed to homogeneous light with a wavelength of 437 nm by changing the conditions of the monochrometor.

The evaluation results are shown in Table 30.

### Example 53

The procedure for the running test and the evaluation in Example 50 was repeated except that the homogenous light used as the discharging light was changed to homogeneous light with a wavelength of 433 nm by changing the conditions of the monochrometor.

The evaluation results are shown in Table 30.

### Example 54

The procedure for the running test and the evaluation in Example 50 was repeated except that the homogenous light used as the discharging light was changed to homogeneous light with a wavelength of 429 nm by changing the conditions of the monochrometor.

The evaluation results are shown in Table 30.

TABLE 30

| | | | Beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 50 | 461 | 85 | 900 | 70 | 900 | 80 |
| Ex. 51 | 443 | 69 | 900 | 70 | 900 | 80 |
| Ex. 52 | 437 | 49 | 900 | 70 | 900 | 80 |
| Ex. 53 | 433 | 29 | 900 | 70 | 900 | 90 |
| Ex. 54 | 429 | 9 | 900 | 70 | 900 | 90 |

It is clear from Table 30 that when the transmittance of the CTL against the discharging light is less than about 30%, the discharging effect slightly deteriorates.

In addition, it is found that the half tone images produced in Examples 50 to 52 are normal but the half tone images produced in Examples 53 and 54 includes a slight ghost image of the stripe image although the quality of the half tone images is still acceptable. The ghost image in the image produced in Example 54 is relatively noticeable compared to that in Example 53.

Thus, it is discovered that even when light with a wavelength of less than 500 nm is used as the discharging light, a minor side effect is produced if the transmittance of the CTL against the light is less than 30%.

### Photoreceptor Preparation Example 32

The procedure for preparation of photoreceptor 29 in Photoreceptor Preparation Example 29 was repeated except that dispersion 6 used for the CGL coating liquid was replaced with dispersion 8.

Thus, a photoreceptor 32 was prepared.

### Photoreceptor Preparation Example 33

The procedure for preparation of photoreceptor 29 in Photoreceptor Preparation Example 29 was repeated except that dispersion 6 used for the CGL coating liquid was replaced with dispersion 9.

Thus, a photoreceptor 33 was prepared.

### Examples 55 and 56

The procedure for the running test and evaluation in Example 45 was repeated except that photoreceptor 29 was replaced with photoreceptor 32 (Example 55) or photoreceptor 33 (Example 55) and a white solid image was produced to determine whether the white solid image has background fouling. The level of background fouling was classified into the following four grades while considering the number and size of black spots formed on the white solid image.

⊚: Excellent

◯: Good

Δ: Acceptable

X: Bad

TABLE 31

| | At beginning of | | | | |
|---|---|---|---|---|---|
| | running test | | After running test | | Background |
| | V_{D} (−V) | V_{L} (−V) | V_{D} (−V) | V_{L} (−V) | fouling |
| Ex. 45 | 900 | 80 | 900 | 90 | Δ-◯ |
| Ex. 55 | 900 | 75 | 900 | 80 | ⊚ |
| Ex. 56 | 900 | 75 | 900 | 85 | ◯ |

It is clear from Table 31 that when the average particle diameter of the CGM dispersed in the CGL coating liquid is less than 0.25 μm (Examples 55 and 56), the initial potential of a lighted portion (V_{L}) can be reduced and in addition occurrence of background fouling can be prevented without increasing the potential of a lighted portion even after long repeated use.

### Photoreceptor Preparation Example 34

The procedure for preparation of photoreceptor 6 in Photoreceptor Preparation Example 6 was repeated except that dispersion 1 used as the CGL coating liquid was replaced with dispersion 7.

Thus, a photoreceptor 34 was prepared.

### Photoreceptor Preparation Example 35

The procedure for preparation of photoreceptor 7 in Photoreceptor Preparation Example 7 was repeated except that dispersion 1 used as the CGL coating liquid was replaced with dispersion 7.

Thus, a photoreceptor 35 was prepared.

### Photoreceptor Preparation Example 36

The procedure for preparation of photoreceptor 8 in Photoreceptor Preparation Example 8 was repeated except that dispersion 1 used as the CGL coating liquid was replaced with dispersion 7.

Thus, a photoreceptor 36 was prepared.

### Photoreceptor Preparation Example 37

The procedure for preparation of photoreceptor 9 in Photoreceptor Preparation Example 9 was repeated except that dispersion 1 used as the CGL coating liquid was replaced with dispersion 7.

Thus, a photoreceptor 37 was prepared.

### Photoreceptor Preparation Example 38

The procedure for preparation of photoreceptor 10 in Photoreceptor Preparation Example 10 was repeated except that dispersion 1 used as the CGL coating liquid was replaced with dispersion 7.

Thus, a photoreceptor 38 was prepared.

### Photoreceptor Preparation Example 39

The procedure for preparation of photoreceptor 11 in Photoreceptor Preparation Example 11 was repeated except that dispersion 1 used as the CGL coating liquid was replaced with dispersion 7.

Thus, a photoreceptor 39 was prepared.

### Photoreceptor Preparation Example 40

The procedure for preparation of photoreceptor 12 in Photoreceptor Preparation Example 12 was repeated except that dispersion 1 used as the CGL coating liquid was replaced with dispersion 7.

Thus, a photoreceptor 40 was prepared.

### Photoreceptor Preparation Example 41

The procedure for preparation of photoreceptor 13 in Photoreceptor Preparation Example 13 was repeated except that dispersion 1 used as the CGL coating liquid was replaced with dispersion 7.

Thus, a photoreceptor 41 was prepared.

### Photoreceptor Preparation Example 42

The procedure for preparation of photoreceptor 14 in Photoreceptor Preparation Example 14 was repeated except that dispersion 1 used as the CGL coating liquid was replaced with dispersion 7.

Thus, a photoreceptor 42 was prepared.

### Photoreceptor Preparation Example 43

The procedure for preparation of photoreceptor 15 in Photoreceptor Preparation Example 15 was repeated except that dispersion 1 used as the CGL coating liquid was replaced with dispersion 7.

Thus, a photoreceptor 43 was prepared.

### Photoreceptor Preparation Example 44

The procedure for preparation of photoreceptor 16 in Photoreceptor Preparation Example 16 was repeated except that dispersion 1 used as the CGL coating liquid was replaced with dispersion 7.

Thus, a photoreceptor 44 was prepared.

### Photoreceptor Preparation Example 45

The procedure for preparation of photoreceptor 17 in Photoreceptor Preparation Example 17 was repeated except that dispersion 1 used as the CGL coating liquid was replaced with dispersion 7.

Thus, a photoreceptor 45 was prepared.

### Photoreceptor Preparation Example 46

The procedure for preparation of photoreceptor 18 in Photoreceptor Preparation Example 41 was repeated except that dispersion 1 used as the CGL coating liquid was replaced with dispersion 7.

Thus, a photoreceptor 46 was prepared.

### Photoreceptor Preparation Example 47

The procedure for preparation of photoreceptor 19 in Photoreceptor Preparation Example 19 was repeated except that dispersion 1 used as the CGL coating liquid was replaced with dispersion 7.

Thus, a photoreceptor 47 was prepared.

### Photoreceptor Preparation Example 48

The procedure for preparation of photoreceptor 20 in Photoreceptor Preparation Example 20 was repeated except that dispersion 1 used as the CGL coating liquid was replaced with dispersion 7.

Thus, a photoreceptor 48 was prepared.

### Photoreceptor Preparation Example 49

The procedure for preparation of photoreceptor 21 in Photoreceptor Preparation Example 21 was repeated except that dispersion 1 used as the CGL coating liquid was replaced with dispersion 7.

Thus, a photoreceptor 49 was prepared.

### Example 57

The procedure for the running test and evaluation in Example 13 was repeated except that photoreceptor 1 was replaced with photoreceptor 30.

The evaluation results are shown in Table 32.

### Examples 58-73

The procedure for the running test and evaluation in Example 57 was repeated except that photoreceptor 30 was replaced with each of photoreceptors 34-49.

The evaluation results are shown in Table 32.

TABLE 32

| | | | V_{L} (−V) | | | | | Abra- |
|---|---|---|---|---|---|---|---|---|
| | | | | After | | | | sion |
| | | T | Initial | 50,000 | | | | loss |
| | No. | (%) | potential | copies | BF | CL | DOT | (μm) |
| Ex. 57 | 30 | 87 | 60 | 75 | Δ | ◯ | ⊚ | 7.0 |
| Ex. 58 | 34 | 85 | 60 | 75 | Δ-◯ | ◯-⊚ | ⊚ | 4.0 |
| Ex. 59 | 35 | 80 | 65 | 85 | ⊚ | Δ-◯ | ◯-⊚ | 2.0 |
| Ex. 60 | 36 | 78 | 70 | 90 | ⊚ | Δ-◯ | ◯ | 1.8 |
| Ex. 61 | 37 | 80 | 60 | 80 | ◯ | Δ-◯ | Δ-◯ | 2.0 |
| Ex. 62 | 38 | 77 | 70 | 85 | ⊚ | Δ-◯ | ◯ | 1.6 |
| Ex. 63 | 39 | 85 | 70 | 85 | ◯-⊚ | ◯ | ◯ | 2.5 |
| Ex. 64 | 40 | 81 | 75 | 90 | ⊚ | Δ-◯ | Δ-◯ | 1.6 |
| Ex. 65 | 41 | 85 | 70 | 85 | ⊚ | ⊚ | ⊚ | 1.4 |
| Ex. 66 | 42 | 85 | 70 | 85 | ◯ | ⊚ | ⊚ | 1.2 |
| Ex. 67 | 43 | 85 | 70 | 85 | ⊚ | Δ-◯ | ⊚ | 2.6 |
| Ex. 68 | 44 | 85 | 70 | 85 | ⊚ | ⊚ | ⊚ | 1.4 |
| Ex. 69 | 45 | 83 | 70 | 90 | ⊚ | Δ-◯ | ⊚ | 1.2 |
| Ex. 70 | 46 | 84 | 65 | 80 | ◯-⊚ | ⊚ | ⊚ | 1.6 |
| Ex. 71 | 47 | 84 | 75 | 90 | ⊚ | ⊚ | ⊚ | 1.4 |
| Ex. 72 | 48 | 80 | 60 | 75 | ◯-⊚ | ⊚ | ⊚ | 1.8 |
| Ex. 73 | 49 | 85 | 80 | 90 | ⊚ | ⊚ | ⊚ | 1.4 |

No.: Number of photoreceptor used
T: Transmittance of protective layer or CTL against the discharging light

It is clear from Table 32 that even when a protective layer is formed, the following knowledge can be obtained.

(1) Even in photoreceptors having a protective layer, the residual potential increasing problem can be avoided if light with a wavelength less than 500 nm is used as the discharging light;

(2) The photoreceptor (Example 58) including a charge transport polymer (polycarbonate resin having a triarylamine structure) in the CTL has better abrasion resistance than the photoreceptor (Example 57) including a low molecular weight CTM in the CTL;

(3) The photoreceptors (Examples 59-73) including a protective layer have better abrasion resistance than the photoreceptor (Example 57) including no protective layer;

(4) Among the photoreceptors having a protective layer including a particulate inorganic material (Examples 59-61), the photoreceptors (Examples 59 and 60) having a protective layer including a particulate inorganic material having a resistivity not less than 10¹⁰ Ω·cm have good dot reproducibility even under high temperature and high humidity conditions;

(5) The photoreceptors having a crosslinked protective layer have better abrasion resistance than the photoreceptor having a non-crosslinked protective layer, in particular, the photoreceptors of Examples 65, 66, 68, and 70-73 having a crosslinked protective layer which is prepared using a tri- or more-functional monomer having no charge transport structure and a monofunctional monomer having a charge transport structure have excellent abrasion resistance; and

(6) the photoreceptors (Examples 65, 66, 68, and 70-73) also have excellent cleanability.

### Comparative Example 34

The procedure for the running test and the evaluation of the images in Example 65 was repeated except that the laser diode was replaced with a laser diode (from Seiwa Electric Mfg. Co., Ltd.) emitting light with a wavelength of 502 nm and a half width of 15 nm. The light intensity was controlled so that the initial potential (V_{L}) of a lighted portion is the same as that in Example 65.

The evaluation results are shown in Table 33.

### Comparative Example 35

The procedure for the running test and the evaluation of the images in Example 65 was repeated except that the laser diode was replaced with a laser diode (from Rohm Co., Ltd.) emitting light with a wavelength of 591 nm and a half width of 15 nm. The light intensity was controlled so that the initial potential (V_{L}) of a lighted portion is the same as that in Example 65.

The evaluation results are shown in Table 33.

### Comparative Example 36

The procedure for the running test and the evaluation of the images in Example 65 was repeated except that the laser diode was replaced with a laser diode (from Rohm Co., Ltd.) emitting light with a wavelength of 630 nm and a half width of 20 nm. The light intensity was controlled so that the initial potential (V_{L}) of a lighted portion is the same as that in Example 65.

The evaluation results are shown in Table 33.

### Comparative Example 37

The procedure for the running test and the evaluation of the images in Example 65 was repeated except that the laser diode was replaced with a fluorescent lamp emitting light having a spectrum illustrated in FIG. 1. The light intensity was controlled so that the initial potential (V_{L}) of a lighted portion is the same as that in Example 65.

The evaluation results are shown in Table 33.

TABLE 33

| | | Transmittance | Potential of | |
|---|---|---|---|---|
| | | (T) of | lighted portion (V_{L}) | |
| | Wavelength | protective layer | (−V) | |
| | (λ) of | against | At | After |
| | discharging | discharging | beginning of | running |
| | light (nm) | light | running test | test |
| Ex. 65 | 472 | 85 | 70 | 85 |
| Comp. Ex. 34 | 502 | 85 | 70 | 115 |
| Comp. Ex. 35 | 591 | 89 | 70 | 120 |
| Comp. Ex. 36 | 630 | 90 | 70 | 125 |
| Comp. Ex. 37 | White light | — | 70 | 110 |

It is clear from Table 33 that when the wavelength of the discharging light is less than 500 nm (Example 65), increase in the potential (V_{L}) is smaller than in Comparative Examples 34-36 using discharging light with a wavelength of not less than 500 nm. In addition, when the discharging light has light including components with a relatively long wavelength of not less than 500 nm (Comparative Example 37), the effect produced in Example 65 cannot be produced.

### Example 74

The procedure for the running test and evaluation in Example 30 was repeated except that photoreceptor 13 was replaced with photoreceptor 41.

The evaluation results are shown in Table 34.

### Example 75

The procedure for the running test and the evaluation in Example 74 was repeated except that the homogenous light used as the discharging light was changed to homogeneous light with a wavelength of 400 nm by changing the conditions of the monochrometor.

The evaluation results are shown in Table 34.

### Example 76

The procedure for the running test and the evaluation in Example 74 was repeated except that the homogenous light used as the discharging light was changed to homogeneous light with a wavelength of 393 nm by changing the conditions of the monochrometor.

The evaluation results are shown in Table 34.

### Example 77

The procedure for the running test and the evaluation in Example 74 was repeated except that the homogenous light used as the discharging light was changed to homogeneous light with a wavelength of 390 nm by changing the conditions of the monochrometor.

The evaluation results are shown in Table 34.

### Example 78

The procedure for the running test and the evaluation in Example 74 was repeated except that the homogenous light used as the discharging light was changed to homogeneous light with a wavelength of 385 nm by changing the conditions of the monochrometor.

The evaluation results are shown in Table 34.

TABLE 34

| | | Transmittance | | |
|---|---|---|---|---|
| | | (T) of | | |
| | Wavelength | protective layer | Potential of lighted portion (V_{L}) | |
| | (λ) of | against | (−V) | |
| | discharging | discharging | At beginning of | After running |
| | light (nm) | light | running test | test |
| Ex. 74 | 450 | 85 | 70 | 85 |
| Ex. 75 | 400 | 73 | 70 | 85 |
| Ex. 32 | 393 | 50 | 70 | 85 |
| Ex. 33 | 390 | 29 | 70 | 90 |
| Ex. 34 | 385 | 9 | 70 | 90 |

It is clear from Table 34 that when the transmittance of the protective layer against the discharging light is less than about 30%, the discharging effect slightly deteriorates.

In addition, it is found that the half tone images produced in Examples 74 to 76 are normal but the half tone images produced in Examples 77 and 78 include a slight ghost image of the stripe image formed on an upper portion of each copy although the quality of the half tone images is still acceptable. The ghost image in the image produced in Example 78 is relatively noticeable compared to that in Example 77.

Thus, it is discovered that even when light with a wavelength of less than 500 nm is used as the discharging light, a minor side effect is produced if the transmittance of the protective layer against the light is less than 30%.

### Photoreceptor Preparation Example 50

The procedure for preparation of photoreceptor 22 in Photoreceptor Preparation Example 22 was repeated except that dispersion 1 used as the CGL coating liquid was replaced with dispersion 7.

Thus, a photoreceptor 50 was prepared.

### Photoreceptor Preparation Example 51

The procedure for preparation of photoreceptor 23 in Photoreceptor Preparation Example 23 was repeated except that dispersion 1 used as the CGL coating liquid was replaced with dispersion 7.

Thus, a photoreceptor 51 was prepared.

### Photoreceptor Preparation Example 52

The procedure for preparation of photoreceptor 24 in Photoreceptor Preparation Example 24 was repeated except that dispersion 1 used as the CGL coating liquid was replaced with dispersion 7.

Thus, a photoreceptor 52 was prepared.

### Photoreceptor Preparation Example 53

The procedure for preparation of photoreceptor 25 in Photoreceptor Preparation Example 25 was repeated except that dispersion 1 used as the CGL coating liquid was replaced with dispersion 7.

Thus, a photoreceptor 53 was prepared.

### Photoreceptor Preparation Example 54

The procedure for preparation of photoreceptor 26 in Photoreceptor Preparation Example 26 was repeated except that dispersion 1 used as the CGL coating liquid was replaced with dispersion 7.

Thus, a photoreceptor 54 was prepared.

### Photoreceptor Preparation Example 55

The procedure for preparation of photoreceptor 27 in Photoreceptor Preparation Example 27 was repeated except that dispersion 1 used as the CGL coating liquid was replaced with dispersion 7.

Thus, a photoreceptor 55 was prepared.

### Examples 79 to 84

The procedure for the running test and evaluation in Example 57 was repeated except that photoreceptor 30 was replaced with each of photoreceptors 50-55. The evaluation results are shown in Table 35.

TABLE 35

| | | | V_{L} (−V) | | | | | |
|---|---|---|---|---|---|---|---|---|
| | | | | After | | | | Abrasion |
| | | T | Initial | 50,000 | | | | loss |
| | No. | (%) | potential | copies | BF | CL | DOT | (μm) |
| Ex. 57 | 30 | 87 | 60 | 75 | Δ | ◯ | ⊚ | 7.0 |
| Ex. 35 | 50 | 87 | 65 | 85 | ⊚ | ◯ | ⊚ | 7.0 |
| Ex. 36 | 51 | 87 | 65 | 80 | ◯ | ◯ | ⊚ | 7.0 |
| Ex. 37 | 52 | 87 | 70 | 90 | ⊚ | ◯ | ⊚ | 7.0 |
| Ex. 38 | 53 | 87 | 75 | 100 | ⊚ | ◯ | ⊚ | 7.0 |
| Ex. 39 | 54 | 87 | 65 | 80 | ◯ | ◯ | ⊚ | 7.0 |
| Ex. 40 | 55 | 87 | 75 | 90 | ⊚ | ◯ | ⊚ | 7.0 |

It is clear from Table 35 that by using a combination of a charge blocking layer and a moiré preventing layer as the intermediate layer, the photoreceptors have good resistance to background fouling.

### Example 85

The procedure for the running test and evaluation in Example 41 was repeated except that photoreceptor 1 was replaced with photoreceptor 30.

The evaluation results are shown in Table 36.

### Example 86

The procedure for the running test and evaluation in Example 85 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 85.

The evaluation results are shown in Table 36.

### Comparative Example 38

The procedure for the running test and evaluation in Example 85 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 85.

The evaluation results are shown in Table 36.

### Comparative Example 39

The procedure for the running test and evaluation in Example 85 was repeated except that the discharging lamp was replaced with a discharging lamp including a LED (from Rohm Co., Ltd.) which emits light having a wavelength of 591 nm and a half width of 15 nm. In this regard, the light intensity of the discharging lamp was controlled so that the potential of the photoreceptor after the discharging process is the same as that in Example 85.

The evaluation results are shown in Table 36.

### Comparative Example 40

The procedure for the running test and evaluation in Example 85 was repeated except that the discharging lamp was replaced with a discharging lamp including a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 85.

The evaluation results are shown in Table 36.

### Comparative Example 41

The procedure for the running test and the evaluation in Example 85 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 85.

The evaluation results are shown in Table 36.

### Comparative Example 42

The procedure for the running test and the evaluation in Example 85 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 85.

The evaluation results are shown in Table 36.

TABLE 36

| | | Transmittance | | |
|---|---|---|---|---|
| | | (T) of | | |
| | Wavelength | protective layer | Potential of lighted portion (V_{L}) | |
| | (λ) of | against | (−V) | |
| | discharging | discharging | At beginning of | After running |
| | light (nm) | light | running test | test |
| Ex. 85 | 428 | 86 | 65 | 80 |
| Ex. 86 | 472 | 87 | 65 | 85 |
| Comp. | 502 | 87 | 65 | 110 |
| Ex. 38 | | | | |
| Comp. | 591 | 88 | 65 | 115 |
| Ex. 39 | | | | |
| Comp. | 630 | 89 | 65 | 120 |
| Ex. 40 | | | | |
| Comp. | White light | — | 65 | 105 |
| Ex. 41 | | | | |
| Comp. | 428 and 630 | 86 and 89 | 65 | 110 |
| Ex. 42 | | | | |

It is clear from Table 36 that when the wavelength of the discharging light is less than 500 nm (Examples 85 and 86), increase in potential (V_{L}) of the lighted portion is lower than that in the cases where the wavelength of the discharging light is not less than 500 nm (Comparative Examples 38-40). In particular, when the wavelength of the discharging light is less than 450 nm (i.e., Example 85), increase in potential (V_{L}) of the lighted portion is lower than that in the case where the wavelength of the discharging light is from 450 to 500 nm (i.e., Example 86).

In addition, it is also found that when discharging light having a wide wavelength range and including light having a relatively long wavelength is used (i.e., Comparative Example 41), such an effect as produced in Examples 85 and 86 cannot be produced. Further, it is found that when a combination of two light sources emitting light with different wavelengths is used (Comparative Example 42), the effect of the light with a relatively short wavelength is reduced.

The image qualities of the color images produced in Examples 85 and 86 were hardly changed before and after the running test. However, the color images produced in Comparative Examples 38-42 after the running test have slightly poor color reproducibility (i.e., the color tones of the color images are changed after the running test).

The azo pigments which has formula (XI) and which are used for the following examples were prepared by the methods described in JP-B 60-29109 and Japanese Patent No. 3,026,645, incorporated by reference.

### Dispersion Preparation Example 10

Formula of Dispersion

| | |
|---|---|
| Azo pigment having the following formula AZO-6 | 5 parts |

| | |
|---|---|
| | AZO-6 |
| 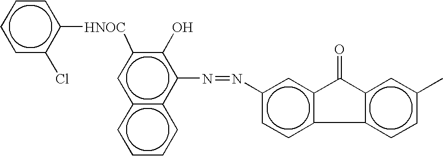 | |

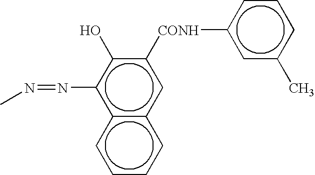

| | |
|---|---|
| Polyvinyl butyral | 2 parts |
| (BX-1 from Sekisui Chemical Co., Ltd.) | |
| Cyclohexanone | 250 parts |
| 2-Butanone | 100 parts |

At first, the polyvinyl butyral resin was dissolved in the solvents. The solution was mixed with the azo pigment and the mixture was subjected to a dispersion treatment for 7 days using a ball mill which includes PSZ balls having a diameter of 10 mm and which is rotated at a revolution of 85 rpm. Thus, a dispersion 10 was prepared.

### Dispersion Preparation Example 11

The procedure for preparation of dispersion 10 in Dispersion Preparation Example 10 was repeated except that the azo pigment was replaced with an azo pigment having the following formula AZO-7.

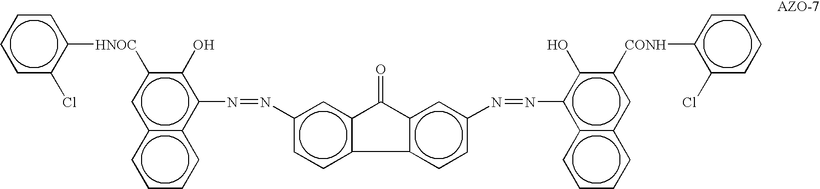

Thus, a dispersion 11 was prepared.

### Dispersion Preparation Example 12

The procedure for preparation of dispersion 11 was repeated except that dispersion 11 was filtered with a cotton wind cartridge filter (TCW-3-CS from Advantech Co., Ltd.) having an effective pore diameter of 3 μm. Filtering was performed under pressure using a pump.

Thus, a dispersion 12 was prepared.

### Dispersion Preparation Example 13

The procedure for preparation of dispersion 12 was repeated except that the filter was replaced with a cotton wind cartridge filter (TCW-5-CS from Advantech Co., Ltd.) having an effective pore diameter of 5 μm.

Thus, a dispersion 13 was prepared.

The particle diameter distribution of the thus prepared dispersions 11 to 13 was measured with a particle diameter measuring instrument (CAPA 700 from Horiba Ltd.). The results are shown in Table 37.

TABLE 37

| | Average particle diameter | Standard deviation of |
|---|---|---|
| Dispersion | (μm) | particle diameter (μm) |
| 10 | 0.26 | 0.18 |
| 11 | 0.27 | 0.17 |
| 12 | 0.20 | 0.15 |
| 13 | 0.23 | 0.17 |

### Photoreceptor Preparation Example 56

The procedure for preparation of photoreceptor 1 in Photoreceptor Preparation Example 1 was repeated except that dispersion 1 used as the CGL coating liquid was replaced with dispersion 10.

Thus, a photoreceptor 56 was prepared.

### Example 87

The procedure for the running test and evaluation in Example 1 was repeated except that photoreceptor 1 was replaced with photoreceptor 56.

The evaluation results are shown in Table 38.

### Example 88

The procedure for the running test and evaluation in Example 87 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 87.

The evaluation results are shown in Table 38.

### Comparative Example 43

The procedure for the running test and evaluation in Example 87 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 87.

The evaluation results are shown in Table 38.

### Comparative Example 44

The procedure for the running test and evaluation in Example 87 was repeated except that the discharging lamp was replaced with a discharging lamp including a LED (from Seiwa Electric Mfg. Co., Ltd.) which emits light having a wavelength of 591 nm and a half width of 15 nm. In this regard, the light intensity of the discharging lamp was controlled so that the potential of the photoreceptor after the discharging process is the same as that in Example 87.

The evaluation results are shown in Table 38.

### Comparative Example 45

The procedure for the running test and evaluation in Example 87 was repeated except that the discharging lamp was replaced with a discharging lamp including a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 87.

The evaluation results are shown in Table 38.

### Comparative Example 46

The procedure for the running test and evaluation in Example 87 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 87.

The evaluation results are shown in Table 38.

### Comparative Example 47

The procedure for the running test and evaluation in Example 87 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 87.

The evaluation results are shown in Table 38.

TABLE 38

| | | | Beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 87 | 428 | 86 | 900 | 50 | 900 | 60 |
| Ex. 88 | 472 | 87 | 900 | 50 | 900 | 65 |
| Comp. Ex. | 502 | 87 | 900 | 50 | 900 | 90 |
| 43 | | | | | | |
| Comp. Ex. | 591 | 88 | 900 | 50 | 900 | 95 |
| 44 | | | | | | |
| Comp. Ex. | 630 | 89 | 900 | 50 | 900 | 100 |
| 45 | | | | | | |
| Comp. Ex. | White | — | 900 | 50 | 900 | 85 |
| 46 | light | | | | | |
| Comp. Ex. | 428, | 86, | 900 | 50 | 900 | 90 |
| 47 | 630 | 89 | | | | |

It is clear from Table 38 that when the wavelength of the discharging light is less than 500 nm (Examples 87 and 88), increase in potential (V_{L}) of the lighted portion is lower than that in the cases where the wavelength of the discharging light is not less than 500 nm (Comparative Examples 43-45). In particular, when the wavelength of the discharging light is less than 450 nm (i.e., Example 87), increase in potential (V_{L}) of the lighted portion is lower than that in Example 88.

In addition, it is also found that when discharging light having a wide wavelength range and including light having a relatively long wavelength is used (i.e., Comparative Example 46), such an effect as produced in Examples 87 and 88 cannot be produced. Further, it is found that when a combination of two light sources emitting light with different wavelengths is used (Comparative Example 47), the effect of the light having a relatively short wavelength is reduced.

### Photoreceptor Preparation Example 57

The procedure for preparation of photoreceptor 56 in Photoreceptor Preparation Example 56 was repeated except that dispersion 10 used as the CGL coating liquid was replaced with dispersion 11.

Thus, a photoreceptor 57 was prepared.

### Example 89

The procedure for the running test and evaluation in Example 87 was repeated except that photoreceptor 56 was replaced with photoreceptor 57.

The evaluation results are shown in Table 39.

### Example 90

The procedure for the running test and evaluation in Example 88 was repeated except that photoreceptor 56 was replaced with photoreceptor 57.

The evaluation results are shown in Table 39.

### Comparative Example 48

The procedure for the running test and evaluation in Comparative Example 43 was repeated except that photoreceptor 56 was replaced with photoreceptor 57.

The evaluation results are shown in Table 39.

### Comparative Example 49

The procedure for the running test and evaluation in Comparative Example 44 was repeated except that photoreceptor 56 was replaced with photoreceptor 57.

The evaluation results are shown in Table 39.

### Comparative Example 50

The procedure for the running test and evaluation in Comparative Example 45 was repeated except that photoreceptor 56 was replaced with photoreceptor 57.

The evaluation results are shown in Table 39.

### Comparative Example 51

The procedure for the running test and evaluation in Comparative Example 46 was repeated except that photoreceptor 56 was replaced with photoreceptor 57.

The evaluation results are shown in Table 39.

TABLE 39

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 89 | 428 | 86 | 900 | 70 | 900 | 80 |
| Ex. 90 | 472 | 87 | 900 | 70 | 900 | 85 |
| Comp. Ex. | 502 | 87 | 900 | 70 | 900 | 110 |
| 48 | | | | | | |
| Comp. Ex. | 591 | 88 | 900 | 70 | 900 | 115 |
| 49 | | | | | | |
| Comp. Ex. | 630 | 89 | 900 | 70 | 900 | 120 |
| 50 | | | | | | |
| Comp. Ex. | White | — | 900 | 70 | 900 | 105 |
| 51 | light | | | | | |

It is clear from Table 39 that when the wavelength of the discharging light is less than 500 nm (Examples 89 to 90), increase in potential (V_{L}) of the lighted portion is lower than that in the cases where the wavelength of the discharging light is not less than 500 nm (Comparative Examples 48-50). In particular, when the wavelength of the discharging light is less than 450 nm (i.e., Example 89), increase in residual potential (V_{L}) of the lighted portion is lower than that in Example 90.

In addition, it is also found that when discharging light having a wide wavelength range and including light having a relatively long wavelength is used (i.e., Comparative Example 51), such an effect as produced in Examples 89 and 90 cannot be produced.

In addition, the residual potential (V_{L}) in Example 87 (shown in Table 38) is lower than that in Example 89. This is because the azo dye which is used for photoreceptor 56 used in Example 87 which includes an asymmetric coupler component enhances the photosensitivity of the photoreceptor.

### Example 91

The procedure for the running test and evaluation in Example 87 was repeated except that the laser diode for use as the image writing light source was replaced with a laser diode emitting light with a wavelength of 408 nm. In addition, a one-dot image including one-dot images having a diameter of 60 μm was produced and the image was observed with a microscope with 150-power magnification.

The evaluation results are shown in Table 40.

TABLE 40

| | | | Beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 87 | 428 | 86 | 900 | 50 | 900 | 60 |
| Ex. 91 | 428 | 86 | 900 | 50 | 900 | 55 |

When electrostatic latent images are written using light with a relatively short wavelength of 408 nm (Example 91), increase in residual potential (V_{L}) can be reduced. In addition, it is found that the dot images produced in Example 91 have clearer outline than the dot images produced in Example 87.

### Photoreceptor Preparation Example 58

The procedure for preparation of photoreceptor 56 in Photoreceptor Preparation Example 56 was repeated except that the CTL coating liquid was replaced with a CTL coating liquid having the following formula.

Formula of CTL Coating Liquid

| | |
|---|---|
| Polycarbonate | 10 parts |
| (TS2050 from Teijin Chemicals Ltd.) | |
| CTM having formula CTM-2 mentioned above | 7 parts |
| Methylene chloride | 80 parts |

Thus, a photoreceptor 58 was prepared.

### Example 92

The procedure for the running test and the evaluation in Example 6 was repeated except that photoreceptor 3 was replaced with photoreceptor 58.

The evaluation results are shown in Table 41.

### Example 93

The procedure for the running test and the evaluation in Example 92 was repeated except that the homogenous light used as the discharging light was changed to homogeneous light with a wavelength of 443 nm by changing the conditions of the monochrometor.

The evaluation results are shown in Table 41.

### Example 94

The procedure for the running test and the evaluation in Example 92 was repeated except that the homogenous light used as the discharging light was changed to homogeneous light with a wavelength of 437 nm by changing the conditions of the monochrometor.

The evaluation results are shown in Table 41.

### Example 95

The procedure for the running test and the evaluation in Example 92 was repeated except that the homogenous light used as the discharging light was changed to homogeneous light with a wavelength of 433 nm by changing the conditions of the monochrometor.

The evaluation results are shown in Table 41.

### Example 96

The procedure for the running test and the evaluation in Example 92 was repeated except that the homogenous light used as the discharging light was changed to homogeneous light with a wavelength of 429 nm by changing the conditions of the monochrometor.

The evaluation results are shown in Table 41.

TABLE 41

| | | | Beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 92 | 461 | 85 | 900 | 60 | 900 | 70 |
| Ex. 93 | 443 | 69 | 900 | 60 | 900 | 70 |
| Ex. 94 | 437 | 49 | 900 | 60 | 900 | 70 |
| Ex. 95 | 433 | 29 | 900 | 60 | 900 | 80 |
| Ex. 96 | 429 | 9 | 900 | 60 | 900 | 80 |

It is clear from Table 41 that when the transmittance of the CTL against the discharging light is less than about 30%, the discharging effect slightly deteriorates.

In addition, it is found that the half tone images produced in Examples 92 to 94 are normal but the half tone images produced in Examples 95 and 96 includes a slight residual image of the stripe image although the half tone images are still acceptable. The residual stripe image in the image produced in Example 96 is relatively noticeable compared to that in Example 95.

Thus, it is discovered that even when light with a wavelength of less than 500 nm is used as the discharging light, a minor side effect is produced if the transmittance of the CTL against the light is less than 30%.

### Photoreceptor Preparation Example 59

The procedure for preparation of photoreceptor 56 in Photoreceptor Preparation Example 56 was repeated except that dispersion 10 used for the CGL coating liquid was replaced with dispersion 12.

Thus, a photoreceptor 59 was prepared.

### Photoreceptor Preparation Example 60

The procedure for preparation of photoreceptor 56 in Photoreceptor Preparation Example 56 was repeated except that dispersion 10 used for the CGL coating liquid was replaced with dispersion 13.

Thus, a photoreceptor 60 was prepared.

### Example 97

The procedure for the running test and evaluation in Example 87 was repeated except that photoreceptor 56 was replaced with photoreceptor 59 and a white solid image was produced to determine whether the white solid image has background fouling. The level of background fouling was classified into the following four grades while considering the number and size of black spots formed on the white solid image.

⊚: Excellent

◯: Good

Δ: Acceptable

X: Bad

The evaluation results are shown in Table 42.

### Example 98

The procedure for the running test and evaluation in Example 87 was repeated except that photoreceptor 56 was replaced with photoreceptor 60 and a white solid image was produced to determine whether the white solid image has background fouling.

The evaluation results are shown in Table 42.

TABLE 42

| | Beginning of | | | | |
|---|---|---|---|---|---|
| | running test | | After running test | | Background |
| | V_{D} (−V) | V_{L} (−V) | V_{D} (−V) | V_{L} (−V) | fouling |
| Ex. 87 | 900 | 50 | 900 | 60 | Δ-◯ |
| Ex. 97 | 900 | 45 | 900 | 50 | ⊚ |
| Ex. 98 | 900 | 45 | 900 | 55 | ◯ |

It is clear from Table 42 that when the average particle diameter of the CGM dispersed in the CGL coating liquid is less than 0.25 μm (Examples 97 and 98), the initial potential of a lighted portion (V_{L}) can be reduced and in addition occurrence of background fouling can be prevented without increasing the potential of a lighted portion even after long repeated use.

### Photoreceptor Preparation Example 61

The procedure for preparation of photoreceptor 6 in Photoreceptor Preparation Example 6 was repeated except that dispersion 1 used as the CGL coating liquid was replaced with dispersion 10.

Thus, a photoreceptor 61 was prepared.

### Photoreceptor Preparation Example 62

The procedure for preparation of photoreceptor 7 in Photoreceptor Preparation Example 7 was repeated except that dispersion 1 used as the CGL coating liquid was replaced with dispersion 10.

Thus, a photoreceptor 62 was prepared.

### Photoreceptor Preparation Example 63

The procedure for preparation of photoreceptor 8 in Photoreceptor Preparation Example 8 was repeated except that dispersion 1 used as the CGL coating liquid was replaced with dispersion 10.

Thus, a photoreceptor 63 was prepared.

### Photoreceptor Preparation Example 64

The procedure for preparation of photoreceptor 9 in Photoreceptor Preparation Example 9 was repeated except that dispersion 1 used as the CGL coating liquid was replaced with dispersion 10.

Thus, a photoreceptor 64 was prepared.

### Photoreceptor Preparation Example 65

The procedure for preparation of photoreceptor 10 in Photoreceptor Preparation Example 10 was repeated except that dispersion 1 used as the CGL coating liquid was replaced with dispersion 10.

Thus, a photoreceptor 65 was prepared.

### Photoreceptor Preparation Example 66

The procedure for preparation of photoreceptor 11 in Photoreceptor Preparation Example 11 was repeated except that dispersion 1 used as the CGL coating liquid was replaced with dispersion 10.

Thus, a photoreceptor 66 was prepared.

### Photoreceptor Preparation Example 67

The procedure for preparation of photoreceptor 12 in Photoreceptor Preparation Example 12 was repeated except that dispersion 1 used as the CGL coating liquid was replaced with dispersion 10.

Thus, a photoreceptor 67 was prepared.

### Photoreceptor Preparation Example 68

The procedure for preparation of photoreceptor 13 in Photoreceptor Preparation Example 13 was repeated except that dispersion 1 used as the CGL coating liquid was replaced with dispersion 10.

Thus, a photoreceptor 68 was prepared.

### Photoreceptor Preparation Example 69

The procedure for preparation of photoreceptor 14 in Photoreceptor Preparation Example 14 was repeated except that dispersion 1 used as the CGL coating liquid was replaced with dispersion 10.

Thus, a photoreceptor 69 was prepared.

### Photoreceptor Preparation Example 70

The procedure for preparation of photoreceptor 15 in Photoreceptor Preparation Example 15 was repeated except that dispersion 1 used as the CGL coating liquid was replaced with dispersion 10.

Thus, a photoreceptor 70 was prepared.

### Photoreceptor Preparation Example 71

The procedure for preparation of photoreceptor 16 in Photoreceptor Preparation Example 16 was repeated except that dispersion 1 used as the CGL coating liquid was replaced with dispersion 10.

Thus, a photoreceptor 71 was prepared.

### Photoreceptor Preparation Example 72

The procedure for preparation of photoreceptor 17 in Photoreceptor Preparation Example 17 was repeated except that dispersion 1 used as the CGL coating liquid was replaced with dispersion 10.

Thus, a photoreceptor 72 was prepared.

### Photoreceptor Preparation Example 73

The procedure for preparation of photoreceptor 18 in Photoreceptor Preparation Example 18 was repeated except that dispersion 1 used as the CGL coating liquid was replaced with dispersion 10.

Thus, a photoreceptor 73 was prepared.

### Photoreceptor Preparation Example 74

The procedure for preparation of photoreceptor 19 in Photoreceptor Preparation Example 19 was repeated except that dispersion 1 used as the CGL coating liquid was replaced with dispersion 10.

Thus, a photoreceptor 74 was prepared.

### Photoreceptor Preparation Example 75

The procedure for preparation of photoreceptor 20 in Photoreceptor Preparation Example 20 was repeated except that dispersion 1 used as the CGL coating liquid was replaced with dispersion 10.

Thus, a photoreceptor 75 was prepared.

### Photoreceptor Preparation Example 76

The procedure for preparation of photoreceptor 21 in Photoreceptor Preparation Example 21 was repeated except that dispersion 1 used as the CGL coating liquid was replaced with dispersion 10.

Thus, a photoreceptor 76 was prepared.

### Example 99

The procedure for the running test and evaluation in Example 13 was repeated except that photoreceptor 1 was replaced with photoreceptor 56.

The evaluation results are shown in Table 43.

### Examples 100-115

The procedure for the running test and evaluation in Example 99 was repeated except that photoreceptor 56 was replaced with each of photoreceptors 61-76.

The evaluation results are shown in Table 43.

TABLE 43

| | | | V_{L} (−V) | | | | | |
|---|---|---|---|---|---|---|---|---|
| | | | | After | | | | Abrasion |
| | | T | | 50,000 | | | | Loss |
| | No. | (%) | Initial | copies | BF | CL | DOT | (μm) |
| Ex. 99 | 56 | 87 | 50 | 65 | Δ | ◯ | ⊚ | 7.0 |
| Ex. 100 | 61 | 85 | 50 | 65 | Δ-◯ | ◯-⊚ | ⊚ | 4.0 |
| Ex. 101 | 62 | 80 | 55 | 75 | ⊚ | Δ-◯ | ◯-⊚ | 2.0 |
| Ex. 102 | 63 | 78 | 60 | 80 | ⊚ | Δ-◯ | ◯ | 1.8 |
| Ex. 103 | 64 | 80 | 50 | 70 | ◯ | Δ-◯ | Δ-◯ | 2.0 |
| Ex. 104 | 65 | 77 | 60 | 75 | ⊚ | Δ-◯ | ◯ | 1.6 |
| Ex. 105 | 66 | 85 | 60 | 75 | ◯-⊚ | ◯ | ◯ | 2.5 |
| Ex. 106 | 67 | 81 | 65 | 80 | ⊚ | Δ-◯ | Δ-◯ | 1.6 |
| Ex. 107 | 68 | 85 | 60 | 75 | ⊚ | ⊚ | ⊚ | 1.4 |
| Ex. 108 | 69 | 85 | 60 | 75 | ◯ | ⊚ | ⊚ | 1.2 |
| Ex. 109 | 70 | 85 | 60 | 75 | ⊚ | Δ-◯ | ⊚ | 2.6 |
| Ex. 110 | 71 | 85 | 60 | 75 | ⊚ | ⊚ | ⊚ | 1.4 |
| Ex. 111 | 72 | 83 | 60 | 80 | ⊚ | Δ-◯ | ⊚ | 1.2 |
| Ex. 112 | 73 | 84 | 55 | 70 | ◯-⊚ | ⊚ | ⊚ | 1.6 |
| Ex. 113 | 74 | 84 | 65 | 80 | ⊚ | ⊚ | ⊚ | 1.4 |
| Ex. 114 | 75 | 80 | 50 | 65 | ◯-⊚ | ⊚ | ⊚ | 1.8 |
| Ex. 115 | 76 | 85 | 70 | 80 | ⊚ | ⊚ | ⊚ | 1.4 |

No.: Number of photoreceptor used
T: Transmittance of protective layer or CTL against the discharging light

It is clear from Table 43 that even when a protective layer is formed, the following knowledge can be obtained.

(1) Even in photoreceptors having a protective layer, the residual potential increasing problem can be avoided if light with a wavelength less than 500 nm is used as the discharging light;

(2) The photoreceptor (Example 100) including a charge transport polymer (polycarbonate resin having a triarylamine structure) in the CTL has better abrasion resistance than the photoreceptor (Example 58) including a low molecular weight CTM in the CTL (Example 57);

(3) The photoreceptors (Examples 101-115) including a protective layer have better abrasion resistance than the photoreceptor (Example 99) including no protective layer;

(4) Among the photoreceptors having a protective layer including a particulate inorganic material (Examples 101-103), the photoreceptors (Examples 101 and 102) having a protective layer including a particulate inorganic material having a resistivity not less than 10¹⁰ Ω·cm have good dot reproducibility even under high temperature and high humidity conditions;

(5) The photoreceptors having a crosslinked protective layer have better abrasion resistance than the photoreceptor having a non-crosslinked protective layer, in particular, the photoreceptors of Examples 107, 108, 110, and 112-115 having a crosslinked protective layer which is prepared using a tri- or more-functional monomer having no charge transport structure and a monofunctional monomer having a charge transport structure have excellent abrasion resistance; and

(6) the photoreceptors (Examples 107, 108, 110, and 112-115) also have excellent cleanability.

### Comparative Example 52

The procedure for the running test and the evaluation of the images in Example 107 was repeated except that the laser diode was replaced with a laser diode (from Seiwa Electric Mfg. Co., Ltd.) emitting light with a wavelength of 502 nm and a half width of 15 nm. The light intensity was controlled so that the initial potential (V_{L}) of a lighted portion is the same as that in Example 107.

The evaluation results are shown in Table 44.

### Comparative Example 53

The procedure for the running test and the evaluation of the images in Example 107 was repeated except that the laser diode was replaced with a laser diode (from Rohm Co., Ltd.) emitting light with a wavelength of 591 nm and a half width of 15 nm. The light intensity was controlled so that the initial potential (V_{L}) of a lighted portion is the same as that in Example 107.

The evaluation results are shown in Table 44.

### Comparative Example 54

The procedure for the running test and the evaluation of the images in Example 107 was repeated except that the laser diode was replaced with a laser diode (from Rohm Co., Ltd.) emitting light with a wavelength of 630 nm and a half width of 20 nm. The light intensity was controlled so that the initial potential (V_{L}) of a lighted portion is the same as that in Example 107.

The evaluation results are shown in Table 44.

### Comparative Example 55

The procedure for the running test and the evaluation of the images in Example 107 was repeated except that the laser diode was replaced with a fluorescent lamp emitting light having a spectrum illustrated in FIG. 1. The light intensity was controlled so that the initial potential (V_{L}) of a lighted portion is the same as that in Example 107.

The evaluation results are shown in Table 44.

TABLE 44

| | | Transmittance | | |
|---|---|---|---|---|
| | | of | | |
| | Wavelength | protective layer | Potential of lighted portion (V_{L}) | |
| | of | against | (−V) | |
| | discharging | discharging | At beginning of | After running |
| | light (nm) | light | running test | test |
| Ex. 107 | 472 | 85 | 60 | 75 |
| Comp. | 502 | 85 | 60 | 105 |
| Ex. 52 | | | | |
| Comp. | 591 | 89 | 60 | 110 |
| Ex. 53 | | | | |
| Comp. | 630 | 90 | 60 | 115 |
| Ex. 54 | | | | |
| Comp. | White light | — | 60 | 100 |
| Ex. 55 | | | | |

It is clear from Table 44 that when the wavelength of the discharging light is less than 500 nm (Example 107), increase in the potential (V_{L}) is smaller than in Comparative Examples 52-54 using discharging light with a wavelength of not less than 500 nm. In addition, when the discharging light has light including components with a relatively long wavelength of not less than 500 nm (Comparative Example 55), the effect produced in Example 107 cannot be produced.

### Example 116

The procedure for the running test and evaluation in Example 30 was repeated except that photoreceptor 13 was replaced with photoreceptor 68.

The evaluation results are shown in Table 45.

### Example 117

The procedure for the running test and the evaluation in Example 116 was repeated except that the homogenous light used as the discharging light was changed to homogeneous light with a wavelength of 400 nm by changing the conditions of the monochrometor.

The evaluation results are shown in Table 45.

### Example 118

The procedure for the running test and the evaluation in Example 116 was repeated except that the homogenous light used as the discharging light was changed to homogeneous light with a wavelength of 393 nm by changing the conditions of the monochrometor.

The evaluation results are shown in Table 45.

### Example 119

The procedure for the running test and the evaluation in Example 116 was repeated except that the homogenous light used as the discharging light was changed to homogeneous light with a wavelength of 390 nm by changing the conditions of the monochrometor.

The evaluation results are shown in Table 45.

### Example 120

The procedure for the running test and the evaluation in Example 116 was repeated except that the homogenous light used as the discharging light was changed to homogeneous light with a wavelength of 385 nm by changing the conditions of the monochrometor.

The evaluation results are shown in Table 45.

TABLE 45

| | | Transmittance | | |
|---|---|---|---|---|
| | | of | | |
| | Wavelength | protective layer | Potential of lighted portion (V_{L}) | |
| | of | against | (−V) | |
| | discharging | discharging | At beginning of | After running |
| | light (nm) | light | running test | test |
| Ex. 116 | 450 | 85 | 60 | 75 |
| Ex. 117 | 400 | 73 | 60 | 75 |
| Ex. 118 | 393 | 50 | 60 | 75 |
| Ex. 119 | 390 | 29 | 60 | 80 |
| Ex. 120 | 385 | 9 | 60 | 80 |

It is clear from Table 45 that when the transmittance of the protective layer against the discharging light is less than about 30%, the discharging effect slightly deteriorates.

In addition, it is found that the half tone images produced in Examples 116 to 118 are normal but the half tone images produced in Examples 119 and 120 include a slight residual image of the stripe image formed on an upper portion of each copy although the half tone images are still acceptable. The residual stripe image in the image produced in Example 120 is relatively noticeable compared to that in Example 119.

Thus, it is discovered that even when light with a wavelength of less than 500 nm is used as the discharging light, a minor side effect is produced if the transmittance of the protective layer against the light is less than 30%.

### Photoreceptor Preparation Example 77

The procedure for preparation of photoreceptor 22 in Photoreceptor Preparation Example 22 was repeated except that dispersion 1 used as the CGL coating liquid was replaced with dispersion 10.

Thus, a photoreceptor 77 was prepared.

### Photoreceptor Preparation Example 78

The procedure for preparation of photoreceptor 23 in Photoreceptor Preparation Example 23 was repeated except that dispersion 1 used as the CGL coating liquid was replaced with dispersion 10.

Thus, a photoreceptor 78 was prepared.

### Photoreceptor Preparation Example 79

The procedure for preparation of photoreceptor 24 in Photoreceptor Preparation Example 24 was repeated except that dispersion 1 used as the CGL coating liquid was replaced with dispersion 10.

Thus, a photoreceptor 79 was prepared.

### Photoreceptor Preparation Example 80

The procedure for preparation of photoreceptor 25 in Photoreceptor Preparation Example 25 was repeated except that dispersion 1 used as the CGL coating liquid was replaced with dispersion 10.

Thus, a photoreceptor 80 was prepared.

### Photoreceptor Preparation Example 81

The procedure for preparation of photoreceptor 26 in Photoreceptor Preparation Example 26 was repeated except that dispersion 1 used as the CGL coating liquid was replaced with dispersion 10.

Thus, a photoreceptor 81 was prepared.

### Photoreceptor Preparation Example 82

The procedure for preparation of photoreceptor 27 in Photoreceptor Preparation Example 27 was repeated except that dispersion 1 used as the CGL coating liquid was replaced with dispersion 10.

Thus, a photoreceptor 82 was prepared.

### Examples 121 to 126

The procedure for the running test and evaluation in Example 99 was repeated except that photoreceptor 56 was replaced with each of photoreceptors 77-82. The evaluation results are shown in Table 46.

TABLE 46

| | | | V_{L} (−V) | | | | | |
|---|---|---|---|---|---|---|---|---|
| | | | | After | | | | Abrasion |
| | | T | | 50,000 | | | | Loss |
| | No. | (%) | Initial | copies | BF | CL | DOT | (μm) |
| Ex. 99 | 56 | 87 | 55 | 70 | Δ | ◯ | ⊚ | 7.0 |
| Ex. 121 | 77 | 87 | 55 | 75 | ⊚ | ◯ | ⊚ | 7.0 |
| Ex. 122 | 78 | 87 | 55 | 70 | ◯ | ◯ | ⊚ | 7.0 |
| Ex. 123 | 79 | 87 | 60 | 80 | ⊚ | ◯ | ⊚ | 7.0 |
| Ex. 124 | 80 | 87 | 65 | 90 | ⊚ | ◯ | ⊚ | 7.0 |
| Ex. 125 | 81 | 87 | 55 | 70 | ◯ | ◯ | ⊚ | 7.0 |
| Ex. 126 | 82 | 87 | 65 | 80 | ⊚ | ◯ | ⊚ | 7.0 |

It is clear from Table 46 that by using a combination of a charge blocking layer and a moiré preventing layer as the intermediate layer, the photoreceptors have good resistance to background fouling.

### Example 127

The procedure for the running test and evaluation in Example 41 was repeated except that photoreceptor 1 was replaced with photoreceptor 56.

The evaluation results are shown in Table 47.

### Example 128

The procedure for the running test and evaluation in Example 127 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 128.

The evaluation results are shown in Table 47.

### Comparative Example 56

The procedure for the running test and evaluation in Example 127 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 127.

The evaluation results are shown in Table 47.

### Comparative Example 57

The procedure for the running test and evaluation in Example 127 was repeated except that the discharging lamp was replaced with a discharging lamp including a LED (from Rohm Co., Ltd.) which emits light having a wavelength of 591 nm and a half width of 15 nm. In this regard, the light intensity of the discharging lamp was controlled so that the potential of the photoreceptor after the discharging process is the same as that in Example 127.

The evaluation results are shown in Table 47.

### Comparative Example 58

The procedure for the running test and evaluation in Example 127 was repeated except that the discharging lamp was replaced with a discharging lamp including a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 127.

The evaluation results are shown in Table 47.

### Comparative Example 59

The procedure for the running test and the evaluation in Example 127 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 127.

The evaluation results are shown in Table 47.

### Comparative Example 60

The procedure for the running test and the evaluation in Example 127 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 127.

The evaluation results are shown in Table 47.

TABLE 47

| | | Transmittance | | |
|---|---|---|---|---|
| | | of | | |
| | Wavelength | protective layer | Potential of lighted portion (V_{L}) | |
| | of | against | (−V) | |
| | discharging | discharging | At beginning of | After running |
| | light (nm) | light | running test | test |
| Ex. 127 | 428 | 86 | 55 | 65 |
| Ex. 128 | 472 | 87 | 55 | 70 |
| Comp. | 502 | 87 | 55 | 95 |
| Ex. 56 | | | | |
| Comp. | 591 | 88 | 55 | 100 |
| Ex. 57 | | | | |
| Comp. | 630 | 89 | 55 | 105 |
| Ex. 58 | | | | |
| Comp. | White light | — | 55 | 90 |
| Ex. 59 | | | | |
| Comp. | 428 and 630 | 86 and 89 | 55 | 95 |
| Ex. 60 | | | | |

It is clear from Table 47 that when the wavelength of the discharging light is less than 500 nm (Examples 127 and 128), increase in potential (V_{L}) of the lighted portion is lower than that in the cases where the wavelength of the discharging light is not less than 500 nm (Comparative Examples 56-58). In particular, when the wavelength of the discharging light is less than 450 nm (i.e., Example 127), increase in potential (V_{L}) of the lighted portion is lower than that in Example 128.

In addition, it is also found that when discharging light having a wide wavelength range and including light having a relatively long wavelength is used (i.e., Comparative Example 59), such an effect as produced in Examples 127 and 128 cannot be produced. Further, it is found that when a combination of two light sources emitting light with different wavelengths is used (Comparative Example 60), the effect of the light having a relatively short wavelength is reduced.

The image qualities of the color images produced in Examples 127 and 128 were hardly changed before and after the running test. However, the color images produced in Comparative Examples 56-60 after the running test have slightly poor color reproducibility (i.e., the color tones of the color images are changed after the running test).

The CGMs, phthalocyanines, which are used for the following examples, were prepared by the methods described in Japanese Patents Nos. 3,123,185 and 3,166,293, incorporated herein by reference.

### Synthesis Example 1

A chlorogallium phthalocyanine was prepared by the method described in synthesis examples and Example 2 of Japanese Patent No. 3,123,185.

Specifically, the following components were mixed.

| | |
|---|---|
| 1,3-Diiminoisoindoline | 30 parts |
| Trichlorogallium | 9.1 parts |
| Quionoline | 230 parts |

The mixture was heated for 3 hours at 200° C. to perform a reaction. The reaction product was filtered, and the cake was washed with acetone, followed by washing with methanol and drying. Thus, a chlorogallium phthalocyanine was prepared.

The thus prepared chlorogallium phthalocyanine was subjected to a dry grinding treatment using an automatic mortar. Next, 0.5 parts of the chlorogallium phthalocyanine was mixed with 20 parts of a mixture solvent of water and chlorobenzene (mixing ratio of 1/10) and the mixture was subjected to ball milling for 24 hours at room temperature using a ball mill including glass beads having a diameter of 1 mm. The resultant dispersion was filtered and the wet cake was washed with 10 parts of methanol, followed by drying. Thus, a chlorogallium phthalocyanine crystal (hereinafter referred to as a phthalocyanine crystal 1) was prepared.

The thus prepared phthalocyanine crystal 1 was subjected to an X-ray diffraction analysis under the following conditions.

X-Ray Diffraction Spectrum Measuring Conditions

X-ray tube: Cu

X-ray used: Cu—K_{α} having a wavelength of 1.542 Å

Voltage: 50 kV

Current: 30 mA

Scanning speed: 2°/min

Scanning range: 3° to 40°

Time constant: 2 seconds

The phthalocyanine crystal 1 has an X-ray diffraction spectrum such that a strong peak is observed at each of Bragg (2 θ) angle of 7.4°, 16.6°, 25.5° and 28.3°. Namely, the spectrum of the crystal 1 is the same as the spectrum illustrated in FIG. 7 of the Japanese Patent No. 3,123,185.

### Synthesis Example 2

A chlorogallium phthalocyanine was prepared by the method described in synthesis examples and Example 2 of Japanese Patent No. 3,166,293.

Specifically, the following components were mixed.

| | |
|---|---|
| 1,3-Diiminoisoindoline | 30 parts |
| Trichlorogallium | 9.1 parts |
| Quionoline | 230 parts |

The mixture was heated for 3 hours at 200° C. to perform a reaction. The reaction product was filtered, and the cake was washed with acetone, followed by washing with methanol and drying. Thus, 28 parts of a chlorogallium phthalocyanine was prepared.

Next, 3 parts of the chlorogallium phthalocyanine was dissolved in 60 parts of concentrated sulfuric acid and the solution was dropped into 450 parts of distilled water at 5° C. to precipitate a crystal. The crystal was washed with distilled water and dilute ammonia water. Thus, 2.5 parts of a hydroxygallium phthalocyanine was prepared. Next, 0.5 parts of the hydroxygallium phthalocyanine was mixed with 15 parts of dimethylformamide and the mixture was subjected to ball milling for 24 hours at room temperature using a ball mill including 30 parts of glass beads having a diameter of 1 mm. The hydroxygallium phthalocyanine was then separated from the solvent, followed by washing with methanol and drying. Thus, a hydroxygallium phthalocyanine was prepared (hereinafter referred to as phthalocyanine crystal 2).

The thus prepared phthalocyanine crystal 1 was subjected to the X-ray diffraction analysis under the above-mentioned conditions.

The phthalocyanine crystal 2 has an X-ray diffraction spectrum such that a strong peak is observed at each of Bragg (2 θ) angle of 7.5°, 9.9°, 12.5°, 16.3°, 18.6°, 25.1° and 28.30. Namely, the spectrum of the crystal 1 is the same as the spectrum illustrated in FIG. 8 of the Japanese Patent No. 3,166,293.

### Dispersion Preparation Example 14

Formula of Dispersion

| | |
|---|---|
| Phthalocyanine crystal 1 | 15 parts |
| Polyvinyl butyral | 10 parts |
| (BX-1 from Sekisui Chemical Co., Ltd.) | |
| Cyclohexanone | 500 parts |

At first, the polyvinyl butyral resin was dissolved in the solvent. The solution was mixed with phthalocyanine crystal 1 and the mixture was subjected to a dispersion treatment for 30 minutes using a bead mill which includes PSZ balls having a diameter of 0.5 mm and which is rotated at a revolution of 1200 rpm.

Thus, a dispersion 14 was prepared.

### Dispersion Preparation Example 15

The procedure for preparation of dispersion 14 was repeated except that phthalocyanine crystal 1 was replaced with phthalocyanine crystal 2.

Thus, a dispersion 15 was prepared.

### Dispersion Preparation Example 16

The procedure for preparation of dispersion 15 was repeated except that dispersion 15 was filtered with a cotton wind cartridge filter (TCW-3-CS from Advantech Co., Ltd.) having an effective pore diameter of 3 μm. Filtering was performed under pressure using a pump.

Thus, a dispersion 16 was prepared.

### Dispersion Preparation Example 17

The procedure for preparation of dispersion 15 was repeated except that the filter was replaced with a cotton wind cartridge filter (TCW-5-CS from Advantech Co., Ltd.) having an effective pore diameter of 5 μm.

Thus, a dispersion 17 was prepared.

The particle diameter distribution of the thus prepared dispersions 14 to 17 was measured with a particle diameter measuring instrument (CAPA 700 from Horiba Ltd.). The results are shown in Table 48.

TABLE 48

| | Average particle diameter | Standard deviation of |
|---|---|---|
| Dispersion | (μm) | particle diameter (μm) |
| 14 | 0.27 | 0.17 |
| 15 | 0.28 | 0.18 |
| 16 | 0.23 | 0.15 |
| 17 | 0.25 | 0.17 |

### Photoreceptor Preparation Example 83

The procedure for preparation of the photoreceptor 1 in Photoreceptor Preparation Example 1 was repeated except that the CGL coating liquid was replaced with dispersion 15.

Thus, a photoreceptor 83 was prepared.

### Example 129

The procedure for the running test and evaluation in Example 1 was repeated except that photoreceptor 1 was replaced with photoreceptor 83.

The evaluation results are shown in Table 49.

### Example 130

The procedure for the running test and the evaluation in Example 129 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 129.

The evaluation results are shown in Table 49.

### Comparative Example 61

The procedure for the running test and the evaluation in Example 129 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 129.

The evaluation results are shown in Table 49.

### Comparative Example 62

The procedure for the running test and the evaluation in Example 129 was repeated except that the discharging lamp was replaced with a discharging lamp including a LED (from Seiwa Electric Mfg. Co., Ltd.) which emits light having a wavelength of 591 nm and a half width of 15 nm. In this regard, the light intensity of the discharging lamp was controlled so that the potential of the photoreceptor after the discharging process is the same as that in Example 129.

The evaluation results are shown in Table 49.

### Comparative Example 63

The procedure for the running test and the evaluation in Example 129 was repeated except that the discharging lamp was replaced with a discharging lamp including a LED (from Rohm Co., Ltd.) which emits light having a wavelength of 630 m and a half width of 20 nm. In this regard, the light intensity of the discharging lamp was controlled so that the potential of the photoreceptor after the discharging process is the same as that in Example 129.

The evaluation results are shown in Table 49.

### Comparative Example 64

The procedure for the running test and the evaluation in Example 129 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 129.

The evaluation results are shown in Table 49.

### Comparative Example 65

The procedure for the running test and the evaluation in Example 129 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 129.

The evaluation results are shown in Table 49.

TABLE 49

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 129 | 428 | 86 | 900 | 140 | 900 | 145 |
| Ex. 130 | 472 | 87 | 900 | 140 | 900 | 150 |
| Comp. Ex. | 502 | 87 | 900 | 140 | 900 | 180 |
| 61 | | | | | | |
| Comp. Ex. | 591 | 88 | 900 | 140 | 900 | 185 |
| 62 | | | | | | |
| Comp. Ex. | 630 | 89 | 900 | 140 | 900 | 190 |
| 63 | | | | | | |
| Comp. Ex. | White | — | 900 | 140 | 900 | 175 |
| 64 | light | | | | | |
| Comp. Ex. | 428, | 86, | 900 | 140 | 900 | 180 |
| 65 | 630 | 89 | | | | |

λ: The wavelength of the discharging light emitted by the discharging lamp.
T: Transmittance of the CTL against the discharging light.
V_{D}: Potential of non-lighted portion.
V_{L}: Potential of lighted portion.

It is clear from Table 49 that when the wavelength of the discharging light is less than 500 nm (Examples 129 and 130), increase in potential (V_{L}) of the lighted portion is lower than that in the cases where the wavelength of the discharging light is not less than 500 nm (Comparative Examples 61-63). In particular, when the wavelength of the discharging light is less than 450 nm (i.e., Example 129), increase in potential (V_{L}) of the lighted portion is lower than that in Example 130.

In addition, it is also found that when discharging light having a wide wavelength range and including light having a relatively long wavelength is used (i.e., Comparative Example 64), such an effect as produced in Examples 129 and 130 cannot be produced. Further, it is found that when a combination of two light sources emitting light with different wavelengths is used (Comparative Example 65), the effect of the light having a relatively short wavelength is reduced.

### Photoreceptor Preparation Example 84

The procedure for preparation of photoreceptor 83 in Photoreceptor Preparation Example 83 was repeated except that dispersion 15 used as the CGL coating liquid was replaced with dispersion 14.

Thus, photoreceptor 84 was prepared.

### Example 131

The procedure for the running test and the evaluation in Example 129 was repeated except that photoreceptor 83 was replaced with photoreceptor 84.

The evaluation results are shown in Table 50.

### Example 132

The procedure for the running test and the evaluation in Example 130 was repeated except that photoreceptor 83 was replaced with photoreceptor 84.

The evaluation results are shown in Table 50.

### Comparative Example 66

The procedure for the running test and the evaluation in Comparative Example 61 was repeated except that photoreceptor 83 was replaced with photoreceptor 84.

The evaluation results are shown in Table 50.

### Comparative Example 67

The procedure for the running test and the evaluation in Comparative Example 62 was repeated except that photoreceptor 83 was replaced with photoreceptor 84.

The evaluation results are shown in Table 50.

### Comparative Example 68

The procedure for the running test and the evaluation in Comparative Example 63 was repeated except that photoreceptor 83 was replaced with photoreceptor 84.

The evaluation results are shown in Table 50.

### Comparative Example 69

The procedure for the running test and the evaluation in Comparative Example 64 was repeated except that photoreceptor 83 was replaced with photoreceptor 84.

The evaluation results are shown in Table 50.

TABLE 50

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 131 | 428 | 86 | 900 | 150 | 900 | 155 |
| Ex. 132 | 472 | 87 | 900 | 150 | 900 | 160 |
| Comp. Ex. | 502 | 87 | 900 | 150 | 900 | 185 |
| 66 | | | | | | |
| Comp. Ex. | 591 | 88 | 900 | 150 | 900 | 190 |
| 67 | | | | | | |
| Comp. Ex. | 630 | 89 | 900 | 150 | 900 | 200 |
| 68 | | | | | | |
| Comp. Ex. | White | — | 900 | 150 | 900 | 180 |
| 69 | light | | | | | |

It is clear from Table 50 that when the wavelength of the discharging light is less than 500 nm (Examples 131 and 132), increase in potential (V_{L}) of the lighted portion is lower than that in the other cases where the wavelength of the discharging light is not less than 500 nm (Comparative Examples 66 to 68). In particular, when the wavelength of the discharging light is less than 450 nm (i.e., Example 131), increase in potential (V_{L}) of the lighted portion is lower than that in Example 132.

In addition, it is also found that when discharging light having a side wavelength range and including light having a relatively long wavelength is used (i.e., Comparative Example 69), such an effect as produced in Examples 131 and 132 cannot be produced.

### Example 133

The procedure for the running test and the evaluation in Example 129 was repeated except that the laser diode used for the light irradiator was replaced with a laser diode emitting light of 408 nm, and a dot image constituted of one-dot images with a diameter of 60 μm was produced and observed with a microscope of 150 power magnification.

The evaluation results are shown in Table 51.

TABLE 51

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 129 | 428 | 86 | 900 | 140 | 900 | 145 |
| Ex. 133 | 428 | 86 | 900 | 140 | 900 | 140 |

The outline of the one-dot image produced in Example 133 is clearer than that of the one-dot image produced in Example 129.

It is clear from Table 51 that increase in potential (V_{L}) of the lighted portion is lower in Example 133 (using a laser diode emitting light with a relatively short wavelength of 408 nm) than that in Example 129.

### Photoreceptor Preparation Example 85

The procedure for preparation of photoreceptor 83 in Photoreceptor Preparation Example 83 was repeated except that the CTL coating liquid was replaced with a CTL coating liquid having the following formula.

Formula of CTL Coating Liquid

| | |
|---|---|
| Polycarbonate | 10 parts |
| (TS2050 from Teijin Chemicals Ltd.) | |
| CTM having formula CTM-2 mentioned above | 7 parts |
| Methylene chloride | 80 parts |

Thus, a photoreceptor 85 was prepared.

### Example 134

The procedure for the running test and the evaluation in Example 6 was repeated except that photoreceptor 3 was replaced with photoreceptor 85.

The evaluation results are shown in Table 52.

### Example 135

The procedure for the running test and the evaluation in Example 134 was repeated except that the homogenous light used as the discharging light was changed to homogeneous light with a wavelength of 443 nm by changing the conditions of the monochrometor.

The evaluation results are shown in Table 52.

### Example 136

The procedure for the running test and the evaluation in Example 134 was repeated except that the homogenous light used as the discharging light was changed to homogeneous light with a wavelength of 437 nm by changing the conditions of the monochrometor.

The evaluation results are shown in Table 52.

### Example 137

The procedure for the running test and the evaluation in Example 134 was repeated except that the homogenous light used as the discharging light was changed to homogeneous light with a wavelength of 433 nm by changing the conditions of the monochrometor.

The evaluation results are shown in Table 52.

### Example 138

The procedure for the running test and the evaluation in Example 134 was repeated except that the homogenous light used as the discharging light was changed to homogeneous light with a wavelength of 429 nm by changing the conditions of the monochrometor.

The evaluation results are shown in Table 52.

TABLE 52

| | | | Beginning of running | | | |
|---|---|---|---|---|---|---|
| | λ | T | test | | After running test | |
| | (%) | (%) | V_{D} (−V) | V_{L} (−V) | V_{D} (−V) | V_{L} (−V) |
| Ex. 134 | 461 | 85 | 900 | 150 | 900 | 155 |
| Ex. 135 | 443 | 69 | 900 | 150 | 900 | 155 |
| Ex. 136 | 437 | 49 | 900 | 150 | 900 | 155 |
| Ex. 137 | 433 | 29 | 900 | 150 | 900 | 160 |
| Ex. 138 | 429 | 9 | 900 | 150 | 900 | 160 |

It is clear from Table 52 that when the transmittance of the CTL against the discharging light is less than about 30%, the discharging effect slightly deteriorates.

In addition, it is found that the half tone images produced in Examples 134 to 136 are normal but the half tone images produced in Examples 137 and 138 includes a slight residual image of the stripe image although the half tone images are still acceptable. The residual stripe image in the image produced in Example 138 is relatively noticeable compared to that in Example 137.

Thus, it is discovered that even when light with a wavelength of less than 500 nm is used as the discharging light, a minor side effect is produced if the transmittance of the CTL against the light is less than 30%.

### Photoreceptor Preparation Example 86

The procedure for preparation of photoreceptor 83 in Photoreceptor Preparation Example 83 was repeated except that dispersion 15 used as the CGL coating liquid was replaced with dispersion 16.

Thus, a photoreceptor 86 was prepared.

### Photoreceptor Preparation Example 87

The procedure for preparation of photoreceptor 83 in Photoreceptor Preparation Example 83 was repeated except that dispersion 15 used as the CGL coating liquid was replaced with dispersion 17.

Thus, a photoreceptor 87 was prepared.

### Example 139

The procedure for the running test and the evaluation in Example 129 was repeated except that photoreceptor 83 was replaced with photoreceptor 86.

In addition, after the running test, a copy of a white solid image was produced and observed to determine whether the white solid image has background fouling (i.e., the white solid image is soiled with toner particles).

The evaluation results are shown in Table 53.

### Example 140

The procedure for the running test and the evaluation in Example 129 was repeated except that photoreceptor 83 was replaced with photoreceptor 87.

The evaluation results are shown in Table 53.

TABLE 53

| | At beginning of | | | | |
|---|---|---|---|---|---|
| | running test | | After running test | | Background |
| | V_{D} (−V) | V_{L} (−V) | V_{D} (−V) | V_{L} (−V) | fouling |
| Ex. 129 | 900 | 140 | 900 | 145 | Δ-◯ |
| Ex. 139 | 900 | 135 | 900 | 135 | ⊚ |
| Ex. 140 | 900 | 135 | 900 | 140 | ◯ |

The level of background fouling is classified into the following four grades while considering the number and size of black spots formed on the white solid image.

⊚: Excellent

◯: Good

Δ: Acceptable

X: Bad

It is clear from Table 53 that when the average particle diameter of the CGM dispersed in the CGL coating liquid is less than 0.25 μm (Examples 139 and 140), the initial potential of a lighted portion (V_{L}) can be reduced and in addition occurrence of background fouling can be prevented without increasing the potential of a lighted portion even after long repeated use.

### Photoreceptor Preparation Example 88

The procedure for preparation of photoreceptor 6 in Photoreceptor Preparation Example 6 was repeated except that dispersion 1 used as the CGL coating liquid was replaced with dispersion 15.

Thus, a photoreceptor 88 was prepared.

### Photoreceptor Preparation Example 89

The procedure for preparation of photoreceptor 7 in Photoreceptor Preparation Example 7 was repeated except that dispersion 1 used as the CGL coating liquid was replaced with dispersion 15.

Thus, a photoreceptor 89 was prepared.

### Photoreceptor Preparation Example 90

The procedure for preparation of photoreceptor 8 in Photoreceptor Preparation Example 8 was repeated except that dispersion 1 used as the CGL coating liquid was replaced with dispersion 15.

Thus, a photoreceptor 90 was prepared.

### Photoreceptor Preparation Example 91

The procedure for preparation of photoreceptor 9 in Photoreceptor Preparation Example 9 was repeated except that dispersion 1 used as the CGL coating liquid was replaced with dispersion 15.

Thus, a photoreceptor 91 was prepared.

### Photoreceptor Preparation Example 92

The procedure for preparation of photoreceptor 10 in Photoreceptor Preparation Example 10 was repeated except that dispersion 1 used as the CGL coating liquid was replaced with dispersion 15.

Thus, a photoreceptor 92 was prepared.

### Photoreceptor Preparation Example 93

The procedure for preparation of photoreceptor 11 in Photoreceptor Preparation Example 11 was repeated except that dispersion 1 used as the CGL coating liquid was replaced with dispersion 15.

Thus, a photoreceptor 93 was prepared.

### Photoreceptor Preparation Example 94

The procedure for preparation of photoreceptor 12 in Photoreceptor Preparation Example 12 was repeated except that dispersion 1 used as the CGL coating liquid was replaced with dispersion 15.

Thus, a photoreceptor 94 was prepared.

### Photoreceptor Preparation Example 95

The procedure for preparation of photoreceptor 13 in Photoreceptor Preparation Example 13 was repeated except that dispersion 1 used as the CGL coating liquid was replaced with dispersion 15.

Thus, a photoreceptor 95 was prepared.

### Photoreceptor Preparation Example 96

The procedure for preparation of photoreceptor 14 in Photoreceptor Preparation Example 14 was repeated except that dispersion 1 used as the CGL coating liquid was replaced with dispersion 15.

Thus, a photoreceptor 96 was prepared.

### Photoreceptor Preparation Example 97

The procedure for preparation of photoreceptor 15 in Photoreceptor Preparation Example 15 was repeated except that dispersion 1 used as the CGL coating liquid was replaced with dispersion 15.

Thus, a photoreceptor 97 was prepared.

### Photoreceptor Preparation Example 98

The procedure for preparation of photoreceptor 16 in Photoreceptor Preparation Example 16 was repeated except that dispersion 1 used as the CGL coating liquid was replaced with dispersion 15.

Thus, a photoreceptor 98 was prepared.

### Photoreceptor Preparation Example 99

The procedure for preparation of photoreceptor 17 in Photoreceptor Preparation Example 17 was repeated except that dispersion 1 used as the CGL coating liquid was replaced with dispersion 15.

Thus, a photoreceptor 99 was prepared.

### Photoreceptor Preparation Example 100

The procedure for preparation of photoreceptor 18 in Photoreceptor Preparation Example 18 was repeated except that dispersion 1 used as the CGL coating liquid was replaced with dispersion 15.

Thus, a photoreceptor 100 was prepared.

### Photoreceptor Preparation Example 101

The procedure for preparation of photoreceptor 19 in Photoreceptor Preparation Example 19 was repeated except that dispersion 1 used as the CGL coating liquid was replaced with dispersion 15.

Thus, a photoreceptor 101 was prepared.

### Photoreceptor Preparation Example 102

The procedure for preparation of photoreceptor 20 in Photoreceptor Preparation Example 20 was repeated except that dispersion 1 used as the CGL coating liquid was replaced with dispersion 15.

Thus, a photoreceptor 102 was prepared.

### Photoreceptor Preparation Example 103

The procedure for preparation of photoreceptor 21 in Photoreceptor Preparation Example 21 was repeated except that dispersion 1 used as the CGL coating liquid was replaced with dispersion 15.

Thus, a photoreceptor 103 was prepared.

### Example 141

The procedure for the running test and evaluation in Example 13 was repeated except that photoreceptor 1 was replaced with photoreceptor 83.

The evaluation results are shown in Table 54.

### Examples 142 to 157

The procedure for evaluation in Example 141 was repeated except that photoreceptor 83 was replaced with each of photoreceptors 88 to 103.

The evaluation results are shown in Table 54.

TABLE 54

| | | | V_{L} (−V) | | | | | |
|---|---|---|---|---|---|---|---|---|
| | | | | After | | | | Abrasion |
| | | T | | 50,000 | | | | Loss |
| | No. | (%) | Initial | copies | BF | CL | DOT | (μm) |
| Ex. 141 | 83 | 87 | 140 | 160 | Δ | ◯ | ⊚ | 7.0 |
| Ex. 142 | 88 | 85 | 140 | 160 | Δ-◯ | ◯-⊚ | ⊚ | 4.0 |
| Ex. 143 | 89 | 80 | 145 | 170 | ⊚ | Δ-◯ | ◯-⊚ | 2.0 |
| Ex. 144 | 90 | 78 | 150 | 175 | ⊚ | Δ-◯ | ◯ | 1.8 |
| Ex. 145 | 91 | 80 | 140 | 165 | ◯ | Δ-◯ | Δ-◯ | 2.0 |
| Ex. 146 | 92 | 77 | 150 | 170 | ⊚ | Δ-◯ | ◯ | 1.6 |
| Ex. 147 | 93 | 85 | 150 | 170 | ◯-⊚ | ◯ | ◯ | 2.5 |
| Ex. 148 | 94 | 81 | 155 | 175 | ⊚ | Δ-◯ | Δ-◯ | 1.6 |
| Ex. 149 | 95 | 85 | 150 | 170 | ⊚ | ⊚ | ⊚ | 1.4 |
| Ex. 150 | 96 | 85 | 150 | 170 | ◯ | ⊚ | ⊚ | 1.2 |
| Ex. 151 | 97 | 85 | 150 | 170 | ⊚ | Δ-◯ | ⊚ | 2.6 |
| Ex. 152 | 98 | 85 | 150 | 170 | ⊚ | ⊚ | ⊚ | 1.4 |
| Ex. 153 | 99 | 83 | 150 | 175 | ⊚ | Δ-◯ | ⊚ | 1.2 |
| Ex. 154 | 100 | 84 | 145 | 165 | ◯-⊚ | ⊚ | ⊚ | 1.6 |
| Ex. 155 | 101 | 84 | 155 | 175 | ⊚ | ⊚ | ⊚ | 1.4 |
| Ex. 156 | 102 | 80 | 140 | 160 | ◯-⊚ | ⊚ | ⊚ | 1.8 |
| Ex. 157 | 103 | 85 | 160 | 175 | ⊚ | ⊚ | ⊚ | 1.4 |

No.: Number of photoreceptor used
T: Transmittance of protective layer or CTL against the discharging light

It is clear from Table 54 that even when a protective layer is formed, the following knowledge can be obtained.

(1) The residual potential increasing problem can be avoided if light with a wavelength less than 500 nm is used as the discharging light;

(2) The photoreceptor (Example 142) including a charge transport polymer in the CTL has better abrasion resistance than the photoreceptor (Example 141) including a low molecular weight CTM in the CTL;

(3) The photoreceptors (Examples 143-157) including a protective layer have better abrasion resistance than the photoreceptors (Examples 141 and 142) including no protective layer;

(4) Among the photoreceptors having a protective layer including a particulate inorganic material (Examples 143-145), the photoreceptors (Examples 143 and 144) having a protective layer including a particulate inorganic material having a resistivity not less than 10¹⁰ Ω·cm have good dot reproducibility even under high temperature and high humidity conditions;

(5) The photoreceptors having a crosslinked protective layer have better abrasion resistance than the photoreceptor having a non-crosslinked protective layer, in particular, the photoreceptors (Examples 149, 150, 152, and 154-157) having a crosslinked protective layer which is prepared using a tri- or more-functional monomer having no charge transport structure and a monofunctional monomer having a charge transport structure have excellent abrasion resistance; and

(6) the photoreceptors (Examples 149, 150, 152, and 154-157) also have excellent cleanability.

### Comparative Example 70

The procedure for the running test and evaluation of the images in Example 149 was repeated except that the laser diode was replaced with a laser diode (from Seiwa Electric Mfg. Co., Ltd.) emitting light with a wavelength of 502 nm and a half width of 15 nm. The light intensity was controlled so that the initial potential (V_{L}) of a lighted portion is the same as that in Example 149.

The evaluation results are shown in Table 55.

### Comparative Example 71

The procedure for the running test and the evaluation of the images in Example 149 was repeated except that the laser diode was replaced with a laser diode (from Rohm Co., Ltd.) emitting light with a wavelength of 591 nm and a half width of 15 nm. The light intensity was controlled so that the initial potential (V_{L}) of a lighted portion is the same as that in Example 149.

The evaluation results are shown in Table 55.

### Comparative Example 72

The procedure for the running test and the evaluation of the images in Example 149 was repeated except that the laser diode was replaced with a laser diode (from Rohm Co., Ltd.) emitting light with a wavelength of 630 nm and a half width of 20 nm. The light intensity was controlled so that the initial potential (V_{L}) of a lighted portion is the same as that in Example 149.

The evaluation results are shown in Table 55.

### Comparative Example 73

The procedure for the running test and the evaluation of the images in Example 149 was repeated except that the laser diode was replaced with a fluorescent lamp emitting light having a spectrum illustrated in FIG. 1. The light intensity was controlled so that the initial potential (V_{L}) of a lighted portion is the same as that in Example 149.

The evaluation results are shown in Table 55.

TABLE 55

| | | Transmittance | | |
|---|---|---|---|---|
| | | of protective | Potential of lighted | |
| | Wavelength of | layer against | portion (V_{L}) (−V) | |
| | discharging | discharging | At beginning of | After |
| | light (nm) | light | running test | running test |
| Ex. 149 | 472 | 85 | 150 | 170 |
| Comp. | 502 | 85 | 150 | 200 |
| Ex. 70 | | | | |
| Comp. | 591 | 89 | 150 | 205 |
| Ex. 71 | | | | |
| Comp. | 630 | 90 | 150 | 210 |
| Ex. 72 | | | | |
| Comp. | White light | — | 150 | 195 |
| Ex. 73 | | | | |

It is clear from Table 55 that when the wavelength of the discharging light is less than 500 nm (Example 149), increase in the potential (V_{L}) is smaller than in Comparative Examples 70-72 using discharging light with a wavelength of not less than 500 nm. In addition, when the discharging light has light including components with a relatively long wavelength of not less than 500 nm (Comparative Example 73), the effect produced in Example 149 cannot be produced.

### Example 158

The procedure for the running test and evaluation in Example 30 was repeated except that photoreceptor 13 was replaced with photoreceptor 95.

The evaluation results are shown in Table 56.

### Example 159

The procedure for the running test and the evaluation in Example 158 was repeated except that the homogenous light used as the discharging light was changed to homogeneous light with a wavelength of 400 nm by changing the conditions of the monochrometor.

The evaluation results are shown in Table 56.

### Example 160

The procedure for the running test and the evaluation in Example 158 was repeated except that the homogenous light used as the discharging light was changed to homogeneous light with a wavelength of 393 nm by changing the conditions of the monochrometor.

The evaluation results are shown in Table 56.

### Example 161

The procedure for the running test and the evaluation in Example 158 was repeated except that the homogenous light used as the discharging light was changed to homogeneous light with a wavelength of 390 nm by changing the conditions of the monochrometor.

The evaluation results are shown in Table 56.

### Example 162

The procedure for the running test and the evaluation in Example 158 was repeated except that the homogenous light used as the discharging light was changed to homogeneous light with a wavelength of 385 nm by changing the conditions of the monochrometor.

The evaluation results are shown in Table 56.

TABLE 56

| | | Transmittance | | |
|---|---|---|---|---|
| | | of protective | Potential of lighted | |
| | Wavelength of | layer against | portion (V_{L}) (−V) | |
| | discharging | discharging | At beginning of | After |
| | light (nm) | light | running test | running test |
| Ex. 158 | 450 | 85 | 150 | 170 |
| Ex. 159 | 400 | 73 | 150 | 170 |
| Ex. 160 | 393 | 50 | 150 | 170 |
| Ex. 161 | 390 | 29 | 150 | 175 |
| Ex. 162 | 385 | 9 | 150 | 175 |

It is clear from Table 56 that when the transmittance of the protective layer against the discharging light is less than about 30%, the discharging effect slightly deteriorates.

In addition, it is found that the half tone images produced in Examples 158 to 160 are normal but the half tone images produced in Examples 161 and 162 include a slight residual image of the stripe image formed on an upper portion of each copy although the half tone images are still acceptable. The residual stripe image in the image produced in Example 162 is relatively noticeable compared to that in Example 161.

Thus, it is discovered that even when light with a wavelength of less than 500 nm is used as the discharging light, a minor side effect is produced if the transmittance of the protective layer against the light is less than 30%.

### Photoreceptor Preparation Example 104

The procedure for preparation of photoreceptor 22 in Photoreceptor Preparation Example 22 was repeated except that dispersion 1 used as the CGL coating liquid was replaced with dispersion 15.

Thus, a photoreceptor 104 was prepared.

### Photoreceptor Preparation Example 105

The procedure for preparation of photoreceptor 23 in Photoreceptor Preparation Example 23 was repeated except that dispersion 1 used as the CGL coating liquid was replaced with dispersion 15.

Thus, a photoreceptor 105 was prepared.

### Photoreceptor Preparation Example 106

The procedure for preparation of photoreceptor 24 in Photoreceptor Preparation Example 24 was repeated except that dispersion 1 used as the CGL coating liquid was replaced with dispersion 15.

Thus, a photoreceptor 106 was prepared.

### Photoreceptor Preparation Example 107

The procedure for preparation of photoreceptor 25 in Photoreceptor Preparation Example 25 was repeated except that dispersion 1 used as the CGL coating liquid was replaced with dispersion 15.

Thus, a photoreceptor 107 was prepared.

### Photoreceptor Preparation Example 108

The procedure for preparation of photoreceptor 26 in Photoreceptor Preparation Example 26 was repeated except that dispersion 1 used as the CGL coating liquid was replaced with dispersion 15.

Thus, a photoreceptor 108 was prepared.

### Photoreceptor Preparation Example 109

The procedure for preparation of photoreceptor 27 in Photoreceptor Preparation Example 27 was repeated except that dispersion 1 used as the CGL coating liquid was replaced with dispersion 15.

Thus, a photoreceptor 109 was prepared.

### Examples 163 to 168

The procedure for the running test and evaluation in Example 141 was repeated except that photoreceptor 83 was replaced with each of photoreceptors 104-109.

The evaluation results are shown in Table 57.

TABLE 57

| | | | V_{L} (−V) | | | | | |
|---|---|---|---|---|---|---|---|---|
| | | | | After | | | | Abrasion |
| | | T | | 50,000 | | | | Loss |
| | No. | (%) | Initial | copies | BF | CL | DOT | (μm) |
| Ex. 141 | 83 | 87 | 140 | 160 | Δ | ◯ | ⊚ | 7.0 |
| Ex. 163 | 104 | 87 | 150 | 175 | ⊚ | ◯ | ⊚ | 7.0 |
| Ex. 164 | 105 | 87 | 150 | 170 | ◯ | ◯ | ⊚ | 7.0 |
| Ex. 165 | 106 | 87 | 155 | 180 | ⊚ | ◯ | ⊚ | 7.0 |
| Ex. 166 | 107 | 87 | 160 | 190 | ⊚ | ◯ | ⊚ | 7.0 |
| Ex. 167 | 108 | 87 | 150 | 170 | ◯ | ◯ | ⊚ | 7.0 |
| Ex. 168 | 109 | 87 | 160 | 180 | ⊚ | ◯ | ⊚ | 7.0 |

It is clear from Table 57 that by using a combination of a charge blocking layer and a moiré preventing layer as the intermediate layer, the photoreceptors have good resistance to background fouling.

### Example 169

The procedure for the running test and evaluation in Example 41 was repeated except that photoreceptor 1 was replaced with photoreceptor 83.

The evaluation results are shown in Table 58.

### Example 170

The procedure for the running test and evaluation in Example 169 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 169.

The evaluation results are shown in Table 58.

### Comparative Example 74

The procedure for the running test and evaluation in Example 169 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 169.

The evaluation results are shown in Table 58.

### Comparative Example 75

The procedure for the running test and evaluation in Example 169 was repeated except that the discharging lamp was replaced with a discharging lamp including a LED (from Rohm Co., Ltd.) which emits light having a wavelength of 591 nm and a half width of 15 nm. In this regard, the light intensity of the discharging lamp was controlled so that the potential of the photoreceptor after the discharging process is the same as that in Example 169.

The evaluation results are shown in Table 58.

### Comparative Example 76

The procedure for the running test and evaluation in Example 169 was repeated except that the discharging lamp was replaced with a discharging lamp including a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 169.

The evaluation results are shown in Table 58.

### Comparative Example 77

The procedure for the running test and the evaluation in Example 169 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 169.

The evaluation results are shown in Table 58.

### Comparative Example 78

The procedure for the running test and the evaluation in Example 169 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 169.

The evaluation results are shown in Table 58.

TABLE 58

| | | Transmittance | Potential of lighted | |
|---|---|---|---|---|
| | | of protective | portion (V_{L}) (−V) | |
| | Wavelength of | layer against | At | After |
| | discharging | discharging | beginning of | running |
| | light (nm) | light | running test | test |
| Ex. 169 | 428 | 86 | 140 | 150 |
| Ex. 170 | 472 | 87 | 140 | 155 |
| Comp. Ex. 74 | 502 | 87 | 140 | 185 |
| Comp. Ex. 75 | 591 | 88 | 140 | 190 |
| Comp. Ex. 76 | 630 | 89 | 140 | 195 |
| Comp. Ex. 77 | White light | — | 140 | 180 |
| Comp. Ex. 78 | 428 and 630 | 86 and 89 | 140 | 185 |

It is clear from Table 58 that when the wavelength of the discharging light is less than 500 nm (Examples 169 and 170), increase in potential (V_{L}) of the lighted portion is lower than that in the cases where the wavelength of the discharging light is not less than 500 nm (Comparative Examples 74-76). In particular, when the wavelength of the discharging light is less than 450 nm (i.e., Example 169), increase in potential (V_{L}) of the lighted portion is lower than that in Example 170.

In addition, it is also found that when discharging light having a wide wavelength range and including light having a relatively long wavelength is used (i.e., Comparative Example 77), such an effect as produced in Examples 169 and 170 cannot be produced. Further, it is found that when a combination of two light sources emitting light with different wavelengths is used (Comparative Example 78), the effect of the light having a relatively short wavelength is reduced.

The image qualities of the color images produced in Examples 169 and 170 were hardly changed before and after the running test. However, the color images produced in Comparative Examples 74-78 after the running test have slightly poor color reproducibility (i.e., the color tones of the color images are changed after the running test).

The CGMs, titanyl phthalocyanines, which are used for the following examples, were prepared by the methods described in JP-B 07-97221 or Japanese Patent No. 3,005,052, incorporated herein by reference.

### Synthesis Example 3

An α-form titanylphthalocyanine crystal was prepared by the method described in Synthesis Example 2 of JP-B 07-97221.

Specifically, the following components were mixed.

| | | |
|---|---|---|
| Phthalodinitrile | 40 | g |
| Tetrachlorotitanium | 18 | g |
| α-chloronaphthalene | 500 | ml |

The mixture was heated for 3 hours at a temperature of from 240 to 250° C. to perform a reaction. The reaction product was filtered to obtain dichlorotitanium phthalocyanine. The thus prepared dichlorotitanium phthalocyanine was mixed with 300 g of concentrated ammonia water, and the mixture was heated while being circulated. Thus, an α-form titanylphthalocyanine was prepared.

In addition, a titanylphthalocyanine crystal was synthesized by the method described in Synthesis Example 1 of JP-B 07-97221. Specifically, 10 parts of the α-form titanylphthalocyanine, 5 to 20 parts of sodium chloride, which serves as an auxiliary grinding agent, and 10 parts of acetophenone, which serves as a dispersion medium were mixed and the mixture was subjected to a grinding treatment for 10 hours at a temperature of from 60 to 120° C. using a sand mill. In this case, when grinding is performed at a relatively high temperature, a β-form titanylphthalocyanine crystal tends to be easily formed and in addition the β-form titanylphthalocyanine tends to be easily decomposed.

The ground mixture was washed with water, followed by washing with methanol, to remove the auxiliary grinding agent and dispersion medium therefrom. The titanylphthalocyanine was refined using 2% dilute sulfuric acid, followed by filtering, washing with water and drying. Thus, a greenish blue crystal (i.e., α-form titanylphthalocyanine crystal, hereinafter referred to as a phthalocyanine crystal 3) was prepared.

The thus prepared phthalocyanine crystal 3 was subjected to the X-ray diffraction analysis mentioned above.

The phthalocyanine crystal 3 has an X-ray diffraction spectrum such that a maximum peak is observed at a Bragg (2 θ) angle of 27.2°. Namely, the spectrum of the crystal 3 is the same as the spectrum illustrated in FIG. 1 of JP-B 07-97221.

### Synthesis Example 4

A titanylphthalocyanine crystal was prepared by the method described in Synthesis Example 1 of Japanese Patent No. 3,005,052.

Specifically, the following components were mixed.

| | |
|---|---|
| o-Phthalodinitrile | 5.0 g |
| Tetrachlorotitanium | 2.0 g |
| α-chloronaphthalene | 100 g |

The mixture was heated for 3 hours at 200° C. to perform a reaction. After being cooled to 50° C., the reaction product was filtered to obtain the precipitated crystal (i.e., a paste of dichlorotitanium phthalocyanine). The thus prepared dichlorotitanium phthalocyanine was washed with 100 ml of N,N′-dimethylformamide heated to 100° C. while agitated, followed by washing twice with 100 ml of methanol heated to 60° C. and filtering. The thus prepared paste was washed for 1 hour with 100 ml of deoinized water heated to 80° C., followed by filtering. Thus, a blue oxytitanium phthalocyanine crystal was prepared.

Then the oxytitanium phthalocyanine crystal was dissolved in 150 g of concentrated sulfuric acid and the solution was dropped into 1500 ml of deionized water at 20° C. to re-precipitate the oxytitanium phthalocyanine crystal, followed by filtering and washing with water. Thus, an amorphous oxytitanium phthalocyanine was prepared. Four (4.0) grams of the amorphous oxytitanium phthalocyanine was suspended in 100 ml of methanol at 22° C. while agitated for 8 hours, followed by filtering and drying under a reduced pressure. Thus, an oxytitanium phthalocyanine having a low crystallinity was prepared. Two (2.0) grams of the thus prepared oxytitanium phthalocyanine was mixed with 40 ml of n-butyl ether and the mixture was subjected to a milling treatment for 20 hours at 22° C. using glass beads having a diameter of 1 mm.

The solid component was separated from the dispersion and the solid component was washed with methanol, followed by washing with water and drying. Thus, a titanyl phthalocyanine crystal (hereinafter referred to as a phthalocyanine crystal 4) was prepared.

The thus prepared phthalocyanine crystal 4 was subjected to the X-ray diffraction analysis mentioned above.

The phthalocyanine crystal 4 has an X-ray diffraction spectrum such that a strong peak is observed at each of Bragg (2 θ) angles of 9.0°, 14.2°, 23.9° and 27.1°. Namely, the spectrum of the crystal 4 is the same as the spectrum illustrated in FIG. 1 of Japanese Patent No. 3,005,052.

### Dispersion Preparation Example 18

Formula of Dispersion

| | |
|---|---|
| Phthalocyanine crystal 3 | 15 parts |
| Polyvinyl butyral | 10 parts |
| (BX-1 from Sekisui Chemical Co., Ltd.) | |
| 2-Butanone | 280 parts |

At first, the polyvinyl butyral resin was dissolved in the solvent. The solution was mixed with phthalocyanine crystal 3 and the mixture was subjected to a dispersion treatment for 30 minutes using a bead mill which includes PSZ balls having a diameter of 0.5 mm and which is rotated at a revolution of 1200 rpm.

Thus, a dispersion 18 was prepared.

### Dispersion Preparation Example 19

The procedure for preparation of dispersion 18 was repeated except that phthalocyanine crystal 3 was replaced with phthalocyanine crystal 4.

Thus, a dispersion 19 was prepared.

### Dispersion Preparation Example 20

The procedure for preparation of dispersion 18 was repeated except that dispersion 18 was filtered with a cotton wind cartridge filter (TCW-3-CS from Advantech Co., Ltd.) having an effective pore diameter of 3 μm. Filtering was performed under pressure using a pump.

Thus, a dispersion 20 was prepared.

### Dispersion Preparation Example 21

The procedure for preparation of dispersion 20 was repeated except that the filter was replaced with a cotton wind cartridge filter (TCW-5-CS from Advantech Co., Ltd.) having an effective pore diameter of 5 μm.

Thus, a dispersion 21 was prepared.

The particle diameter distribution of the thus prepared dispersions 14 to 17 was measured with a particle diameter measuring instrument (CAPA 700 from Horiba Ltd.). The results are shown in Table 48.

TABLE 48

| | Average particle diameter | Standard deviation of |
|---|---|---|
| Dispersion | (μm) | particle diameter (μm) |
| 18 | 0.27 | 0.18 |
| 19 | 0.25 | 0.17 |
| 20 | 0.21 | 0.15 |
| 21 | 0.25 | 0.17 |

### Photoreceptor Preparation Example 110

The procedure for preparation of the photoreceptor 83 in Photoreceptor Preparation Example 83 was repeated except that the CGL coating liquid was replaced with dispersion 18.

Thus, a photoreceptor 110 was prepared.

### Example 171

The procedure for the running test and evaluation in Example 1 was repeated except that photoreceptor 1 was replaced with photoreceptor 110.

The evaluation results are shown in Table 60.

### Example 172

The procedure for the running test and the evaluation in Example 171 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 171.

The evaluation results are shown in Table 60.

### Comparative Example 79

The procedure for the running test and the evaluation in Example 171 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 171.

The evaluation results are shown in Table 60.

### Comparative Example 80

The procedure for the running test and the evaluation in Example 171 was repeated except that the discharging lamp was replaced with a discharging lamp including a LED (from Seiwa Electric Mfg. Co., Ltd.) which emits light having a wavelength of 591 nm and a half width of 15 nm. In this regard, the light intensity of the discharging lamp was controlled so that the potential of the photoreceptor after the discharging process is the same as that in Example 171.

The evaluation results are shown in Table 60.

### Comparative Example 81

The procedure for the running test and the evaluation in Example 171 was repeated except that the discharging lamp was replaced with a discharging lamp including a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 171.

The evaluation results are shown in Table 60.

### Comparative Example 82

The procedure for the running test and the evaluation in Example 171 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 171.

The evaluation results are shown in Table 60.

### Comparative Example 83

The procedure for the running test and the evaluation in Example 171 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 171.

The evaluation results are shown in Table 60.

TABLE 60

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 171 | 428 | 86 | 900 | 120 | 900 | 125 |
| Ex. 172 | 472 | 87 | 900 | 120 | 900 | 130 |
| Comp. Ex. | 502 | 87 | 900 | 120 | 900 | 160 |
| 79 | | | | | | |
| Comp. Ex. | 591 | 88 | 900 | 120 | 900 | 165 |
| 80 | | | | | | |
| Comp. Ex. | 630 | 89 | 900 | 120 | 900 | 170 |
| 81 | | | | | | |
| Comp. Ex. | White | — | 900 | 120 | 900 | 155 |
| 82 | light | | | | | |
| Comp. Ex. | 428, | 86, | 900 | 120 | 900 | 160 |
| 83 | 630 | 89 | | | | |

λ: The wavelength of the discharging light emitted by the discharging lamp.
T: Transmittance of the CTL against the discharging light.
V_{D}: Potential of non-lighted portion.
V_{L}: Potential of lighted portion.

It is clear from Table 60 that when the wavelength of the discharging light is less than 500 nm (Examples 171 and 172), increase in potential (V_{L}) of the lighted portion is lower than that in the cases where the wavelength of the discharging light is not less than 500 nm (Comparative Examples 79-81). In particular, when the wavelength of the discharging light is less than 450 nm (i.e., Example 171), increase in potential (V_{L}) of the lighted portion is lower than that in Example 172.

In addition, it is also found that when discharging light having a wide wavelength range and including light having a relatively long wavelength is used (i.e., Comparative Example 82), such an effect as produced in Examples 171 and 172 cannot be produced. Further, it is found that when a combination of two light sources emitting light with different wavelengths is used (Comparative Example 83), the effect of the light having a relatively short wavelength is reduced.

### Photoreceptor Preparation Example 111

The procedure for preparation of photoreceptor 110 in Photoreceptor Preparation Example 110 was repeated except that dispersion 18 used as the CGL coating liquid was replaced with dispersion 19.

Thus, photoreceptor 111 was prepared.

### Example 173

The procedure for the running test and the evaluation in Example 171 was repeated except that photoreceptor 110 was replaced with photoreceptor 111.

The evaluation results are shown in Table 61.

### Example 174

The procedure for the running test and the evaluation in Example 172 was repeated except that photoreceptor 110 was replaced with photoreceptor 111.

The evaluation results are shown in Table 61.

### Comparative Example 84

The procedure for the running test and the evaluation in Comparative Example 79 was repeated except that photoreceptor 110 was replaced with photoreceptor 111.

The evaluation results are shown in Table 61.

### Comparative Example 85

The procedure for the running test and the evaluation in Comparative Example 80 was repeated except that photoreceptor 110 was replaced with photoreceptor 111.

The evaluation results are shown in Table 61.

### Comparative Example 86

The procedure for the running test and the evaluation in Comparative Example 81 was repeated except that photoreceptor 110 was replaced with photoreceptor 111.

The evaluation results are shown in Table 61.

### Comparative Example 87

The procedure for the running test and the evaluation in Comparative Example 82 was repeated except that photoreceptor 110 was replaced with photoreceptor 111.

The evaluation results are shown in Table 61.

TABLE 61

| | | | Beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 173 | 428 | 86 | 900 | 130 | 900 | 135 |
| Ex. 174 | 472 | 87 | 900 | 130 | 900 | 140 |
| Comp. Ex. | 502 | 87 | 900 | 130 | 900 | 165 |
| 84 | | | | | | |
| Comp. Ex. | 591 | 88 | 900 | 130 | 900 | 170 |
| 85 | | | | | | |
| Comp. Ex. | 630 | 89 | 900 | 130 | 900 | 180 |
| 86 | | | | | | |
| Comp. Ex. | White | — | 900 | 130 | 900 | 160 |
| 87 | light | | | | | |

It is clear from Table 61 that when the wavelength of the discharging light is less than 500 nm (Examples 173 and 174), increase in potential (V_{L}) of the lighted portion is lower than that in the other cases where the wavelength of the discharging light is not less than 500 nm (Comparative Examples 84 to 86). In particular, when the wavelength of the discharging light is less than 450 nm (i.e., Example 173), increase in potential (V_{L}) of the lighted portion is lower than that in Example 174.

In addition, it is also found that when discharging light having a side wavelength range and including light having a relatively long wavelength is used (i.e., Comparative Example 87), such an effect as produced in Examples 173 and 174 cannot be produced.

### Example 175

The procedure for the running test and the evaluation in Example 171 was repeated except that the laser diode used for the light irradiator was replaced with a laser diode emitting light of 408 nm, and a dot image constituted of one-dot images with a diameter of 60 μm was produced and observed with a microscope of 150 power magnification.

The evaluation results are shown in Table 62.

TABLE 62

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 171 | 428 | 86 | 900 | 120 | 900 | 125 |
| Ex. 175 | 428 | 86 | 900 | 120 | 900 | 120 |

The outline of the one-dot image produced in Example 175 is clearer than that of the one-dot image produced in Example 171.

It is clear from Table 62 that increase in potential (V_{L}) of the lighted portion is lower in Example 175 (using a laser diode emitting light with a relatively short wavelength of 408 nm) than that in Example 171.

### Photoreceptor Preparation Example 112

The procedure for preparation of photoreceptor 110 in Photoreceptor Preparation Example 110 was repeated except that the CTL coating liquid was replaced with a CTL coating liquid having the following formula.

Formula of CTL Coating Liquid

| | |
|---|---|
| Polycarbonate | 10 parts |
| (TS2050 from Teijin Chemicals Ltd.) | |
| CTM having formula CTM-2 mentioned above | 7 parts |
| Methylene chloride | 80 parts |

Thus, a photoreceptor 112 was prepared.

### Example 176

The procedure for the running test and the evaluation in Example 6 was repeated except that photoreceptor 3 was replaced with photoreceptor 112.

The evaluation results are shown in Table 63.

### Example 177

The procedure for the running test and the evaluation in Example 176 was repeated except that the homogenous light used as the discharging light was changed to homogeneous light with a wavelength of 443 nm by changing the conditions of the monochrometor.

The evaluation results are shown in Table 63.

### Example 178

The procedure for the running test and the evaluation in Example 176 was repeated except that the homogenous light used as the discharging light was changed to homogeneous light with a wavelength of 437 nm by changing the conditions of the monochrometor.

The evaluation results are shown in Table 63.

### Example 179

The procedure for the running test and the evaluation in Example 176 was repeated except that the homogenous light used as the discharging light was changed to homogeneous light with a wavelength of 433 nm by changing the conditions of the monochrometor.

The evaluation results are shown in Table 63.

### Example 180

The procedure for the running test and the evaluation in Example 176 was repeated except that the homogenous light used as the discharging light was changed to homogeneous light with a wavelength of 429 nm by changing the conditions of the monochrometor.

The evaluation results are shown in Table 63.

TABLE 63

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 176 | 461 | 85 | 900 | 140 | 900 | 145 |
| Ex. 177 | 443 | 69 | 900 | 140 | 900 | 145 |
| Ex. 178 | 437 | 49 | 900 | 140 | 900 | 145 |
| Ex. 179 | 433 | 29 | 900 | 140 | 900 | 150 |
| Ex. 180 | 429 | 9 | 900 | 140 | 900 | 150 |

It is clear from Table 63 that when the transmittance of the CTL against the discharging light is less than about 30%, the discharging effect slightly deteriorates.

In addition, it is found that the half tone images produced in Examples 176 to 178 are normal but the half tone images produced in Examples 179 and 180 includes a slight residual image of the stripe image although the half tone images are still acceptable. The residual stripe image in the image produced in Example 180 is relatively noticeable compared to that in Example 179.

Thus, it is discovered that even when light with a wavelength of less than 500 nm is used as the discharging light, a minor side effect is produced if the transmittance of the CTL against the light is less than 30%.

### Photoreceptor Preparation Example 113

The procedure for preparation of photoreceptor 110 in Photoreceptor Preparation Example 110 was repeated except that dispersion 18 used as the CGL coating liquid was replaced with dispersion 20.

Thus, a photoreceptor 113 was prepared.

### Photoreceptor Preparation Example 114

The procedure for preparation of photoreceptor 110 in Photoreceptor Preparation Example 110 was repeated except that dispersion 18 used as the CGL coating liquid was replaced with dispersion 21.

Thus, a photoreceptor 114 was prepared.

### Example 181

The procedure for the running test and the evaluation in Example 171 was repeated except that photoreceptor 110 was replaced with photoreceptor 113.

In addition, after the running test, a copy of a white solid image was produced and observed to determine whether the white solid image has background fouling (i.e., the white solid image is soiled with toner particles).

The evaluation results are shown in Table 64.

### Example 182

The procedure for the running test and the evaluation in Example 171 was repeated except that photoreceptor 110 was replaced with photoreceptor 114.

The evaluation results are shown in Table 64.

TABLE 64

| | | |
|---|---|---|
| At beginning of | | |
| running test | After running test | Background |

| | V_{D} (−V) | V_{L} (−V) | V_{D} (−V) | V_{L} (−V) | fouling |
|---|---|---|---|---|---|
| Ex. 171 | 900 | 120 | 900 | 125 | Δ-◯ |
| Ex. 181 | 900 | 115 | 900 | 115 | ⊚ |
| Ex. 182 | 900 | 115 | 900 | 120 | ◯ |

The level of background fouling is classified into the following four grades while considering the number and size of black spots formed on the white solid image.

⊚: Excellent

◯: Good

Δ: Acceptable

X: Bad

It is clear from Table 64 that when the average particle diameter of the CGM dispersed in the CGL coating liquid is less than 0.25 μm (Examples 181 and 182), the initial potential of a lighted portion (V_{L}) can be reduced and in addition occurrence of background fouling can be prevented without increasing the potential of a lighted portion even after long repeated use.

### Photoreceptor Preparation Example 115

The procedure for preparation of photoreceptor 6 in Photoreceptor Preparation Example 6 was repeated except that dispersion 1 used as the CGL coating liquid was replaced with dispersion 18.

Thus, a photoreceptor 115 was prepared.

### Photoreceptor Preparation Example 116

The procedure for preparation of photoreceptor 7 in Photoreceptor Preparation Example 7 was repeated except that dispersion 1 used as the CGL coating liquid was replaced with dispersion 18.

Thus, a photoreceptor 116 was prepared.

### Photoreceptor Preparation Example 117

The procedure for preparation of photoreceptor 8 in Photoreceptor Preparation Example 8 was repeated except that dispersion 1 used as the CGL coating liquid was replaced with dispersion 18.

Thus, a photoreceptor 117 was prepared.

### Photoreceptor Preparation Example 118

The procedure for preparation of photoreceptor 9 in Photoreceptor Preparation Example 9 was repeated except that dispersion 1 used as the CGL coating liquid was replaced with dispersion 18.

Thus, a photoreceptor 118 was prepared.

### Photoreceptor Preparation Example 119

The procedure for preparation of photoreceptor 10 in Photoreceptor Preparation Example 10 was repeated except that dispersion 1 used as the CGL coating liquid was replaced with dispersion 18.

Thus, a photoreceptor 119 was prepared.

### Photoreceptor Preparation Example 120

The procedure for preparation of photoreceptor 11 in Photoreceptor Preparation Example 11 was repeated except that dispersion 1 used as the CGL coating liquid was replaced with dispersion 18.

Thus, a photoreceptor 120 was prepared.

### Photoreceptor Preparation Example 121

The procedure for preparation of photoreceptor 12 in Photoreceptor Preparation Example 12 was repeated except that dispersion 1 used as the CGL coating liquid was replaced with dispersion 18.

Thus, a photoreceptor 121 was prepared.

### Photoreceptor Preparation Example 122

The procedure for preparation of photoreceptor 13 in Photoreceptor Preparation Example 13 was repeated except that dispersion 1 used as the CGL coating liquid was replaced with dispersion 18.

Thus, a photoreceptor 122 was prepared.

### Photoreceptor Preparation Example 123

The procedure for preparation of photoreceptor 14 in Photoreceptor Preparation Example 14 was repeated except that dispersion 1 used as the CGL coating liquid was replaced with dispersion 18.

Thus, a photoreceptor 123 was prepared.

### Photoreceptor Preparation Example 124

The procedure for preparation of photoreceptor 15 in Photoreceptor Preparation Example 15 was repeated except that dispersion 1 used as the CGL coating liquid was replaced with dispersion 18.

Thus, a photoreceptor 124 was prepared.

### Photoreceptor Preparation Example 125

The procedure for preparation of photoreceptor 16 in Photoreceptor Preparation Example 16 was repeated except that dispersion 1 used as the CGL coating liquid was replaced with dispersion 18.

Thus, a photoreceptor 125 was prepared.

### Photoreceptor Preparation Example 126

The procedure for preparation of photoreceptor 17 in Photoreceptor Preparation Example 17 was repeated except that dispersion 1 used as the CGL coating liquid was replaced with dispersion 18.

Thus, a photoreceptor 126 was prepared.

### Photoreceptor Preparation Example 127

The procedure for preparation of photoreceptor 18 in Photoreceptor Preparation Example 18 was repeated except that dispersion 1 used as the CGL coating liquid was replaced with dispersion 18.

Thus, a photoreceptor 127 was prepared.

### Photoreceptor Preparation Example 128

The procedure for preparation of photoreceptor 19 in Photoreceptor Preparation Example 19 was repeated except that dispersion 1 used as the CGL coating liquid was replaced with dispersion 18.

Thus, a photoreceptor 128 was prepared.

### Photoreceptor Preparation Example 129

The procedure for preparation of photoreceptor 20 in Photoreceptor Preparation Example 20 was repeated except that dispersion 1 used as the CGL coating liquid was replaced with dispersion 18.

Thus, a photoreceptor 129 was prepared.

### Photoreceptor Preparation Example 130

The procedure for preparation of photoreceptor 21 in Photoreceptor Preparation Example 21 was repeated except that dispersion 1 used as the CGL coating liquid was replaced with dispersion 18.

Thus, a photoreceptor 130 was prepared.

### Example 183

The procedure for the running test and evaluation in Example 13 was repeated except that photoreceptor 1 was replaced with photoreceptor 110.

The evaluation results are shown in Table 65.

### Examples 184 to 199

The procedure for evaluation in Example 183 was repeated except that photoreceptor 110 was replaced with each of photoreceptors 115 to 130.

The evaluation results are shown in Table 65.

TABLE 65

| | | | V_{L} (−V) | | | | | |
|---|---|---|---|---|---|---|---|---|
| | | | | After | | | | Abrasion |
| | | T | | 50,000 | | | | Loss |
| | No. | (%) | Initial | copies | BF | CL | DOT | (μm) |
| Ex. 183 | 110 | 87 | 120 | 140 | Δ | ◯ | ⊚ | 7.0 |
| Ex. 184 | 115 | 85 | 120 | 140 | Δ-◯ | ◯-⊚ | ⊚ | 4.0 |
| Ex. 185 | 116 | 80 | 125 | 150 | ⊚ | Δ-◯ | ◯-⊚ | 2.0 |
| Ex. 186 | 117 | 78 | 130 | 155 | ⊚ | Δ-◯ | ◯ | 1.8 |
| Ex. 187 | 118 | 80 | 120 | 145 | ◯ | Δ-◯ | Δ-◯ | 2.0 |
| Ex. 188 | 119 | 77 | 130 | 150 | ⊚ | Δ-◯ | ◯ | 1.6 |
| Ex. 189 | 120 | 85 | 130 | 150 | ◯-⊚ | ◯ | ◯ | 2.5 |
| Ex. 190 | 121 | 81 | 135 | 155 | ⊚ | Δ-◯ | Δ-◯ | 1.6 |
| Ex. 191 | 122 | 85 | 130 | 150 | ⊚ | ⊚ | ⊚ | 1.4 |
| Ex. 192 | 123 | 85 | 130 | 150 | ◯ | ⊚ | ⊚ | 1.2 |
| Ex. 193 | 124 | 85 | 130 | 150 | ⊚ | Δ-◯ | ⊚ | 2.6 |
| Ex. 194 | 125 | 85 | 130 | 150 | ⊚ | ⊚ | ⊚ | 1.4 |
| Ex. 195 | 126 | 83 | 130 | 155 | ⊚ | Δ-◯ | ⊚ | 1.2 |
| Ex. 196 | 127 | 84 | 125 | 145 | ◯-⊚ | ⊚ | ⊚ | 1.6 |
| Ex. 197 | 128 | 84 | 135 | 155 | ⊚ | ⊚ | ⊚ | 1.4 |
| Ex. 198 | 129 | 80 | 120 | 140 | ◯-⊚ | ⊚ | ⊚ | 1.8 |
| Ex. 199 | 130 | 85 | 140 | 145 | ⊚ | ⊚ | ⊚ | 1.4 |

No.: Number of photoreceptor used
T: Transmittance of protective layer or CTL against the discharging light

It is clear from Table 65 that even when a protective layer is formed, the following knowledge can be obtained.

(1) The residual potential increasing problem can be avoided if light with a wavelength less than 500 nm is used as the discharging light;

(2) The photoreceptor (Example 184) including a charge transport polymer in the CTL has better abrasion resistance than the photoreceptor (Example 183) including a low molecular weight CTM in the CTL;

(3) The photoreceptors (Examples 185-199) including a protective layer have better abrasion resistance than the photoreceptors (Examples 183 and 184) including no protective layer;

(4) Among the photoreceptors having a protective layer including a particulate inorganic material (Examples 185-187), the photoreceptors (Examples 185 and 186) having a protective layer including a particulate inorganic material having a resistivity not less than 10¹⁰ Ω·cm have good dot reproducibility even under high temperature and high humidity conditions;

(5) The photoreceptors having a crosslinked protective layer have better abrasion resistance than the photoreceptor having a non-crosslinked protective layer, in particular, the photoreceptors (Examples 191, 192, 194, and 196-199) having a crosslinked protective layer which is prepared using a tri- or more-functional monomer having no charge transport structure and a monofunctional monomer having a charge transport structure have excellent abrasion resistance; and

(6) the photoreceptors (Examples 191, 192, 194, and 196-199) also have excellent cleanability.

### Comparative Example 88

The procedure for the running test and evaluation of the images in Example 191 was repeated except that the laser diode was replaced with a laser diode (from Seiwa Electric Mfg. Co., Ltd.) emitting light with a wavelength of 502 nm and a half width of 15 nm. The light intensity was controlled so that the initial potential (V_{L}) of a lighted portion is the same as that in Example 191.

The evaluation results are shown in Table 66.

### Comparative Example 89

The procedure for the running test and the evaluation of the images in Example 191 was repeated except that the laser diode was replaced with a laser diode (from Rohm Co., Ltd.) emitting light with a wavelength of 591 nm and a half width of 15 nm. The light intensity was controlled so that the initial potential (V_{L}) of a lighted portion is the same as that in Example 191.

The evaluation results are shown in Table 66.

### Comparative Example 90

The procedure for the running test and the evaluation of the images in Example 191 was repeated except that the laser diode was replaced with a laser diode (from Rohm Co., Ltd.) emitting light with a wavelength of 630 nm and a half width of 20 nm. The light intensity was controlled so that the initial potential (V_{L}) of a lighted portion is the same as that in Example 191.

The evaluation results are shown in Table 66.

### Comparative Example 91

The procedure for the running test and the evaluation of the images in Example 191 was repeated except that the laser diode was replaced with a fluorescent lamp emitting light having a spectrum illustrated in FIG. 1. The light intensity was controlled so that the initial potential (V_{L}) of a lighted portion is the same as that in Example 191.

The evaluation results are shown in Table 66.

TABLE 66

| | | Transmittance | Potential of lighted | |
|---|---|---|---|---|
| | Wavelength | of protective | portion (V_{L}) (−V) | |
| | of | layer against | At | After |
| | discharging | discharging | beginning of | running |
| | light (nm) | light | running test | test |
| Ex. 191 | 472 | 85 | 130 | 150 |
| Comp. Ex. 88 | 502 | 85 | 130 | 180 |
| Comp. Ex. 89 | 591 | 89 | 130 | 185 |
| Comp. Ex. 90 | 630 | 90 | 130 | 190 |
| Comp. Ex. 91 | White light | — | 130 | 175 |

It is clear from Table 66 that when the wavelength of the discharging light is less than 500 nm (Example 191), increase in the potential (V_{L}) is smaller than in Comparative Examples 88-90 using discharging light with a wavelength of not less than 500 nm. In addition, when the discharging light has light including components with a relatively long wavelength of not less than 500 nm (Comparative Example 91), the effect produced in Example 191 cannot be produced.

### Example 200

The procedure for the running test and evaluation in Example 30 was repeated except that photoreceptor 13 was replaced with photoreceptor 122.

The evaluation results are shown in Table 67.

### Example 201

The procedure for the running test and the evaluation in Example 200 was repeated except that the homogenous light used as the discharging light was changed to homogeneous light with a wavelength of 400 nm by changing the conditions of the monochrometor.

The evaluation results are shown in Table 67.

### Example 202

The procedure for the running test and the evaluation in Example 200 was repeated except that the homogenous light used as the discharging light was changed to homogeneous light with a wavelength of 393 nm by changing the conditions of the monochrometor.

The evaluation results are shown in Table 67.

### Example 203

The procedure for the running test and the evaluation in Example 200 was repeated except that the homogenous light used as the discharging light was changed to homogeneous light with a wavelength of 390 nm by changing the conditions of the monochrometor.

The evaluation results are shown in Table 67.

### Example 204

The procedure for the running test and the evaluation in Example 200 was repeated except that the homogenous light used as the discharging light was changed to homogeneous light with a wavelength of 385 nm by changing the conditions of the monochrometor.

The evaluation results are shown in Table 67.

TABLE 67

| | | Transmittance | | |
|---|---|---|---|---|
| | Wavelength | of protective | Potential of lighted | |
| | of | layer against | portion (V_{L}) (−V) | |
| | discharging | discharging | At beginning of | After running |
| | light (nm) | light | running test | test |
| Ex. 158 | 450 | 85 | 130 | 150 |
| Ex. 159 | 400 | 73 | 130 | 150 |
| Ex. 160 | 393 | 50 | 130 | 150 |
| Ex. 161 | 390 | 29 | 130 | 155 |
| Ex. 162 | 385 | 9 | 130 | 155 |

It is clear from Table 67 that when the transmittance of the protective layer against the discharging light is less than about 30%, the discharging effect slightly deteriorates.

In addition, it is found that the half tone images produced in Examples 200 to 202 are normal but the half tone images produced in Examples 203 and 204 include a slight residual image of the stripe image formed on an upper portion of each copy although the half tone images are still acceptable. The residual stripe image in the image produced in Example 204 is relatively noticeable compared to that in Example 203.

Thus, it is discovered that even when light with a wavelength of less than 500 nm is used as the discharging light, a minor side effect is produced if the transmittance of the protective layer against the light is less than 30%.

### Photoreceptor Preparation Example 131

The procedure for preparation of photoreceptor 22 in Photoreceptor Preparation Example 22 was repeated except that dispersion 1 used as the CGL coating liquid was replaced with dispersion 18.

Thus, a photoreceptor 131 was prepared.

### Photoreceptor Preparation Example 132

The procedure for preparation of photoreceptor 23 in Photoreceptor Preparation Example 23 was repeated except that dispersion 1 used as the CGL coating liquid was replaced with dispersion 18.

Thus, a photoreceptor 132 was prepared.

### Photoreceptor Preparation Example 133

The procedure for preparation of photoreceptor 24 in Photoreceptor Preparation Example 24 was repeated except that dispersion 1 used as the CGL coating liquid was replaced with dispersion 18.

Thus, a photoreceptor 133 was prepared.

### Photoreceptor Preparation Example 134

The procedure for preparation of photoreceptor 25 in Photoreceptor Preparation Example 25 was repeated except that dispersion 1 used as the CGL coating liquid was replaced with dispersion 18.

Thus, a photoreceptor 134 was prepared.

### Photoreceptor Preparation Example 135

The procedure for preparation of photoreceptor 26 in Photoreceptor Preparation Example 26 was repeated except that dispersion 1 used as the CGL coating liquid was replaced with dispersion 18.

Thus, a photoreceptor 135 was prepared.

### Photoreceptor Preparation Example 136

The procedure for preparation of photoreceptor 27 in Photoreceptor Preparation Example 27 was repeated except that dispersion 1 used as the CGL coating liquid was replaced with dispersion 18.

Thus, a photoreceptor 136 was prepared.

### Examples 205 to 210

The procedure for the running test and evaluation in Example 183 was repeated except that photoreceptor 110 was replaced with each of photoreceptors 131-136.

The evaluation results are shown in Table 68.

TABLE 68

| | | | V_{L} (−V) | | | | | |
|---|---|---|---|---|---|---|---|---|
| | | | | After | | | | Abrasion |
| | | T | | 50,000 | | | | Loss |
| | No. | (%) | Initial | copies | BF | CL | DOT | (μm) |
| Ex. 183 | 110 | 87 | 120 | 140 | Δ | ◯ | ⊚ | 7.0 |
| Ex. 205 | 131 | 87 | 130 | 155 | ⊚ | ◯ | ⊚ | 7.0 |
| Ex. 206 | 132 | 87 | 130 | 150 | ◯ | ◯ | ⊚ | 7.0 |
| Ex. 207 | 133 | 87 | 135 | 160 | ⊚ | ◯ | ⊚ | 7.0 |
| Ex. 208 | 134 | 87 | 140 | 170 | ⊚ | ◯ | ⊚ | 7.0 |
| Ex. 209 | 135 | 87 | 130 | 150 | ◯ | ◯ | ⊚ | 7.0 |
| Ex. 210 | 136 | 87 | 140 | 160 | ⊚ | ◯ | ⊚ | 7.0 |

It is clear from Table 68 that by using a combination of a charge blocking layer and a moiré preventing layer as the intermediate layer, the photoreceptors have good resistance to background fouling.

### Example 211

The procedure for the running test and evaluation in Example 41 was repeated except that photoreceptor 1 was replaced with photoreceptor 110.

The evaluation results are shown in Table 69.

### Example 212

The procedure for the running test and evaluation in Example 211 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 211.

The evaluation results are shown in Table 69.

### Comparative Example 92

The procedure for the running test and evaluation in Example 211 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 211.

The evaluation results are shown in Table 69.

### Comparative Example 93

The procedure for the running test and evaluation in Example 211 was repeated except that the discharging lamp was replaced with a discharging lamp including a LED (from Rohm Co., Ltd.) which emits light having a wavelength of 591 nm and a half width of 15 nm. In this regard, the light intensity of the discharging lamp was controlled so that the potential of the photoreceptor after the discharging process is the same as that in Example 211.

The evaluation results are shown in Table 69.

### Comparative Example 94

The procedure for the running test and evaluation in Example 211 was repeated except that the discharging lamp was replaced with a discharging lamp including a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 211.

The evaluation results are shown in Table 69.

### Comparative Example 95

The procedure for the running test and the evaluation in Example 211 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 211.

The evaluation results are shown in Table 69.

### Comparative Example 96

The procedure for the running test and the evaluation in Example 211 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 211.

The evaluation results are shown in Table 69.

TABLE 69

| | | Transmittance | Potential of lighted | |
|---|---|---|---|---|
| | Wavelength | of protective | portion (V_{L})(−V) | |
| | of | layer against | At | After |
| | discharging | discharging | beginning of | running |
| | light (nm) | light | running test | test |
| Ex. 211 | 428 | 86 | 130 | 135 |
| Ex. 212 | 472 | 87 | 130 | 140 |
| Comp. Ex. 92 | 502 | 87 | 130 | 170 |
| Comp. Ex. 93 | 591 | 88 | 130 | 175 |
| Comp. Ex. 94 | 630 | 89 | 130 | 180 |
| Comp. Ex. 95 | White light | — | 130 | 165 |
| Comp. Ex. 96 | 428 and 630 | 86 and 89 | 130 | 170 |

It is clear from Table 69 that when the wavelength of the discharging light is less than 500 nm (Examples 211 and 212), increase in potential (V_{L}) of the lighted portion is lower than that in the cases where the wavelength of the discharging light is not less than 500 nm (Comparative Examples 92-94). In particular, when the wavelength of the discharging light is less than 450 nm (i.e., Example 211), increase in potential (V_{L}) of the lighted portion is lower than that in Example 212.

In addition, it is also found that when discharging light having a wide wavelength range and including light having a relatively long wavelength is used (i.e., Comparative Example 95), such an effect as produced in Examples 211 and 212 cannot be produced. Further, it is found that when a combination of two light sources emitting light with different wavelengths is used (Comparative Example 96), the effect of the light having a relatively short wavelength is reduced.

The image qualities of the color images produced in Examples 211 and 212 were hardly changed before and after the running test. However, the color images produced in Comparative Examples 92-96 after the running test have slightly poor color reproducibility (i.e., the color tones of the color images are changed after the running test).

The CGMs, titanyl phthalocyanines, which are used for the following examples, were prepared by the methods described in JP-A 2001-19871, incorporated herein by reference.

### Synthesis Example 5

A titanylphthalocyanine crystal was prepared by the method described in JP-A 2001-19871.

Specifically, at first 29.2 g of 1,3-diiminoisoindoline and 200 ml of sulforane were mixed. Then 20.4 g of titanium tetrabutoxide was dropped into the mixture under a nitrogen gas flow. The mixture was then heated to 180° C. and a reaction was performed for 5 hours at a temperature of from 170 to 180° C. while agitating. After the reaction, the reaction product was cooled, followed by filtering. The thus prepared wet cake was washed with chloroform until the cake colored blue. Then the cake was washed several times with methanol, followed by washing several times with hot water heated to 80° C. and drying. Thus, a crude titanyl phthalocyanine was prepared.

One part of the thus prepared crude titanyl phthalocyanine was dropped into 20 parts of concentrated sulfuric acid to be dissolved therein. The solution was dropped into 100 parts of ice water while stirred, to precipitate a titanyl phthalocyanine pigment. The pigment was obtained by filtering. The pigment was washed with ion-exchange water having a pH of 7.0 and a specific conductivity of 1.0 μS/cm until the filtrate became neutral. In this case, the pH and specific conductivity of the filtrate was 6.8 and 2.6 μS/cm. Thus, an aqueous paste of a titanyl phthalocyanine pigment was obtained. Forty (40) grams of the thus prepared aqueous paste of the titanyl phthalocyanine pigment, which has a solid content of 15% by weight, was added to 200 g of tetrahydrofuran (THF) and the mixture was stirred for about 4 hours. The weight ratio of the titanyl phthalocyanine pigment to the crystal changing solvent (i.e., THF) was 1/33. Then the mixture was filtered and the wet cake was dried to prepare a titanyl phthalocyanine crystal (hereinafter referred to as a phthalocyanine crystal 5).

The materials used for the titanyl phthalocyanine pigment does not include a halogenated compound.

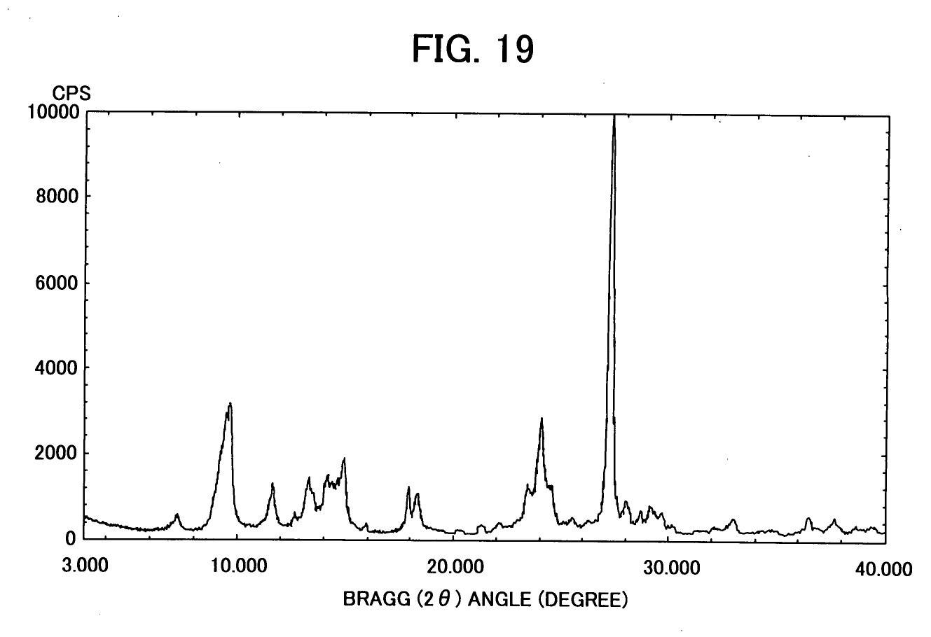

When the thus prepared phthalocyanine crystal 5 was subjected to the X-ray diffraction analysis mentioned above, it was confirmed that the crystal 5 has an X-ray diffraction spectrum such that a maximum peak is observed at a Bragg (2 θ) angle of 27.2±0.2°, a lowest angle peak at an angle of 7.3±0.2°, and a main peak at each of angles of 9.4±0.2°, 9.6±0.2°, and 24.0±0.2°, wherein no peak is observed between the peaks of 7.3° and 9.4° and at an angle of 26.3. The X-ray diffraction spectrum thereof is illustrated in FIG. 19.

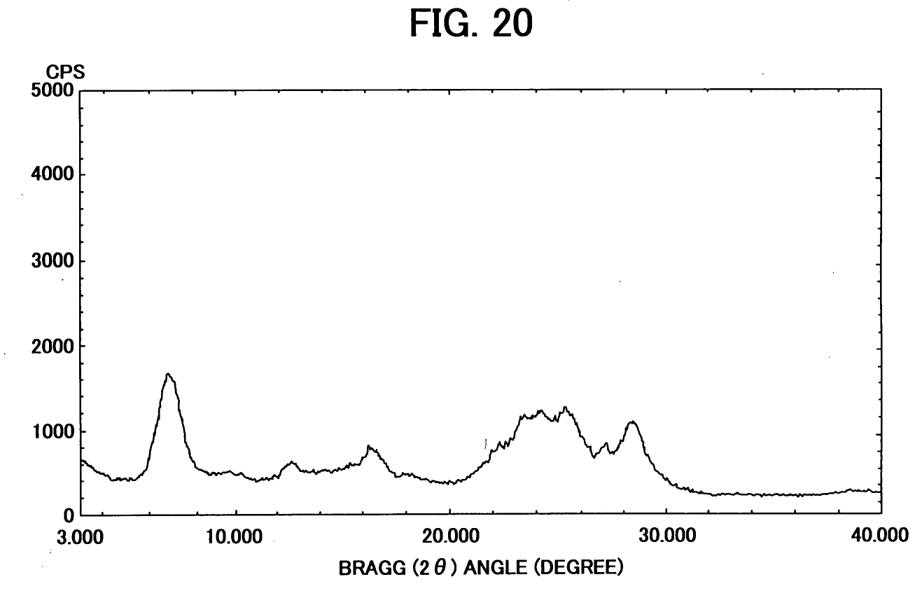

In addition, a part of the aqueous paste prepared above was dried at 80° C. for 2 days under a reduced pressure of 5 mmHg, to prepare a titanyl phthalocyanine pigment, which has a low crystallinity. The X-ray diffraction spectrum of the titanyl phthalocyanine pigment is illustrated in FIG. 20.

### Synthesis Example 6

The procedure for preparation of the aqueous paste in Synthesis Example 5 was repeated. The aqueous paste was subjected to the following crystal change treatment to prepare a titanyl phthalocyanine crystal having a particle diameter smaller than phthalocyanine crystal 5.

Specifically, 60 parts of the thus prepared aqueous paste of the titanyl phthalocyanine pigment, which has a solid content of 15% by weight, was added to 400 g of tetrahydrofuran (THF) and the mixture was strongly agitated with a HOMOMIXER (MARK IIf from Kenis Ltd.) at a revolution of 2,000 rpm until the color of the paste was changed from navy blue to light blue. The color was changed after the agitation was performed for about 20 minutes. In this regard, the ratio of the titanyl phthalocyanine pigment to the crystal change solvent (THF) is 44. The dispersion was then filtered under a reduced pressure. The thus obtained cake on the filter was washed with tetrahydrofuran to prepare a wet cake of a titanyl phthalocyanine crystal. The crystal was dried for 2 days at 70° C. under a reduced pressure of 5 mmHg. Thus, 8.5 parts of a titanyl phthalocyanine crystal (hereinafter referred to as a phthalocyanine crystal 6) was prepared. No halogen-containing raw material was used for synthesizing the phthalocyanine crystal 6. The solid content of the wet cake was 15% by weight, and the weight ratio (S/C) of the solvent (S) used for crystal change to the wet cake (C) was 44. Phthalocyanine crystal 6 was also subjected to the X-ray diffraction spectrum mentioned above. As a result, it was confirmed that the X-ray diffraction spectrum of crystal 6 is the same as that of crystal 5.

A part of the aqueous paste of the titanyl phthalocyanine pigment prepared above in Synthesis Example 5, which had not been subjected to a crystal change treatment, was diluted with ion-exchange water such that the resultant dispersion has a solid content of 1% by weight. The dispersion was placed on a 150-mesh copper net covered with a continuous collodion membrane and a conductive carbon layer. The titanyl phthalocyanine pigment was observed with a transmission electron microscope (H-9000NAR from Hitachi Ltd., hereinafter referred to as a TEM) of 75,000 power magnification to measure the average particle size of the titanyl phthalocyanine pigment. The average particle diameter thereof was determined as follows.

The image of particles of the titanyl phthalocyanine pigment in the TEM was photographed, which is shown in FIG. 16. Among the particles (needle form particles) of the titanyl phthalocyanine pigment in the photograph, 30 particles were randomly selected to measure the lengths of the particles in the long axis direction of the particles. The lengths were arithmetically averaged to determine the average particle diameter of the titanyl phthalocyanine pigment.

As a result, it was confirmed that the titanyl phthalocyanine pigment in the aqueous paste prepared in Synthesis Example 5 has an average primary particle diameter of 0.06 μm.

Similarly, each of the phthalocyanine crystals 5 and 6 prepared in Synthesis Examples 5 and 6, which had been subjected to the crystal change treatment but was not filtered, was diluted with tetrahydrofuran such that the resultant dispersion has a solid content of 1% by weight. The photographs of the dispersions are shown in FIGS. 17 and 18. The average particle diameters of phthalocyanine crystals 5 and 6 were determined by the method mentioned above. The results are shown in Table 70. In this regard, the form of the crystals was not uniform and includes triangle forms, quadrangular forms, etc. Therefore, the maximum lengths of the diagonal lines of the particles were arithmetically averaged.

It is clear from Table 70 below that phthalocyanine crystal 5 prepared in Synthesis Example 5 has a relatively large average particle diameter and in addition includes coarse particles. In contrast, the phthalocyanine crystal 6 prepared in Synthesis Example 6 has a relatively small average particle diameter and in addition the particle size of the particles is uniform.

TABLE 70

| | Average | |
|---|---|---|
| | particle | |
| Phthalocyanine | diameter | |
| crystal | (μm) | Note |
| Crystal 5 | 0.31 | Coarse particles having a particle diameter of |
| (Syn. Ex. 5) | | from 0.3 to 0.4 μm are included. |
| Crystal 6 | 0.12 | The particle diameters of the crystal |
| (Syn. Ex. 6) | | are almost uniform. |

### Dispersion Preparation Example 22

Formula of Dispersion

| | |
|---|---|
| Phthalocyanine crystal 5 | 15 parts |
| Polyvinyl butyral | 10 parts |
| (BX-1 from Sekisui Chemical Co., Ltd.) | |
| 2-Butanone | 280 parts |

At first, the polyvinyl butyral resin was dissolved in the solvent. The solution was mixed with phthalocyanine crystal 3 and the mixture was subjected to a dispersion treatment for 30 minutes using a bead mill which includes PSZ balls having a diameter of 0.5 mm and which is rotated at a revolution of 1200 rpm.

Thus, a dispersion 22 was prepared.

### Dispersion Preparation Example 23

The procedure for preparation of dispersion 22 was repeated except that phthalocyanine crystal 5 was replaced with phthalocyanine crystal 6.

Thus, a dispersion 23 was prepared.

### Dispersion Preparation Example 24

The procedure for preparation of dispersion 22 was repeated except that dispersion 22 was filtered with a cotton wind cartridge filter (TCW-3-CS from Advantech Co., Ltd.) having an effective pore diameter of 1 μm. Filtering was performed under pressure using a pump.

Thus, a dispersion 24 was prepared.

### Dispersion Preparation Example 25

The procedure for preparation of dispersion 24 was repeated except that the filter was replaced with a cotton wind cartridge filter (TCW-3-CS from Advantech Co., Ltd.) having an effective pore diameter of 3 μm.

Thus, a dispersion 25 was prepared.

### Dispersion Preparation Example 26

The procedure for preparation of dispersion 24 was repeated except that the filter was replaced with a cotton wind cartridge filter (TCW-5-CS from Advantech Co., Ltd.) having an effective pore diameter of 5 μm.

Thus, a dispersion 26 was prepared.

The particle diameter distribution of the thus prepared dispersions 22 to 26 was measured with a particle diameter measuring instrument (CAPA 700 from Horiba Ltd.). The results are shown in Table 71.

TABLE 71

| | | Average particle | |
|---|---|---|---|
| | Phthalocyanine | diameter | Standard deviation of |
| Dispersion | crystal | (μm) | particle diameter (μm) |
| 22 | Crystal 5 | 0.29 | 0.18 |
| 23 | Crystal 6 | 0.19 | 0.13 |
| 24 | Crystal 5 | 0.22 | 0.16 |
| 25 | Crystal 5 | 0.24 | 0.17 |
| 26 | Crystal 5 | 0.28 | 0.18 |

### Photoreceptor Preparation Example 137

On an aluminum drum of JIS 1050 having a diameter of 100 mm, the following intermediate layer coating liquid, a CGL coating liquid, a CTL coating liquid were coated and dried one by one. Thus, a multi-layered photoreceptor (hereinafter referred to as a photoreceptor 1) having an intermediate transfer layer having a thickness of 3.5 μm, a CGL having a thickness of 0.3 μm, and a CTL having a thickness of 28 μm was prepared.

Formula of Intermediate Layer Coating Liquid

| | |
|---|---|
| Titanium oxide | 70 parts |
| (CR-EL from Ishihara Sangyo Kaisha Ltd., average | |
| particle diameter of 0.25 μm) | |
| Alkyd resin | 15 parts |
| (BEKKOLITE M6401-50-S from Dainippon Ink & | |
| Chemicals, Inc., solid content of 50%) | |
| Melamine resin | 10 parts |
| (SUPER BEKKAMIN L-121-60 from Dainippon Ink & | |
| Chemicals, Inc., solid content of 60%) | |
| 2-Butanone | 100 parts |

Formula of CGL Coating Liquid

Dispersion 22 prepared above was used as the CGL coating liquid.

Formula of CTL Coating Liquid

| | |
|---|---|
| Polycarbonate | 10 parts |
| (TS2050 from Teijin Chemicals Ltd.) | |
| CTM having formula CTM-1 mentioned above | 7 parts |
| Methylene chloride | 80 parts |

Thus, a photoreceptor 137 was prepared.

### Example 213

The procedure for the running test and evaluation in Example 171 was repeated except that photoreceptor 110 was replaced with photoreceptor 137.

The evaluation results are shown in Table 72.

### Example 214

The procedure for the running test and the evaluation in Example 213 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 213.

The evaluation results are shown in Table 72.

### Comparative Example 97

The procedure for the running test and the evaluation in Example 213 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 213.

The evaluation results are shown in Table 72.

### Comparative Example 98

The procedure for the running test and the evaluation in Example 213 was repeated except that the discharging lamp was replaced with a discharging lamp including a LED (from Seiwa Electric Mfg. Co., Ltd.) which emits light having a wavelength of 591 nm and a half width of 15 nm. In this regard, the light intensity of the discharging lamp was controlled so that the potential of the photoreceptor after the discharging process is the same as that in Example 213.

The evaluation results are shown in Table 72.

### Comparative Example 99

The procedure for the running test and the evaluation in Example 213 was repeated except that the discharging lamp was replaced with a discharging lamp including a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 213.

The evaluation results are shown in Table 72.

### Comparative Example 100

The procedure for the running test and the evaluation in Example 213 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 213.

The evaluation results are shown in Table 72.

### Comparative Example 101

The procedure for the running test and the evaluation in Example 213 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 213.

The evaluation results are shown in Table 72.

TABLE 72

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 213 | 428 | 86 | 900 | 110 | 900 | 115 |
| Ex. 214 | 472 | 87 | 900 | 110 | 900 | 120 |
| Comp. Ex. | 502 | 87 | 900 | 110 | 900 | 150 |
| 97 | | | | | | |
| Comp. Ex. | 591 | 88 | 900 | 110 | 900 | 155 |
| 98 | | | | | | |
| Comp. Ex. | 630 | 89 | 900 | 110 | 900 | 160 |
| 99 | | | | | | |
| Comp. Ex. | White | — | 900 | 110 | 900 | 145 |
| 100 | light | | | | | |
| Comp. Ex. | 428, | 86, | 900 | 110 | 900 | 150 |
| 101 | 630 | 89 | | | | |

λ: The wavelength of the discharging light emitted by the discharging lamp.
T: Transmittance of the CTL against the discharging light.
V_{D}: Potential of non-lighted portion.
V_{L}: Potential of lighted portion.

It is clear from Table 72 that when the wavelength of the discharging light is less than 500 nm (Examples 213 and 214), increase in potential (V_{L}) of the lighted portion is lower than that in the cases where the wavelength of the discharging light is not less than 500 nm (Comparative Examples 97-99). In particular, when the wavelength of the discharging light is less than 450 nm (i.e., Example 213), increase in potential (V_{L}) of the lighted portion is lower than that in Example 214.

In addition, it is also found that when discharging light having a wide wavelength range and including light having a relatively long wavelength is used (i.e., Comparative Example 100), such an effect as produced in Examples 213 and 214 cannot be produced. Further, it is found that when a combination of two light sources emitting light with different wavelengths is used (Comparative Example 101), the effect of the light having a relatively short wavelength is reduced.

### Photoreceptor Preparation Example 138

The procedure for preparation of photoreceptor 137 in Photoreceptor Preparation Example 137 was repeated except that dispersion 22 used as the CGL coating liquid was replaced with dispersion 23.

Thus, photoreceptor 138 was prepared.

### Example 215

The procedure for the running test and the evaluation in Example 213 was repeated except that photoreceptor 137 was replaced with photoreceptor 138.

The evaluation results are shown in Table 73.

### Example 216

The procedure for the running test and the evaluation in Example 214 was repeated except that photoreceptor 137 was replaced with photoreceptor 138.

The evaluation results are shown in Table 73.

### Comparative Example 102

The procedure for the running test and the evaluation in Comparative Example 97 was repeated except that photoreceptor 137 was replaced with photoreceptor 138.

The evaluation results are shown in Table 73.

### Comparative Example 103

The procedure for the running test and the evaluation in Comparative Example 98 was repeated except that photoreceptor 137 was replaced with photoreceptor 138.

The evaluation results are shown in Table 73.

### Comparative Example 104

The procedure for the running test and the evaluation in Comparative Example 99 was repeated except that photoreceptor 137 was replaced with photoreceptor 138.

The evaluation results are shown in Table 73.

### Comparative Example 105

The procedure for the running test and the evaluation in Comparative Example 100 was repeated except that photoreceptor 137 was replaced with photoreceptor 138.

The evaluation results are shown in Table 73.

TABLE 73

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 215 | 428 | 86 | 900 | 100 | 900 | 105 |
| Ex. 216 | 472 | 87 | 900 | 100 | 900 | 110 |
| Comp. Ex. | 502 | 87 | 900 | 100 | 900 | 140 |
| 102 | | | | | | |
| Comp. Ex. | 591 | 88 | 900 | 100 | 900 | 145 |
| 103 | | | | | | |
| Comp. Ex. | 630 | 89 | 900 | 100 | 900 | 150 |
| 104 | | | | | | |
| Comp. Ex. | White | — | 900 | 100 | 900 | 135 |
| 105 | light | | | | | |

It is clear from Table 73 that when the wavelength of the discharging light is less than 500 nm (Examples 215 and 216), increase in potential (V_{L}) of the lighted portion is lower than that in the other cases where the wavelength of the discharging light is not less than 500 nm (Comparative Examples 102 to 104). In particular, when the wavelength of the discharging light is less than 450 nm (i.e., Example 215), increase in potential (V_{L}) of the lighted portion is lower than that in Example 216.

In addition, it is also found that when discharging light having a side wavelength range and including light having a relatively long wavelength is used (i.e., Comparative Example 105), such an effect as produced in Examples 215 and 216 cannot be produced.

### Example 217

The procedure for the running test and the evaluation in Example 215 was repeated except that the laser diode used for the light irradiator was replaced with a laser diode emitting light of 408 nm, and a dot image constituted of one-dot images with a diameter of 60 μm was produced and observed with a microscope of 150 power magnification.

The evaluation results are shown in Table 74.

TABLE 74

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 215 | 428 | 86 | 900 | 100 | 900 | 105 |
| Ex. 217 | 428 | 86 | 900 | 100 | 900 | 100 |

The outline of the one-dot image produced in Example 217 is clearer than that of the one-dot image produced in Example 215.

It is clear from Table 74 that increase in potential (V_{L}) of the lighted portion is lower in Example 217 (using a laser diode emitting light with a relatively short wavelength of 408 nm) than that in Example 215.

### Photoreceptor Preparation Example 139

The procedure for preparation of photoreceptor 137 in Photoreceptor Preparation Example 137 was repeated except that the CTL coating liquid was replaced with a CTL coating liquid having the following formula.

Formula of CTL Coating Liquid

| | |
|---|---|
| Polycarbonate | 10 parts |
| (TS2050 from Teijin Chemicals Ltd.) | |
| CTM having formula CTM-2 mentioned above | 7 parts |
| Methylene chloride | 80 parts |

Thus, a photoreceptor 217 was prepared.

### Example 218

The procedure for the running test and the evaluation in Example 176 was repeated except that photoreceptor 112 was replaced with photoreceptor 139.

The evaluation results are shown in Table 75.

### Example 219

The procedure for the running test and the evaluation in Example 218 was repeated except that the homogenous light used as the discharging light was changed to homogeneous light with a wavelength of 443 nm by changing the conditions of the monochrometor.

The evaluation results are shown in Table 75.

### Example 220

The procedure for the running test and the evaluation in Example 218 was repeated except that the homogenous light used as the discharging light was changed to homogeneous light with a wavelength of 437 nm by changing the conditions of the monochrometor.

The evaluation results are shown in Table 75.

### Example 221

The procedure for the running test and the evaluation in Example 218 was repeated except that the homogenous light used as the discharging light was changed to homogeneous light with a wavelength of 433 nm by changing the conditions of the monochrometor.

The evaluation results are shown in Table 75.

### Example 222

The procedure for the running test and the evaluation in Example 218 was repeated except that the homogenous light used as the discharging light was changed to homogeneous light with a wavelength of 429 nm by changing the conditions of the monochrometor.

The evaluation results are shown in Table 75.

TABLE 75

| | | | At beginning of | | | |
|---|---|---|---|---|---|---|
| | λ | T | running test | | After running test | |
| | (%) | (%) | V_{D} (−V) | V_{L} (−V) | V_{D} (−V) | V_{L} (−V) |
| Ex. 218 | 461 | 85 | 900 | 120 | 900 | 125 |
| Ex. 219 | 443 | 69 | 900 | 120 | 900 | 125 |
| Ex. 220 | 437 | 49 | 900 | 120 | 900 | 125 |
| Ex. 221 | 433 | 29 | 900 | 120 | 900 | 130 |
| Ex. 222 | 429 | 9 | 900 | 120 | 900 | 130 |

It is clear from Table 75 that when the transmittance of the CTL against the discharging light is less than about 30%, the discharging effect slightly deteriorates.

In addition, it is found that the half tone images produced in Examples 218 to 220 are normal but the half tone images produced in Examples 221 and 222 includes a slight residual image of the stripe image although the half tone images are still acceptable. The residual stripe image in the image produced in Example 222 is relatively noticeable compared to that in Example 221.

Thus, it is discovered that even when light with a wavelength of less than 500 nm is used as the discharging light, a minor side effect is produced if the transmittance of the CTL against the light is less than 30%.

### Photoreceptor Preparation Example 140

The procedure for preparation of photoreceptor 137 in Photoreceptor Preparation Example 137 was repeated except that dispersion 22 used as the CGL coating liquid was replaced with dispersion 24.

Thus, a photoreceptor 140 was prepared.

### Photoreceptor Preparation Example 141

The procedure for preparation of photoreceptor 137 in Photoreceptor Preparation Example 137 was repeated except that dispersion 22 used as the CGL coating liquid was replaced with dispersion 25.

Thus, a photoreceptor 141 was prepared.

### Photoreceptor Preparation Example 142

The procedure for preparation of photoreceptor 137 in Photoreceptor Preparation Example 137 was repeated except that dispersion 22 used as the CGL coating liquid was replaced with dispersion 26.

Thus, a photoreceptor 142 was prepared.

### Example 223

The procedure for the running test and the evaluation in Example 213 was repeated except that photoreceptor 137 was replaced with photoreceptor 140.

In addition, after the running test, a copy of a white solid image was produced and observed to determine whether the white solid image has background fouling (i.e., the white solid image is soiled with toner particles).

The evaluation results are shown in Table 76.

### Example 224

The procedure for the running test and the evaluation in Example 213 was repeated except that photoreceptor 137 was replaced with photoreceptor 141.

The evaluation results are shown in Table 76.

### Example 225

The procedure for the running test and the evaluation in Example 213 was repeated except that photoreceptor 137 was replaced with photoreceptor 142.

The evaluation results are shown in Table 76.

TABLE 76

| | | |
|---|---|---|
| At beginning of | | |
| running test | After running test | Background |

| | V_{D} (−V) | V_{L} (−V) | V_{D} (−V) | V_{L} (−V) | fouling |
|---|---|---|---|---|---|
| Ex. 213 | 900 | 100 | 900 | 105 | Δ-◯ |
| Ex. 214 | 900 | 100 | 900 | 100 | ⊚ |
| Ex. 215 | 900 | 100 | 900 | 105 | ◯ |
| Ex. 216 | 900 | 100 | 900 | 105 | Δ-◯ |

The level of background fouling is classified into the following four grades while considering the number and size of black spots formed on the white solid image.

⊚: Excellent

◯: Good

Δ: Acceptable

X: Bad

It is clear from Table 76 that when the average particle diameter of the CGM dispersed in the CGL coating liquid is less than 0.25 μm (Examples 223 and 224), the initial potential of a lighted portion (V_{L}) can be reduced and in addition occurrence of background fouling can be prevented without increasing the potential of a lighted portion even after long repeated use.

### Photoreceptor Preparation Example 143

The procedure for preparation of photoreceptor 6 in Photoreceptor Preparation Example 6 was repeated except that dispersion 1 used as the CGL coating liquid was replaced with dispersion 22.

Thus, a photoreceptor 143 was prepared.

### Photoreceptor Preparation Example 144

The procedure for preparation of photoreceptor 7 in Photoreceptor Preparation Example 7 was repeated except that dispersion 1 used as the CGL coating liquid was replaced with dispersion 22.

Thus, a photoreceptor 144 was prepared.

### Photoreceptor Preparation Example 145

The procedure for preparation of photoreceptor 8 in Photoreceptor Preparation Example 8 was repeated except that dispersion 1 used as the CGL coating liquid was replaced with dispersion 22.

Thus, a photoreceptor 145 was prepared.

### Photoreceptor Preparation Example 146

The procedure for preparation of photoreceptor 9 in Photoreceptor Preparation Example 9 was repeated except that dispersion 1 used as the CGL coating liquid was replaced with dispersion 22.

Thus, a photoreceptor 146 was prepared.

### Photoreceptor Preparation Example 147

The procedure for preparation of photoreceptor 10 in Photoreceptor Preparation Example 10 was repeated except that dispersion 1 used as the CGL coating liquid was replaced with dispersion 22.

Thus, a photoreceptor 147 was prepared.

### Photoreceptor Preparation Example 148

The procedure for preparation of photoreceptor 11 in Photoreceptor Preparation Example 11 was repeated except that dispersion 1 used as the CGL coating liquid was replaced with dispersion 22.

Thus, a photoreceptor 148 was prepared.

### Photoreceptor Preparation Example 149

The procedure for preparation of photoreceptor 12 in Photoreceptor Preparation Example 12 was repeated except that dispersion 1 used as the CGL coating liquid was replaced with dispersion 22.

Thus, a photoreceptor 149 was prepared.

### Photoreceptor Preparation Example 150

The procedure for preparation of photoreceptor 13 in Photoreceptor Preparation Example 13 was repeated except that dispersion 1 used as the CGL coating liquid was replaced with dispersion 22.

Thus, a photoreceptor 150 was prepared.

### Photoreceptor Preparation Example 151

The procedure for preparation of photoreceptor 14 in Photoreceptor Preparation Example 14 was repeated except that dispersion 1 used as the CGL coating liquid was replaced with dispersion 22.

Thus, a photoreceptor 151 was prepared.

### Photoreceptor Preparation Example 152

The procedure for preparation of photoreceptor 15 in Photoreceptor Preparation Example 15 was repeated except that dispersion 1 used as the CGL coating liquid was replaced with dispersion 22.

Thus, a photoreceptor 152 was prepared.

### Photoreceptor Preparation Example 153

The procedure for preparation of photoreceptor 16 in Photoreceptor Preparation Example 16 was repeated except that dispersion 1 used as the CGL coating liquid was replaced with dispersion 22.

Thus, a photoreceptor 153 was prepared.

### Photoreceptor Preparation Example 154

The procedure for preparation of photoreceptor 17 in Photoreceptor Preparation Example 17 was repeated except that dispersion 1 used as the CGL coating liquid was replaced with dispersion 22.

Thus, a photoreceptor 154 was prepared.

### Photoreceptor Preparation Example 155

The procedure for preparation of photoreceptor 18 in Photoreceptor Preparation Example 18 was repeated except that dispersion 1 used as the CGL coating liquid was replaced with dispersion 22.

Thus, a photoreceptor 155 was prepared.

### Photoreceptor Preparation Example 156

The procedure for preparation of photoreceptor 19 in Photoreceptor Preparation Example 19 was repeated except that dispersion 1 used as the CGL coating liquid was replaced with dispersion 22.

Thus, a photoreceptor 156 was prepared.

### Photoreceptor Preparation Example 157

The procedure for preparation of photoreceptor 20 in Photoreceptor Preparation Example 20 was repeated except that dispersion 1 used as the CGL coating liquid was replaced with dispersion 22.

Thus, a photoreceptor 157 was prepared.

### Photoreceptor Preparation Example 158

The procedure for preparation of photoreceptor 21 in Photoreceptor Preparation Example 21 was repeated except that dispersion 1 used as the CGL coating liquid was replaced with dispersion 22.

Thus, a photoreceptor 158 was prepared.

### Example 226

The procedure for the running test and evaluation in Example 183 was repeated except that photoreceptor 110 was replaced with photoreceptor 137.

The evaluation results are shown in Table 77.

### Examples 227 to 242

The procedure for evaluation in Example 226 was repeated except that photoreceptor 137 was replaced with each of photoreceptors 143 to 158.

The evaluation results are shown in Table 77.

TABLE 77

| | | | V_{L} (−V) | | | | | |
|---|---|---|---|---|---|---|---|---|
| | | | | After 50,000 | | | | Abrasion Loss |
| | No. | T (%) | Initial | copies | BF | CL | DOT | (μm) |
| Ex. 226 | 137 | 87 | 100 | 110 | Δ | ◯ | ⊚ | 7.0 |
| Ex. 227 | 143 | 85 | 100 | 110 | Δ-◯ | ◯-⊚ | ⊚ | 4.0 |
| Ex. 228 | 144 | 80 | 100 | 120 | ⊚ | Δ-◯ | ◯-⊚ | 2.0 |
| Ex. 229 | 145 | 78 | 100 | 125 | ⊚ | Δ-◯ | ◯ | 1.8 |
| Ex. 230 | 146 | 80 | 100 | 115 | ◯ | Δ-◯ | Δ-◯ | 2.0 |
| Ex. 231 | 147 | 77 | 100 | 120 | ⊚ | Δ-⊚ | ◯ | 1.6 |
| Ex. 232 | 148 | 85 | 100 | 120 | ◯-⊚ | ◯ | ◯ | 2.5 |
| Ex. 233 | 149 | 81 | 100 | 125 | ⊚ | Δ-◯ | Δ-◯ | 1.6 |
| Ex. 234 | 150 | 85 | 100 | 120 | ⊚ | ⊚ | ⊚ | 1.4 |
| Ex. 235 | 151 | 85 | 100 | 120 | ◯ | ⊚ | ⊚ | 1.2 |
| Ex. 236 | 152 | 85 | 100 | 120 | ⊚ | Δ-◯ | ⊚ | 2.6 |
| Ex. 237 | 153 | 85 | 100 | 120 | ⊚ | ⊚ | ⊚ | 1.4 |
| Ex. 238 | 154 | 83 | 100 | 125 | ⊚ | Δ-◯ | ⊚ | 1.2 |
| Ex. 239 | 155 | 84 | 100 | 115 | ◯-⊚ | ⊚ | ⊚ | 1.6 |
| Ex. 240 | 156 | 84 | 100 | 125 | ⊚ | ⊚ | ⊚ | 1.4 |
| Ex. 241 | 157 | 80 | 100 | 110 | ◯-⊚ | ⊚ | ⊚ | 1.8 |
| Ex. 242 | 158 | 85 | 100 | 125 | ⊚ | ⊚ | ⊚ | 1.4 |

No.: Number of photoreceptor used
T: Transmittance of protective layer or CTL against the discharging light

It is clear from Table 77 that even when a protective layer is formed, the following knowledge can be obtained.

(1) The residual potential increasing problem can be avoided if light with a wavelength less than 500 nm is used as the discharging light;

(2) The photoreceptor (Example 227) including a charge transport polymer in the CTL has better abrasion resistance than the photoreceptor (Example 226) including a low molecular weight CTM in the CTL;

(3) The photoreceptors (Examples 228-242) including a protective layer have better abrasion resistance than the photoreceptors (Examples 226 and 227) including no protective layer;

(4) Among the photoreceptors having a protective layer including a particulate inorganic material (Examples 228-230), the photoreceptors (Examples 228 and 229) having a protective layer including a particulate inorganic material having a resistivity not less than 10¹⁰ Ω·cm have good dot reproducibility even under high temperature and high humidity conditions;

(5) The photoreceptors having a crosslinked protective layer have better abrasion resistance than the photoreceptor having a non-crosslinked protective layer, in particular, the photoreceptors (Examples 234, 235, 237, and 239-242) having a crosslinked protective layer which is prepared using a tri- or more-functional monomer having no charge transport structure and a monofunctional monomer having a charge transport structure have excellent abrasion resistance; and

(6) the photoreceptors (Examples 234, 235, 237, and 239-242) also have excellent cleanability.

### Comparative Example 106

The procedure for the running test and evaluation of the images in Example 234 was repeated except that the laser diode was replaced with a laser diode (from Seiwa Electric Mfg. Co., Ltd.) emitting light with a wavelength of 502 nm and a half width of 15 nm. The light intensity was controlled so that the initial potential (V_{L}) of a lighted portion is the same as that in Example 234.

The evaluation results are shown in Table 78.

### Comparative Example 107

The procedure for the running test and the evaluation of the images in Example 234 was repeated except that the laser diode was replaced with a laser diode (from Rohm Co., Ltd.) emitting light with a wavelength of 591 nm and a half width of 15 nm. The light intensity was controlled so that the initial potential (V_{L}) of a lighted portion is the same as that in Example 234.

The evaluation results are shown in Table 78.

### Comparative Example 108

The procedure for the running test and the evaluation of the images in Example 234 was repeated except that the laser diode was replaced with a laser diode (from Rohm Co., Ltd.) emitting light with a wavelength of 630 nm and a half width of 20 nm. The light intensity was controlled so that the initial potential (V_{L}) of a lighted portion is the same as that in Example 234.

The evaluation results are shown in Table 78.

### Comparative Example 109

The procedure for the running test and the evaluation of the images in Example 234 was repeated except that the laser diode was replaced with a fluorescent lamp emitting light having a spectrum illustrated in FIG. 1. The light intensity was controlled so that the initial potential (V_{L}) of a lighted portion is the same as that in Example 234.

The evaluation results are shown in Table 78.

TABLE 78

| | | Transmittance | Potential of lighted | |
|---|---|---|---|---|
| | Wavelength | of protective | portion (V_{L}) (−V) | |
| | of | layer against | At | After |
| | discharging | discharging | beginning of | running |
| | light (nm) | light | running test | test |
| Ex. 234 | 472 | 85 | 100 | 120 |
| Comp. Ex. 106 | 502 | 85 | 100 | 150 |
| Comp. Ex. 107 | 591 | 89 | 100 | 155 |
| Comp. Ex. 108 | 630 | 90 | 100 | 160 |
| Comp. Ex. 109 | White light | — | 100 | 145 |

It is clear from Table 78 that when the wavelength of the discharging light is less than 500 nm (Example 234), increase in the potential (V_{L}) is smaller than in Comparative Examples 106-108 using discharging light with a wavelength of not less than 500 nm. In addition, when the discharging light has light including components with a relatively long wavelength of not less than 500 nm (Comparative Example 109), the effect produced in Example 234 cannot be produced.

### Example 243

The procedure for the running test and evaluation in Example 30 was repeated except that photoreceptor 13 was replaced with photoreceptor 150.

The evaluation results are shown in Table 79.

### Example 244

The procedure for the running test and the evaluation in Example 243 was repeated except that the homogenous light used as the discharging light was changed to homogeneous light with a wavelength of 400 nm by changing the conditions of the monochrometor.

The evaluation results are shown in Table 79.

### Example 245

The procedure for the running test and the evaluation in Example 243 was repeated except that the homogenous light used as the discharging light was changed to homogeneous light with a wavelength of 393 nm by changing the conditions of the monochrometor.

The evaluation results are shown in Table 79.

### Example 246

The procedure for the running test and the evaluation in Example 243 was repeated except that the homogenous light used as the discharging light was changed to homogeneous light with a wavelength of 390 nm by changing the conditions of the monochrometor.

The evaluation results are shown in Table 79.

### Example 247

The procedure for the running test and the evaluation in Example 243 was repeated except that the homogenous light used as the discharging light was changed to homogeneous light with a wavelength of 385 nm by changing the conditions of the monochrometor.

The evaluation results are shown in Table 79.

TABLE 79

| | | Transmittance | | |
|---|---|---|---|---|
| | Wavelength | of protective | Potential of lighted portion (V_{L}) | |
| | of | layer against | (−V) | |
| | discharging | discharging | At beginning of | After running |
| | light (nm) | light | running test | test |
| Ex. 243 | 450 | 85 | 100 | 120 |
| Ex. 244 | 400 | 73 | 100 | 120 |
| Ex. 245 | 393 | 50 | 100 | 120 |
| Ex. 246 | 390 | 29 | 100 | 125 |
| Ex. 247 | 385 | 9 | 100 | 125 |

It is clear from Table 79 that when the transmittance of the protective layer against the discharging light is less than about 30%, the discharging effect slightly deteriorates.

In addition, it is found that the half tone images produced in Examples 243 to 245 are normal but the half tone images produced in Examples 246 and 247 include a slight residual image of the stripe image formed on an upper portion of each copy although the half tone images are still acceptable. The residual stripe image in the image produced in Example 247 is relatively noticeable compared to that in Example 246.

Thus, it is discovered that even when light with a wavelength of less than 500 nm is used as the discharging light, a minor side effect is produced if the transmittance of the protective layer against the light is less than 30%.

### Photoreceptor Preparation Example 159

The procedure for preparation of photoreceptor 22 in Photoreceptor Preparation Example 22 was repeated except that dispersion 1 used as the CGL coating liquid was replaced with dispersion 22.

Thus, a photoreceptor 159 was prepared.

### Photoreceptor Preparation Example 160

The procedure for preparation of photoreceptor 23 in Photoreceptor Preparation Example 23 was repeated except that dispersion 1 used as the CGL coating liquid was replaced with dispersion 22.

Thus, a photoreceptor 160 was prepared.

### Photoreceptor Preparation Example 161

The procedure for preparation of photoreceptor 24 in Photoreceptor Preparation Example 24 was repeated except that dispersion 1 used as the CGL coating liquid was replaced with dispersion 22.

Thus, a photoreceptor 161 was prepared.

### Photoreceptor Preparation Example 162

The procedure for preparation of photoreceptor 25 in Photoreceptor Preparation Example 25 was repeated except that dispersion 1 used as the CGL coating liquid was replaced with dispersion 22.

Thus, a photoreceptor 162 was prepared.

### Photoreceptor Preparation Example 163

The procedure for preparation of photoreceptor 26 in Photoreceptor Preparation Example 26 was repeated except that dispersion 1 used as the CGL coating liquid was replaced with dispersion 22.

Thus, a photoreceptor 163 was prepared.

### Photoreceptor Preparation Example 164

The procedure for preparation of photoreceptor 27 in Photoreceptor Preparation Example 27 was repeated except that dispersion 1 used as the CGL coating liquid was replaced with dispersion 22.

Thus, a photoreceptor 164 was prepared.

### Examples 248 to 253

The procedure for the running test and evaluation in Example 226 was repeated except that photoreceptor 137 was replaced with each of photoreceptors 159-164. The evaluation results are shown in Table 80.

TABLE 80

| | | | V_{L} (−V) | | | | | |
|---|---|---|---|---|---|---|---|---|
| | | | | After | | | | |
| | | T | | 50,000 | | | | Abrasion Loss |
| | No. | (%) | Initial | copies | BF | CL | DOT | (μm) |
| Ex. 226 | 137 | 87 | 100 | 110 | Δ | ◯ | ⊚ | 7.0 |
| Ex. 248 | 159 | 87 | 100 | 115 | ⊚ | ◯ | ⊚ | 7.0 |
| Ex. 249 | 160 | 87 | 100 | 110 | ◯ | ◯ | ⊚ | 7.0 |
| Ex. 250 | 161 | 87 | 105 | 120 | ⊚ | ◯ | ⊚ | 7.0 |
| Ex. 251 | 162 | 87 | 110 | 130 | ⊚ | ◯ | ⊚ | 7.0 |
| Ex. 252 | 163 | 87 | 100 | 110 | ◯ | ◯ | ⊚ | 7.0 |
| Ex. 253 | 164 | 87 | 110 | 120 | ⊚ | ◯ | ⊚ | 7.0 |

It is clear from Table 80 that by using a combination of a charge blocking layer and a moiré preventing layer as the intermediate layer, the photoreceptors have good resistance to background fouling.

### Example 254

The procedure for the running test and evaluation in Example 211 was repeated except that photoreceptor 110 was replaced with photoreceptor 137.

The evaluation results are shown in Table 81.

### Example 255

The procedure for the running test and evaluation in Example 254 was repeated except that the discharging lamp was replaced with a discharging lamp including a LED (from Seiwa Electric Mfg. Co., Ltd.) which emits light having a wavelength of 472 nm and a half width of 15 nm. In this regard, the light intensity of the discharging lamp was controlled so that the potential of the photoreceptor after the discharging process is the same as that in Example 254.

The evaluation results are shown in Table 81.

### Comparative Example 110

The procedure for the running test and evaluation in Example 254 was repeated except that the discharging lamp was replaced with a discharging lamp including a LED (from Seiwa Electric Mfg. Co., Ltd.) which emits light having a wavelength of 502 nm and a half width of 15 nm. In this regard, the light intensity of the discharging lamp was controlled so that the potential of the photoreceptor after the discharging process is the same as that in Example 254.

The evaluation results are shown in Table 81.

### Comparative Example 111

The procedure for the running test and evaluation in Example 254 was repeated except that the discharging lamp was replaced with a discharging lamp including a LED (from Rohm Co., Ltd.) which emits light having a wavelength of 591 nm and a half width of 15 nm. In this regard, the light intensity of the discharging lamp was controlled so that the potential of the photoreceptor after the discharging process is the same as that in Example 254.

The evaluation results are shown in Table 81.

### Comparative Example 112

The procedure for the running test and evaluation in Example 254 was repeated except that the discharging lamp was replaced with a discharging lamp including a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 254.

The evaluation results are shown in Table 81.

### Comparative Example 113

The procedure for the running test and the evaluation in Example 254 was repeated except that the discharging lamp was replaced with a fluorescent lamp which emits light having a spectrum as illustrated in FIG. 1. In this regard, the light intensity of the discharging lamp was controlled so that the potential of the photoreceptor after the discharging process is the same as that in Example 254.

The evaluation results are shown in Table 81.

### Comparative Example 114

The procedure for the running test and the evaluation in Example 254 was repeated except that the discharging lamp was replaced with a discharging lamp including a combination of a LED (from Rohm Co., Ltd.) which emits light having a wavelength of 428 nm and a half width of 65 nm and a LED (from Rohm Co., Ltd.) which emits light having a wavelength of 630 nm and a half width of 20 nm. In this regard, the light intensity of the discharging lamp was controlled so that the potential of the photoreceptor after the discharging process is the same as that in Example 254.

The evaluation results are shown in Table 81.

TABLE 81

| | | | Potential of | |
|---|---|---|---|---|
| | | Transmittance | lighted portion (V_{L}) | |
| | | of protective | (−V) | |
| | Wavelength of | layer against | At beginning | After |
| | discharging | discharging | of | running |
| | light (nm) | light | running test | test |
| Ex. 254 | 428 | 86 | 110 | 115 |
| Ex. 255 | 472 | 87 | 110 | 120 |
| Comp. Ex. 110 | 502 | 87 | 110 | 150 |
| Comp. Ex. 111 | 591 | 88 | 110 | 155 |
| Comp. Ex. 112 | 630 | 89 | 110 | 160 |
| Comp. Ex. 113 | White light | — | 110 | 145 |
| Comp. Ex. 114 | 428 and 630 | 86 and 89 | 110 | 150 |

It is clear from Table 81 that when the wavelength of the discharging light is less than 500 nm (Examples 254 and 255), increase in potential (V_{L}) of the lighted portion is lower than that in the cases where the wavelength of the discharging light is not less than 500 nm (Comparative Examples 110-112). In particular, when the wavelength of the discharging light is less than 450 nm (i.e., Example 254), increase in potential (V_{L}) of the lighted portion is lower than that in Example 255.

In addition, it is also found that when discharging light having a wide wavelength range and including light having a relatively long wavelength is used (i.e., Comparative Example 113), such an effect as produced in Examples 254 and 255 cannot be produced. Further, it is found that when a combination of two light sources emitting light with different wavelengths is used (Comparative Example 114), the effect of the light having a relatively short wavelength is reduced.

The image qualities of the color images produced in Examples 254 and 255 were hardly changed before and after the running test. However, the color images produced in Comparative Examples 110-114 after the running test have slightly poor color reproducibility (i.e., the color tones of the color images are changed after the running test).

Finally, an experiment was performed to confirm whether the lowest angle peak of the X-ray diffraction spectrum of the titanyl phthalocyanine crystal used for the present invention, which is observed at an angle of 7.3°, is the same as or different from the lowest angle peak of the X-ray diffraction spectrum of known titanyl phthalocyanine crystals, which is observed at an angle of 7.5°.

### Comparative Synthesis Example 1

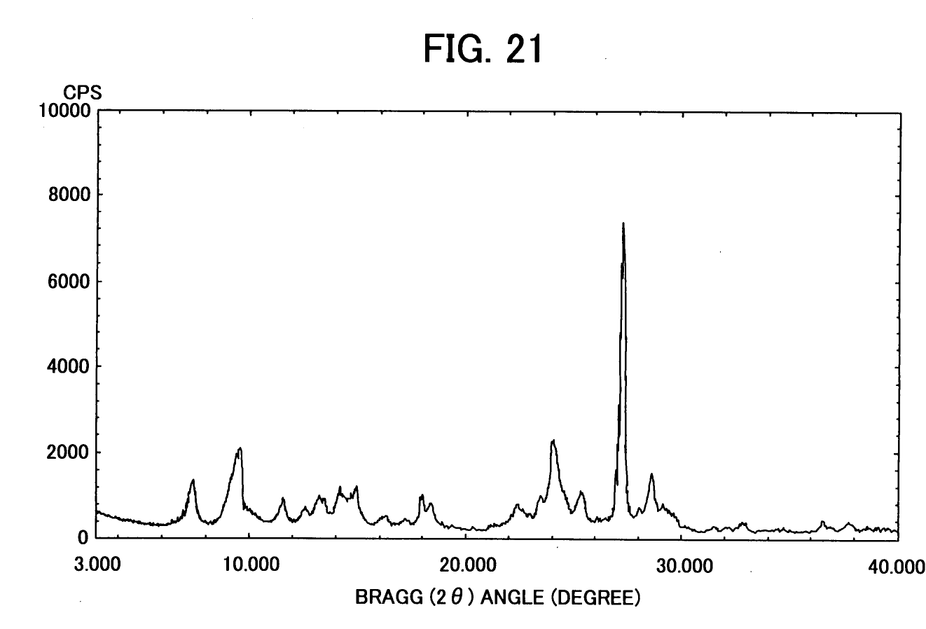

The procedure for preparation of the titanyl phthalocyanine crystal in Synthesis Example 5 and the X-ray diffraction analysis was repeated except that the crystal conversion solvent was changed from tetrahydrofuran to 2-butanone. The X-ray diffraction spectrum of the thus prepared titanyl phthalocyanine crystal is illustrated in FIG. 21. It is clear from FIGS. 19 and 21 that the lowest angle peak (7.3°) of the titanyl phthalocyanine crystal prepared in Synthesis Example 5 is different from the lowest angle peak (7.5°) of the above-prepared titanyl phthalocyanine crystal.

### Measurement Example 1

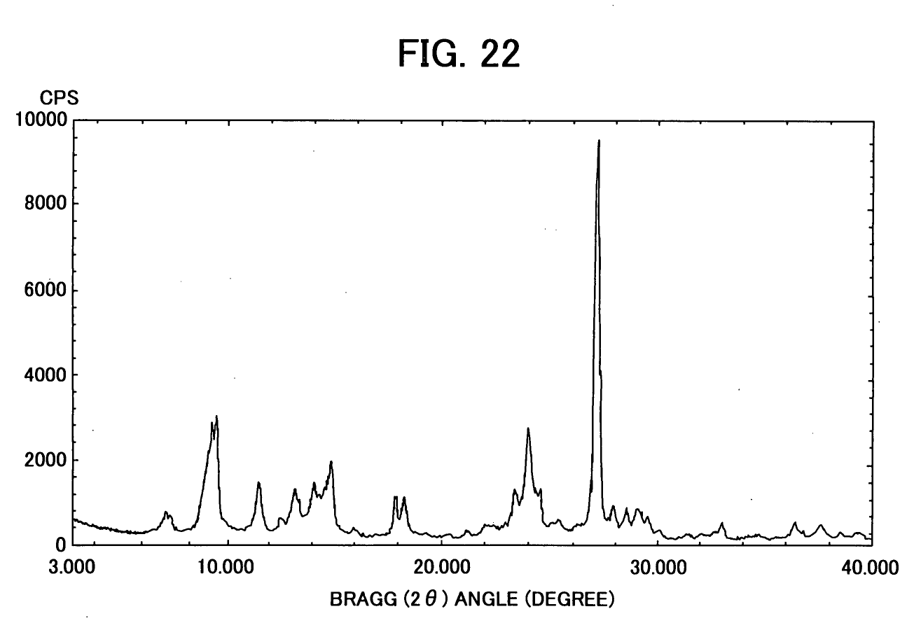

The titanyl phthalocyanine pigment which was prepared in Synthesis Example 5 and which has a lowest angle peak at 7.3° was mixed with a titanyl phthalocyanine crystal, which was prepared by the same method as disclosed in JP-A 61-239248 and which has a lowest angle peak at 7.5°, in a weight ratio of 100:3. The mixture was mixed in a mortar. The mixture was subjected to the X-ray diffraction analysis. The spectrum of the mixture is shown in FIG. 22.

### Measurement Example 2

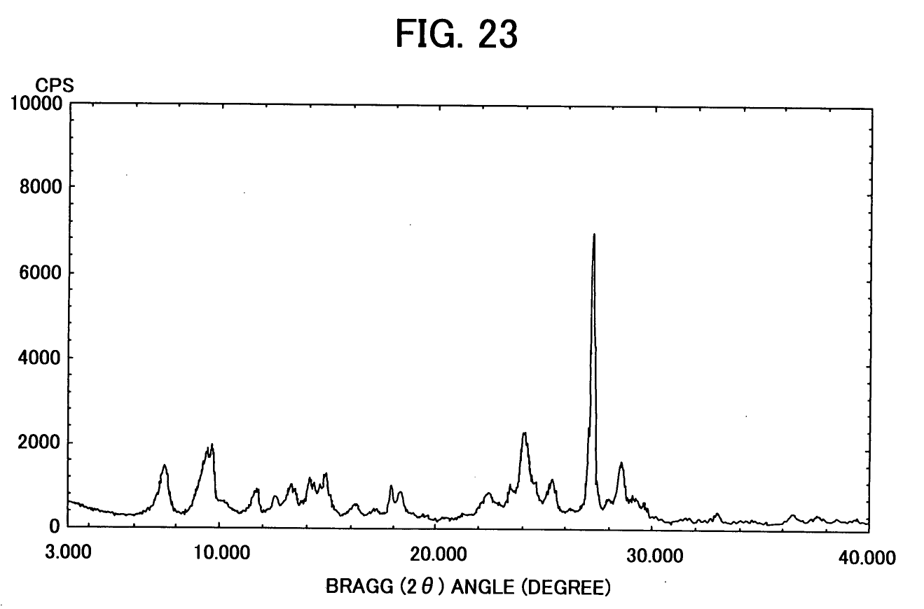

The titanyl phthalocyanine pigment which was prepared in Comparative Synthesis Example 1 and which has a lowest angle peak at 7.5° was mixed with a TiOPc crystal, which was prepared by the same method as disclosed in JP-A 61-239248 and which has a lowest angle peak at 7.5°, in a weight ratio of 100:3. The mixture was mixed in a mortar. The mixture was subjected to the X-ray diffraction analysis. The spectrum of the mixture is shown in FIG. 23.

As can be understood from the spectrum as shown in FIG. 22, two independent peaks are present at 7.3° and 7.5°. Therefore, the peaks are different from the other. In contrast, in the spectrum as shown in FIG. 23, only one lowest angle peak is present at 7.5°, namely the spectrum as shown in FIG. 19 is clearly different from the spectrum as shown in FIG. 21. Therefore, the lowest angle peak (7.3°) of the titanyl phthalocyanine crystal of the present invention is clearly different from the lowest angle peak (7.5°) of the conventional titanyl phthalocyanine crystal.

This document claims priority and contains subject matter related to Japanese Patent Application No. 2005-059829, filed on Mar. 4, 2005, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image forming apparatus comprising:
an electrostatic latent image bearing member configured to bear an electrostatic latent image, said image bearing member including a photosensitive layer including a charge generation layer containing an organic charge generation material, and a charge transport layer;
an electrostatic latent image forming device configured to form the electrostatic latent image on a surface of the electrostatic latent image bearing member;
a developing device configured to develop the electrostatic latent image with a developer including a toner to form a toner image on the surface of the image bearing member;
a transferring device configured to transfer the toner image onto a receiving material;
a fixing device configured to fix the toner image to the receiving material; and
a discharging device configured to dissipate charges remaining on the image bearing member after the toner image is transferred by irradiating the electrostatic latent image bearing member with discharging light having a wavelength of less than 500 nm.

2. The image forming apparatus according to claim 1, wherein the organic charge generation material is an azo pigment having the following formula (XI):
Ar—(—N═N-Cp)ₙ (XI)
wherein Ar represents a substituted or unsubstituted aromatic hydrocarbon group or a substituted or unsubstituted heterocyclic ring group, which can be connected with the azo group with or without a group therebetween; Cp represents a residual group of a coupler; n is an integer of from 2 to 6, wherein the coupler has the following formula (XII): 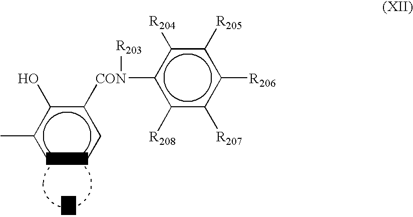
wherein R₂₀₃ represents a hydrogen atom, an alkyl group, or an aryl group; R₂₀₄, R₂₀₅, R₂₀₆, R₂₀₇ and R₂₀₈ independently represent a hydrogen atom, a nitro group, a cyano group, a halogen atom, a halogenated alkyl group, an alkyl, an alkoxyl group, a dialkylamino group or a hydroxyl group; and Z represents an atomic group needed for constituting a substituted or unsubstituted aromatic carbon ring or a substituted or unsubstituted aromatic heterocyclic ring.

3. The image forming apparatus according to claim 2, wherein the azo pigment has the following formula (XIII): 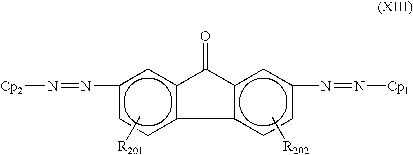
wherein R₂₀₁ and R₂₀₂ independently represent a hydrogen atom, a halogen atom, an alkyl group, an alkoxyl group, or a cyano group; and Cp₁ and Cp₂ independently represent a residual group of a coupler having formula (XII).

4. The image forming apparatus according to claim 3, wherein the groups Cp₁ and Cp₂ are different from each other.

5. The image forming apparatus according to claim 1, wherein the organic charge generation material is a phthalocyanine compound.

6. The image forming apparatus according to claim 5, wherein the phthalocyanine compound is a member selected from the group consisting of gallium phthalocyanine compounds, and titanyl phthalocyanine compounds.

7. The image forming apparatus according to claim 6, wherein the phthalocyanine compound is a titanyl phthalocyanine compound having an X-ray diffraction spectrum such that a maximum peak is observed at a Bragg (2 θ) angle of 27.2°±0.2°.

8. The image forming apparatus according to claim 7, wherein the titanyl phthalocyanine compound has an X-ray diffraction spectrum such that a maximum peak is observed at a Bragg (2 θ) angle of 27.2±0.20, a lowest angle peak at an angle of 7.3±0.2°, and a main peak at each of Bragg (2 θ) angles of 9.4±0.2°, 9.6±0.2°, and 24.0±0.2°, wherein no peak is observed between the peaks of 7.3°±0.2° and 9.4°±0.2° and at an angle of 26.3±0.2°.

9. The image forming apparatus according to claim 8, wherein the titanyl phthalocyanine compound has an average primary particle diameter of not greater than 0.25 μm.

10. The image forming apparatus according to claim 1, wherein the charge transport layer has a transmittance of not less than 30% against the discharging light.

11. The image forming apparatus according to claim 1, wherein the electrostatic latent image bearing member further includes a protective layer overlying the charge transport layer.

12. The image forming apparatus according to claim 11, wherein the protective layer has a transmittance of not less than 30% against the discharging light.

13. The image forming apparatus according to claim 11, wherein the protective layer includes a crosslinked polymer having a unit obtained from a radical polymerizable monomer having three or more functional groups and no charge transport structure and a unit obtained from a monofunctional radical polymerizable monomer having a charge transport structure.

14. The image forming apparatus according to claim 1, wherein the electrostatic latent image bearing member further includes an intermediate layer between the substrate and the charge generation layer, wherein the intermediate layer includes titanium oxide.

15. The image forming apparatus according to claim 1, wherein the electrostatic latent image bearing member further includes an intermediate layer between the substrate and the charge generation layer, wherein the intermediate layer includes a charge blocking layer and a moiré preventing layer.

16. The image forming apparatus according to claim 15, wherein the charge blocking layer includes an insulating material and has a thickness of less than 2.0 μm and not less than 0.3 μm, and the moiré preventing layer includes an inorganic pigment and a binder resin, wherein a volume ratio of the inorganic pigment to the binder resin is from 1/1 to 3/1.

17. The image forming apparatus according to claim 1, wherein the electrostatic latent image forming device includes:
a charging device configured to charge the surface of the electrostatic latent image bearing member; and
a light irradiator configured to irradiate the charged electrostatic latent image bearing member with imagewise light having a wavelength of less than 450 nm to form the electrostatic latent image on the surface of the electrostatic latent image bearing member.

18. The image forming apparatus according to claim 1, wherein the image forming apparatus comprises a plurality of image forming units each including the electrostatic latent image bearing member, the electrostatic latent image forming device, the developing device, the transferring device and the discharging device.

19. The image forming apparatus according to claim 1, wherein the image forming apparatus comprises a process cartridge including:
the electrostatic latent image bearing member; and
at least one of the developing device, the discharging device and a cleaning device configured to clean the surface of the electrostatic latent image bearing member,
wherein the process cartridge is detachably attached to the image forming apparatus as a unit.

20. An image forming method comprising:
forming an electrostatic latent image on an electrostatic latent image bearing member including a photosensitive layer including a charge generation layer containing an organic charge generation material, and a charge transport layer;
developing the electrostatic latent image with a developer including a toner to form a toner image on the image bearing member;
transferring the toner image onto a receiving material;
fixing the toner image to the receiving material; and
dissipating charges remaining on the electrostatic latent image bearing member after transferring the toner image by irradiating the electrostatic latent image bearing member with discharging light having a wavelength of less than 500 nm.

21. The image forming method according to claim 20, wherein the electrostatic latent image forming comprises:
charging an electrostatic latent image bearing member including a photosensitive layer including a charge generation layer containing an organic charge generation material, and a charge transport layer; and
irradiating the charged electrostatic latent image bearing member with imagewise light having a wavelength less than 450 nm to form the electrostatic latent image on the electrostatic latent image bearing member.

22. The image forming method according to claim 20, wherein the electrostatic latent image forming, the electrostatic latent image developing, the toner image transferring and the charge dissipating processes are performed plural times to form an image.
